(19) United States
(12) Patent Application Publication
(10) Pub. No.: US 2026/0322212 A1
(43) Pub. Date: Oct. 15, 2026

(54) FASTENER TOOL WITH LINEAR MOTOR

(71) Applicant: Black & Decker Inc., New Britain, CT (US)

(72) Inventors: Matthew J. Lazzaro, Forest Hill, MD (US); Kelvin M. Donoghue, Baltimore, MD (US); Corey L. Bean, Baltimore, MD (US); Daniel Amos Odean Hegarty, Baltimore, MD (US); Vivekkumar Mohankumar, Ellicott City, MD (US); Joseph C. Baybrick, Parkville, MD (US); Kyle M. Staley, Cockeysville, MD (US); Anish P Patil, Cockeysville, MD (US)

(21) Appl. No.: 19/697,145

(22) Filed: Jun. 3, 2026

Related U.S. Application Data
(63) Continuation of application No. PCT/US2024/058242, filed on Dec. 3, 2024.
(60) Provisional application No. 63/605,733, filed on Dec. 4, 2023.
(60) Provisional application No. 63/659,233, filed on Jun. 12, 2024.

(51) Int. Cl. H02K 7/14; B25C 1/06; B25C 5/15; H02K 1/16; H02K 3/28; H02K 11/215; H02K 11/33; H02K 41/03

(52) U.S. Cl. CPC H02K 7/145; B25C 1/06; B25C 5/15; H02K 1/16; H02K 3/28; H02K 11/215; H02K 11/33; H02K 41/031

(57) ABSTRACT

A fastener device that drives one or more fasteners into a workpiece includes a tool housing, a motor assembly, and a driver. The motor assembly is within the tool housing, and the motor assembly comprises a stator set including a first stator, a second stator, and a plunger. The driver is within the tool housing and coupled to the plunger. The plunger is configured to travel along a drive axis between a retracted condition and an extended condition to drive a fastener of the one or more fasteners into the workpiece during a drive stroke. The first and second stators are spaced apart circumferentially around the plunger and the plunger is disposed between the first stator and the second stator to magnetically interact with each of the first and second stator.

### RELATED APPLICATION(S)

The present patent application is a continuation application of PCT Application No. PCT/US2024/058242, filed Dec. 3, 2024, and titled “Fastener Tool With Linear Motor,” which claims the benefit of U.S. Provisional Patent Application Ser. Nos. 63/605,733 filed Dec. 4, 2023, and 63/659,233 filed Jun. 12, 2024, all of which are incorporated herein by reference in their entireties.

### FIELD

The patent application relates, in general, to the field of power tools. In particular, this patent application relates to linear electromagnetic motors and portable fastening or driving tools, such as nailers and staplers.

### BACKGROUND

Fastener devices/tools, such as nailers and staplers, are relatively commonplace in the construction trades. Several types of the nailers have been introduced to the market in an effort to satisfy the demands of modern consumers. Some of the nailers use a spring-loaded device to push fasteners into position such that a drive mechanism or driver may then be actuated to fire or push a fastener/nail/staple into a workpiece.

The fastener device may typically include a drum for storing a coil of collated fasteners and a feed mechanism or feeder configured to feed the fasteners into a nosepiece/nose assembly of the fastener device. These fastener devices are known in the art for attaching a series or a succession of nails or fasteners into workpieces.

The fastener devices can be electric, battery or pneumatic powered.

In the fastener devices that employ pneumatic actuation to drive a fastener into a workpiece, air pressure from a pneumatic system can be utilized to both drive the fastener into the workpiece and to reset the fastener device after driving the fastener. It will be appreciated that, in the pneumatic fastener system, a hose and a compressor are required to accompany the fastener device. A combination of the hose, the device and the compressor can provide for a large, heavy and bulky package that can be relatively inconvenient and cumbersome to transport.

The battery powered fastener device can engage a transmission and a motor to drive a fastener into the workpiece. Inefficiencies inherent in the transmission and the motor, however, can limit battery life. Disadvantages of the battery powered system may also include power & fastening energy.

A solenoid has been used in fastener devices to drive small fasteners into the workpiece. Typically, the solenoid executes multiple impacts on a single fastener to generate the force needed to drive the fastener into a workpiece. In other instances, corded fastener devices, i.e., connected to wall voltage, can use a solenoid to drive the fastener in a single stroke but the power requirements can be relatively large and are better suited to corded applications.

U.S. Patent Application Publication No. 2022/0324089A1 (“the '089 Patent Publication”) is titled “Multistage Solenoid Fastener Device with a Magnetic Driver” and is commonly assigned to the same assignee as the present patent application. The '089 Patent Publication is incorporated by reference in its entirety in the present patent application.

The '089 Patent Publication discloses a multistage solenoid that may be configured to be used in combination with a nailer. The multistage solenoid may be referred to as a linear electromagnetic motor or a multistage linear electromagnetic motor. The motor of the '089 Patent Publication may include multiple coils/coil assemblies in series constrained axially and the magnetic driver circumscribed by the multiple coils/coil assemblies, where each coil is circumferentially wound around the magnetic driver. By selectively energizing and de-energizing stages, electromagnetic fields of the multistage solenoid interact with magnetic field of the magnetic driver to establish a generally linear motion (e.g., along longitudinal axis A-A) of the magnetic driver. The interaction between the electromagnetic fields and the magnetic field of the magnetic driver is configured to efficiently drive one or more fasteners into a workpiece.

The present patent application provides improvements in the linear electromagnetic motors and the fastener tools.

### SUMMARY

One aspect of the present disclosure provides a fastener device that drives one or more fasteners into a workpiece. The fastener device comprises a tool housing, a motor assembly, and a driver. The motor assembly is within the tool housing, and the motor assembly comprises a stator set including a first stator, a second stator, and a plunger. The driver is within the tool housing and coupled to the plunger. The driver is configured to travel along a drive axis between a retracted condition and an extended condition to drive a fastener of the one or more fasteners into the workpiece during a drive stroke. The first and second stators are spaced apart circumferentially around the plunger and the plunger is disposed between the first stator and the second stator to magnetically interact with each of the first and second stator.

Implementations of the foregoing aspects may include one or more of the following features.

In an aspect, the first stator may include a first stator core oriented along a first plane that is substantially parallel to the drive axis, a plurality of first teeth extending inwardly from the first stator core in a direction substantially perpendicularly to the first plane and perpendicular to the drive axis, and a plurality of first windings wound around the first stator teeth. The second stator may include a second stator core oriented along a second plane that is substantially parallel to the drive axis, a plurality of second teeth extending inwardly from the second stator core in a direction substantially perpendicular to the second plane and perpendicular to the drive axis, and a plurality of second windings wound around the second stator teeth.

In an aspect, the first stator and the second stator may be physically separate from each other. The first stator and the second stator may be configured to be operated synchronously.

In an aspect, a plurality of phases of the first stator may respectively electrically coupled to a plurality of phases of the second stator. The fastener device may further comprise an inverter circuit comprising a plurality of power switches that may be configured to synchronously drive the first and second stators via a common plurality of phase voltage input lines.

In an aspect, the motor assembly may further comprise a frame. The first stator and the second stator may be configured to be coupled to the frame. The plurality of phases of the first stator may be connected to the plurality of phases of the second stator via a plurality of connectors or wires disposed along the frame.

In an aspect, the fastener device may further comprise a first inverter circuit comprising a plurality of first power switches configured to drive the first stator via a first plurality of phase voltage input lines, and a second inverter circuit comprising a plurality of second power switches configured to drive the second stator via a second plurality of phase voltage input lines.

In an aspect, the first inverter circuit and the second inverter circuit may be synchronously controlled to cause synchronous drive of the first and second stators.

In an aspect, the motor assembly may include a plurality of first stators and a plurality of second stators. The plurality of first stators may extend along a single first axis substantially parallel to the drive axis and are disposed on one side of the driver. The plurality of second stators may extend along a single second axis substantially parallel to the drive axis and are disposed on the opposing side of the driver. The first stator may be one of the plurality of first stators and the second stator may be one of the plurality of second stators. One of the plurality of first stators and one of the plurality of second stators may be operated synchronously to drive the driver along the drive axis. The plurality of first stators may be configured to be sequentially energized to drive the driver along the drive axis. The plurality of second stators may be configured to be sequentially energized to drive the driver along the drive axis.

In an aspect, a commutation of a subsequent stator of the plurality of first stators may begin when the plunger reaches a predetermined distance relative to the first stator.

In an aspect, the plunger may include a plurality of magnets with alternating polarities in sequence. The plunger may include a plurality of plunger cores. Each plunger core may be configured to house at least one magnet of the plurality of magnets.

In an aspect, the at least one magnet may include two magnets having the same polarity. Each plunger core may be configured to house one magnet on one side of the plunger core and the other magnet on an opposing side of the plunger core.

In an aspect, the motor assembly may further comprise a frame. The first stator and the second stator may be configured to be coupled to the frame.

In an aspect, the frame may comprise non-magnetic material.

In an aspect, the frame may extend along a third plane substantially perpendicular to the first and second planes between the first stator and the second stator.

Another aspect of the present disclosure provides a fastener device that drives one or more fasteners into a workpiece comprises a tool housing, a motor assembly, and a driver. The motor assembly is within the tool housing, and the motor assembly comprises a stator assembly, a plunger, and a frame. The driver is within the tool housing, and the driver is configured to travel along a drive axis between a retracted condition and an extended condition to drive a fastener of the one or more fasteners into the workpiece during a drive stroke. The stator assembly is configured to drive the driver along the drive axis. The plunger is coupled to the driver and includes a plurality of magnets with alternating polarities in sequence. The plunger includes at least one plunger core securely mounted on the driver and configured to house at least one magnet of the plurality of magnets. The frame includes a first axial guide member. The plunger core includes a second axial guide member on a surface thereof that does not face the stator assembly arranged to slidingly engage the first axial guide feature to guide the plunger along the drive axis at a set distance relative to the stator assembly.

Implementations of the foregoing aspects may include one or more of the following features.

In an aspect, the first axial guide member includes a guide rod extending substantially parallel to the drive axis and the second axial guide member includes a guide rod receiving opening configured to receive the guide rod therethrough to enable the plunger to slide along lengths of the guide rods so as to maintain an air gap between the plunger and the stator assembly.

In an aspect, the plunger may include at least one plunger core including at least one magnet receiving opening configured to receive the plurality of magnets therein.

In an aspect, the magnets received in the magnet receiving openings of one of the plunger cores may have the same polarity.

In an aspect, the at least one plunger core may comprise at least a first plunger core and a second plunger core. A first magnet received within a first magnet receiving opening of the first plunger core may have a different polarity than a second magnet received within a second magnet receiving opening of the second plunger core.

In an aspect, the at least one plunger core may comprise at least a first plunger core and a second plunger core. The second axial guide member may be formed on the first plunger core, and the second plunger core includes a notch formed therein that allows axial passage of the first axial guide member alongside thereof.

In an aspect, the at least one plunger core may include a driver receiving opening arranged to securely receive the driver. The driver receiving opening may be disposed centrally or offset from a center point of the plunger core.

In an aspect, the frame assembly may include two opposing sides. The stator assembly is connected to at least one of the two opposing sides. Each of the other of the two opposing sides may include openings that are configured to receive portions of the first axial guide member therein so as to connect the first axial guide member to the frame assembly.

Yet another aspect of the present disclosure provides a linear motor comprises a plunger and a stator. The plunger includes at least one permanent magnet configured to travel along a drive axis. The stator is in magnetic interface with the plunger. The stator comprises a stator core oriented along a plane that is substantially parallel to the drive axis, a plurality of stator teeth extending from the stator core towards the plunger in a direction substantially perpendicular to the plane, and a plurality of stator windings wound around the plurality of stator teeth such that a winding plane of the plurality of stator windings is substantially perpendicular to the drive axis.

Implementations of the foregoing aspects may include one or more of the following features.

In an aspect, the plunger may include a plunger core that supports one or more permanent magnets in magnetic interaction with the plurality of stator windings.

In an aspect, the linear motor may further comprise a sense magnet secured to a side of the plunger core not facing the stator, and a frame extending from the stator configured to support a Hall board having one or more of Hall sensors linearly oriented to sense a magnetic flux of the sense magnet as the plunger travels along the drive axis.

Yet another aspect of the present disclosure provides a power tool that comprises a linear motor, and at least one controller. The linear motor includes a plunger including at least one permanent magnet configured to travel along a drive axis; a first stator in magnetic interface with the plunger; and a second stator in magnetic interface with the plunger and disposed adjacent the first stator along the drive axis. Each of the first stator and the second stator includes: a stator core, a plurality of stator teeth extending from the stator core towards the plunger, and a plurality of stator windings wound around the plurality of stator teeth such that a winding plane of the plurality of stator windings is substantially tangential to the drive axis, the plurality of stator windings forming a plurality of phases for each of the first and the second stators. The at least one controller is configured to control a commutation of the first and second stators such that, during at least a position of the plunger relative to the first and second stator, at least of a plurality of phases of the first stator applies a repelling force to the plunger while at least one of a plurality of phases of the second stator applies an attracting force to the plunger.

In yet another embodiment, a fastener device that drives one or more fasteners into a workpiece is provided. The fastener device comprises a tool housing and a motor assembly within the tool housing. The motor assembly comprises a plunger including a plurality of permanent magnets moveable along a drive axis and a stator extending peripherally around the plunger. The stator includes a stator core having an outer body and a plurality of teeth that extend inwardly from the outer body in the direction of the plunger, and a plurality of stator windings respectively wound around the plurality of stator teeth. The plurality of stator windings is located peripherally around the plunger along a radial plane that is substantially perpendicular to the drive axis to magnetically interact with the permanent magnets of the plunger.

Implementations of the foregoing aspects may include one or more of the following features.

In an aspect, the fastener device may further comprise a driver within the tool housing and configured to be drivable via the plunger. The plunger may be configured to travel along the drive axis between a retracted condition and an extended condition to drive a fastener of the one or more fasteners into the workpiece during a drive stroke.

In an aspect, the stator core may include a plurality of arcuate stator segments that interlock with each other to form a substantially cylindrical outer body.

In an aspect, each arcuate stator segment may be formed from a plurality of steel laminations. Each steel lamination may include an arcuate portion extending at an angular distance that is approximately equivalent to 360/n degrees, where n is the number of the plurality of arcuate stator segments, a tooth portion extending radially inwardly from the arcuate portion, and a tooth shoe extending laterally from an inner end of the tooth portion.

In an aspect, each of the plurality of stator windings may be wound along a winding axis that is substantially perpendicular to the drive axis.

In an aspect, the plurality of stator windings may be spaced apart along a circumferential direction.

In an aspect, the motor assembly may include a plurality of stators including at least the stator and at least a second stator. The second stator may be oriented along a second radial plane substantially parallel to the radial plane of the stator.

In an aspect, the plurality of stator windings of the stator may be energized in a first energization pattern. The plurality of stator windings of the second stator may be energized in a second energization pattern.

In an aspect, at a first predetermined position of the plunger, the plurality of stator windings of the stator and the plurality of stator windings of the second stator may both be energized at the first energization pattern. At a second predetermined position of the plunger, the plurality of stator windings of the stator may be energized at a second energization pattern that is different from the first energization pattern and the plurality of stator windings of the second stator may be energized at the first energization pattern.

In an aspect, each of the plurality of permanent magnets may include a singular magnetic polarity facing the plurality of stator windings. In the first energization pattern, the plurality of stator windings of the stator may be energized in the same polarity.

In an aspect, the stator includes a single-pole construction and the plurality of stator windings of the stator may be wound from a single magnet wire and in the same winding direction.

In an aspect, each of the plurality of permanent magnets may include at least a N-S magnetic polarity in a circumferential direction. The stator includes a multi-pole construction and the plurality of stator windings of the stator may be wound in at least two opposite winding directions.

In an aspect, an axial distance between the plurality of permanent magnets may be approximately equal to ¾th an axial distance between the plurality of stators.

In an aspect, each of the plurality of stators may be configured to be separated from adjacent stators of the plurality of stators along the drive axis.

In an aspect, the motor assembly may further include a plurality of stator spacers. Each of the plurality of stator spacers may be configured to separate adjacent stators of the plurality of stators.

In an aspect, each of the plurality of stator spacers comprises at least one of magnetic material, insulating material or non-magnetic material. Each of the plurality of stator spacers may be molded around at least one lead wire that supplies electric power to the plurality of stator windings of at least one of the plurality of the stators.

In an aspect, the motor assembly may further include an outer housing that is configured to receive and fixedly support the plurality of stator spacers and the plurality of stators. An inner circumferential surface of the outer housing may be configured to engage with outer circumferential surfaces of the plurality of stator spacers and the plurality of stators.

In an aspect, the motor assembly may further include a plurality of sensors linearly oriented and utilized to sense an axial position of the plunger as the plunger travels along the drive axis. The plurality of sensors may be disposed on a circuit board supported by inner circumferential surfaces of the stator cores of the plurality of stators. In an embodiment, the stator assembly may include at least one optical sensor that senses the axial position of the plunger.

In an aspect, the plurality of sensors includes a plurality of optical transmitters and a plurality of optical receivers oriented on two sides of the plunger. Optical transmission between at least one of the plurality of optical transmitters and the plurality of optical receivers is disrupted by the plunger as the plunger travels along the drive axis.

In an aspect, the fastener device may further include at least one controller configured to control a commutation of the plurality of stators such that, during at least a position of the plunger relative to the plurality of stators, the plurality of stator windings of the stator applies a repelling force to the plunger while the plurality of stator windings of the second stator applies an attracting force to the plunger.

In as aspect, the plunger may be configured to be securely mounted on the driver. The plunger may include a plurality of plunger spacers disposed between the plurality of permanent magnets. Each of the plurality of plunger spacers and each of the plurality of permanent magnets may include a ring-shaped configuration and includes a driver receiving opening configured to securely receive the driver therein. Each of the plurality of permanent magnets may include a magnet ring including a plurality of magnetic poles or a plurality of arcuate magnet portions that cooperate with each other to form the permanent magnet. The plurality of arcuate magnet portions may include alternating polarities in sequence along the circumference of the permanent magnet.

In an aspect, the motor assembly may further include an inner housing that is disposed radially between the plunger and the plurality of stators. The inner housing may include non-magnetic, low friction material. The inner housing may be securely positioned relative to inner ends of the plurality of stator teeth. The inner housing may be configured to receive and support the plurality of plunger spacers and the plurality of permanent magnets therein. An inner circumferential surface of the inner housing may be configured to support outer circumferential surfaces of the plurality of permanent magnets as the plurality of permanent magnets travel along the drive axis.

In an aspect, the inner housing may include longitudinal extending openings that are configured to enable optical sensing of the plunger as the plunger travels along the drive axis.

In an aspect, the driver may include a driver body having a central longitudinal axis. The central longitudinal axis may be parallel to the drive axis. The driver may include a driver blade that is oriented along a plane that is substantially parallel to the drive axis and the central longitudinal axis and that may be offset from the central longitudinal axis of the drive body.

In an aspect the plurality of arcuate stator segments may include an even number of stator segments.

In an aspect, the plunger may comprise a central longitudinal axis that is parallel to and spaced apart from the drive axis. The plunger may comprise a plurality of plunger cores including a first plunger core and a second plunger core. The first plunger core and the second plunger core may be adjacent to each other. The second plunger core may be oriented along a second radial plane substantially parallel to a first radial plane of the first plunger core.

In an aspect, each of the plurality of plunger cores may be configured to receive one or more of the plurality of permanent magnets therein.

In aspect, each of the plurality of plunger cores may comprise one or more magnet pockets. Each magnet pocket may be configured to receive one of the one or more permanent magnets therein.

In an aspect, each magnet pocket may be configured to fully enclose one of the one or more permanent magnets therein.

In an aspect, each magnet pocket may be configured to partially enclose one of the one or more permanent magnets therein.

In an aspect, the motor assembly may further include a plurality of plunger spacers. Each of the plurality of plunger spacers may be configured to separate, along the drive axis, adjacent plunger cores of the plurality of plunger cores.

In an aspect, the motor assembly may further include a central guide rod that extends substantially parallel to the drive axis. The plunger may be configured to be securely mounted on the central guide rod. Each of the plurality of plunger spacers and each of the plurality of plunger cores may comprise a ring-shaped configuration.

In an aspect, each of the plurality of plunger spacers and each of the plurality of plunger cores comprise a driver receiving opening configured to securely receive the driver therein, a fastener receiving opening configured to securely receive a fastener therein, and a guide rod receiving opening configured to receive the central guide rod therethrough to enable the plunger to slide along a length of the central guide rod so as to maintain an air gap between the plunger and the stator.

In an aspect, the fastener may be configured to connect the plurality of plunger cores to each other. The driver may be also configured to connect the plurality of plunger cores to each other. The driver receiving opening and the fastener receiving opening may be configured to be interchangeably used such that the one of the driver receiving opening and the fastener receiving opening is configured to securely receive the driver and the other of the driver receiving opening and the fastener receiving opening is configured to securely receive the fastener.

In an aspect, the size, the shape and/or the configuration of the driver receiving opening and the fastener receiving opening may be the same.

In an aspect, the guide rod receiving opening may be disposed between the driver receiving opening and the fastener receiving opening.

In an aspect, the one or more magnet pockets may be disposed on peripheral portions of each plunger core. The guide rod receiving opening, the driver receiving opening and the fastener receiving opening may be disposed in central portions of each plunger core.

In an aspect, for each plunger core, the one or more magnet pockets may be disposed to surround the guide rod receiving opening, the driver receiving opening and the fastener receiving opening.

In an aspect, for each plunger core, the guide rod receiving opening, the driver receiving opening and the fastener receiving opening may be disposed within the one or more magnet pockets.

In an aspect, the fastener device may further comprise a guide rod receiving member that is configured to be received in the guide rod receiving openings of the plunger spacers and the plunger cores. The guide rod receiving member may be also configured to receive the guide rod therethrough.

In an aspect, the guide rod receiving member may be a linear bearing.

In yet another embodiment, a linear motor is provided. The linear motor comprises a plunger including a plurality of permanent magnets moveable along a drive axis, and a stator. The stator extending peripherally around the plunger. The stator includes a stator core having an outer body and a plurality of teeth that extend inwardly from the outer body in the direction of the plunger. The stator includes a plurality of stator windings respectively wound around the plurality of stator teeth. The plurality of stator windings is located peripherally around the plunger along a radial plane that is substantially perpendicular to the drive axis to magnetically interact with the permanent magnets of the plunger.

In yet another embodiment, a fastener device that drives one or more fasteners into a workpiece is provided. The fastener device comprises a tool housing; a motor assembly within the tool housing, and a driver within the tool housing. The motor assembly comprises a stator supporting a plurality of stator windings, and a plunger including at least one permanent magnet that magnetically interact with the plurality of stator windings to cause linear movement of the plunger along a center longitudinal axis. The plunger includes at least one plunger core comprising a magnet pocket through which the center longitudinal axis passes and within which the at least one permanent magnet is securely housed, and a driver receiving opening through which the driver is securely received so that the linear movement of the plunger along the center longitudinal axis drives the driver along a drive axis that is offset from but parallel to the center longitudinal axis.

Implementations of the foregoing aspects may include one or more of the following features.

In an aspect, the fastener device may further comprise an offset plunger core disposed adjacent the at least one plunger core. The offset plunger core may include a magnet pocket that is substantially aligned with the magnet pocket of the at least one plunger core. The driver may pass outside a body of the offset plunger core.

In an aspect, the tool housing may include a top end portion. The driver may be disposed closer to the top end portion of the tool housing.

In an aspect, the at least one plunger core of the plunger may include a fastener receiving opening that is configured to securely receive a fastener, and a guide rod receiving opening that is configured to receive a guide rod therethrough to enable the plunger to slide along a length of the guide rod so as to maintain an air gap between the plunger and the stator.

In an aspect, the at least one plunger core of the plunger may include a first plunger core and a second plunger core. The first plunger core and the second plunger core may be adjacent to each other. The fastener may be configured to connect the first plunger core and the second plunger core to each other. The driver may also be configured to connect the first plunger core and the second plunger core to each other. The driver receiving opening and the fastener receiving opening may be configured to be interchangeably used such that the one of the driver receiving opening and the fastener receiving opening is configured to securely receive the driver and the other of the driver receiving opening and the fastener receiving opening is configured to securely receive the fastener.

In an aspect, the size, the shape and/or the configuration of the driver receiving opening and the fastener receiving opening may be the same.

In an aspect, the driver receiving opening and the fastener receiving opening formed on the first plunger core may be configured to securely receive the driver and the fastener, respectively. The driver receiving opening and the fastener receiving opening formed on the second plunger core may be configured to securely receive the fastener and the driver, respectively.

In an aspect, the driver receiving opening formed on the first plunger core may be configured to align with the fastener receiving opening formed on the second plunger core so as to securely receive the driver therein. The fastener receiving opening formed on the first plunger core may be configured to align with the driver receiving opening formed on the second plunger core so as to securely receive the fastener therein.

In an aspect, a portion of the driver that is received in the driver receiving opening formed on the first plunger core and the fastener receiving opening formed on the second plunger core may include the same shape, size and configuration as a portion of the fastener that is received in the fastener receiving opening formed on the first plunger core and the driver receiving opening formed on the second plunger core.

In an aspect, the guide rod receiving opening may be formed on the first plunger core and may be disposed on one side of the driver. The guide rod receiving opening may be formed on the second plunger core and may be disposed on the other side of the driver.

In an aspect, the guide rod receiving opening formed on the first plunger core may be disposed above the driver and the guide rod receiving opening formed on the second plunger core may be disposed below the driver.

In an aspect, the motor assembly may include a frame. The frame may include the first guide rod and a second guide rod. The first guide rod and the second guide rod may extend substantially parallel to the drive axis. The guide rod receiving opening formed on the first plunger core may be configured to receive the first guide rod therethrough to enable the plunger to slide along the length of the first guide rod so as to maintain the air gap between the plunger and the stator. The guide rod receiving opening formed on the second plunger core may be configured to receive the second guide rod therethrough to enable the plunger to slide along the length of the second guide rod so as to maintain the air gap between the plunger and the stator.

In an aspect, the first guide rod may be disposed on one side of the driver and the second guide rod may be disposed on the other side of the driver.

In an aspect, the first guide rod may be disposed above the driver and the second guide rod may be disposed below the driver.

In an aspect, the at least one permanent magnet may have a pole facing the plurality of stator windings.

In an aspect, the magnet pocket may be disposed between the driver receiving opening and the fastener receiving opening. The magnet pocket may be disposed below the driver.

In an aspect, the magnet pocket may be disposed between the first guide rod and the second guide rod. The magnet pocket may be disposed below the driver.

In an aspect, the first guide rod may be disposed above the driver and may be disposed above the magnet pocket with the magnet therein. The second guide rod may be disposed below the driver and may be disposed below the magnet pocket with the magnet therein.

In an aspect, the fastener device may further comprise a sense magnet secured to the at least one plunger core. The sense magnet may be configured to extend along an axis parallel to the drive axis and may be disposed below the driver, the first guide rod, and the second guide rod. The fastener device may further comprise a frame extending from the stator configured to support a sensor to sense a magnetic flux of the sense magnet as the plunger travels along the drive axis.

In an aspect, the plunger may include a plurality of plunger cores and a plurality of plunger spacers. The at least one plunger core may be one of the plurality of plunger cores. Each of the plurality of plunger spacers may be configured to separate adjacent plunger cores of the plurality of plunger cores. Each of the plurality of plunger spacers may include a driver receiving opening that is configured to securely receive the driver, a fastener receiving opening that is configured to securely receive a fastener, and a first guide rod receiving opening and a second guide rod receiving opening that are configured to receive a first guide rod and a second guide rod, respectively therethrough to enable the plunger to slide along lengths of the first and the second guide rod so as to maintain an air gap between the plunger and the stator.

In an aspect, each of the plurality of plunger spacers may include a sensor magnet receiving portion that is configured to receive and support a sense magnet therein.

In an aspect, the stator may be in magnetic interface with the plunger. The stator may comprise a stator core, a plurality of stator teeth extending from the stator core towards the plunger, and the plurality of stator windings wound around the plurality of stator teeth. The at least one plunger core of the plunger may be configured to support one of the plurality of permanent magnets in magnetic interaction with the plurality of stator windings.

In an aspect, the stator may include a first stator and a second stator that are spaced apart circumferentially around the plunger and the plunger may be disposed between the first stator and the second stator to magnetically interact with each of the first and second stator.

In an aspect, the first stator may include a first stator core oriented along a first plane that is substantially perpendicular to the drive axis, a plurality of first teeth extending inwardly from the first stator core in a direction substantially parallel to the first plane and perpendicular to the drive axis, and a plurality of first windings wound around the first stator teeth. The second stator may include a second stator core oriented along a second plane that is substantially perpendicular to the drive axis, a plurality of second teeth extending inwardly from the second stator core in a direction substantially parallel to the second plane and perpendicular to the drive axis, and a plurality of second windings wound around the second stator teeth.

In an aspect, the stator may comprise a plurality of stator core segments provided along a first plane extending parallel to a second plane formed by the drive axis and the center longitudinal axis, and a plurality of stator teeth extending perpendicularly from the plurality of stator core segments in the direction of the second plane. The plurality of stator windings may be wound around the plurality of stator teeth.

In an aspect, the at least one permanent magnet may traverse proximate inner tips of the plurality of stator teeth in magnetic interaction with the plurality of stator windings, and the driver may traverse proximate a top portion of the plurality of stator teeth.

In an aspect, the driver may be configured to travel along the drive axis between a retracted position and an extended position to drive a fastener of the one or more fasteners into the workpiece during a drive stroke. The fastener device may further comprise a magazine that holds the one or more fasteners; and a fastener feed mechanism that arranges the fastener from the magazine along the drive axis for engagement with the driver.

In an aspect, the center longitudinal axis intersects the magazine.

In an aspect, the tool housing may include a handle portion that supports a trigger switch below the motor assembly, and a front wall that supports a bumper along the center longitudinal axis that limits the movement of the plunger along the longitudinal center axis. The driver may traverse through an opening of the front wall at a location above the bumper.

In yet another embodiment, a fastener device that drives one or more fasteners into a workpiece is provided. The fastener device comprises a tool housing, a motor assembly within the tool housing, a driver within the tool housing, and a lock. The motor assembly comprises a plunger and a stator. The driver is configured to be drivable via the plunger. The plunger is configured to travel along a drive axis between a retracted position and an extended position to drive a fastener of the one or more fasteners into the workpiece during a drive stroke. The lock is configured to releasably lock the plunger when the plunger is in the retracted position.

Implementations of the foregoing aspects may include one or more of the following features.

In an aspect, the lock may comprise an electronically activated lock.

In an aspect, the fastener device may further comprise a controller configured to cause the electronically activated lock to release the plunger from the retracted position approximately at or within a predetermined time-period before or after the stator being energized to drive the plunger.

In an aspect, the electronically activated lock may comprise a spring biased and solenoid actuated lock member. The lock member may be moveable along an axis that is substantially perpendicular to the drive axis to engage or disengage the plunger.

In an aspect, the fastener device may further include a solenoid that drives the lock member. The lock member may be biased by a biasing member to engage with the recess when the plunger is in its retracted position. When the solenoid is activated, the lock member may be retracted against the bias of the biasing member so as to release the lock member from the recess.

In an aspect, the fastener device may further comprise a biasing member that biases the lock member to hold the plunger in the retracted position. The plunger may be disengaged from the retracted position when an electromagnetic force applied by the stator to the plunger exceeds a threshold biasing force of the biasing member applies to the lock member.

In an aspect, the retracted position of the plunger may be a home position of the plunger. The lock may include a first lock portion and a second lock portion that are configured to engage with each other to releasably lock the plunger when the plunger is in its retracted position. The first lock portion may include a lock member. The second lock portion may include a recess formed in the driver. The recess may be configured to receive the lock member when the plunger is in the retracted position.

The second lock portion may include a chamfered portion that is configured to enable the plunger to slide past the lock member, as the plunger is being moved to its retracted position, so that the lock member is received in the recess when the plunger is in its retracted position.

In an aspect, the retracted position of the plunger may be a home position of the plunger. The lock may include a first lock portion and a second lock portion that are configured to engage with each other to releasably lock the plunger when the plunger is in its retracted position. The first lock portion may include two protruding members that are disposed on the plunger and that extend towards the second lock portion. In an aspect, the second lock portion may include a biasing member that is configured to bias the second lock portion towards the first lock portion. In an aspect, the second lock portion may also include a first angled surface portion, a second angled surface portion, and a flat surface portion between the first and second angled surface portions. The flat surface portion may extend in a plane parallel the drive axis. The first and second angled surface portions may be configured to be angled with respect to the drive axis. A first of the two protruding members of the plunger may be configured to engage with the first angled surface portion and a second of the two protruding members of the plunger may be configured to engage with the second angled surface portion to releasably lock the plunger when the plunger is in its retracted position.

In an aspect, an angle of the first angled surface portion may be different from an angle of the second angled surface portion.

In an aspect, the angle of the second angled surface portion may be greater than the angle of the first angle surface portion. The second angled surface portion may include a steeper slope than the first angle surface portion.

In an aspect, as the plunger is being moved from its extended position to its retracted position, the second of the two protruding members may first be configured to engage with the first angled surface portion and a first force is applied to the plunger to move the second of the two protruding members past the first angled surface portion. As the plunger is being moved from its retracted position to its extended position, a second force may be applied to the plunger to move the second of the two protruding members past the second angled surface portion. The second force may be greater than the first force.

In an aspect, the second force may be greater than a spring biasing force that biases the second lock portion towards the first lock portion.

In yet another embodiment, the linear motor comprises a frame, a plunger, and a stator. The frame may have a first guide rod and a second guide rod. The plunger may include one or more magnets configured to travel along a drive axis. The stator may be in magnetic interface with the plunger. The stator may comprise: a stator core, a plurality of stator teeth extending from the stator core towards the plunger, and a plurality of stator windings wound around the plurality of stator teeth. The plunger may include at least two plunger cores that support the one or more magnets in magnetic interaction with the plurality of stator windings. The at least two plunger cores may include a first plunger core and a second plunger core. The first plunger core may be configured to be coupled to the first guide rod and the second plunger core may be configured to be coupled to the second guide rod. The first guide rod and the second guide rod may be configured to enable the plunger to slide along lengths of the first and the second guide rods so as to maintain an air gap between the plunger and the stator.

In yet another embodiment, a fastener device comprises a housing and a motor assembly within the housing. The motor assembly comprises a stator including a plurality of coils and a plunger including at least one permanent magnet configured to magnetically interact with the plurality of coils of the stator to cause a linear movement of the plunger along a drive axis between a retracted position and an extended position, to drive a fastener into a workpiece during a drive stroke in a direction of the extended position and return to the retracted position during a return stroke. The fastener device comprises a power source configured to provide electric power to the stator, and a controller disposed within the housing. The controller is configured switchably to control a supply of electric power from the power source to the stator to control the linear movement of the plunger during the drive stroke and the return stroke. The controller is configured to control the electric power applied the stator at a lower level during the return stroke than during the drive stroke such that a velocity of the linear movement of the plunger is greater during the drive stroke within which the plunger drives the fastener into the workpiece than it is during the return stroke within which a subsequent fastener is positioned for engagement with the plunger.

In an aspect, the power source may include a capacitor mounted within the housing. The fastener device may further comprise a battery receptacle configured to receive a removeable battery pack. The battery pack may be configured to apply a charge current to the capacitor.

In an aspect, a discharge current from the capacitor may power the stator during the drive stroke and the return stroke.

In an aspect, a discharge current from the capacitor may power the stator during the drive stroke and a discharge current from the battery pack powers the stator during the return stroke.

In an aspect, a discharge current from the capacitor is boosted by a discharge current from the battery pack to power the stator during the drive stroke, but not during the return stroke.

In an aspect, the capacitor may be configured to be discharged only during the drive stroke.

In an aspect, the capacitor may have a nominal voltage of approximately 60V to 480V and may be capable of storing electric energy of greater than or equal to approximately 10 Joules, and the battery pack may have a maximum voltage of less than approximately 20 V.

In an aspect, a nominal voltage of the electric energy applied to the stator may be greater during the drive stroke than it is during the return stroke by a factor of approximately 3 to 4 times.

In an aspect, the controller configured to control the electric energy applied to the stator may be in a range of approximately 0.25 Joules to 2 Joules, preferably approximately 0.5 Joules to 1.5 Joules, during the return stroke, and in a range of approximately 4.5 Joules to 9.5 Joules, preferably greater than or equal to 5.5 Joules, during the drive stroke.

In an aspect, the fastener device may further comprise a switch circuit located between the power source and the motor. The controller may be configured to apply drive signals to the switch circuit to control the commutation of the stator.

In an aspect, the controller may be configured to apply the drive signals to control an average current of the electric power applied to the stator to be greater during the drive stroke than it is during the return stroke by a factor of approximately 4 to 12 times, preferably at least approximately 6 times, more preferably approximately 7 times.

In an aspect, the controller may be configured to set a pulse-width modulation (PWM) duty cycle of the drive signals to a first level during the drive stroke and to a second level that is smaller than the first level during the return stroke.

In an aspect, the PWM duty cycle may be in a range of approximately 11% to approximately 100%, preferably at least approximately 20%, during the drive stroke and in a range of approximately 2% to approximately 10% during the return stroke.

In an aspect, the controller may be configured to control a pulse-width modulation (PWM) duty cycle of the drive signals to regulate the flow of electric power to the stator, and to apply a cycle-by-cycle current limit by interrupting the flow of electric power through the switch circuit for a remainder of each PWM cycle if a current level of the electric power exceeds a current threshold. The cycle-by-cycle current limit may be set to a first level during the drive stroke and to a second level that is smaller than the first level during the return stroke.

In an aspect, the controller may be configured to control a conduction band corresponding to a bandwidth of the plurality of phases of the stator. The conduction band may be set to a first level during the drive stroke and to a second level that is smaller than the first level during the return stroke. In another or further aspect, the controller may be configured to apply a current vector control, or a field-oriented control (FOC), so as to apply current at a first level during the drive stroke and at a second level that is smaller than the first level during the return stroke.

In yet another embodiment, a fastener device comprises a housing and a motor assembly within the housing. The motor assembly comprises a stator including a plurality of coils and a plunger including at least one permanent magnet configured to magnetically interact with the plurality of coils of the stator to cause a linear movement of the plunger along a drive axis between a retracted position and an extended position, to drive a fastener into a workpiece during a drive stroke in a direction of the extended position and return to the retracted position during a return stroke. The fastener device comprises a capacitor that provides electric power to the stator and a controller disposed within the housing. The controller is configured switchably to control a supply of electric power from the capacitor to the stator to control the linear movement of the plunger during the drive stroke and the return stroke. The controller is configured to: obtain a voltage of the capacitor during at least one of a charge sequence or a discharge sequence of the capacitor; measure a rate of change of the voltage of the capacitor during the at least one of the charge sequence or the discharge sequence; and if the rate of change of the voltage of the capacitor is below a predetermined threshold: interrupt the at least one of the charge sequence and/or the discharge sequence; and apply a warming sequence including a plurality of charge pulses and a plurality of discharge current pulses to the capacitor for a preset duration of time or until the rate of change of the voltage of the capacitor is greater than or equal to the predetermined threshold.

In an aspect, the controller may be configured to control the plurality of discharge current pulses such that the plurality of discharge current pulses does not cause a substantial movement of the plunger away from the retracted position.

In an aspect, the controller may be configured to control the plurality of discharge current pulses to have a smaller average current than the discharge sequence.

In an aspect, the controller may be configured to set a pulse-width modulation (PWM) duty cycle for discharging the capacitor to a first level during the drive stroke and to a second level that is smaller than the first level during the warming sequence.

In an aspect, the fastener device may further comprise a switch circuit located between the power source and the motor. The controller may be configured to apply drive signals to the switch circuit to control the commutation of the stator. The controller may be configured to control the drive signals in a sequence that substantially prevents the movement of the plunger away from the retracted position while applying the plurality of discharge current pulses to the capacitor.

In an aspect, the fastener device may further comprise a voltage sensor coupled to the capacitor. The controller may be configured to obtain the voltage of the capacitor from the voltage sensor.

In an aspect, the predetermined threshold may correspond to the rate of change of the voltage of the capacitor during the at least one of the charge sequence or the discharge sequence when a temperature of the capacitor is within an ambient temperature range.

In an aspect, the predetermined threshold may include a first threshold that corresponds to the charge sequence of the capacitor and a second threshold that corresponds to the discharge sequence of the capacitor.

In an aspect, the fastener device may further comprise a warming sequence illuminator mounted on the housing. The controller may be configured to illuminate the warming sequence illuminator during the warming sequence of the capacitor.

In yet another embodiment, a fastener device comprises a housing and a motor assembly within the housing. The motor assembly comprises a stator including a plurality of coils and a plunger including at least one permanent magnet configured to magnetically interact with the plurality of coils of the stator to cause a linear movement of the plunger along a drive axis between a retracted position and an extended position, to drive a fastener into a workpiece during a drive stroke in a direction of the extended position and return to the retracted position during a return stroke. The fastener device comprises a power source configured to provide electric power to the stator and a controller disposed within the housing. The controller is configured switchably to control a supply of electric power from the power source to the stator to control the linear movement of the plunger during the drive stroke and the return stroke. The controller is configured to: determine a bounce back velocity of the plunger relative to the extended position; and change an energization value of the electric power supplied to the stator if the bounce back velocity of the plunger is outside a predetermined range relative to a bounce back velocity threshold.

In an aspect, the fastener device may further comprise a sensor configured to output a signal corresponding to a position of the plunger. The controller may be configured to determine bounce back velocity after the plunger reaches the extended position based on the signal from the sensor.

In an aspect, the controller may be configured to dynamically set the bounce back velocity threshold as a function of repeated operations of the fastener device.

In an aspect, the controller may be configured to: determine a plurality of bounce back velocity values associated with a predetermined number of drive strokes; determine a target bounce back velocity of the plunger as a function of the plurality of bounce back velocity values; and change the bounce back velocity threshold according to the target bounce back velocity if the target bounce back velocity is outside the predetermined range relative to the bounce back velocity threshold.

In an aspect, the controller may be configured to maintain the bounce back velocity threshold if the target bounce back velocity of the plunger is within the predetermined range.

In an aspect, the controller may be configured to calculate the bounce back velocity during a preset amount of time or a preset amount of distance after the plunger begins to move towards the retracted position from the extended position.

In an aspect, the controller may be configured to: determine that the plunger has a high bounce back velocity if the bounce back velocity of the plunger is greater than the predetermined range relative to the bounce back velocity threshold; and decrease the energization value if the plunger has the high bounce back velocity.

In an aspect, the controller may be configured to: determine that the plunger has a low bounce back velocity if the bounce back velocity of the plunger is smaller than the predetermined range relative to the bounce back velocity threshold; and increase the energization value if the plunger has the low bounce back velocity.

In an aspect, the controller may be configured to: determine that the plunger has a normal bounce back velocity if the bounce back velocity of the plunger is within the predetermined range relative to the bounce back velocity threshold; and maintain the energization value of the motor assembly if the plunger has the normal bounce back velocity.

In an aspect, the fastener device may further comprise a bumper that is engaged by the plunger or a driver coupled to the plunger when the driver reaches the extended position. The bounce back velocity may be associated with contact with the bumper.

In an aspect, the controller may be configured to control a pulse-width modulation (PWM) duty cycle of the drive signals at a first duty cycle during the drive stroke and at a second duty cycle during the return stroke. The controller may be configured to modify at least one of the second duty cycle during the return stroke or the first duty cycle during a subsequent drive stroke if the bounce back velocity of the plunger is outside the predetermined range relative to the bounce back velocity threshold.

In an aspect, the controller may be configured to control a pulse-width modulation (PWM) duty cycle of the drive signals to regulate the flow of electric power to the stator, and to apply a cycle-by-cycle current limit by interrupting the flow of electric power through the switch circuit for a remainder of each PWM cycle if a current level of the electric power exceeds a current threshold, wherein the cycle-by-cycle current limit is set to a first level during the drive stroke and to a second level during the return stroke. The controller may be configured to modify at least one of the second duty cycle during the return stroke or the first duty cycle during a subsequent drive stroke if the bounce back velocity of the plunger is outside the predetermined range relative to the bounce back velocity threshold.

In yet another embodiment, a fastener device comprises a housing and a motor assembly within the housing. The motor assembly comprises a stator including a plurality of coils and a plunger including at least one permanent magnet configured to magnetically interact with the plurality of coils of the stator to cause a linear movement of the plunger along a drive axis between a retracted position and an extended position, to drive a fastener into a workpiece during a drive stroke in a direction of the extended position and return to the retracted position during a return stroke. The fastener device comprises a power source configured to provide electric power to the stator, and a controller disposed within the housing. The controller is configured switchably to control a supply of electric power from the power source to the stator to control the linear movement of the plunger during the drive stroke and the return stroke. The controller is configured to: detect a change in a velocity of the plunger during a drive stroke; and detect an abnormal drive event indicative of the fastener not having been driven during the drive stroke as a function of an axial position of the plunger at the time of the detected change of the velocity of the plunger.

In an aspect, the fastener device may further comprise a sensor configured to output a signal corresponding to a position of the plunger. The abnormal drive event may be a dry fire event. The controller may be configured to calculate a rate of change in the velocity of the plunger within a predetermined travel range of the plunger relative to the extended position to detect the dry fire event. In an aspect, the predetermined travel range corresponds to the length of the fastener, and an absence of change in the velocity of the plunger until it has reached the extended position is indicative of the dry fire event.

In an aspect, the predetermined travel range of the plunger may correspond to a length of the fastener relative to an end of each drive stroke.

In an aspect, the abnormal drive event may include a jam event related to the fastener. The controller may be configured to detect the jam event if a magnitude of the detected rate of change of velocity exceeds a predetermined threshold and the detected change in the velocity of the plunger occurs at a distance from the extended position that is greater than a distance threshold.

In an aspect, the fastener device may further comprise a jam error illuminator. The controller may be configured to (a) illuminate the jam error illuminator when the jam event is detected and (b) wait until the plunger is in a cogging position before initiating the return stroke.

In an aspect, the distance threshold may correspond to a length of the fastener.

In an aspect, the controller may be configured to detect a normal drive stroke if the change in the velocity of the plunger occurs at a distance from the extended position that is within a distance threshold range.

In an aspect, the controller may be configured to initiate the return stroke when the normal drive stroke is detected.

In an aspect, the distance threshold range may correspond to a range of possible lengths of the fastener.

In an aspect, the fastener device may further comprise an abnormal drive error illuminator. The controller may be configured to illuminate the abnormal drive error illuminator when the abnormal drive event is detected.

In an aspect, the controller may be configured to: obtain the velocity and the position of the plunger for each return stroke; and detect a stall event if the velocity and/or the position of the plunger for each return stroke is not within a predetermined return stroke threshold.

In an aspect, the predetermined return stroke threshold may include a predetermined return stroke velocity threshold and/or a predetermined return stroke position threshold.

In an aspect, the fastener device may further comprise a stall error illuminator. The controller may be configured to illuminate the stall error illuminator when the stall event is detected.

In an aspect, after detection of the stall event, the controller may be configured to wait until the plunger is in a cogging position relative to the stator before initiating a return sequence.

In one embodiment, a fastener device that drives one or more fasteners into a workpiece is provided. The fastener device comprises a housing and a motor assembly within the housing. The motor assembly comprises a stator supporting a plurality of stator windings, and a plunger including one or more permanent magnets that magnetically interact with the plurality of stator windings to cause linear movement of the plunger along a longitudinal axis. The plunger comprises an overmold structure that is configured to hold/secure the one or more permanent magnets in place during the linear movement of the plunger along the longitudinal axis.

In an aspect, the overmold structure may comprise at least a plunger body. The fastener device may further comprise at least two magnet support members provided in engagement with opposite surfaces of the one or more permanent magnets. Each magnet support member may include a body portion in contact with the one or more permanent magnets and a retaining portion that is captured by the overmold structure to secure the one or more permanent magnets relative to the overmold structure.

In an aspect, the at least two magnet support members may be disposed on opposing sides of one of the one or more permanent magnets such that the body portion of each magnet support member engages with the outer side surface of one of the one or more permanent magnets and the retaining portion of each magnet support member engages with the at least portions of the top surface and the bottom surface of the one or more permanent magnets.

In an aspect, the retaining portion of each magnet support member may include two angular lip portions projecting from ends of the body portion.

In an aspect, the retaining portion of each magnet support member may include two substantially U-shaped members that projects over at least portions of the top surface and the bottom surface of the one or more permanent magnets.

In an aspect, one of the one or more permanent magnets and the at least two magnet support members surrounding/sandwiching portions of one of the one or more permanent magnets may be configured to be insert molded into the plunger body so as to form the overmold structure.

In an aspect, the plunger body may be made of a plastic material and each magnet support member may be made of a metal material.

In an aspect, each magnet support member may be exposed and substantially uncovered by the overmold structure alongside the one or more permanent magnets facing the stator.

In an aspect, the body portions of the magnet support members may be disposed in planes that are parallel to each other and are parallel to a plane formed by the plurality of stator windings.

In an aspect, a lateral width of the overmold structure may be greater than a lateral width defined between outer surfaces of the two magnet support members.

In an aspect, the overmold structure may comprise two discrete portions each engaging one end of the magnet support members.

In an aspect, the fastener device may further comprise a driver within the housing. The driver may be configured to be drivable axially/longitudinally via the plunger. The housing may include a top end portion. The driver may be disposed closer to the top end portion of the housing.

In an aspect, the linear movement of the plunger along the longitudinal axis may drive the driver along the drive axis that is offset from but parallel to the longitudinal axis.

In an aspect, the at least a plunger body may include a fastener receiving opening that is configured to securely receive a fastener, and at least one guide rod receiving opening that is configured to receive a guide rod therethrough to enable the plunger to slide along a length of the guide rod so as to maintain an air gap between the plunger and the stator.

In an aspect, the at least one guide rod receiving opening may include two guide rod receiving openings. One of the two guide rod receiving openings may be configured to disposed on a top end portion of the housing and the other of the two guide-rod receiving openings may be configured to disposed on a bottom end portion of the housing.

In an aspect, the plunger body may include a guide rod receiving member that is configured to be received in the at least one guide rod receiving opening. The guide rod receiving member may also be configured to receive the guide rod therethrough.

In an aspect, the guide rod receiving member may be a linear bearing.

In an aspect, the guide rod receiving member may be configured to be insert molded into the at least one guide rod receiving opening of the plunger body.

In an aspect, the longitudinal axis may be a center longitudinal axis. The plunger body may comprise a magnet pocket through which the center longitudinal axis passes and in which the at least two magnet support members along with one of the one or more permanent magnets therebetween are insert molded, and a driver receiving opening through which the driver is securely received so that the linear movement of the plunger along the center longitudinal axis drives the driver along the drive axis that is offset from but parallel to the center longitudinal axis.

In an aspect, the overmold structure may comprise two or more plunger bodies.

In an aspect, the two or more plunger bodies may include a first plunger body and a second plunger body. The first plunger body and the second plunger body may be adjacent to each other. A magnet pocket of the first plunger body may be substantially aligned with a magnet pocket of the second plunger body. The fastener may be configured to connect the first plunger body and the second plunger body to each other. The driver may also be configured to connect the first plunger body and the second plunger body to each other. The driver receiving opening and the fastener receiving opening may be configured to be interchangeably used such that the one of the driver receiving opening and the fastener receiving opening is configured to securely receive the driver and the other of the driver receiving opening and the fastener receiving opening is configured to securely receive the fastener.

In an aspect, the overmold structure may comprise two or more plunger bodies each associated with a corresponding permanent magnet of the one or more permanent magnets. Each plunger body may include a first overmold portion securing a first end of the corresponding permanent magnet and a second overmold portion securing a second end of the corresponding permanent magnet. The first overmold portion may include a guide rod receiving opening and the second overmold portion is smaller than the first overmold portion and does not include a guide rod receiving opening. The one or more permanent magnets may be substantially aligned with one another, but the first overmold portion of a first of the plunger bodies is not aligned with the first overmold portion of a second of the plunger bodies.

In yet another embodiment, a linear motor is provided. The linear motor comprises a plunger and a stator in magnetic interface with the plunger, the stator supporting a plurality of stator windings. The plunger comprises at least one permanent magnet that magnetically interacts with the plurality of stator windings to cause linear movement of the plunger along a longitudinal axis. The plunger comprises an overmold structure that is configured to hold the at least one permanent magnet in place during the linear movement of the plunger along the longitudinal axis.

In yet another embodiment, a linear motor is provided. The linear motor comprises a frame, a plunger including one or more permanent magnets configured to travel along a drive axis, and at least one stator disposed on one side of the plunger and in magnetic interface with the plunger. The at least one stator includes a plurality of stator segments and a spacer disposed between the plurality of stator segments, Each of the spacer and the stator segment includes one or more first engagement portions. The frame comprises one or more second engagement portions that correspond to the one or more first engagement portions of the at least one stator. The one or more second engagement portions of the frame are configured to engage with the one or more first engagements portions of the at least one stator to support the at least one stator on the frame.

In an aspect, the one or more first engagement portions of the at least one stator may be spaced apart and equidistant from each other. The one or more second engagement portions of the frame may be spaced apart and equidistant from each other.

In an aspect, the one or more first engagement portions of the at least one stator may include pin members.

In an aspect, the one or more second engagement portions of the frame may include openings that are configured to receive the pin members.

In an aspect, each of the spacer may include a spacer core and a spacer tooth extending from the spacer core towards the plunger. Each of the plurality of stator segments may include a stator core, a stator tooth extending from the stator core towards the plunger, and a stator winding wound around the stator segment tooth.

In an aspect, the size and shape of the spacer core may be the same as the size and shape of the stator core.

In an aspect, the stator windings of adjacent stator segments are separated from each other by the spacer tooth.

In an aspect, the plurality of stator segments may include three stator segments and the spacer includes one of two spacers.

In yet another embodiment, a fastener device that drives one or more fasteners into a workpiece is provided. The fastener device comprises a housing, a motor assembly within the housing, and a driver within the housing. The motor assembly comprises a stator supporting a plurality of stator windings, and a plunger comprising at least a plunger core comprising a magnet pocket through which a longitudinal axis passes and within which at least one permanent magnet is securely housed. The at least one permanent magnet magnetically interacts with the plurality of stator windings to cause linear movement of the plunger along the longitudinal axis. The driver is driveably coupled to the plunger and configured to drive the one or more fasteners into the workpiece with movement by the driver along a drive axis that is the same as or parallel to the longitudinal axis. The driver is securely coupled to an end of the plunger and is configured not to longitudinally extend through the at least the plunger core.

In an aspect, the plunger may include an end cap mounted to the end thereof adjacent a longitudinal end of the at least one plunger core. The driver may include a head extending perpendicularly from a rear end thereof. The end cap may include a driver head opening that is configured to securely receive the head therein.

In an aspect, the at least a plunger core may include a plurality of plunger cores including a front plunger core, a rear plunger core and one or more plunger cores therebetween. The plurality of plunger cores may be separated from each other by a plunger spacer. The plunger may also include an end cap configured to be attached to a front wall of the front plunger core. The end cap may be oriented substantially along a plane that is perpendicular to the longitudinal axis.

In an aspect, the end cap includes a driver head opening that is configured to receive at least a portion of a head of the driver therein.

In an aspect, the plunger may include a driver support assembly that is configured to support the driver. The front end-cap may include a driver head opening that is configured to receive at least a portion of a head of the driver therein. The driver support assembly includes the front end-cap.

In an aspect, the driver head opening may be disposed centrally on the front end-cap.

In an aspect, the driver support assembly may also include a driver retention member. The driver retention member may include a driver body opening that is configured to receive and allow a body of the driver to pass therethrough. A rear wall of the driver retention member may be configured to engage with a front wall of the front end-cap when the driver retention member is connected to the front end-cap. Portions of the rear wall of the driver retention member that surround the driver body opening are configured to engage with portions of the head of the driver received in the driver head opening when the driver retention member is connected to the front end-cap. The driver retention member may also include two fastener receiving openings that are configured to securely receive fasteners therein. Each fastener may be configured extend axially/longitudinally through the plunger cores to connect the plunger cores to each other. One of the two fastener receiving openings of the driver retention member may be disposed on one side of the driver and the other of the two fastener receiving openings of the driver retention member is disposed on the other side of the driver.

In yet another embodiment, a fastener device is provided. The fastener device comprises a housing and a motor assembly within the housing. The motor assembly comprises a plunger configured to travel along a longitudinal axis and comprising at least one permanent magnet and a stator in magnetic interface with the plunger. The fastener device comprises a driver within the housing and coupled to the plunger. The driver drivable along a drive axis via the plunger. The fastener comprises a sense magnet secured to the driver and a frame configured to support a sensor to sense a magnetic flux of the sense magnet as the plunger travels along the longitudinal axis so as to detect an axial position of the plunger.

In an aspect, the sense magnet may be separate from the at least one permanent magnet of the plunger.

In an aspect, the fastener device may further comprise a support member that is configured to be coupled to a blade of the driver. The sense magnet may be supported by and mounted on the support member.

In an aspect, the sensor may be a magnetic sensor including one or more Hall sensors that are configured to output a signal corresponding to a position of the plunger based on a magnetic flux of the sense magnet relative to the magnetic sensor.

In an aspect, the fastener device may further comprise a nose assembly. The nose assembly may include the frame. The sensor may be configured to be supported by and received in a portion of the frame.

In an aspect, the frame may be configured to extend from the stator and the frame may be configured to support the sensor.

In an aspect, the sense magnet may be configured to extend axially/longitudinally along an axis parallel to the drive axis of the driver and the longitudinal axis of the plunger. The sense magnet may be disposed above the driver.

In an aspect, the stator may be configured to extend peripherally around the plunger. The stator may comprise a stator core including a plurality of stator teeth that extend inwardly from the stator core in the direction of the plunger, and a plurality of stator windings respectively wound around the plurality of stator teeth. The plurality of stator windings may be located peripherally around the plunger along a radial plane that is substantially perpendicular to the drive axis to magnetically interact with the at least one permanent magnet of the plunger.

In an aspect, the plunger may be configured to interact with the plurality of stator windings to cause linear movement of the plunger along the longitudinal axis. The linear movement of the plunger along the longitudinal axis may drive the driver along the drive axis that is offset from but parallel to the longitudinal axis.

In an aspect, the sense magnet may comprise a plurality of sense magnets having opposing polarities mounted along the drive axis.

In an aspect, the plunger may be moveable along the drive axis between a retracted position and an extended position, to drive a fastener into a workpiece during a drive stroke in a direction of the extended position and return to the retracted position during a return stroke. The plurality of sense magnets may be positioned relative to a front face of the plunger such that, in the extended position, none of the plurality of sense magnets may be located within a body of the stator, and in the retracted position, at least one of the plurality of sense magnets may be located within the body of the stator.

These and other aspects of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present disclosure, the structural components illustrated herein are drawn to scale. It is to be expressly understood, however, that the drawings are for the purpose of illustration and description only and are not intended as a definition of the limits of the present disclosure. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

Other aspects, features, and advantages of the present disclosure will become apparent from the following detailed description, the accompanying drawings, and the appended claims.

### BRIEF DESCRIPTION OF THE DRAWINGS

FIG. 1 shows a perspective view of an exemplary fastener device in accordance with an embodiment of the present disclosure;

FIGS. 2 and 3 show a front view and a perspective view, respectively of the exemplary fastener device of FIG. 1, where some portions of a housing of the fastener device are not shown to better illustrate other portions of the fastener device;

FIGS. 4 and 5 show perspective views of a motor assembly, a magazine, and portions of a nose assembly of the exemplary fastener device of FIG. 1, where some portions of the housing are shown in FIG. 4 and where a driver is shown in FIG. 5;

FIGS. 6-8 show an upper perspective view, a lower perspective view and a rear perspective view, respectively, of the motor assembly and the driver in accordance with an embodiment of the present disclosure;

FIGS. 9-10 show a front exploded view and a rear exploded view, respectively, of the motor assembly and the driver in accordance with an embodiment of the present disclosure, wherein a frame, guide rods, bumpers, a plunger, and stators of the motor assembly are also shown;

FIGS. 11-12 show a partial cutaway front view and a partial cutaway perspective view, respectively, of the motor assembly and the driver in accordance with an embodiment of the present disclosure, where the driver is in an extended condition;

FIGS. 13-14 show a partial cutaway front view and a partial cutaway perspective view, respectively, of the motor assembly and the driver in accordance with an embodiment of the present disclosure, where the driver is in an intermediate condition between the extended condition and a retracted condition;

FIGS. 15-16 show a partial cutaway front view and a partial cutaway perspective view, respectively, of the motor assembly and the driver in accordance with an embodiment of the present disclosure, where the driver is in another intermediate condition between the extended condition and the retracted condition;

FIGS. 17-18 show a partial cutaway front view and a partial cutaway perspective view, respectively, of the motor assembly and the driver in accordance with an embodiment of the present disclosure, where the driver is in the retracted condition;

FIGS. 19-21 show perspective views of the motor assembly and the driver in accordance with an embodiment of the present disclosure, where the driver is in the extended condition in FIG. 19, is in the intermediate condition in FIG. 20, and is in the retracted condition in FIG. 21;

FIG. 22 shows a perspective view of the motor assembly (including the guide rods) and the driver in accordance with an embodiment of the present disclosure, where a frame of the motor assembly is not shown to better illustrate other portions of the motor assembly;

FIGS. 23-24 show a perspective view and a front view, respectively, of the stators of the motor assembly in accordance with an embodiment of the present disclosure;

FIGS. 25-28 show a front perspective view, a rear perspective view, a partial cutaway perspective view, and another partial cutaway perspective view, respectively, of the plunger of the motor assembly and the driver in accordance with an embodiment of the present disclosure;

FIG. 29 shows a perspective view of the driver in accordance with an embodiment of the present disclosure;

FIGS. 30 and 31 show exploded views of the plunger of the motor assembly in accordance with an embodiment of the present disclosure;

FIGS. 32 and 33 show perspective views of a dual motor assembly, a magazine, and portions of a nose assembly of the exemplary fastener device of FIG. 1, where some portions of the housing are shown in FIG. 32 and where a driver is shown in FIG. 33;

FIGS. 34-36 show an upper perspective view, a lower perspective view and a rear perspective view, respectively, of the dual motor assembly and the driver in accordance with an embodiment of the present disclosure;

FIGS. 37-38 show a front exploded view and a rear exploded view, respectively, of the dual motor assembly and the driver in accordance with an embodiment of the present disclosure;

FIGS. 39-40 show a partial cutaway front view and a partial cutaway perspective view, respectively, of the dual motor assembly and the driver in accordance with an embodiment of the present disclosure, where the driver is in an extended condition;

FIGS. 41-42 show a partial cutaway front view and a partial cutaway perspective view, respectively, of the dual motor assembly and the driver in accordance with an embodiment of the present disclosure, where the driver is in an intermediate condition between the extended condition and a retracted condition;

FIGS. 43-44 show a partial cutaway front view and a partial cutaway perspective view, respectively, of the dual motor assembly and the driver in accordance with an embodiment of the present disclosure, where the driver is in another intermediate condition between the extended condition and the retracted condition;

FIGS. 45-46 show a partial cutaway front view and a partial cutaway perspective view, respectively, of the dual motor assembly and the driver in accordance with an embodiment of the present disclosure, where the driver is in the retracted condition;

FIGS. 47-49 show perspective views of the dual motor assembly and the driver in accordance with an embodiment of the present disclosure, where the driver is in the extended condition in FIG. 47, is in the intermediate condition in FIG. 48, and is in the retracted condition in FIG. 49;

FIG. 50 shows a perspective view of the dual motor assembly and the driver in accordance with an embodiment of the present disclosure, where the frame of the motor assembly is not shown to better illustrate other portions of the dual motor assembly;

FIGS. 51-52 show a perspective view and a front view, respectively, of the stator assembly in the dual motor assembly in accordance with an embodiment of the present disclosure;

FIGS. 53-55 show a front view, a perspective view and a top view, respectively, of the fastener device with the motor assembly and a hall board in accordance with an embodiment of the present disclosure;

FIGS. 56-57 show a partial cutaway top view and a partial cutaway perspective view, respectively, of the motor assembly and the hall board in accordance with an embodiment of the present disclosure;

FIGS. 58-59 show a rear view and a perspective view, respectively, of the hall board in accordance with an embodiment of the present disclosure;

FIG. 60 shows a perspective view of the plunger assembly of the motor assembly and the driver in accordance with another embodiment of the present disclosure;

FIGS. 61-62 show a front view and a rear view, respectively, of one of the plunger stacks of FIG. 60;

FIGS. 63A-63B show an exemplary motor assembly at a start position, the exemplary motor assembly at 360 eDeg, and another exemplary motor assembly shown in FIG. 63C in which the stator and the plunger are extended infinitely out, respectively, in accordance with an embodiment of the present disclosure;

FIG. 64A shows a graphical representation of electrical angles and corresponding displacements of the driver in drive direction for an exemplary motor assembly, which is shown in FIG. 64B, in accordance with an embodiment of the present disclosure;

FIGS. 65A and 65B show an exemplary motor assembly in accordance with an embodiment of the present disclosure, while FIG. 65C is a bottom view showing windings for the stator of the motor assembly of FIGS. 65A-65B;

FIG. 66A shows a single three phase inverter and FIG. 66B shows three phase motor winding of a single linear motor to which the single three phase inverter of FIG. 66A is connected to in accordance with an embodiment of the present disclosure;

FIG. 67A shows a single three phase inverter and FIG. 67B shows three phase motor winding of a dual/multiple linear motors that are series wound to which the single three phase inverter of FIG. 67A is connected to in accordance with an embodiment of the present disclosure;

FIG. 68A shows multiple three phase inverters and FIG. 68B shows three phase motor winding of a dual/multiple linear motors to which each of the multiple three phase inverters of FIG. 68A is respectively connected to in accordance with an embodiment of the present disclosure;

FIG. 69 shows timing for a dual three phase inverters in accordance with an embodiment of the present disclosure;

FIG. 70A shows a single three phase inverter, each of the six switches of the single three phase inverter are turned off/on using a field-oriented control (FOC) voltage drive to induce the current waveforms, as shown in FIG. 70B, for each phase in accordance with an embodiment of the present disclosure;

FIG. 71A shows a table with electrical angles, displacements, displacement proportions, phase voltages, etc. when the motor is being controlled by a trapezoidal voltage drive and FIG. 71B shows the motor configurations at various electrical angles when the motor is being controlled by a trapezoidal voltage drive in accordance with an embodiment of the present disclosure;

FIG. 72A shows a single three phase inverter, and FIG. 72B shows a table with electrical angles and corresponding voltages at various inverter connections, etc. in accordance with an embodiment of the present disclosure;

FIGS. 73A-73B show magnet(s) of the plunger and Hall sensors that are configured to detect stray fields from the magnet(s) of the plunger in accordance with an embodiment of the present disclosure, while FIG. 73C shows a graphical representation of hall output levels in accordance with an embodiment of the present disclosure;

FIG. 74 shows an exemplary positioning of the Hall PCB so that a Phase A Hall sensor may activate Phase A winding at an optimal time in accordance with an embodiment of the present disclosure;

FIG. 75 shows six exemplary steps/procedures showing the travel of the driver (and the plunger coupled to it) from its extended to its retracted condition in accordance with an embodiment of the present disclosure, FIG. 75 also shows directions and magnitudes of currents applied to each winding of the stator during these exemplary steps/procedures.

FIG. 76 shows an exemplary time graph of the power output of the fastening device;

FIG. 77 shows an exemplary linear motor along with an exemplary motor drive, an exemplary current modulation module, and an exemplary power source (e.g., capacitor(s)) in accordance with an embodiment of the present disclosure;

FIG. 78 shows an exemplary linear motor in accordance with an embodiment of the present disclosure, a table comparing features of the linear motor with another motor assembly, and a graphical representation of input estimated power, output power, and piston velocity in accordance with an embodiment of the present disclosure;

FIGS. 79-80 show a partial front view and a partial perspective view, respectively, of an exemplary fastener device in accordance with another embodiment of the present disclosure, wherein some portions of a housing of the fastener device are not shown to better illustrate other portions of the fastener device;

FIGS. 81-85 show perspective views or front views of a motor assembly, a magazine, and portions of a nose assembly of the exemplary fastener device of FIGS. 79-80, wherein FIGS. 81, 83 and 85 show the perspective views, wherein FIGS. 82 and 84 show the front views, wherein some portions of a stator are not shown in FIGS. 82 and 83, and wherein some portions of the stator and the plunger are not shown in FIGS. 84 and 85;

FIGS. 86-87 show a front assembled view and a perspective assembled view of the plunger of the motor assembly and the driver in accordance with an embodiment of the present disclosure;

FIG. 88 shows a partial perspective view of the plunger of the motor assembly and the driver in accordance with an embodiment of the present disclosure, wherein some portions of the plunger of the motor assembly and the driver are not shown to better illustrate other portions of the plunger of the motor assembly and the driver;

FIG. 89 shows an exploded view of the plunger of the motor assembly and the driver in accordance with an embodiment of the present disclosure;

FIG. 90 shows a lamination of the plunger core of the motor assembly in accordance with an embodiment of the present disclosure;

FIGS. 91-92 show a front view and a perspective view, respectively, of a linear motor having a cylindrical stator in accordance with an embodiment of the present disclosure;

FIGS. 93-94 show a partial perspective view and a partial side view of the linear motor in FIGS. 91-92, wherein some portions of the linear motor are not shown to better illustrate other portions of the linear motor;

FIG. 95 shows an exploded view of the linear motor in FIGS. 91-92;

FIG. 96 shows a partially exploded view of the stator along with sensor of the linear motor in FIGS. 91-92;

FIG. 97 shows another exploded view of the stator of the linear motor in FIGS. 91-92;

FIG. 98 shows a front view of an assembled stator lamination of the linear motor in FIGS. 91-92;

FIG. 99 shows a perspective view of a partially assembled stator lamination, wherein three arcuate stator segments are assembled to form the stator lamination and a fourth arcuate stator segment is yet to be assembled into the stator lamination;

FIG. 100 shows an arcuate stator segment of the stator lamination;

FIGS. 101 and 102 show a perspective view and a front view, respectively, of the assembled plunger and the driver of the linear motor in FIGS. 91-92;

FIG. 103 shows a perspective view of the exploded plunger and the driver of the linear motor in FIGS. 91-92;

FIG. 104 shows a partial perspective view of the linear motor in FIGS. 91-92, wherein some portions of the linear motor are not shown to better illustrate other portions of the linear motor;

FIG. 105 shows a stator lamination, before and after the assembly with another stator lamination, in accordance with an embodiment of the present disclosure;

FIG. 106 shows a stator lamination, before and after the assembly with another stator lamination, in accordance with another embodiment of the present disclosure;

FIG. 107 shows a stator lamination, before and after the assembly with another stator lamination, in accordance with yet another embodiment of the present disclosure;

FIGS. 108-112 show various views of a linear motor assembly having a lock that releasably locks a plunger of the linear motor assembly when the plunger is in the retracted position in accordance with an embodiment of the present disclosure, wherein FIGS. 108-109 show the lock in its locked configuration, FIGS. 110-112 show the lock in its unlocked configuration;

FIGS. 113-114 show the lock in its unlocked configuration and its locked configuration, respectively;

FIGS. 115-119 show various view of linear motor assembly having a lock that releasably locks a plunger of the linear motor assembly when the plunger is in the retracted position in accordance with another embodiment of the present disclosure;

FIG. 120 shows a second lock portion of the lock shown in FIGS. 115-119;

FIGS. 121 and 122 show an assembled view and an exploded view, respectively of an exemplary plunger that includes an overmold structure that is configured to hold/secure the one or more permanent magnets in place during the linear movement of the plunger along the longitudinal axis in accordance with an embodiment of the present disclosure;

FIG. 123 shows a permanent magnet and at least two magnet support members that are configured to be in engagement with opposite surfaces of the permanent magnet in accordance with an embodiment of the present disclosure;

FIG. 124 shows a cross-sectional view of the plunger taken along an axis XX-XX of FIG. 121;

FIGS. 125 and 126 show an assembled view and an exploded view, respectively of an exemplary plunger that includes an overmold structure that includes two or more plunger bodies each associated with a corresponding permanent magnet of one or more permanent magnets in accordance with an embodiment of the present disclosure;

FIG. 127 shows one of the at least two magnet support members that are configured to be in engagement with opposite surfaces of the corresponding permanent magnet in accordance with an embodiment of the present disclosure;

FIG. 128 shows a plunger body (with the at least two magnet support members therein) and its corresponding permanent magnet in accordance with an embodiment of the present disclosure;

FIGS. 129 and 130 show an assembled view and a partial exploded view, respectively of an exemplary plunger of a linear motor in accordance with an embodiment of the present disclosure;

FIG. 131 shows a cross-sectional view of the plunger shown in FIGS. 129-130;

FIGS. 132 and 133 show an assembled perspective view and a partially exploded view, respectively of a linear motor in accordance with another embodiment of the present disclosure;

FIGS. 134 and 135 show a front view and a perspective view of the linear motor (of FIGS. 132-133) connected to portions of the frame of a fastener device;

FIGS. 136 and 137 show a linear motor connected to portions of the frame of a fastener device in accordance with another embodiment of the present disclosure, wherein some portions of the frame are not shown to clearly shown portions of the linear motor;

FIGS. 138 and 139 show an assembled perspective view and a partially exploded view, respectively of the linear motor (of FIGS. 136-137);

FIGS. 140-141 show an assembled view and a cross-sectional view, respectively of a cylindrical linear motor with cylindrical stator and cylindrical plunger in accordance with an embodiment of this disclosure;

FIG. 142 shows an exploded view of the cylindrical plunger of the linear motor as shown in FIGS. 140-141;

FIG. 143 shows a partially exploded view of the cylindrical plunger core (of the cylindrical plunger of the linear motor as shown in FIGS. 140-141) and one or more permanent magnets received therein;

FIGS. 144-145 show a perspective view and an exploded view, respectively of a cylindrical plunger in accordance with another embodiment of this disclosure;

FIGS. 146-147 show a cross-sectional view and an exploded view, respectively of a plunger core (of the cylindrical plunger of FIGS. 144-145) and the magnets disposed therein;

FIG. 148 shows a perspective view of a linear motor having a cylindrical stator in accordance with another embodiment of the present disclosure, wherein a sense magnet is secured to the driver;

FIG. 149 shows another perspective view of the linear motor of FIG. 148, wherein a frame is configured to support a sensor to sense a magnetic flux of the sense magnet as the plunger travels along the longitudinal axis so as to detect an axial position of the plunger;

FIGS. 150 and 151 show a perspective view and a cross-sectional view, respectively of the linear motor of FIG. 148 when the plunger (and the driver) is in its retracted position;

FIGS. 152 and 153 show a perspective view and a cross-sectional view, respectively of the linear motor of FIG. 148 when the plunger (and the driver) is in its extended position;

FIGS. 154 and 155 shows an assembled view and a partial exploded view, respectively of an exemplary linear motor in accordance with an embodiment of the present disclosure, wherein one or more second engagement portions of the frame are configured to engage with the one or more first engagements portions the at least one stator to support the at least one stator on the frame;

FIGS. 156 and 157 shows a perspective view and a top view, respectively of an exemplary stator in accordance with an embodiment of the present disclosure, wherein the one or more first engagements portions the at least one stator are shown;

FIG. 158 shows an exemplary comparison of source power for the drive stroke and for the return stroke in a fastener device in accordance with an embodiment of the present disclosure;

FIG. 159 shows an exemplary comparison of source current for the drive stroke and for the return stroke in a fastener device in accordance with an embodiment of the present disclosure;

FIG. 160 shows an exemplary plunger drive sequence in a fastener device in accordance with an embodiment of the present disclosure;

FIG. 161 shows an exemplary plunger return sequence in a fastener device in accordance with an embodiment of the present disclosure;

FIGS. 162 and 163 show an exemplary method for detecting bounce back of the plunger and for changing energization values based on the detected plunger bounce back in a fastener device in accordance with an embodiment of the present disclosure;

FIG. 164 shows an exemplary method for applying a warming sequence to a capacitor of a fastener device, during at least one of a charge sequence or a discharge sequence of the capacitor in accordance with an embodiment of the present disclosure; and

FIGS. 165 and 166 show an exemplary method for detecting abnormal drive events (including dry-fire, stall and/or jam events) in a fastener device in accordance with an embodiment of the present disclosure.

### DETAILED DESCRIPTION

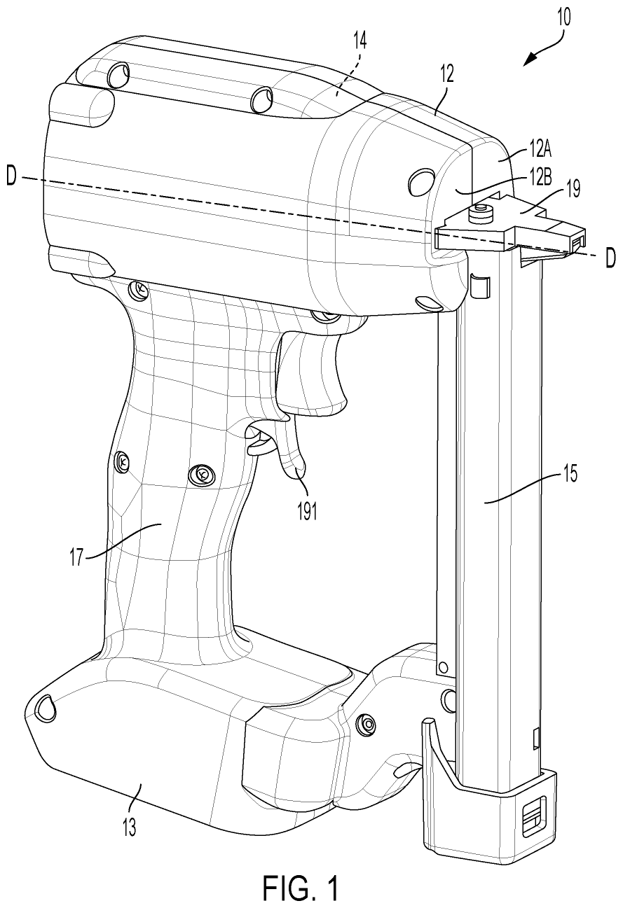

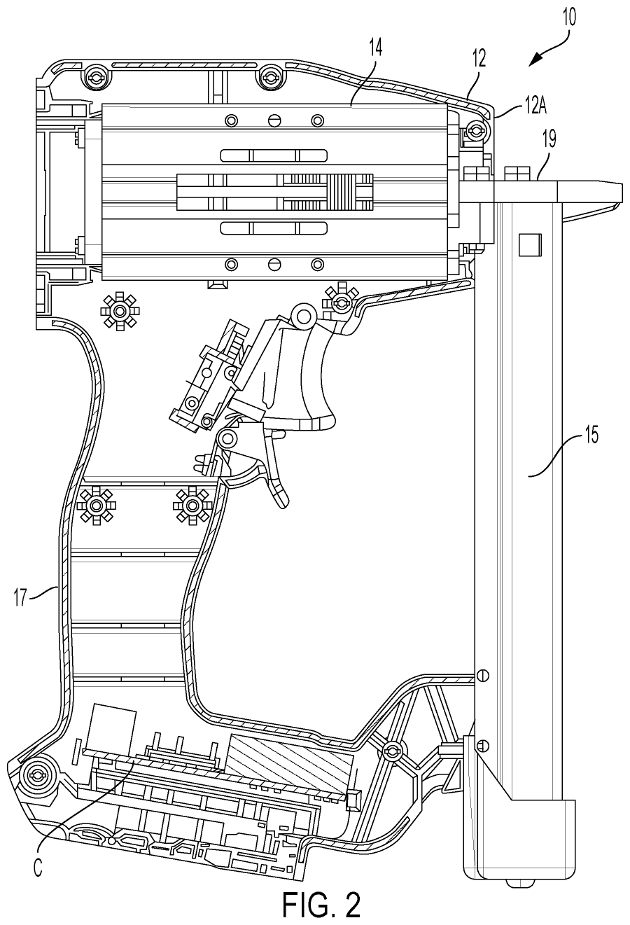

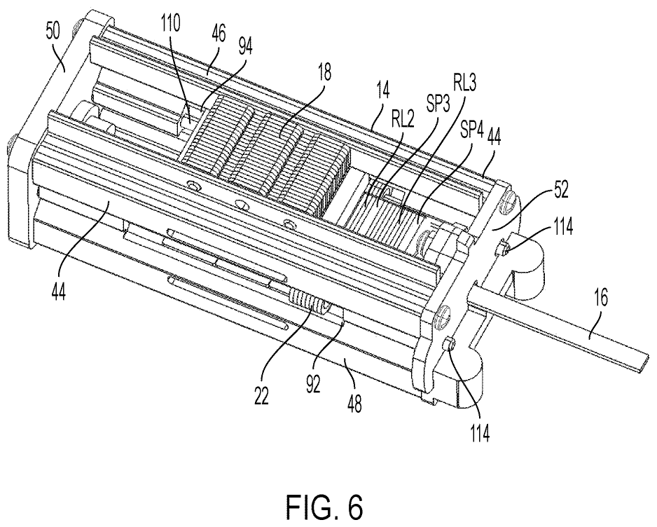

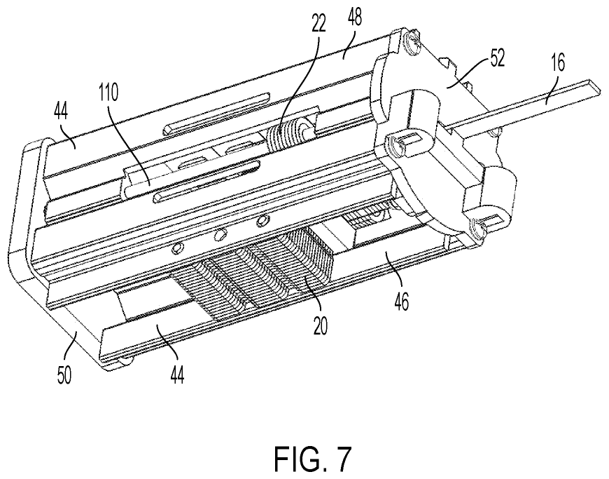

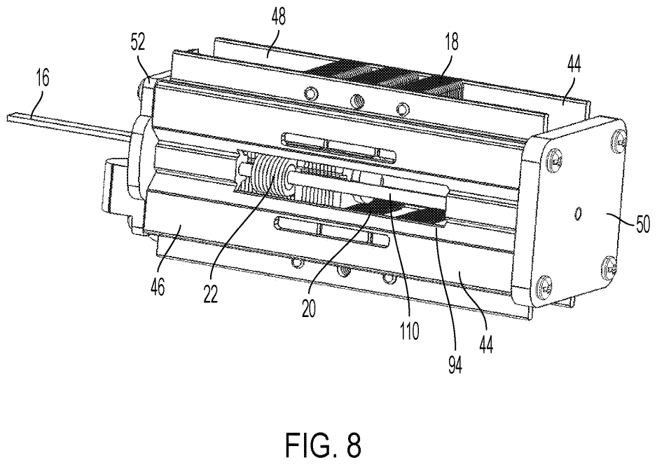

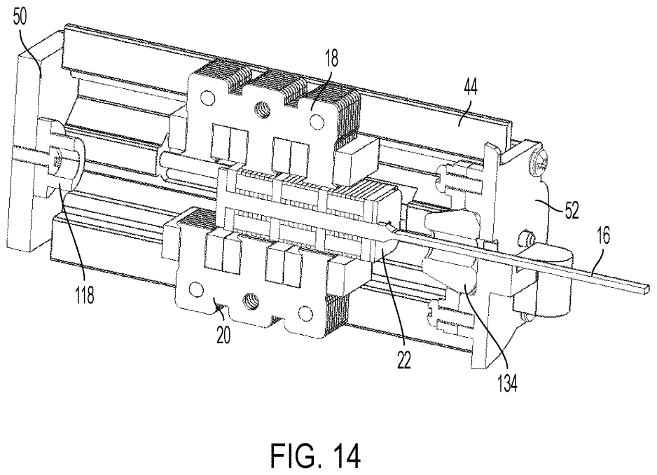

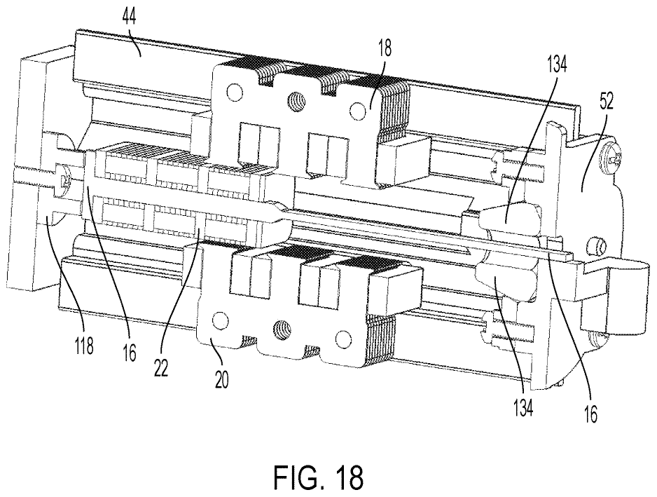

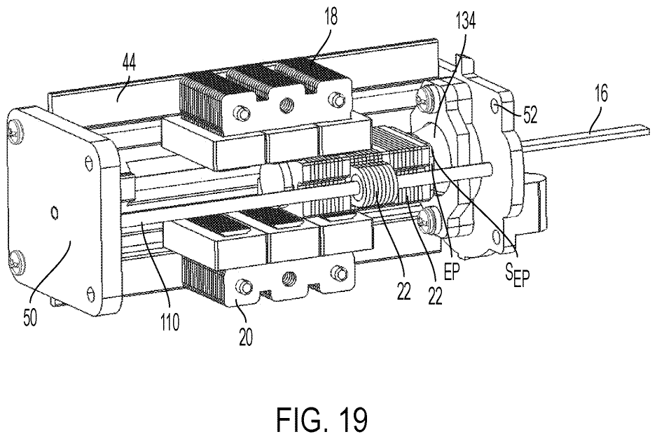

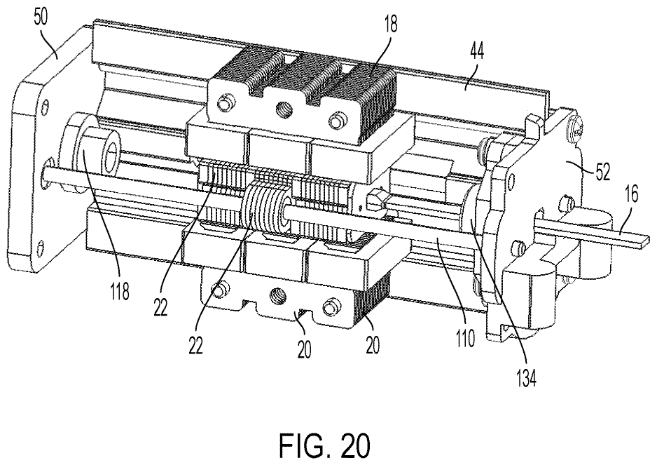

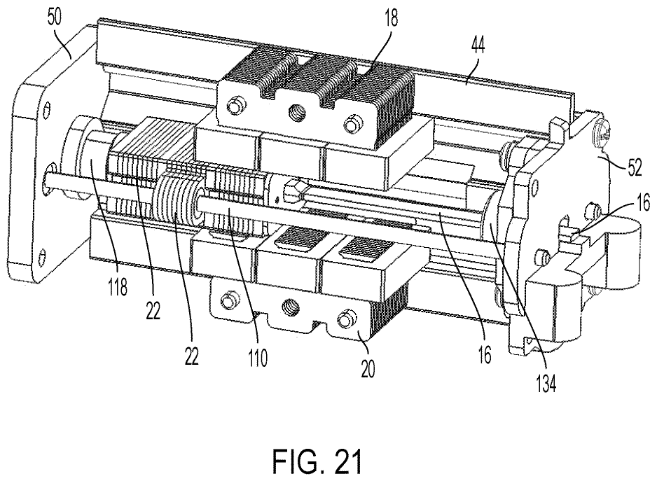

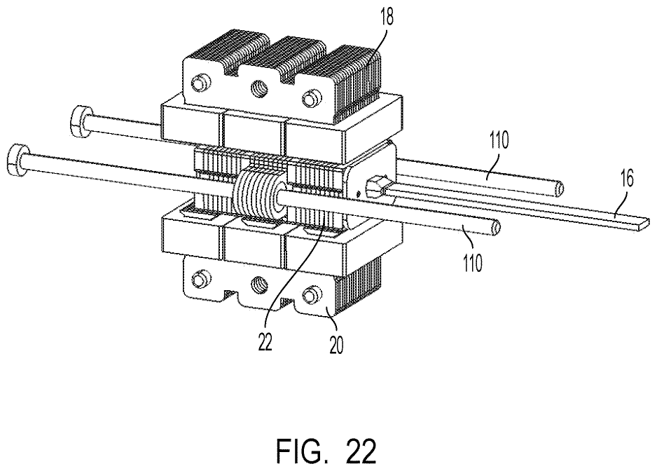

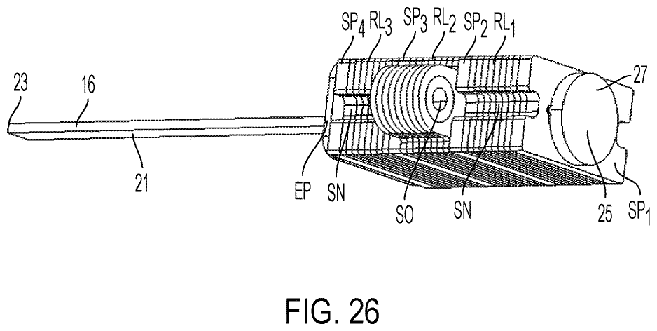

In one embodiment of the present disclosure, referring to FIGS. 1-31, a fastener device 10 that drives one or more fasteners 11 into a workpiece (not shown) is provided. The fastener device 10 comprises a tool housing 12, a motor assembly 14, and a driver 16. The motor assembly 14 is within the tool housing 12. The motor assembly 14 comprises a plunger 22 and a stator set including a first stator 18, a second stator 20. The driver 16 is within the tool housing 12 and is coupled to the plunger 22. The driver 16 is configured to travel along a drive axis D-D between a retracted condition and an extended condition to drive a fastener of the one or more fasteners into the workpiece during a drive stroke. The drive axis D-D may interchangeably be referred to as fastener drive axis. The first stator 18 and the second stator 20 may be configured to drive the driver 16 along the drive axis D-D. The first and second stator 18, 20 are spaced apart circumferentially around the plunger 22. The plunger 22 is disposed between the first stator 18 and the second stator 20 to magnetically interact with each of the first and second stator 18, 20. The plunger 22 may be coupled to the driver 16. One of the first stator 18 or the second stator 20 may be disposed on one side S₁ of the driver 16 and the other of the first stator 18 or the second stator 20 may be disposed on an opposing side S₂ of the driver 16. In an illustrated embodiment, the one side S₁ of the driver 16 is a top side and the opposing side S₂ of the driver 16 is a bottom side. The first stator 18 may be a top stator and the second stator 20 may be a bottom stator. In another embodiment, the one side of the driver 16 may be a left side or a right side of the driver 16 and the opposing side of the driver 16 may be a right side or a left side of the driver 16. The first stator 18 may be a left side stator or a right side stator and the second stator 20 may be a right side stator or a left side stator.

In one embodiment, the present disclosure provides the linear motor 14 that includes the plunger 22 and the stator 18, 20. The plunger 22 may include at least one permanent magnet configured to travel along the drive axis D-D. The stator 18, 20 is in magnetic interface with the plunger 22. The stator 18, 20 may include a stator core 24, 26 oriented along a plane that is substantially parallel to the drive axis D-D, a plurality of stator teeth 32, 34 extending from the stator core 24, 26 towards the plunger 22 in a direction substantially perpendicular to the plane, and a plurality of stator windings 28, 30 wound around the plurality of stator teeth 32, 34 such that a winding plane of the plurality of stator windings 28, 30 is substantially perpendicular to the drive axis D-D. The plunger 22 may include a plunger core RL that supports one or more permanent magnets in magnetic interaction with the plurality of stator windings 28, 30. The linear motor 14 may further comprise a sense magnet secured to a side of the plunger core RL not facing the stator 18, 20, and the frame 44 extending from the stator 18, 20 configured to support a Hall board HB having a plurality of Hall sensors linearly oriented to sense a magnetic flux of the sense magnet as the plunger 22 travels along the drive axis D-D.

In another embodiment, the present disclosure provides a power tool that comprises the linear motor 14, and at least one controller C. The linear motor 14 may include a plunger 22 including at least one permanent magnet configured to travel along the drive axis D-D; a first stator 18 in magnetic interface with the plunger 22; and a second stator 20 in magnetic interface with the plunger 22 and disposed adjacent the first stator 18 along the drive axis D-D. Each of the first stator 18 and the second stator 20 may include: a stator core 24, 26, a plurality of stator teeth 32, 34 extending from the stator core 24, 26 towards the plunger 22, and a plurality of stator windings 28, 30 wound around the plurality of stator teeth 32, 34 such that a winding plane of the plurality of stator windings 28, 30 is substantially tangential to the drive axis D-D, the plurality of stator windings 28, 30 forming a plurality of phases for each of the first and the second stators18, 20. The at least one controller C may be configured to control a commutation of the first and second stators 18, 20 such that, during at least a position of the plunger 22 relative to the first and second stator 18, 20, at least one of a plurality of phases of the first stator 18 applies a repelling force to the plunger 22 while at least one of a plurality of phases of the second stator 20 applies an attracting force to the plunger 22.

The plunger, as used in the present disclosure, may have many of the characteristics commonly found in rotors of rotary motors but the plunger of the present disclosure is technically not a rotor, since there is no rotation.

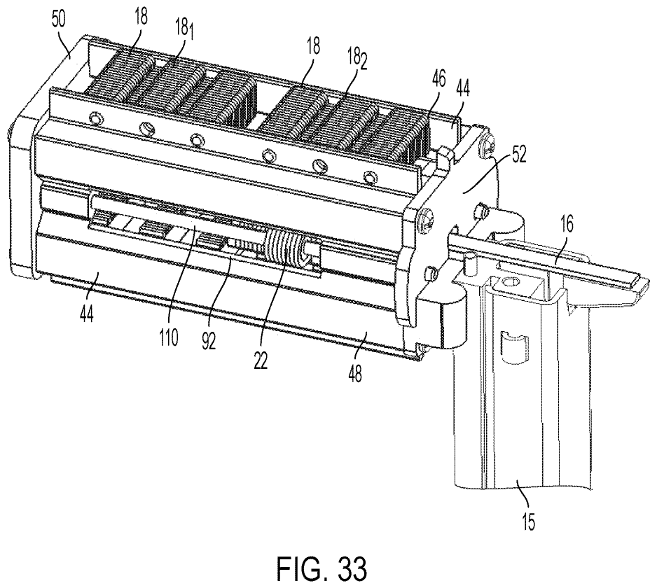

The pair of opposite stators may make up a stator set. For example, in the arrangement of FIG. 33, there are multiple stator sets, each including two stators. Each stator includes stator core and stator windings. The stator core includes a stator body (i.e., back-iron, which is the planar portion), and a plurality of stator teeth that project from the stator body. The stator windings may be wound around the teeth.

This disclosure relates to corded or cordless, portable fastener driving tools/devices, such as a nailers and staplers, and improvements made therein for driving capabilities of the fastener device 10. The fastener device 10 may include a battery powered device or a cordless device. The fastener device 10 may include a battery powered nailer/nail gun. The fastener device 10 may include a battery powered stapler gun.

The fastener device 10 may be interchangeably referred to as a fastener tool, a fastener driver, a fastener driving tool, a fastener driving device, a nail gun, a stapler gun, a nailer, any such device/a tool that is adapted to drive one or more fastener(s) into the workpiece. The fastener device 10 may be configured to drive one or more fasteners into the workpiece. The fasteners may include staples, U-shaped staples, brads, clips, nails, or any such suitable fasteners, and the like. The fastener and the nail may interchangeably be used herein. In one embodiment, the fasteners may be collated. The fastener tool 10 may be a cordless power tool, in accordance with an embodiment. In one embodiment, the fastener tool 10 is a nailer or a nail gun configured to drive nail(s) into the workpiece.

In one embodiment, a battery receptacle 13, receiving a battery of the battery powered fastener device 10 can be configured with a suitable nominal voltage such as 7.2, 12, 36 volts (V), etc. using a suitable battery chemistry such as nickel cadmium, lithium ion, etc. The fastener driver 10 may also be configured to be hybrid between being powered by an alternating current (AC) power source (e.g., wall voltage) and a direct current (DC) power source (e.g., the battery).

The fastener device 10 may be an electric fastener tool. The electric power may be supplied, e.g., by a battery pack, an internal battery, or from being plugged into a common household AC outlet. The bottom end of the housing 12 may have a removable and rechargeable energy storage device, which may include the battery receptacle 13. The battery pack may be configured to engage an end portion of the fastener device 10 and provide power to the motor assembly 14 within the housing 12, such that the fastener device 10 may drive one or more fasteners that are fed from the magazine 15 into a workpiece. The location of the battery receptacle 13 as shown in the Figures is not limiting and is illustrative only; indeed, the battery receptacle 13 can be located anywhere on the fastener device 10. In addition, although the energy storage device is illustrated as being a battery pack, embodiments of this disclosure are not limited to battery packs being the energy storage device. That is, in some embodiments, the fastener device 10 may include a cord and a plug for plugging into a common household AC outlet. While the fastener device 10 is described as being electrically powered by a suitable power source or energy storage device, such as the battery pack, a person of ordinary skill in the art would appreciate that this disclosure, in its broader aspects, may apply to other powered fastening tools.

The fastener device 10 may include a power source that is suited for linear fastening applications. The fastener device 10 may be powered by a capacitor or capacitor(s). A high energy capacitor(s) may be used as the power source. The fastener device 10 may be powered by the capacitor or capacitor(s) in combination with other power sources. The capacitor or capacitor(s) may be periodically charged by the primary power source (e.g., battery). The capacitor may be charged by the battery pack during off cycles of the linear electromagnetic motor/LEM, and discharged to power the motor. The motor may be solely powered by the capacitor. Alternatively, the capacitor may be used to supplement the voltage of the battery pack in a hybrid mode. The power source may be configured to quickly charge, for example, charge at a charge rate greater than or equal to 3 cycles/second. The power source may also be configured to quickly discharge, for example, discharge at a discharge rate at greater than or equal to 3 cycles/second. The motor assembly 14 may operatively connected to a power supply controller and a power supply (e.g., a capacitor, a battery, etc.). The power supply controller may be a part of a controller C of the fastener device 10.

The housing 12 may be an exterior (clam shell) housing. The housing 12 may be formed from molded parts. In one embodiment, a first side part 12A and a second side part 12B of the housing 12 may be molded and joined together to encapsulate/enclose parts/components of a driving/drive mechanism and a feed mechanism (described in greater detail below) of the fastener device 10 within the housing 12. The drive/driving mechanism may be interchangeably referred to as the driver or the driver assembly and the feed/feeder mechanism may interchangeably referred to as the feeder or feed/feeder assembly.

The housing 12 may be made of extruded or molded plastic material, for example. The housing 12 may be formed from an Acrylonitrile Butadiene Styrene (ABS) plastic material. These examples materials of the housing 12 should not be limiting. Other materials, such as polycarbonates and/or combinations of materials, may also be used to form the housing 12. The housing 12 has a front end and a back end. The housing 12 may include a handle 17 that is adapted to be gripped by the hand of an operator or a user. In one embodiment, the handle 17 is configured to extend between a top end and a bottom end of the housing 12. The housing 12 may also conventionally house a trigger 191 and the motor assembly 14 with the driver 16, which may be selectively translated along the drive axis D-D to drive the fastener into the workpiece. Further details of the housing 12 are provided in U.S. Pat. No. 7,866,521 (“the '521 Patent”) and U.S. Pat. No. 11,745,323 (“the '323 Patent”), each of which are commonly assigned to the same entity as the present disclosure and are incorporated by reference herein in their entirety. That is, the driver 16 and the motor assembly 14 (e.g., including stators 18, 20, the plunger 22, a frame 44, guide rods 110, bumpers 118, 134, and/or other components) may be disposed within the housing 12. The guide rods 110 may be referred to as a first axial guide member. The guide rods 110, in other embodiments, may be linear retainment devices.

The nose assembly 19 may extend from the housing 12 proximate the magazine 15 (described in detail below) and may be conventionally configured to engage the magazine 15 so as to sequentially receive fasteners therefrom. The nose assembly 19 may also serve in a conventional manner to guide the driver 16 and fastener when the fastener device 10 has been actuated to install/drive the fastener into the workpiece.

The nose assembly 19 may be interchangeably referred to as nosepiece or nosepiece assembly, and the magazine 15 may be interchangeably referred to as magazine assembly. The nose assembly 19 may further include a contact trip assembly, which is described in detail below. In addition to the contact trip assembly, the nose assembly 19 may include a barrel that forms a part of a drive channel for the driver 16 to move within an interior portion thereof and drive a fastener. The nose assembly 19 of the fastener device 10 may include one, some, or all features as described in U.S. Pat. No. 9,827,658 (“the '658 Patent”) and/or U.S. Pat. No. 10,926,385 (“the '385 Patent”), both of which are commonly assigned to the same entity as the present disclosure and are incorporated by reference herein in their entireties.

The driver 16 may be configured for translational movement within the drive channel of the nose assembly 19 along the drive axis D-D. The driver 16 may be made of any number of materials, including, but not limited to, aluminum, nickel, steel, stainless steel, and/or combinations of these or other metals/metal alloys. The fastener device 10 may include a magnetic driver piston.

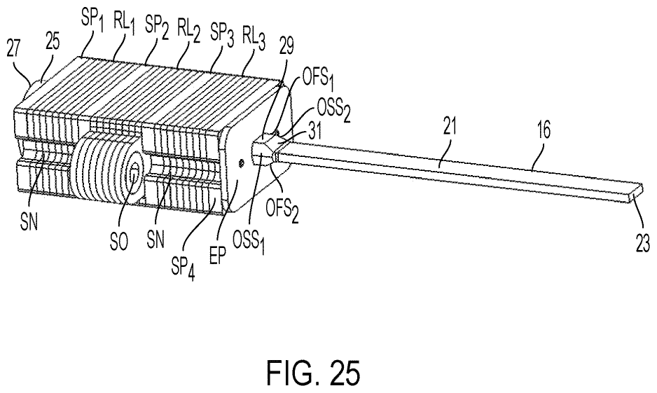

Referring to FIGS. 25-29, the driver 16 may include a first end 23 and a second opposing end 27. The driver 16 may include a driver blade 21, a driver head 25, and a driver body 29. The driver blade 21, the driver head 25, and the driver body 29 of the driver 16 may be integrally formed with each other. In another embodiment, the driver blade 21, the driver head 25, and the driver body 29 of the driver 16 may be connected to each other.

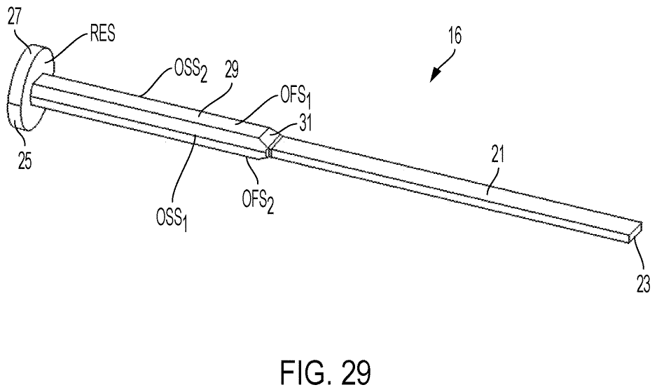

The driver head 25 may be disposed at the second opposing end 27 of the driver 16. The driver head 25 may be centered relative to the driver blade 21 and/or the driver body 29. The driver head 25 may be offset relative to the driver blade 21 and/or the driver body 29. The driver head 25 may have a head cross-section that extends perpendicularly relative to a longitudinal axis of the driver body 29 and/or the driver body 29. The driver head 25 may have an enlarged head cross-section. The driver head cross-section may have a circular shaped configuration. In another embodiment, the driver head cross-section may have a square, a rectangular, or an oval shaped configuration. As shown in FIG. 29, the driver head 25 may include a plunger engaging surface RES that is configured to engage or connect/coupled with portions (e.g., a surface of a spacer member SP₁ as will be descried in detail) of the plunger 22 when the driver 16 is coupled with/connected to the plunger 22.

The driver body 29 may extend between the driver head 25 and the driver blade 21. The driver body 29 may have two opposing flat surfaces OFS₁ and OFS₂ and may include two opposing rounded/semi-circular sides/side surfaces OSS₁ and OSS₂ that connect the two opposing flat surfaces OFS₁ and OFS₂. When the driver 16 is coupled with/connected to the plunger 22, the driver body 29 may be configured to be received by portions (e.g., openings DL) of the plunger 22 and supported by the plunger 22. The shape and configuration of the driver body 29 are similar and complementary to the shapes and configurations of the openings DL of the plunger 22. As will be clear from the discussions below, the openings DL of the plunger 22 are configured and arranged to receive the driver body 29 therein when the driver 16 is coupled with/connected to the plunger 22. The driver body 29 may have thicker/larger cross-sectional configuration than that of the driver blade 21.

The driver blade 21 may extend between the driver body 29 and the end 23 of the driver 16. The driver blade 21 may have a thinner, smaller or flatter (e.g., rectangular or square cross-sectional) configuration. The driver blade 21 may have a rectangular or a square cross-sectional configuration. At the end 23 of the driver 16, the driver blade 21 may be configured to engage with and drive a lead fastener (of the one or more fasteners) in the drive channel of the nose assembly 19 into a workpiece.

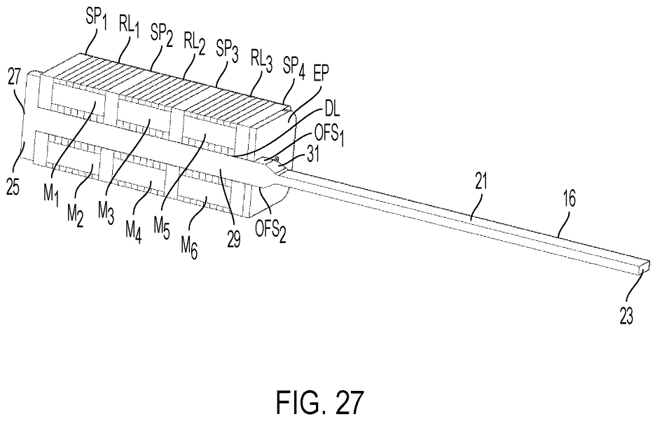

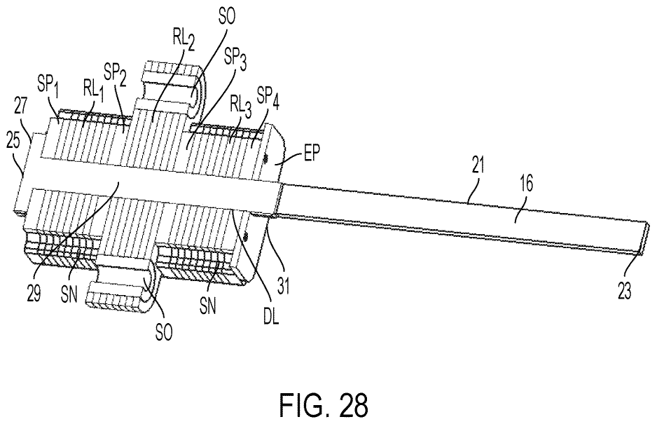

The driver 16 may also include a transition portion 31 that may be configured to transition the thicker cross-sectional configuration of the driver body 29 to the thinner or flatter configuration of the driver blade 21. As shown in FIGS. 27-28, when the driver 16 is coupled with/connected to the plunger 22, the transition portion 31 may be disposed outside the plunger 22. The driver blade 21 may extend between the transition portion 31 and the end 23 of the driver 16.

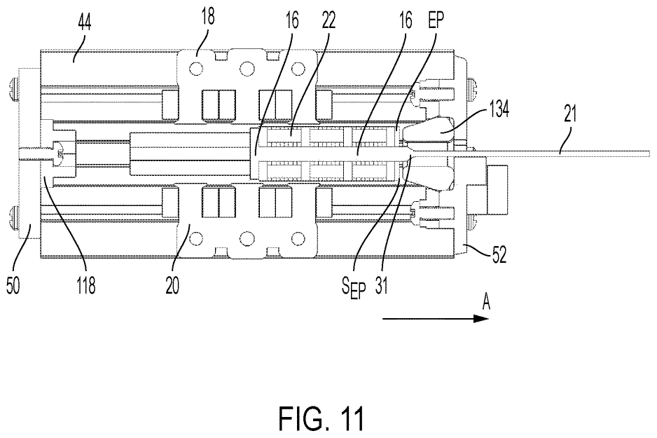

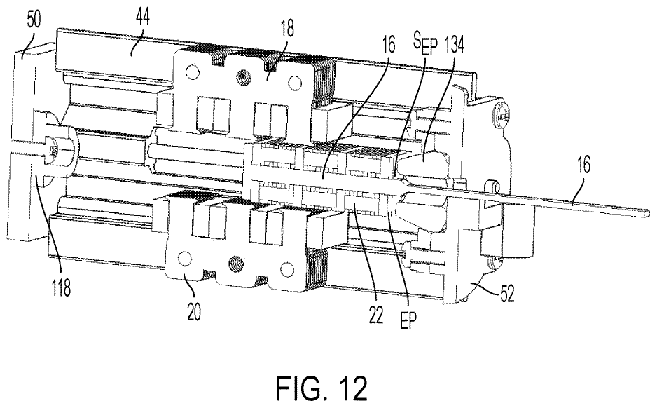

Referring to FIGS. 11-12, the transition portion 31 of the driver 16 may be configured to engage with portions (e.g., of the bumper/bumper member 134 of the frame assembly 44) of the motor assembly 14 so as to stop the driver 16 in its extended condition (i.e., to keep/retain/maintain the driver 16 in its extended condition and prevent any further movement (e.g., in the direction of an arrow A) of the driver 16 from its extended condition).

The driver 16 may include a drive cycle/sequence/stroke. The drive cycle may include a time from which the driver 16 is activated to engage and drive the fastener in the drive channel of the nose assembly 19 into the workpiece to a time until the driver 16 is retracted along the drive axis D-D to clear the drive channel of the nose assembly 19 and to allow for feeding of a subsequent fastener (e.g., by the feed mechanism/assembly) into the drive channel of the nose assembly 19. That is, the nail/fastener driving/drive cycle may include time from the activation of the driver mechanism until the driver 16 has partially returned far enough to allow feeding of the next/subsequent nail/fastener (i.e., the drive path/channel of the nose assembly 19 is cleared).

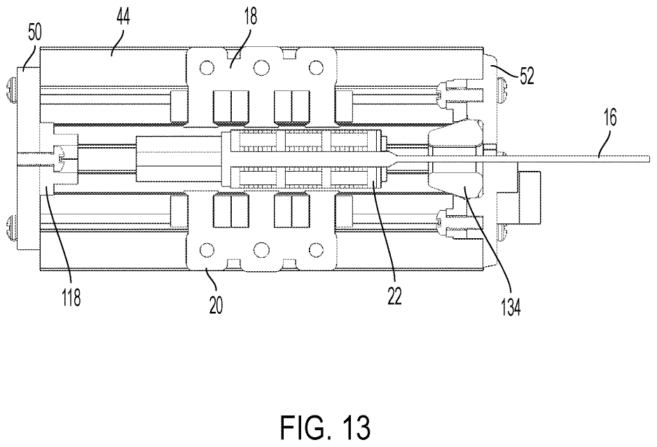

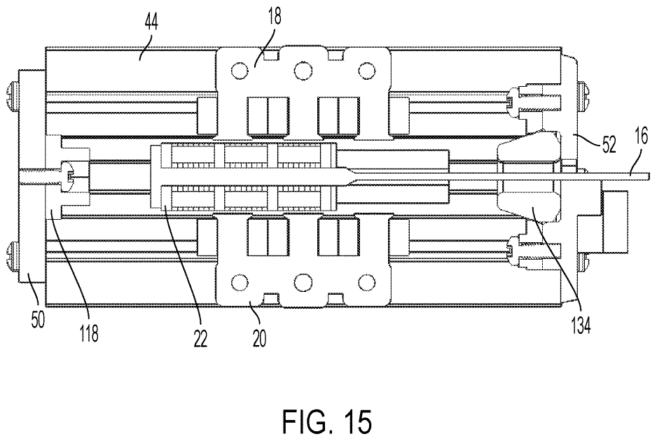

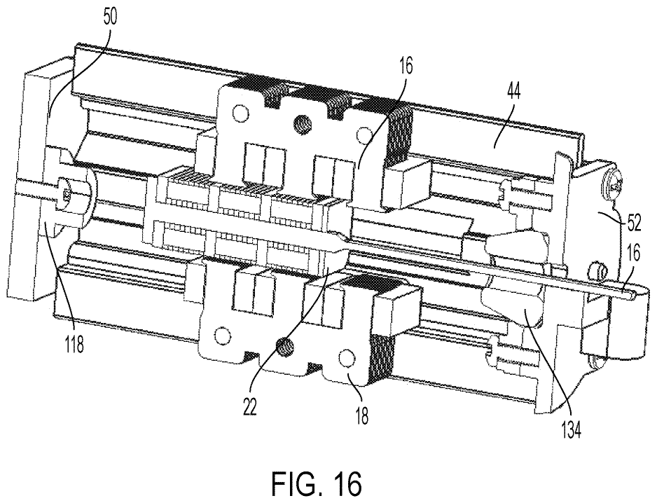

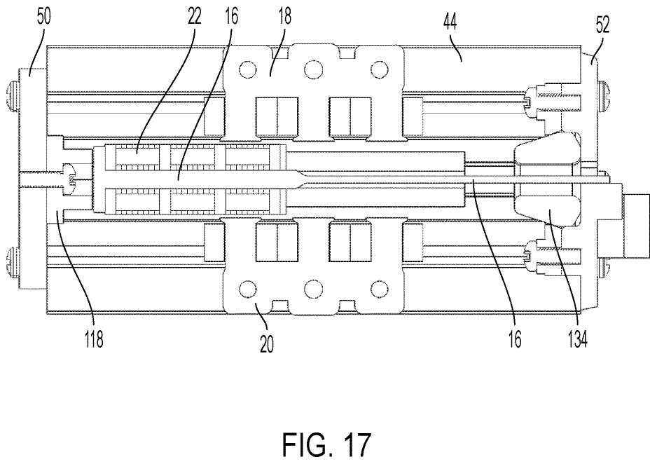

The extended condition and the retracted condition of the driver 16 may interchangeably be referred to as the extended position and the retracted position. The driver 16 may have one or more intermediate conditions/positions (two intermediate conditions are shown in the figures) between the extended condition and the retracted condition. FIGS. 11-12 and 19 show a partial cutaway front view, a partial cutaway perspective view, and a perspective view respectively, of the motor assembly 14 and the driver 16, where the driver 16 is in the extended condition. FIGS. 13-14 and 20 show a partial cutaway front view, a partial cutaway perspective view, and a perspective view, respectively, of the motor assembly 14 and the driver 16, where the driver 16 is in an intermediate condition between the extended condition and the retracted condition. FIGS. 15-16 show a partial cutaway front view and a partial cutaway perspective view, respectively, of the motor assembly 14 and the driver 16, where the driver 16 is in another intermediate condition between the extended condition and the retracted condition. FIGS. 17-18 and 21 show a partial cutaway front view, a partial cutaway perspective view, and a perspective view, respectively, of the motor assembly 14 and the driver 16, where the driver 16 is in the retracted condition.

The driver 16 may be disposed offset from the central axis of the plunger (the motor could be rotated 90 degrees about the drive axis & have the driver positioned closer to the top of the nailer) to enhance edge or corner access. For example, ⅜″ Crown staplers may include an offset driver configuration for this purpose.

The motor assembly 14 of the present disclosure may interchangeably be referred to as a motor, a linear motor, a linear electromagnetic motor (LEM) or a linear motor assembly. The linear motor may be an electric motor that includes stator 18, 20 and plunger 22 in an “unrolled” configuration, thus, instead of producing a torque (rotation), the motor 14 may be configured to produce a linear force along its (longitudinal) length. However, linear motors may include non-linear portions and other configurations. Characteristically, a linear motor's active section may have end portions, whereas more conventional motors are arranged as a continuous loop. The stator 18, 20 of the linear motor 14 may be referred to the stationary part (as they are fixedly connected to the frame 44) and the plunger 22 may be referred to the moving part (as it moves along the drive axis D-D The stator 18, 20 may have windings/coils 28/30 and the plunger 22 may have the permanent magnets M₁-M₆. In the motor assembly, an air gap is maintained between the stator 18, 20 and the plunger 22. The air gap is the distance between the stator 18, 20 and the plunger 22. FIGS. 11, 13, 15 and 17 show an air gap between the stator 16 and one side of the plunger 22 and an air gap between the stator 18 and other side of the plunger 22 as the plunger 22 (and the driver 16 coupled thereto) translates/moves between the extended condition of the driver 16 and the retracted condition of the driver 16 and along the drive axis D-D. For maximum efficiency, the air gap between the plunger 22 and each of stators 18, 20 may be kept as small as possible. In one embodiment, the air gap between the plunger 22 and each of stators 18, 20 may generally less than 2 mm, preferably less than or equal to 1 mm, e.g., approximately 0.5 mm.

One type of the linear electromagnetic motor (LEM) is shown and described in detail in U.S. Pat. No. 12,053,869, which is commonly assigned to the same entity as the present application and is herein incorporated by reference in its entirety. The motor assembly 14 of the present disclosure uses a multi-phase motor drive system (e.g., similar to rotary brushless motors) with permanent magnets M₁-M₆ in the plunger 22 that magnetically interact with the coils/windings 28/30 of the stators 18, 20.

The frame 44, the stator 18, 20 and the plunger 22 may interchangeably be referred to as the frame assembly, the stator assembly, and the plunger assembly, respectively.

The linear electromagnetic motor may be a multi-phase E-frame type linear electromagnetic motor. The linear electromagnetic motor may include multiphase stator configuration. The linear electromagnetic motor may include multistage stator windings. The linear electromagnetic motor may include multi-pole armature configuration. The linear electromagnetic motor may be a permanent magnet (PM) synchronous motor. The linear electromagnetic motor may be a linear synchronous motor.

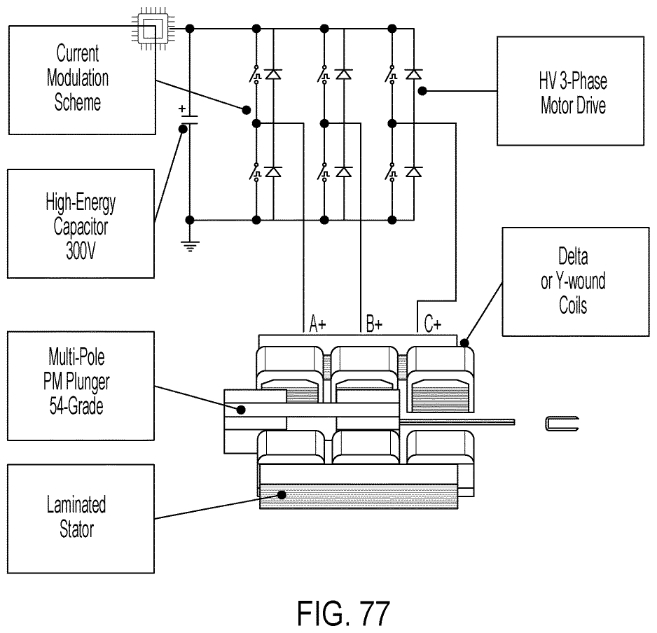

The linear electromagnetic motor may be a high efficiency linear motor. The linear electromagnetic motor may be a high efficiency linear motor that has an efficiency more than 40%. The linear electromagnetic motor may be configured to both drive the driver 16 from its retracted condition to its extended condition and also to return the driver 16 from its extended condition to its retracted condition. The linear electromagnetic motor may operatively connected to a power supply controller and a power supply (e.g., a capacitor, a battery, etc.). As shown in FIG. 77, the linear electromagnetic motor may be operatively connected to a current modulation module, a high voltage three phase motor drive module, and a high-energy capacitor. For example, E=½C *(V²). That is, for a given energy (E) needed, the system voltage (V) and the (minimum) capacitance (C) can be determined. As an example, for a 10J system at 300V, a 222 uF capacitor may be needed. The capacitor may include an electrolytic capacitor, a film capacitor, a strobe capacitor, etc. The current modulation module and the high voltage three phase motor drive module may be part of the controller C.

The linear electromagnetic motor may be configured to receive sinusoidal input current. The linear electromagnetic motor may be configured to receive approximately 300 Volts (V) at up to 40 A current. The voltage may be anywhere from approximately 50-60V to approximately 500+ V depending on the application.

The linear electromagnetic motor may be configured to include insignificant module/hardware loss (e.g., less than 200 Watts (W), insignificant eddy/hysteresis loss (e.g., less than 100 W) and/or insignificant drag/friction loss (e.g., less than 100 W).

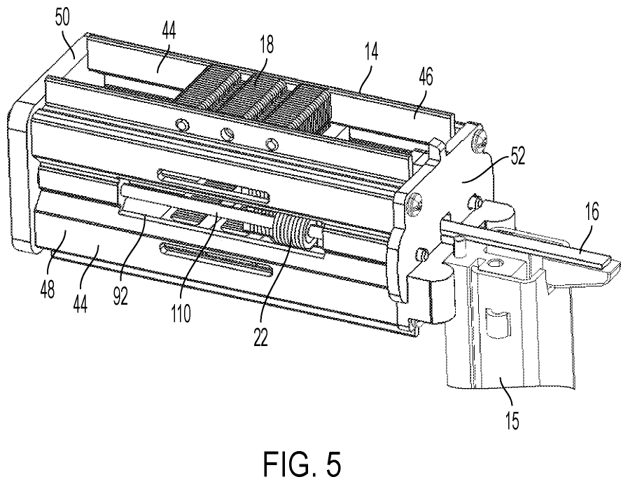

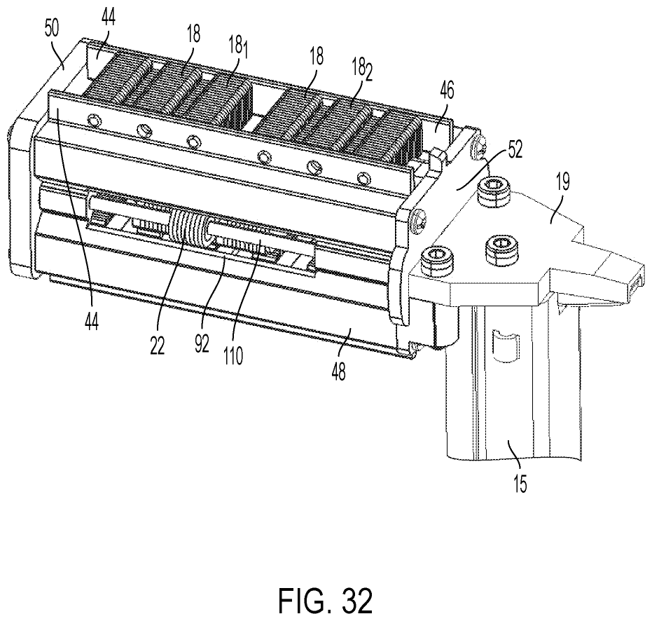

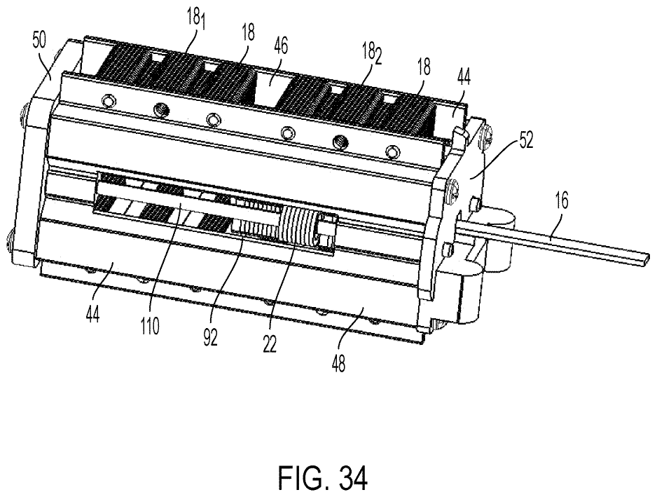

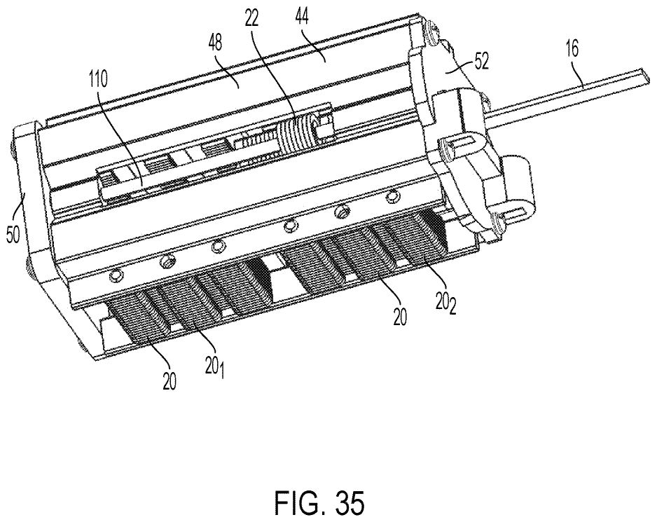

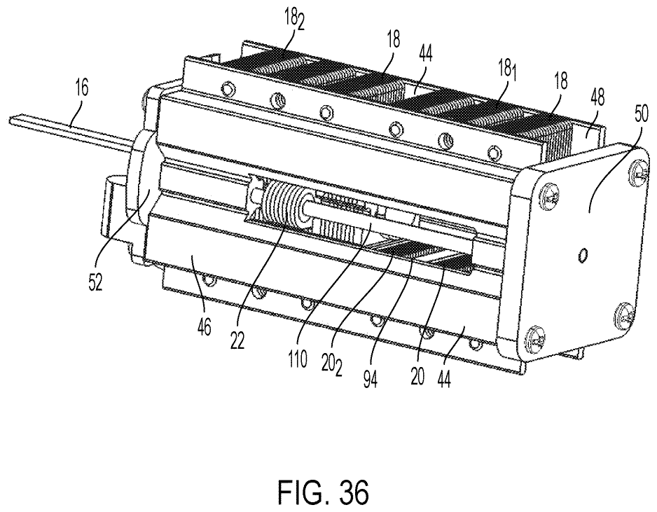

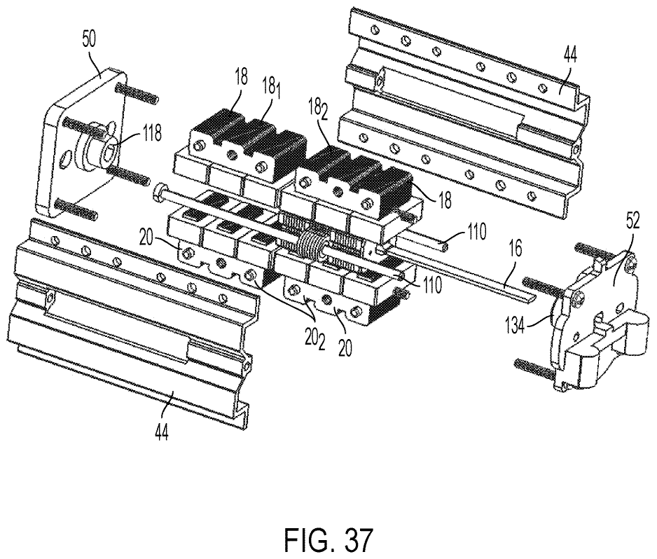

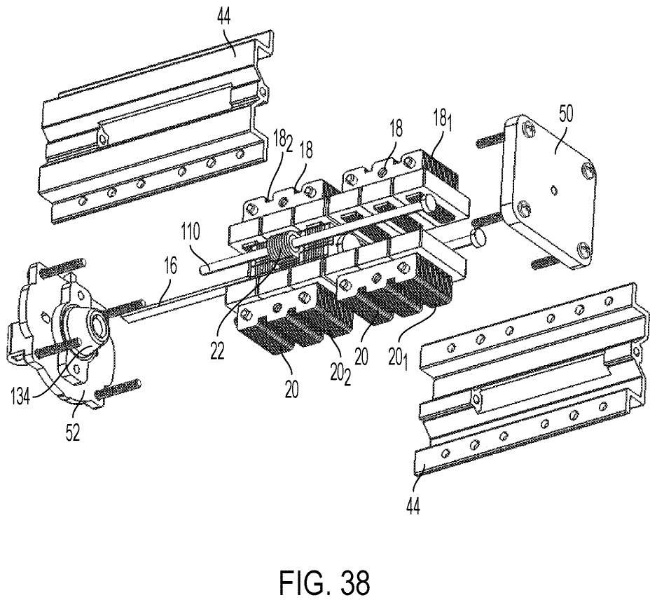

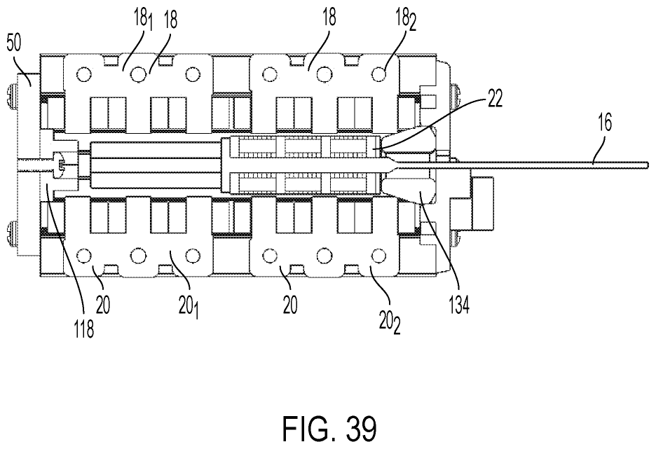

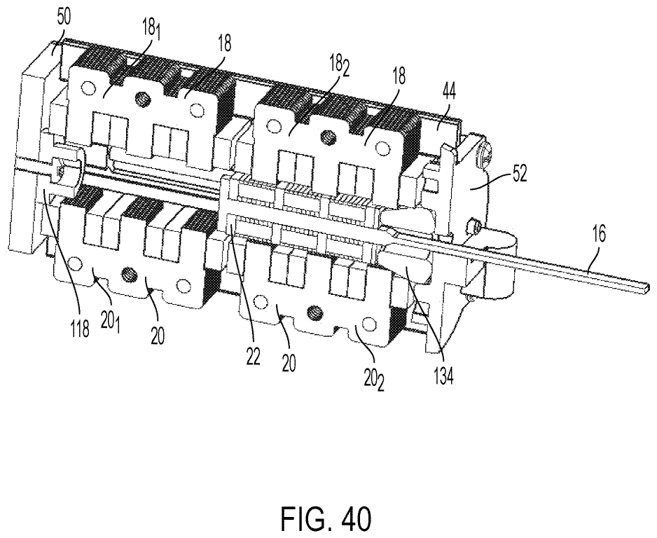

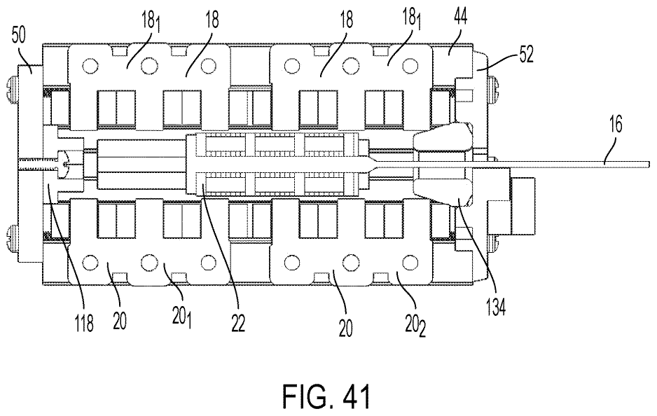

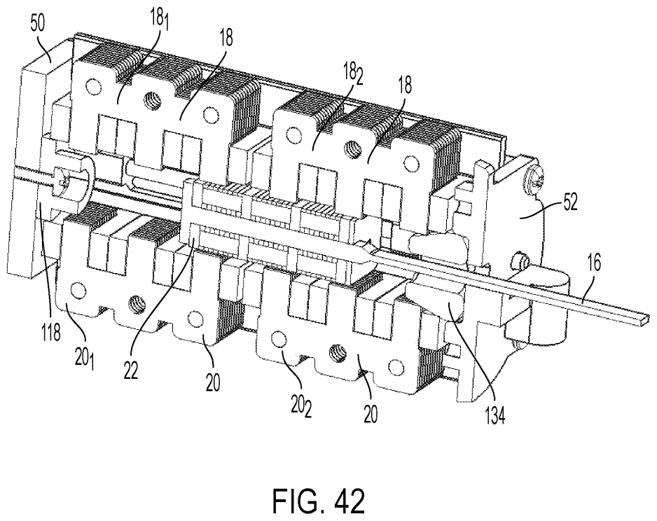

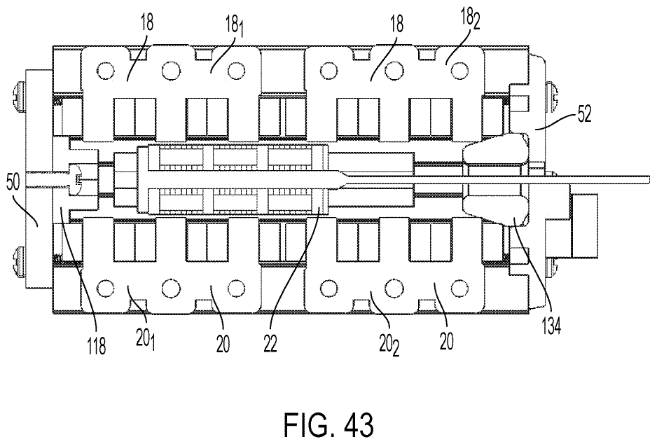

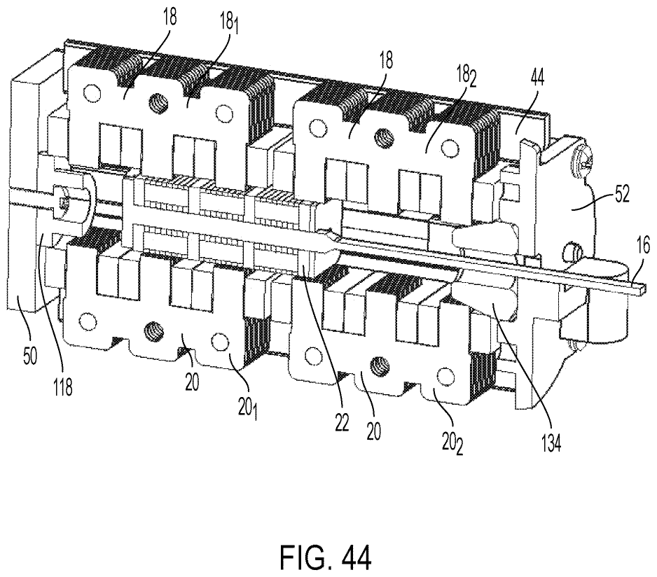

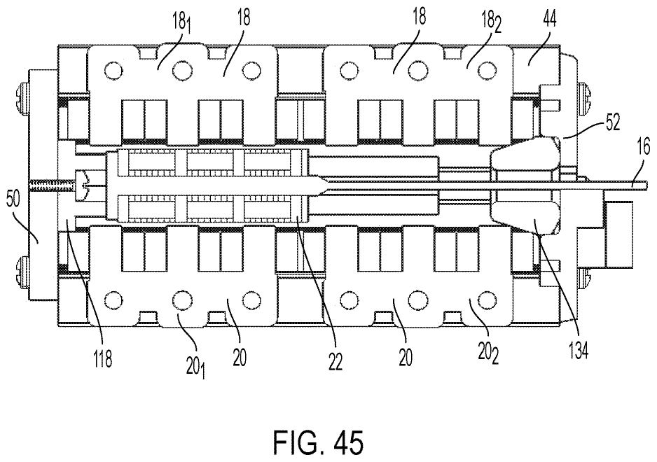

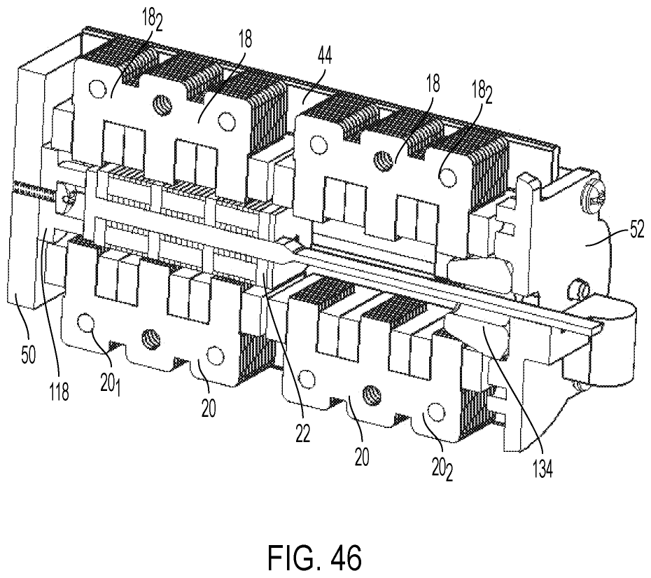

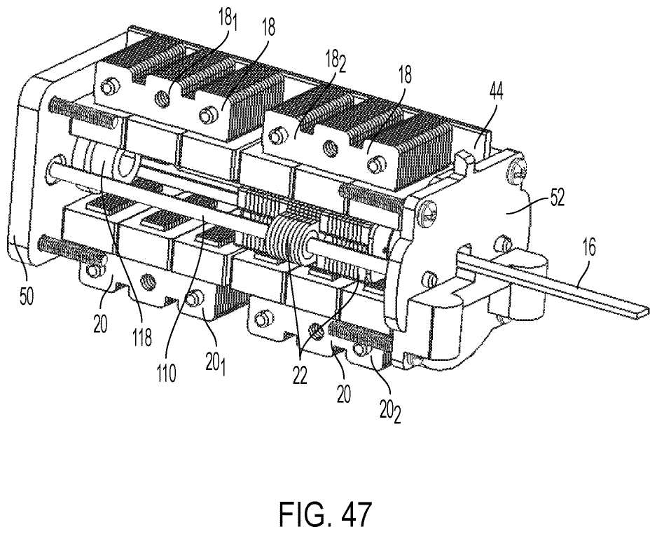

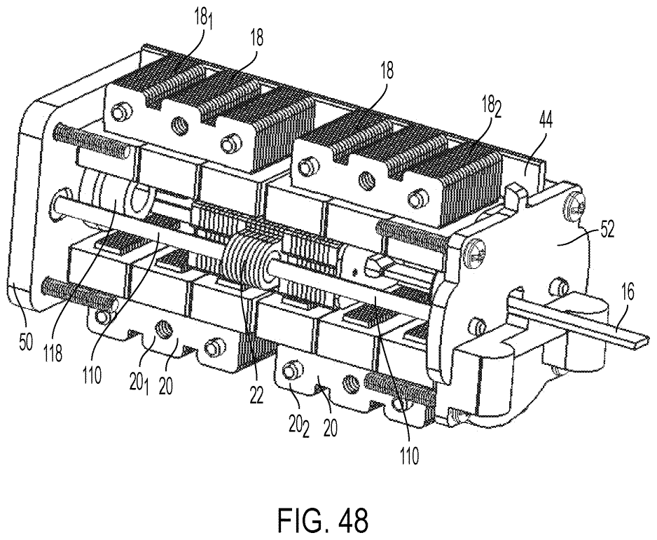

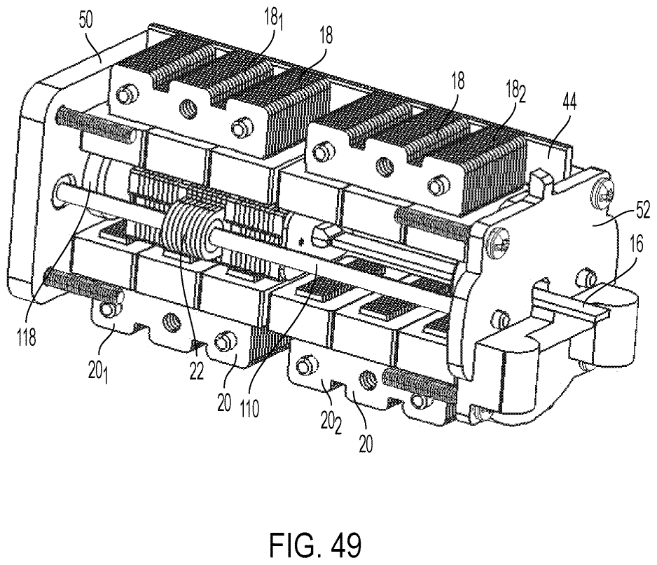

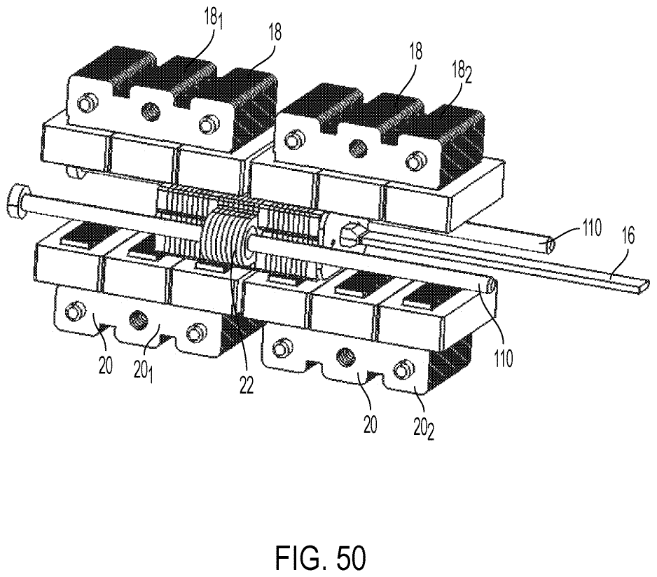

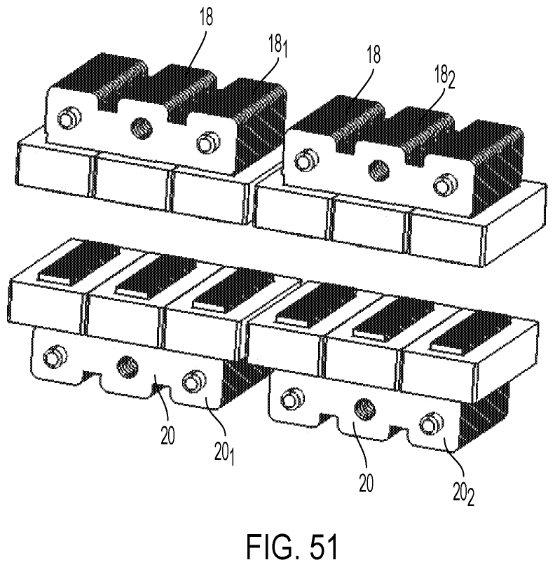

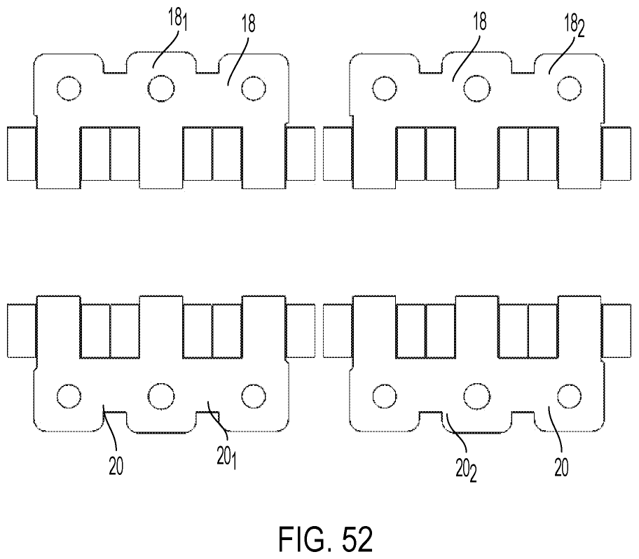

FIGS. 1-31 show a multistage motor assembly 14 (e.g., with a single stator set) in which electromagnetic fields of the stators 18, 20 interact with magnetic fields of magnets of the plunger 22. Each stator set may have three stages. The stator may be a three-phase stator, where there are three teeth for each stator core. Each stator may be a multi-phase stator, where there may be predetermined number of teeth for each stator core. Other embodiments can be envisioned where there are more than three teeth (e.g., 6 teeth or 9 teeth) where the windings are connected in three phases. The embodiment of FIG. 32 may be defined as multiple stator sets, each including two stators, each including three phases. The phases of the two stators in each set may be synchronously driven (i.e., where the magnets of opposite polarities are disposed on two sides of the plunger 22). There may be other embodiments where the phases of the two stators are not synchronously driven. One embodiment of the present disclosure, however, uses a multistage motor assembly 14 that has at least two stators as shown in and described below in detail with respect to FIGS. 32-52. For example, FIG. 5 shows the motor assembly 14 with one stator, which includes two stator cores disposed on two sides of the plunger 22 and FIG. 33 shows the motor assembly 14 with two stators located adjacent one another along the drive axis, each including two stator cores disposed on two sides of the plunger 22.

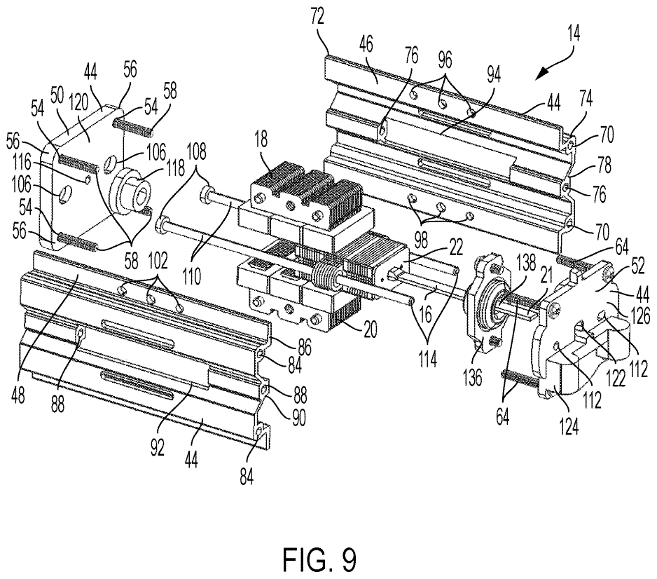

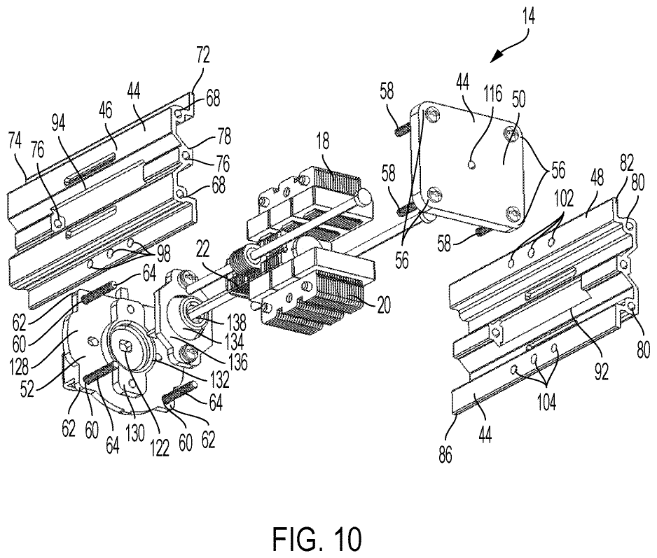

Referring to FIGS. 9 and 10, the motor assembly 14 may include the frame 44. The frame 44 may be configured to enclose/protect the components of the motor assembly 14 and at least portions of the driver 16. The frame 44 may also be configured to support the components of the motor assembly 14 and at least portions of the driver 16. The frame 44 may also be configured to facilitate (1) connections between the stators 18, 20 and the frame 44 so as to fixedly/stationarily connect the stators 18, 20 to the frame 44, and (2) connections between guide rods 110 and the frame 44 so as to enable movable connections between the plunger 22 and/or the driver 16 and the frame 44. For example, the plunger 22 and/or the driver 16 may be configured to slide along the guide rods 110 of the frame 44. The frame 44 may include two guide rods 110 extending along (e.g., the length of) the frame 44. As will be clear from the discussions below, the guide rods 110 may be configured to enable the plunger 22 and/or the driver 16 to travel/translate between the extended and the retracted conditions of the driver 16. The stator core (i.e., stator body or back-iron and the stator teeth) is the flux concentrating element 44 for each stator.

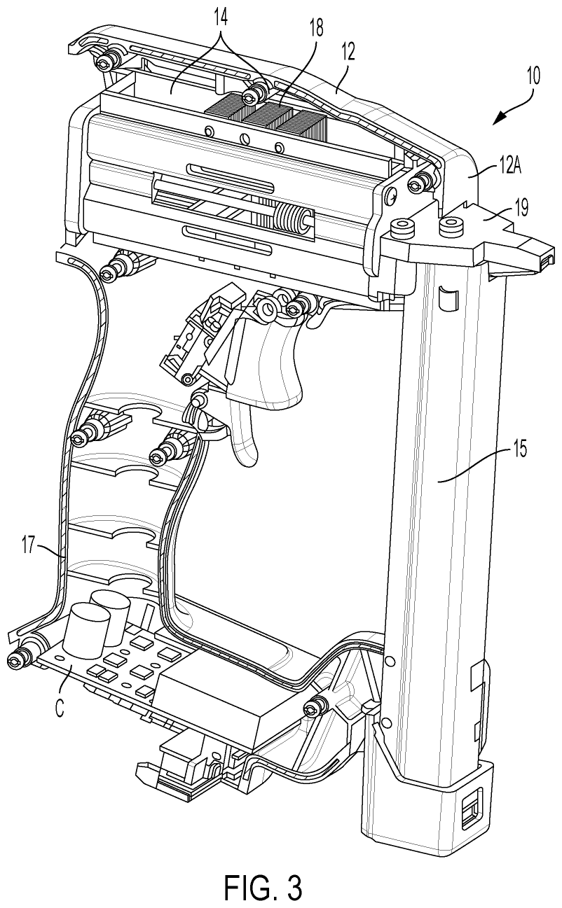

The frame 44 may include two opposing longitudinal frame members 46 and 48, and two frame end portions 50 and 52. Each of the two opposing longitudinal frame members 46 and 48, and two frame end portions 50 and 52 may include wall portions. The two opposing longitudinal frame members 46 and 48 may extend along the drive axis D-D. The two frame end portions 50 and 52 may be perpendicular to the drive axis D-D and may also be perpendicular the two opposing longitudinal frame members 46 and 48. As shown in FIG. 3, the top and bottom portions (e.g., that extend along the drive axis D-D) of the frame 44 may be enclosed/covered by portions of the housing 12. In another embodiment, the top and bottom portions (e.g., that extend along the drive axis D-D) of the frame 44 may include opposing top and bottom frame members (not shown).

The longitudinal frame member 46 may include two openings 68 at one end 72 and two openings 70 at an opposing end 74. The openings 68 and the openings 70 may extend (longitudinally) along the drive axis D-D and may extend for predetermined lengths (away) from their respective ends. The openings 68 and the openings 70 may include threaded openings that are configured to engage with and receive threaded fasteners therein so as to connect the frame end portions 50 and 52 to the longitudinal frame member 46. One of the two openings 68 and one of the two openings 70 may be disposed on an upper/top portion of longitudinal frame member 46, while the other of the two openings 68 and the other of the two openings 70 may be disposed on a lower/bottom portion of longitudinal frame member 46.

The longitudinal frame member 46 may also include an opening 76 that is disposed in a central portion 78 of the longitudinal frame member 46. In the illustrated embodiment of FIGS. 9 and 10, the opening 76 may not extend the entire length of the longitudinal frame member 46 (i.e., the entire length between the end 72 to the end 74) but rather the openings 76 may extend for predetermined lengths from each ends 72 and 74. The longitudinal frame member 46 may also include a cutout portion 94 that is disposed between the two spaced apart opening portions/openings 76. The cutout portion 94 may be configured to allow portions of the plunger 22 to protrude therethrough so as to interact with a sensor (e.g., Hall sensor HS) connected to the frame 44. As will be clear from the discussions below, the sensor may be configured to detect the position of the plunger 22 with respect to the frame 44 or the stators 18, 20.

The longitudinal frame member 46 may also include three openings 96 on the upper/top portion of the longitudinal frame member 46 and three openings 98 on the lower/bottom portion of the longitudinal frame member 46. As will be clear from the discussions below, the openings 96 may be configured to align with openings 36 of the first stator 18 and to receive connectors 40 so as to secure the first stator 18 to the longitudinal frame member 46 and the openings 98 may be configured to align with openings 38 of the second stator 20 and to receive connectors 42 so as to secure the second stator 20 to the longitudinal frame member 46.

The longitudinal frame member 48 may include two openings 80 at one end 82 and two openings 84 at an opposing end 86. The openings 80 and the openings 84 may extend (longitudinally) along the drive axis D-D and may extend for predetermined lengths (away) from their respective ends. The openings 80 and the openings 84 may include threaded openings that are configured to engage with and receive threaded fasteners therein so as to connect the frame end portions 50 and 52 to the longitudinal frame member 48. One of the two openings 80 and one of the two openings 86 may be disposed on an upper/top portion of longitudinal frame member 48, while the other of the two openings 80 and the other of the two openings 86 may be disposed on a lower/bottom portion of longitudinal frame member 48. The longitudinal frame member 48 may also include an opening 88 that is disposed in a central portion 90 of the longitudinal frame member 48. In the illustrated embodiment of FIGS. 9 and 10, the opening 88 may not extend the entire length of the longitudinal frame member 48 (e.g., the entire length between the end 82 to the end 86) but rather the openings 88 may extend for predetermined lengths from each ends 82 and 86. The longitudinal frame member 48 may also include a cutout portion 92 that is disposed between the two spaced apart opening portions/openings 88. The cutout portion 92 may be configured to allow portions of the plunger 22 to protrude therethrough so as to interact with a sensor (e.g., Hall sensor HS) connected to the frame 44. The cutout portion 92 may be configured to provide clearance for the plunger 22. The cutout portion 92 may be configured to interact with the bumpers. As will be clear from the discussions below, the sensor may be configured to detect the position of the plunger 22 with respect to the frame 44 or the stators 18, 20.

The longitudinal frame member 48 may also include three openings 102 on the upper/top portion and three openings 104 on the lower/bottom portion. As will be clear from the discussions below, the openings 102 are configured to align with openings 36 of the first stator 18 and to receive connectors 40 so as to secure the first stator 18 to the longitudinal frame member 48 and the openings 104 are configured to align with opening 38 of the second stator 20 and to receive connectors 42 so as to secure the second stator 20 to the longitudinal frame member 48.

The frame end portion 50 may include openings 54 at each corner 56 and fasteners 58 received in the openings 54. In the illustrated embodiment, the number of fasteners 58 and the corner openings 54 may be four. The number of fasteners 58 and the corner openings 54 may vary. The fasteners 58 on the top/upper portion of the frame end portion 50 may be configured to align with and be received by the opening 68 of the longitudinal frame member 46 and the opening 80 of the longitudinal frame member 48 so as to connect the frame end portion 50, at its the top/upper portion, with the longitudinal frame members 46, 48. Similarly, the fasteners 58 on the bottom/lower portion of the frame end portion 50 may be configured to align with and be received by the opening 68 of the longitudinal frame member 46 and the opening 80 of the longitudinal frame member 48 so as to connect the frame end portion 50, at its the bottom/lower portion, with the longitudinal frame members 46, 48.

The frame end portion 50 may also include two receiving portions 106 that are configured to receive head portions 108 of the guide rods 110 therein so as to connect the head portions 108 of the guide rods 110 to the frame end portion 50.

The frame end portion 50 may also include an opening 116 that is configured to facilitate a connection of the bumper/bumper member 118 to a surface 120 of the frame end portion 50. A fastener may be received in the opening 116 to enable the connection of the bumper member 118 to the surface 120 of the frame end portion 50.

The frame end portion 52 may include openings 60 at each corner 62 and fasteners 64 received in the openings 66. In the illustrated embodiment, the number of fasteners 64 and the corner openings 60 may be four. The number of fasteners 64 and the corner openings 60 may vary. The fasteners 64 on the top/upper portion of the frame end portion 52 may be configured to align with and be received by the opening 70 of the longitudinal frame member 46 and the opening 84 of the longitudinal frame member 48 so as to connect the frame end portion 52, at its the top/upper portion, with the longitudinal frame members 46, 48. Similarly, the fasteners 64 on the bottom/lower portion of the frame end portion 52 may be configured to align with and be received by the opening 70 of the longitudinal frame member 46 and the opening 84 of the longitudinal frame member 48 so as to connect the frame end portion 52, at its the bottom/lower portion, with the longitudinal frame members 46, 48.

The frame end portion 52 may also include two openings 112 that are configured to receive end portions 114 of the guide rods 110 so as to connect the end portions 114 of the guide rods 110 to the frame end portion 52. The end portions 114 of the guide rails/rods 110 may align with the frame end portion 52.

The frame end portion 52 may also include an opening 122 that is configured to enable the driver blade 21 to pass therethrough when the driver 16 moves between the retracted and the extended conditions.

A support portion 124 may be secured to a surface 126 of the frame end portion 52. The support portion 124 may be disposed on the lower/bottom portion of the frame end portion 52 to support the driver blade 21 when the driver 16 moves between the retracted and the extended conditions. Referring to FIG. 5, the support portion 124 may be constructed and arranged to receive, engage, and support portions of the magazine 15 and/or portions of the nose assembly 19. The support portion 124 may be configured to receive fasteners for the nose assembly 19.

Referring to FIGS. 9 and 10, a first member 130 may be disposed on a surface 128 of the frame end portion 52. The surface 128 and the surface 126 are two opposing surfaces of the frame end portion 52. The first member 130 may include a central opening 132 that is configured to receive portions of the bumper member 134 therein. The first member 130 also may include two openings disposed above and below the central opening 132. These two openings of the first member 130 may be configured to be aligned with openings of a second member 136 and to receive fasteners to connect/couple the first member 130 and the second member 136 to the frame end portion 52.

The bumper member 134 may be disposed centrally on the second member 136. The bumper member 134 may include an opening 138 that is configured to enable the driver blade 21 to pass therethrough when the driver 16 moves between the retracted and the extended conditions. The opening 138 may be disposed centrally on the bumper member 134 and may be configured to be aligned with the opening 122 of the frame end portion 52 to enable the driver blade 21 to pass therethrough when the driver 16 moves between the retracted and the extended conditions. The bumper member 134 may be disposed on the guide rails/rods.

The frame assembly 44 may include two opposing sides. The stator assembly 18, 20 is connected to at least one of the two opposing sides. Each of the other of the two opposing sides includes openings that are configured to receive portions of a first axial guide member 110 (described in detail below) therein so as to connect the first axial guide member 110 to the frame assembly 44.

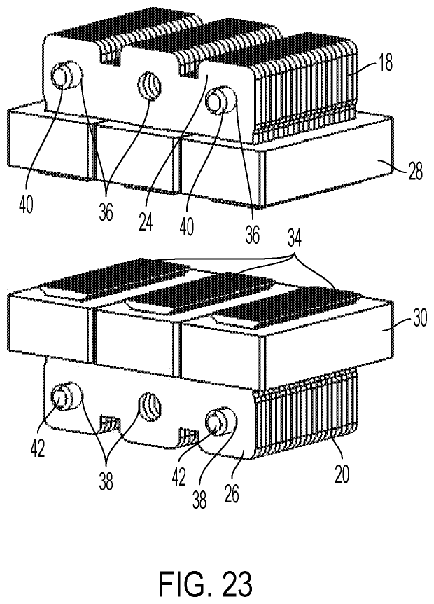

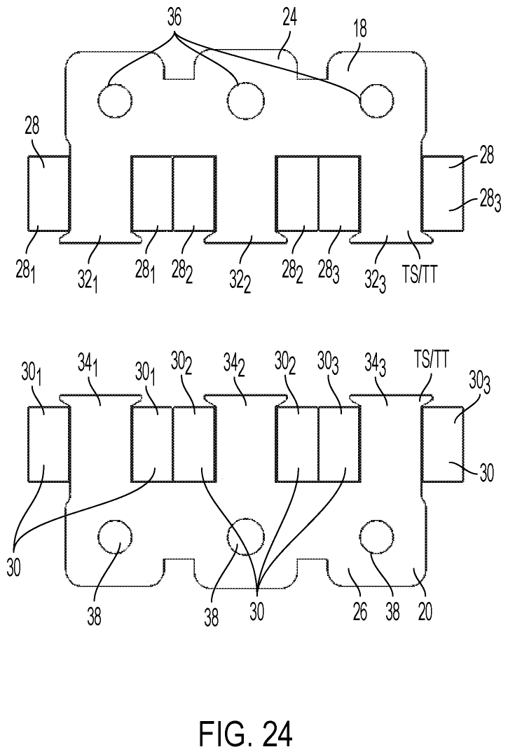

Referring to FIGS. 23-24, each stator core may include a solid-core construction including a single piece of metallic material, or may be constructed from a series of stamped laminations fixed together to form the stator core. That is, the stator may have a solid-core construction or may made of a lamination stack. The stator may have no steel. The stator may include a soft magnetic material (steel, Powder Metallurgy (PM)). The stator includes soft magnetic frame for stator coils. The stator may include laminations (but laminations are not required). Each stator 18, 20 may include an E-frame type linear electromagnetic motor stator. Each stator 18, 20 may include an E-frame/stator core 24, 26 and linear electromagnetic motor phase windings 28, 30. Each stator 18, 20 may be configured to extend along the drive axis D-D.

Some information about the stator geometry and general design is described in detail here. The width of the stator teeth and the width of the slot may be optimized so as to maximize the amount of space for the stator coils while also maximizing the amount of flux passing within the tooth. The width of the tooth may be configured such that the magnetic flux passing from the magnets to within the teeth does not saturate the soft magnetic material that the stator is made out of. Higher performance magnetic steels can be chosen to minimize the tooth width needed before saturation occurs, or to maximize flux concentrating effects from the magnet plunger to the stator. The optimum width may be guided by flux saturation but may be ultimately determined using Finite Element Analysis (FEA) and optimization to arrive at the final width, to maximize output efficiency, minimize stroke length, and maximize output energy during the drive stroke.

The width of the teeth tips TT/TS (referred to as “tooth shoe”) may be designed to be wide to capture more flux from the magnets, but not too wide so as to create a flux shorting path from one tooth to the next tooth. In some realizations, there might be no tooth tip to allow for a bobbin-style wind, where the coil may be slid onto the tooth after it is wound independently from the stator. Each dimension of the magnet in the plunger core may also be optimized to minimize plunger mass and maximize performance. The optimal magnet thickness may be determined using the FEA and optimization to maximize the aforementioned performance parameters (efficiency, drive stroke energy) while minimizing magnet volume and mass. The magnet width may go through a similar optimization process. These parameters can be optimized independently or as a part of a large-scale Design of Experiments (DOE). The stator back iron (part that connects the teeth) is designed to be thick enough so as to not restrict flux/saturate, but not too thick to keep the stator volume and mass as low as possible.

The first stator 18 may include a first stator core 24 oriented along a first plane that is substantially parallel to the drive axis D-D, a plurality of first teeth 32 extending inwardly from the first stator core 24 in a direction substantially perpendicularly to the first plane and perpendicular to the drive axis D-D, and a plurality of first windings 28 wound around the first stator teeth 32 (e.g., for defining phases of the motor assembly 14). The first windings may be interchangeably referred to as first stator windings. The first stator 18 may include a first stator lamination stack 24 having the first linear stator core 24. The first stator core 24 may include the series of first teeth 32 and the first stator windings (i.e., coils) 28 wound around the first teeth 32. The teeth may be perpendicular to the drive direction.

The plurality of first stator teeth 32 extending from the first stator core 24 may include first stator tooth 32₁, first stator tooth 32₂, and first stator tooth 32₃. Although three first stator teeth 32 are shown, the number of first stator teeth 32 in the first stator 18 may vary. The first stator teeth may be parallel to each other. The first stator teeth may be substantially perpendicular to a plane of the stator core (or stator body) and/or the drive axis/direction. The first stator teeth may include pole tips TT/TS. The pole tips TT/TS are the notches that extend from the inner ends of the stator teeth.

The plurality of first stator windings 28 wound around the first stator teeth 32 may include first stator windings 28₁ wound around the first stator teeth 32₁, first stator windings 28₂ wound around the first stator teeth 32₂, and first stator windings 28₃ wound around the first stator teeth 32₃. Although three first stator windings 28 are shown, the number of first stator windings 28 in the first stator 18 may vary and may depend on the number of first stator teeth 32.

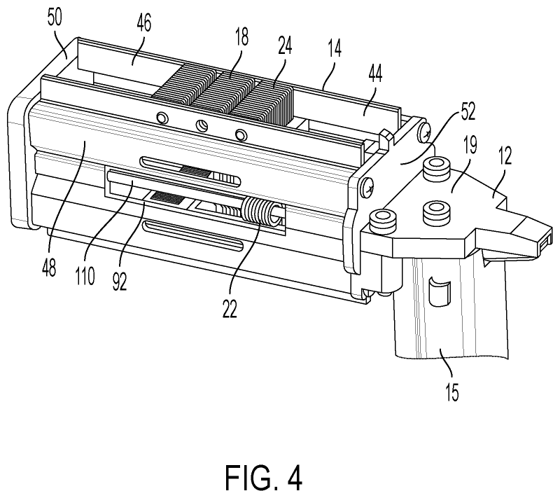

The first stator 18 may be configured to be coupled/connected to the frame 44 of the motor assembly 14. The first stator core 24 of the first stator 18 may be secured to the frame 44 of the motor assembly 14 on one of the two opposing sides of the plunger 22 and/or the driver 16. The first stator core 24 of the first stator 18 may include one or more openings 36 therethrough that are configured to receive connectors 40 to secure the first stator core 24 of the first stator 18 to the frame 44. In the illustrated embodiment of FIGS. 4-25, three openings 36 are shown and only two of the three connectors 40 (in the outer (first and the last (i.e., not the middle)) openings 36) are shown. The number of openings 36 in the first stator 18 and the number of connectors 40 that are used to connect the first stator 18 to the frame 44 may vary.

The first stator 18 may be secured to the two longitudinal frame members 46 and 48 of the frame 44. As discussed in detail above, the two longitudinal frame members 46 and 48 may include the openings 96 and 102 that are configured to align with the openings 36 of the first stator 18. The aligned openings of the two longitudinal frame members 46 and 48 of the frame 44 and that of the first stator 18 may be configured to receive the connectors 40 therein so as to secure the first stator 18 to the frame 44. The openings 96 and 102 of the two longitudinal frame members 46 and 48 may be disposed on the upper/top portions of the two longitudinal frame members 46 and 48 so as to connect the first stator 18 to the frame 44 of the motor assembly 14 and to position the first stator 18 above the plunger 22 and/or the driver 16.

The second stator 20 may include a second stator core 26 oriented along a second plane that is substantially parallel to the drive axis D-D, a plurality of second teeth 34 extending inwardly from the second stator core 26 in a direction substantially perpendicular to the second plane and perpendicular to the drive axis D-D, and a plurality of second windings 30 wound around the second stator teeth 34. The second stator 20 may include a stator lamination stack 26 having the second linear stator core 26.

The plurality of second stator teeth 34 extending from the second stator core 26 may include second stator tooth 34₁, second stator tooth 34₂, and second stator tooth 34₃. Although three second stator teeth 34 are shown, the number of second stator teeth 34 in the second stator 20 may vary. The second stator teeth may be parallel to each other. The second stator teeth may be substantially perpendicular to a plane of the stator core (or stator body) and/or the drive axis/direction.

The plurality of second stator windings 30 wound around the second stator teeth 34 may include second stator windings 30₁ wound around the second stator teeth 34₁, second stator windings 30₂ wound around the second stator teeth 34₂, and second stator windings 30₃ wound around the second stator teeth 34₃. Although three second stator windings are shown, the number of second stator windings 30 wound around their respective second stator teeth in the second stator 20 may vary and may depend on the number of second stator teeth 34.

The second stator 20 may be configured to be coupled/connected to the frame 44 of the motor assembly 14. The second stator core 26 of the second stator 20 may be secured to the frame 44 of the motor assembly 14 on the other/second of the two opposing sides of the plunger 22 and/or the driver 16. The second stator core 26 of the second stator 20 may include one or more openings 38 therethrough that are configured to receive connectors 42 to secure the second stator core 26 of the second stator 20 to the frame 44 of the motor assembly 14. In the illustrated embodiment of FIGS. 4-25, three openings 38 are shown and two connectors 42 (in the outer (first and the last (i.e., not the middle)) openings 38) are shown. The number of openings 38 in the second stator 20 and the number of connectors 42 that are used to connect the second stator 20 to the frame 44 of the motor assembly 14 may vary.

The second stator 20 may be secured to the two longitudinal frame members 46 and 48 of the frame 44. As discussed in detail above, the two longitudinal frame members 46 and 48 may include the openings 98 and 104 that are configured to align with the openings 38 of the second stator 20. The aligned openings of the two longitudinal frame members 46 and 48 of the frame 44 and that of the second stator 20 may be configured to receive the connectors 42 therein so as to secure the second stator 20 to the frame 44. The openings 98 and 104 of the two longitudinal frame members 46 and 48 of the frame 44 may be disposed on the bottom/lower halves of the two longitudinal frame members 46 and 48 so as to connect the second stator 20 to the frame 44 of the motor assembly 14 and to position the second stator 20 below the plunger 22 and/or the driver 16.

The first and the second stator 18, 20 may be fixedly connected to the frame 44 so that the first and the second stators 18, 20 may function as the stationary part of the motor 14. The first stator lamination stack 24 and the second stator lamination stack 26 may each be assembled from a stack of laminations stamped from sheets of electrical steel (e.g., generally less than or equal to 0.5 mm, preferably approximately smaller than or equal to 0.35 mm thick). The first stator lamination stack 24 and the second stator lamination stack 26 may be designed to minimize eddy currents, which would otherwise waste energy and create heat.

In the stator, windings/coils are wounded around the laminated steel structure called or referred to as a tooth, which channels more magnetic flux through them. A slot is the section between two teeth. A three-phase motor have slots (and teeth) that is evenly divisible by three. Windings may include insulated conductors that pass through the slots cut in the stator. The spaces between the slots may be referred to as teeth of the stator. The shape of the slots and teeth depends upon the design of the motor assembly. The slots may be rectangular. The wider part at the end of the tooth is called a tooth shoe. A phase is an individual group of windings with a single terminal accessible from outside the motor.

The windings 28, 30 may be round end-windings. The windings 28, 30 may be bobbin-style windings. The stator windings 28, 30 of the same stator may be connected in a variety of configurations including a delta or a wye configuration. The stator windings 28, 30 may be independently driven without interconnections between oppositely-facing stator windings. Alternatively, oppositely-facing stator windings 28, 30 of the two stators may be connected in a series of parallel configuration via metal routings or wirings (not shown) passing along the frame 44. Different stator windings connections that are used to achieve the series wye (“Y” shaped), series delta, and parallel delta configurations are described in detail and shown in U.S. Pat. No. 9,450,472 (“the '472 Patent”), which is commonly assigned to the same entity as the present disclosure and is incorporated by reference herein in its entirety. A parallel wye configuration may also be achieved, although such configuration is not explicitly shown in the '472 Patent. The three stator windings in a six-pole brushless motor are typically designated as U-U₁; V-V₁; and W-W₁ windings, where each winding includes two poles (U and U₁, for example, designate two poles of the same winding). For example, FIG. 24 illustrates the respective poles, as an example U-U₁ are 28₁-30₁, V-V₁ are 28₂-30₂, W-W₁, are 28₃-30₃. The wye configuration, sometimes called a star winding, connects all of the windings to a neutral (e.g., ground) point and power is applied to the remaining end of each winding. The delta configuration connects the three windings to each other in a triangle-like circuit, and power is applied at each of the connections. For a given rotary motor, the delta configuration achieves higher speed (rpm) at lower torque, whereas the wye configuration achieves relatively higher torque at lower speed. The parallel delta configuration achieves the even higher speed at lower torque load. Whereas for a given linear motor, the delta configuration can achieve higher top speed (m/s) at a lower force. The wye configuration achieves relatively higher force at lower top speed. The parallel delta configuration achieves an even higher speed at lower force.

The first stator 18 and the second stator 20 may be physically separate from each other. For example, the first stator 18 may be disposed above the plunger 22 and/or the driver 16, while the second stator 20 may be disposed below the plunger 22 and/or the driver 16. In another embodiment, the first stator 18 may be disposed on one side of the plunger 22 and/or the driver 16, while the second stator 20 may be disposed on the other side of the plunger 22 and/or the driver 16.

The first stator 18 and the second stator 20 may be configured to be electrically connected to each other. A plurality of phases of the first stator 18 may be respectively electrically coupled to a plurality of phases of the second stator 20. The fastener device 10 may further include an inverter circuit comprising a plurality of power switches configured to synchronously drive the first and second stators 18 and 20 via a common plurality of phase voltage input lines. The plurality of phases of the first stator 18 may be connected to the plurality of phases of the second stator 20 via a plurality of connectors or wires disposed along the frame 44.

The fastener device 10 may include a first inverter circuit that includes a plurality of first power switches configured to drive the first stator via a first plurality of phase voltage input lines, and a second inverter circuit that includes a plurality of second power switches configured to drive the second stator via a second plurality of phase voltage input lines. The first inverter circuit and the second inverter circuit are synchronously controlled to cause synchronous drive of the first and second stators 18, 20.

The first stator 18 and the second stator 20 may be configured to be operated synchronously. The first stator 18 and the second stator 20 may be configured to be coupled to the frame 44. The frame 44 may include non-magnetic material. The frame 44 itself is not flux concentrating, i.e., it is made of non-magnetic metal such as aluminum. The frame 44 may be magnetically isolated from the stators 18, 20. The frame 44 may extend along a third plane substantially perpendicular to the first and second planes between the first stator 18 and the second stator 20.

Referring to FIGS. 32-52, the motor assembly 14 may include a plurality of first stators 18 and 18₂ and a plurality of second stators 20₁ and 20₂. The plurality of first stators 18₁ and 18₂ may extend along a single first axis substantially parallel to the drive axis D-D and may be disposed on one side S₁ of the driver 16 and/or the plunger 22. The plurality of second stators 20₁ and 20₂ may extend along a single second axis substantially parallel to the drive axis D-D and may be disposed on the opposing side S₂ of the driver 16 and/or the plunger 22. The single first axis and the single second axis may be substantially parallel to each other and may be substantially parallel to the drive axis D-D. The motor assembly 14 may include two or more stators arranged alongside one another along the movement axis, where each stator includes two discrete stator cores.

The first stator 18 may be one of the plurality of first stators 18₁ and 18₂ and the second stator 20 may be one of the plurality of second stators 20₁ and 20₂. One of the plurality of first stators 18₁ and 18₂ and one of the plurality of second stators 20₁ and 20₂ may be operated synchronously to drive the driver 16 and/or the plunger 22 along the drive axis D-D. The plurality of first stators 18₁ and 18₂ may be configured to be sequentially energized to drive the driver 16 and/or the plunger 22 along the drive axis D-D. The plurality of first stators 18₁ and 18₂ may be configured to be energized one after the other. Each of the plurality of first stators 18₁ and 18₂ may be configured to be energized to be synchronously operated with each of the plurality of second stators 20₁ and 20₂. The first stators 18₁ and 18₂ may be configured to be sequenced in sync. A commutation of a subsequent stator of the plurality of first stators 18₁ and 18₂ begins when the plunger 22 reaches a predetermined distance relative to the first stator 18₁.

The plurality of second stators 20₁ and 20₂ may be configured to be sequentially energized to drive the driver 16 along the drive axis D-D. Each of the plurality of second stators 20₁ and 20₂ may be configured to be energized to be synchronously operated with each of the plurality of second stators 18₁ and 18₂. The second stators 20₁ and 20₂ may be configured to be sequenced in sync. A commutation of a subsequent stator of the plurality of second stators 20₁ and 20₂ begins when the plunger 22 reaches a predetermined distance relative to the second stator 20₁.

FIGS. 32-52 are similar to FIGS. 4-24, except that dual motor assembly 14 having the plurality of first stators 18₁ and 18₂ and the plurality of second stators 20₁ and 20₂ are used in the embodiment shown in FIGS. 32-52. FIGS. 32-52 will not be described in detail here.

When a current is supplied to the coils/windings 28, 30 of the stator 18, 20 in a predetermined direction, the stator 18, 20 may be configured to generate the electromagnetic field. That is, when a current is supplied through the coils/winding 28, 30 of the stator 18, 20, an electromagnetic field is generated and the stator 18, 20 becomes active. The direction in which the current is driven/supplied through the coils/windings 28, 30 may determine the polarity of the electromagnetic field of the stator 18, 20. As will be clear from the discussion below, the plunger 22 (including permanent magnets M₁-M₆ and their own magnetic fields) may pass through the electromagnetic field of the stator 18, 20 when the driver 16 (coupled to the plunger 22) is moved between its retracted and its extended conditions. This may cause an interaction between the electromagnetic fields of the stator 18, 20 and the magnetic fields of the plunger 22. When the direction of the electromagnetic field of the stator 18, 20 is same to the direction of the magnetic field of the plunger 22, the (magnet of the) plunger 22 and the driver 16 coupled to the plunger 22 are attracted by the electromagnetic field of the stator 18, 20. Similarly, when the direction of the electromagnetic field of the stator 18, 20 is opposite to the direction of the magnetic field of the plunger 22, the (magnet of the) plunger 22 and the driver 16 coupled to the plunger 22 are repelled by the electromagnetic field of the stator 18, 20. The polarity of the electromagnetic field of the stator 18, 20 may either repel the magnet/plunger 22 from or attract the magnet/plunger 22 to the electromagnetic field of the stator 18, 20. There may be multiple fields from the multiple teeth so that they may be attracting and repelling at the same time rather than just attracting or repelling.

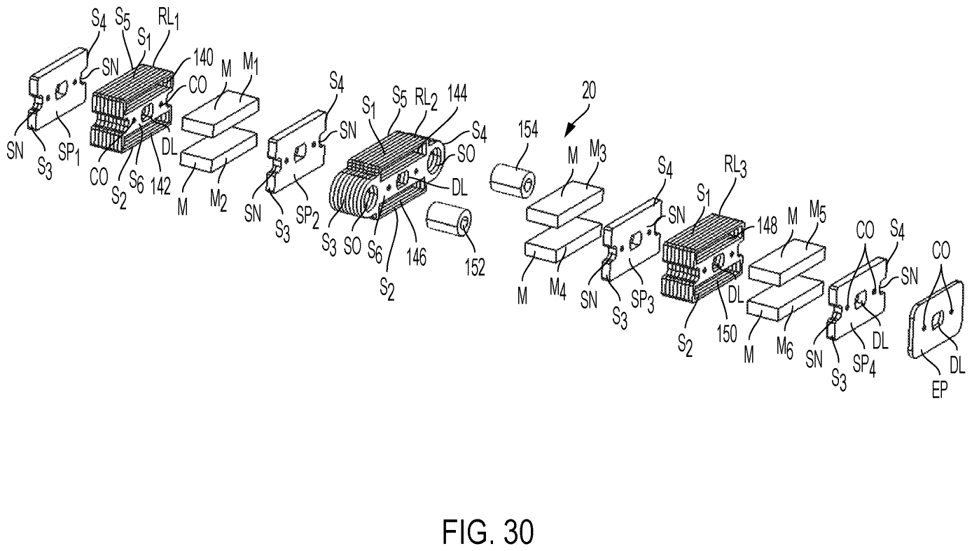

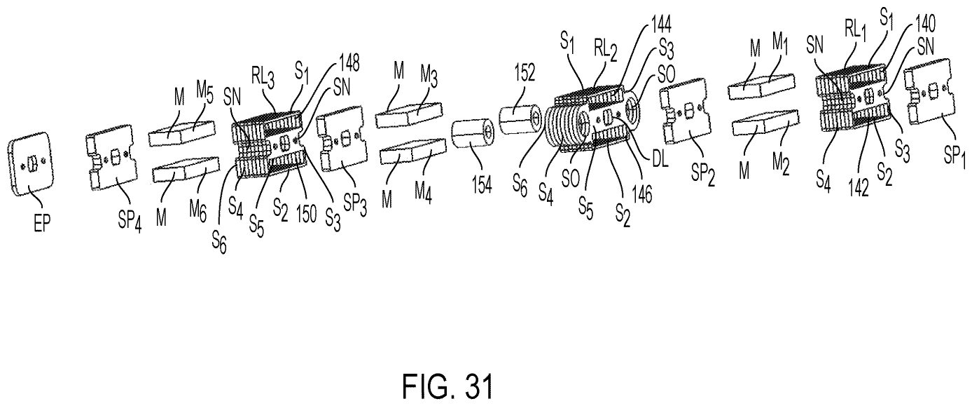

The plunger 22 and the driver 16 are shown in an assembled configuration in FIGS. 25-28 and the plunger 22 is shown in an exploded configuration in FIGS. 30-31. FIGS. 25-28 shows the assembled configuration of the plunger 22 along with the driver 16. Although the guide rods 110 of the frame 44 may be configured to be received in openings SO and notches SN of the plunger 22 when the plunger 22 and the driver 16 are assembled in the frame 44, the guide rods 110 are not shown in FIGS. 25-28 to better illustrate other portions/components of the plunger 22. The opening SO may also be configured to be a pocket. The pocket SO may be configured for holding a bushing or linear bearing (guide rod receiving members 152 and 154). The opening SO may be interchangeably referred to as second axial guide member. The second axial guide member SO may be formed on the first plunger core RL₁, and the second plunger core RL₂ may include a notch SN formed therein that allows axial passage of the first axial guide member 110 alongside thereof. One of the rotor core RL may have the openings SO into which the bushings are press fit and which interfaces with the guide rods 110. The bushing may be made of Polytetrafluoroethylene (PTFE) or Bronze material, preferably a powdered metal Iron Bronze or Iron Copper blend with embedded lubricant.

The plunger 22 may include a multi-pole plunger. The plunger 22 may include a single multi-pole magnet instead of multiple magnets. The plunger 22 may include a plunger core and permanent magnets M₁-M₆. The plunger 22 may be the only moving part of the linear electromagnetic motor 14. The plunger 22 may include a multi-pole PM plunger (e.g., having 54-Grade). The plunger 22 may be configured to support the driver 16 with a total weight (including the plunger and the driver having a weight range between approximately 50 grams (gms) and approximately 80 gms. The plunger 22 may be configured to extend along the drive axis D-D.

Referring to FIGS. 25-28 and 30-31, the plunger 22 includes a plurality of plunger lamination stacks RL, a plurality of magnets M, a plurality of spacers SP, an end plate/member EP, and a pair of guide rod receiving members 152 and 154. The plunger 22 may interchangeably be referred to as plunger, moveable plunger or plunger assembly. The plunger 22 may include a plurality of magnets M with alternating polarities in sequence. The plunger 22 may include a lamination stack that houses a plurality/series of magnets M with alternating polarities in sequence. The plunger 22 may include a single magnet with a plurality of polarities in sequence. The plunger 22 may include a soft magnetic material and may not include the lamination stack. The plunger 22 may include a non-magnetic carrier for the magnets. The plunger 22 may include a plurality of plunger cores. Each plunger core may be configured to house at least one magnet M of the plurality of magnets M. The guide rod receiving members 152 and 154 may interchangeably referred to as bushings or linear bearings.

The plunger 22 may include the plurality of magnets M with alternating polarities in sequence. For example, the plurality of magnets M include the magnets M₁-M₆. Although six plunger magnets are shown, the number of magnets in the plunger 22 may vary and may depend on the number of plunger lamination stacks/cores RL. The magnets M₁ and M₂ may have the same N-S N-S polarity so that the plunger 22 has a N-S polarity interfacing with the stator assembly at the location of the magnets M₁ and M₂. The magnets M₃ and M₄ may have the same S-N S-N polarity so that the plunger 22 has a S-N polarity interfacing with the stator assembly at the location of the magnets M_{S} and M₄. The magnets M₅ and M₆ may similarly have the same N-S N-S polarity.

The plunger 22 includes at least one plunger core RL that is securely mounted on the driver 16 and is configured to house at least one magnet M of the plurality of magnets M.

The plunger 22 may include the plurality of plunger lamination stacks RL having the plunger cores RL. Although the plunger lamination stacks are described in some embodiments, in other embodiments, the plunger do not need to be laminated. That is, the plunger may have a solid-core construction or may made of a lamination stack. In the case of the plunger, it can be either magnetic or non-magnetic material.

The plurality of plunger lamination stacks/plunger cores RL may include plunger lamination stack RL₁, plunger lamination stack RL₂, and plunger lamination stack RL₃. Although three plunger lamination stacks are shown, the number of plunger lamination stacks in the plunger 22 may vary. The plunger lamination stack RL may be assembled from a stack of laminations stamped from sheets of electrical steel (e.g., generally approximately 0.35 to 0.5 mm thick). The plunger lamination stack may be designed to minimize eddy currents, which would otherwise waste energy and create heat.

The at least one plunger core RL comprises at least a first plunger core RL₁ and a second plunger core RL₂. A first magnet may be received within a first magnet receiving opening of the first plunger core RL₁ has a different polarity than a second magnet received within a second magnet receiving opening of the second plunger core RL₂.

Each plunger core RL_{1,} RL_{2,} and RL₃ may be configured to house at least one magnet M of the plurality of magnets M. The at least one magnet housed in the plunger core RL may include two magnets having the same polarity. For example, the plunger core RL₁ may be configured to house the magnets M₁ and M₂ that have the same polarity. Similarly, the plunger core RL₂ may be configured to house the magnets M₃ and M₄ that have the same polarity and the plunger core RL₃ may be configured to house the magnets M₅ and M₆ that have the same polarity.

Each plunger core RL may be configured to house one magnet on one side of the plunger core and the other magnet on an opposing side of the plunger core. Each of the plunger cores RL may include a first side S₁, a second side S₂ opposite the first side S₁, a third side S₃ and a fourth side S₄ opposite the third side S₃. The first side S₁ and the second side S₂ of each of the plunger cores RL may have magnet receiving openings. The magnet receiving openings of each of the plunger cores may be configured to receive the magnets M therein. The plunger 22 may include at least one plunger core that include at least one magnet receiving opening configured to receive the plurality of magnets therein.

The magnets M received in the magnet receiving opening(s) of one of the plunger cores RL may have the same polarity. The magnets M received in the magnet receiving openings of one of the plunger cores RL may have different polarity than the magnets received in the magnet receiving openings of an adjacent one of the plunger cores RL. The at least one plunger core may comprise at least a first plunger core and a second plunger core. A first magnet may be received within a first magnet receiving opening of the first plunger core may have a different polarity than a second magnet received within a second magnet receiving opening of the second plunger core.

For example, the plunger core RL₁ may include an opening 140 on the first side S₁ and an opening 142 on the second side S₂. The opening 140 of the plunger core RL₁ may be configured to receive the magnet M₁ therein, while the opening 142 of the plunger core RL₁ may be configured to receive the magnet M₂ therein. As noted above, the magnets M₁ and M₂ in the openings 140 and 142 of the plunger core RL₁ have the same polarity. The openings 140, 142 may interchangeably referred to as magnet receiving openings.

Similarly, the plunger core RL₂ may include an opening 144 on the first side S₁ and an opening 146 on the second side S₂. The opening 144 of the plunger core RL₂ may be configured to receive the magnet M₃ therein, while the opening 146 of the plunger core RL₂ may be configured to receive the magnet M₄ therein. The openings 144, 146 may interchangeably referred to as magnet receiving openings. The magnets M₃ and M₄ in the openings 144 and 146 of the plunger core RL₂ have the same polarity. The magnets M₃ and M₄ in the openings 144 and 146 of the plunger core RL₂ have different polarity from the magnets M₁ and M₂ in the openings 140 and 142 of the plunger core RL₁.

The plunger core RL₃ may include an opening 148 on the first side S₁ and an opening 150 on the second side S₂. The opening 148 of the plunger core RL₃ may be configured to receive the magnet M₅ therein, while the opening 150 of the plunger core RL₃ may be configured to receive the magnet M₅ therein. The openings 148, 150 may interchangeably referred to as magnet receiving openings. The magnets M₅ and M₆ in the openings 148 and 150 of the plunger core RL₃ have the same polarity. The magnets M₅ and M₆ in the openings 148 and 150 of the plunger core RL₃ have the same polarity as the magnets M₁ and M₂ in the openings 140 and 142 of the plunger core RL₁. The magnets M₅ and M₆ in the openings 148 and 150 of the plunger core RL₃ have different polarity from the magnets M₃ and M₄ in the openings 144 and 146 of the plunger core RL₂.

The at least one plunger core RL may include the driver receiving opening DL arranged to securely receive the driver 16. The driver receiving opening DL may be disposed centrally or offset from a center point of the rotor core RL. Each of the plunger cores RL may include the driver receiving opening DL that is configured to receive the driver 16 therethrough so as to couple the driver 16 and the plunger assembly 22. The opening DL of each of the plunger cores RL may be disposed in a central portion in the corresponding plunger core RL and may be configured to receive portions of the driver 16 therein when the plunger 22 is in an assembled configuration as shown in FIGS. 25-28. Each plunger core RL may also include connector openings CO that are configured to receive fasteners/connectors therein to assemble all the components of the plunger 22. The connector openings CO may be alignment detents, that is, no fastener are required.

The plunger cores RL₁ and RL₃ each may also include two side notches SN, one side notch SN on each of the sides S₃ and S₄ of the plunger cores RL₁ and RL₃. The side notches SN of the plunger cores RL₁ and RL₃ may be configured to receive portions of the guide rods 110 therein. The side notches SN of the plunger cores RL₁ and RL₃ may be configured to engage with the portions of the guide rods 110 so as to allow the longitudinal translational movement of the plunger 22 and the driver 16 coupled/connected thereto between the extended and retracted conditions of the driver 16. The side notches SN of the plunger cores RL₁ and RL₃ may be configured for weight saving and for clearance.

As discussed above, the frame 44 may include a first axial guide member. For example, the frame 44 may also include one or two guide rods 110 extending substantially parallel to the drive axis D-D and extending along the frame 44. The first axial guide member may include one or more guide rods. The guide rods 110 may be one exemplary configuration of the first axial guide member. The first axial guide member may have other configurations as would be appreciated by one skilled in the art.

The plunger core RL may include a second axial guide member on a surface thereof that does not face the stator assembly arranged to slidingly engage the first axial guide feature to guide the plunger 22 along the drive axis D-D at a set distance relative to the stator assembly. For example, the plunger core RL may include I guide rod receiving openings SO of the at least one of the plunger cores RL₂ may be disposed the third side S₃ and the fourth side S₄ of the at least one of the plunger cores RL₂. Other of the plunger cores RL₁ and RL₃ may include guide rod/side notches SN that are disposed the third side S₃ and the fourth side S₄ of the other of the plunger cores RL₁ and RL₃. The guide rod notches SN may be configured to engage with at least a portion of the guide rods 110 so as to enable the plunger assembly 22 to slide along the lengths of the guide rods 110. The second axial guide member may include guide rod receiving openings SO. The guide rod receiving openings SO may also be interchangeably referred to as bushing receiving openings. The guide rod receiving openings SO/bushings may be one exemplary configuration of the second axial guide member. The second axial guide member may have other configurations as would be appreciated by one skilled in the art.

At least one of the plunger cores RL₂ include guide rod receiving openings SO that are configured to receive the guide rods 110 therethrough to enable the plunger assembly 22 to slide along lengths of the guide rods 110 so as to move the driver 16, coupled to the plunger assembly 22, between the retracted condition and the extended condition. The guide rod receiving openings may interchangeably be referred to as side openings. That is, the plunger core RL₂ may include two guide rod receiving openings SO, one side opening SO on each of the sides S₃ and S₄ of the plunger cores RL₂. The side openings SO of the plunger cores RL₂ may be configured to receive portions of the guide rods 110 therein. The side openings SO of the plunger cores RL₂ may be configured to engage with the portions of the guide rods 110 so as to allow the longitudinal translational movement of the plunger 22 and the driver 16 coupled/connected thereto between the extended and retracted conditions of the driver 16. The guide rod receiving openings SO may be configured to receive the guide rods 110 therethrough to enable the plunger assembly 22 to slide along lengths of the guide rods 110 so as to maintain the air gap between the plunger assembly 22 and the stator assembly 18, 20.

Each of the plunger cores RL may further include a fifth side S₅ and a sixth side S₆ opposite the fifth side S₅. The fifth side and the sixth side of each of the plunger cores RL may be perpendicular to the drive axis D-D. The plunger assembly 22 may further comprise the plurality of spacer members SP. One of the plurality of spacer members SP may be disposed on the fifth side S₅ of each plunger core RL and a second one of the plurality of spacer members SP may be disposed on the sixth side S₆ of each plunger core RL so as to separate each plunger core RL from its adjacent plunger cores RL. The spacer members SP may be configured to provide insulation. The spacer members SP may include non-magnetic material. The spacers may be a non-ferrous material, like plastic, etc. The plunger cores may be magnetically separate from each other. The plunger cores may be flux isolated from each other.

The plurality of spacers SP may include spacers SP₁, SP₂, SP₃, and SP₄. Although four spacers are shown, the number of spacers in the plunger 22 may vary and may depend on the number of plunger lamination stacks/cores RL. Each spacer SP may include an opening DL that is disposed centrally and is configured to receive portions of the driver 16 therein when the plunger 22 is in an assembled configuration as shown in FIGS. 25-28.

The spacers SP may be configured to separate each plunger lamination stack from an adjacent plunger lamination stack. For example, the spacer SP₂ is configured to separate the plunger lamination stacks RL₁ and the plunger lamination stacks RL₂. The spacer SP₃ is configured to separate the plunger lamination stack RL₂ and the plunger lamination stack RL₃.

The spacers SP may also be configured to cover an end of the plunger lamination stack. For example, the spacer SP₁ is configured to cover an end of the plunger lamination stack RL₃. The spacer SP₄ is configured to cover an end of the plunger lamination stack RL₃.

Each spacer SP may also include two side notches SN, one side notch SN on each of the sides S₃ and S₄ of the spacer SP. The side notches SN of the spacer SP may be configured to receive portions of the guide rods 110 therein. The side notches SN of the spacer SP may be configured to engage with the portions of the guide rods 110 so as to allow the longitudinal translational movement of the plunger 22 and the driver 16 coupled/connected thereto between the extended and retracted conditions of the driver 16. Each spacer SP may also include connector openings CO that are configured to receive fasteners/connectors therein to assemble all the components of the plunger 22.

The end plate EP may include an opening DL that is disposed centrally and is configured to receive portions of the driver 16 therein when the plunger 22 is in an assembled configuration as shown in FIGS. 25-28. The end plate EP may also include connector openings CO that are configured to receive fasteners/connectors therein to assemble all the components of the plunger 22. As shown in FIGS. 11-12 and 19, a surface S_{EP} of the end plate EP may be configured to engage with the bumper member 134 when the driver 16 is in its extended condition.

The pair of guide rod receiving members 152 and 154 are received in the side openings SO on the sides S₃ and S₄ of the plunger core RL₂. The guide rods 110 are received in the pair of guide rod receiving members 152 and 154, which are in turn received in the side openings SO on the sides S₃ and S₄ of the plunger core RL₂.

The fastener device 10 may include one or more sensors that are operatively connected to the motor assembly 14. The one or more sensors is configured to measure and output at least a signal indicative of a characteristic of the motor assembly 14. The one or more sensors is also operatively connected to the controller C. The one or more sensors may be configured to measure and output a signal indicative of a characteristic of the motor assembly 14. As a person of ordinary skill in the art would appreciate from this disclosure, the one or more sensors may sense the characteristic directly or indirectly. For example, some characteristics may be sensed directly, as through encoders, position detector(s), mechanical sensor(s), optical sensor(s), variable reluctance sensor(s), inductive proximity sensor(s), eddy current sensors or Hall effect sensors, or indirectly, as through the back electromotive force of the motor assembly 14.

The fastener device 10 may include a system that is configured to detect position of the driver 16 and commutation. Although, in some embodiments, Hall sensing may be used, in other embodiments, the sensing may be performed using inductive sensors/sensing elements or optical sensors/sensing elements. The linear electromagnetic motor may include a Hall board to sense a displacement of the plunger along the axis. This information may be used by the controller to determine when to commutate the next phase of the motor. Alternatively, sensorless motors controls (e.g., sensorless trapezoidal, sensorless field-oriented control, etc. may be used.

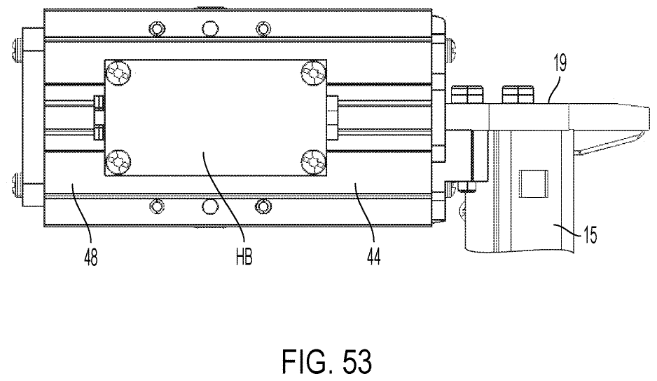

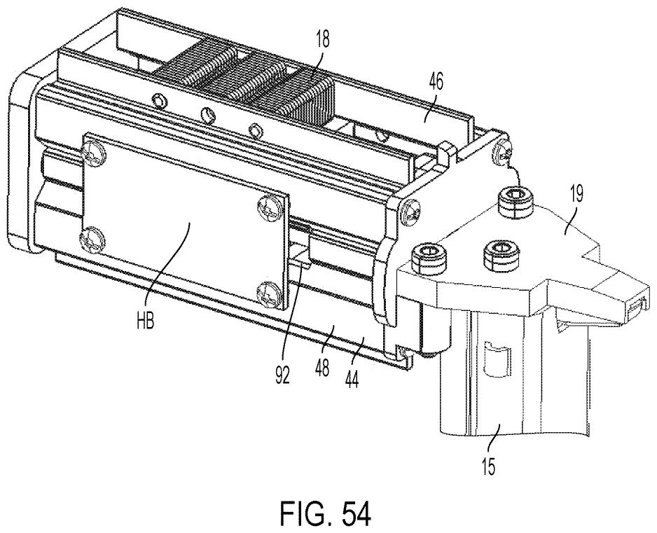

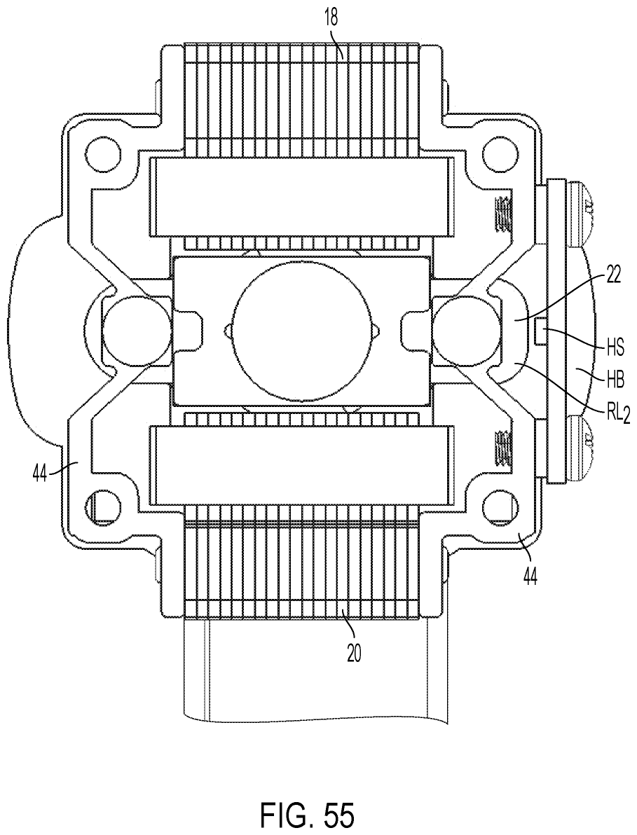

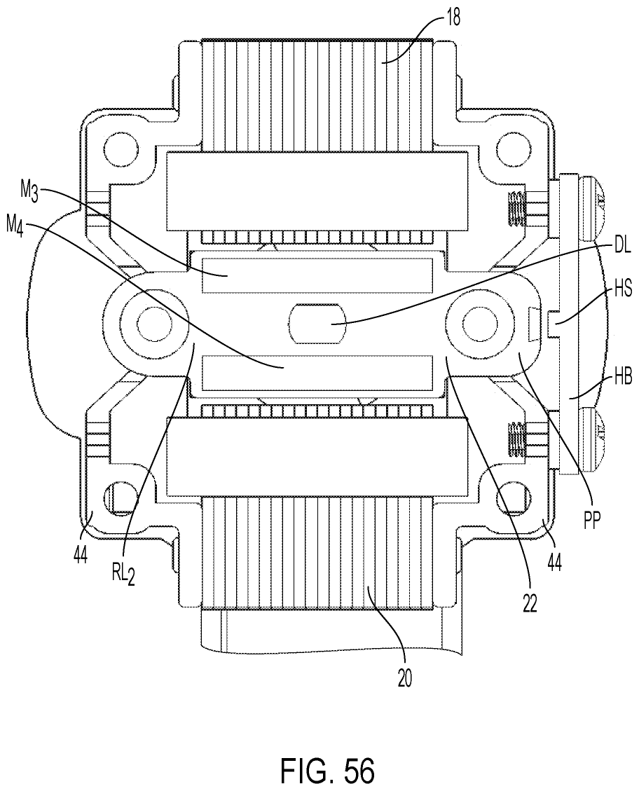

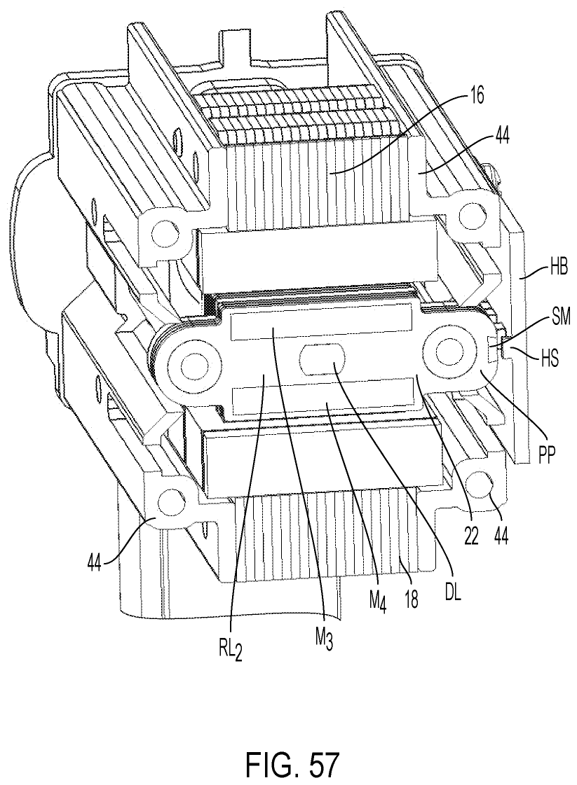

FIGS. 53-59 show a Hall board HB added to the fastener device 10. For example, the Hall board HB is connected to one of the longitudinal frame members 46, 48 of the frame 44 (e.g., using fasteners at corner portions of the Hall board HB). Although the Hall board HB is connected/coupled to the longitudinal frame member 48 of the frame 44 in FIGS. 53-57, the Hall board HB may be connected/coupled to the longitudinal frame member 46 of the frame 44 in other embodiments.

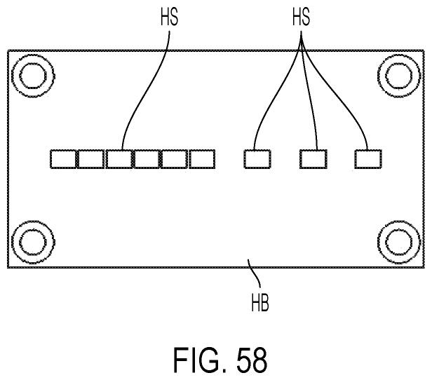

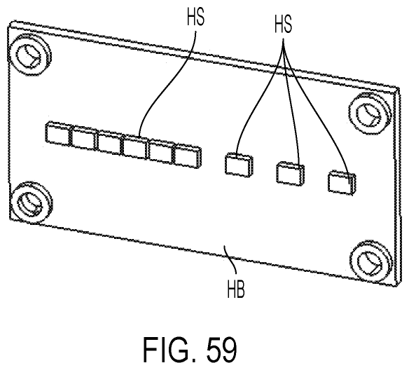

FIGS. 58-59 show a rear view and a perspective view of the Hall board HB. The Hall board HB includes a plurality of sensors HS mounted thereon. The sensors HS may interchangeably be referred to as Hall effect sensor or Hall sensor. The sensor HS may include sensors that are configured detect the presence and magnitude of a magnetic field (e.g., of the plunger core of the plunger 22) using the Hall effect. The output voltage of the sensors HS may be directly proportional to the strength of the magnetic field.

The sensors HS of the Hall board HB may be aligned with the cutout portion 92 in the longitudinal frame member 48 of the frame 44 such that the sensors S are configured to interact with the magnetic field of the plunger core RL₂. Portions PP of the plunger core RL₂ may be configured to protrude through the cutout portion 92 in the longitudinal frame member 48 of the frame 44 and protrude outwardly towards the Hall board HB so as to interact with the sensors S disposed on the Hall board HB.

The Hall sensors S are configured to sense the position of the plunger 22 and to switch the transistors in the right sequence. The Hall sensors HS may be used as binary switches in position sensing (e.g., sensing the position of the plunger 22). The hall sensors may be configured to detect a magnetic field (e.g., of the plunger core of the plunger 22) and to output an analog signal proportional to its magnitude of the magnetic field. The output of the hall sensor HS may be converted to an ON/OFF digital signal via a comparator and then may be used as the plunger position signal of the motor. The hall sensor HS may have a higher durability because the Hall sensor HS detects the position of the plunger 22 without contact with it.

In order to move the motor, the controller C may be configured to send current through the stator's coil/winding 28, 30. This produces electromagnetic field that in turn interacts with magnetic field of the permanent magnet M₁-M₆ of the plunger 22. As a result, the plunger 22 starts to move. If the plunger 22 reaches near the electromagnetic field that is moving it, the plunger 22 may tend stop because of the changed polarity. At this instance, the electromagnetic field may begin to attract the plunger 22 and stop the movement of the plunger 22. To avoid this, the controller C may be configured to switch the current supplied to the stator 18, 20 and a new magnetic field may be created and the plunger 22 continues its movement. The process of commutation is switching the current supplied to the stator 18, 20 when the plunger 22 has reached the desired position. The sensor may provide feedback to the controller C indicating when the plunger 22 has reached the desired position. The position of the plunger 22 has to be determined with respect to the stator 18, 20.

When the plunger magnet crosses one of the Hall sensors HS or a sense magnet, it produces a low or high signal depending on whether it is the North pole or the South pole of the plunger 22 that has passed. As the plunger 22 crosses all three sensors, these sensors switch between low and high, thus giving out the position of the plunger every 60 degrees. The spacing of the sensors may be based on commutation degree, it is possible that less accuracy may be needed for initial drive sequence, hence greater spacing.

Each of the boxes in FIGS. 58-59 are sensors. The sensors may be spaced to give less spatial resolution when the plunger 22 is moving slowly and not in contact with staple/workpiece (towards the retracted condition), and the sensors may be spaced closer together towards the end of the stroke (towards extended condition) to give higher spatial resolution when the plunger/driver/staple has contacted the workpiece, which may apply an unknown amount of force to the plunger 22.

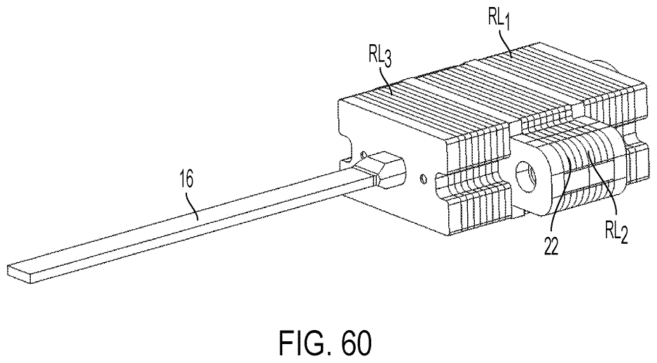

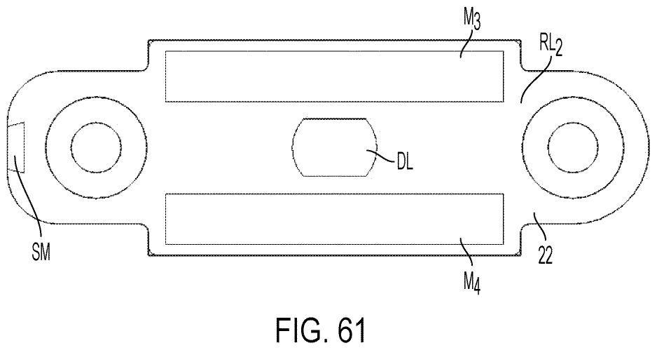

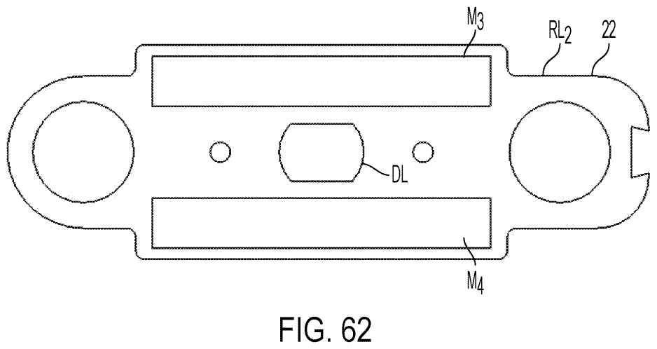

FIG. 60 shows the plunger 22 and the driver 16 in their assembled configuration and FIGS. 61 and 62 show side views of the plunger core RL₂ of the plunger 22. Referring to FIG. 61, the notch may include a sensor magnet SM.

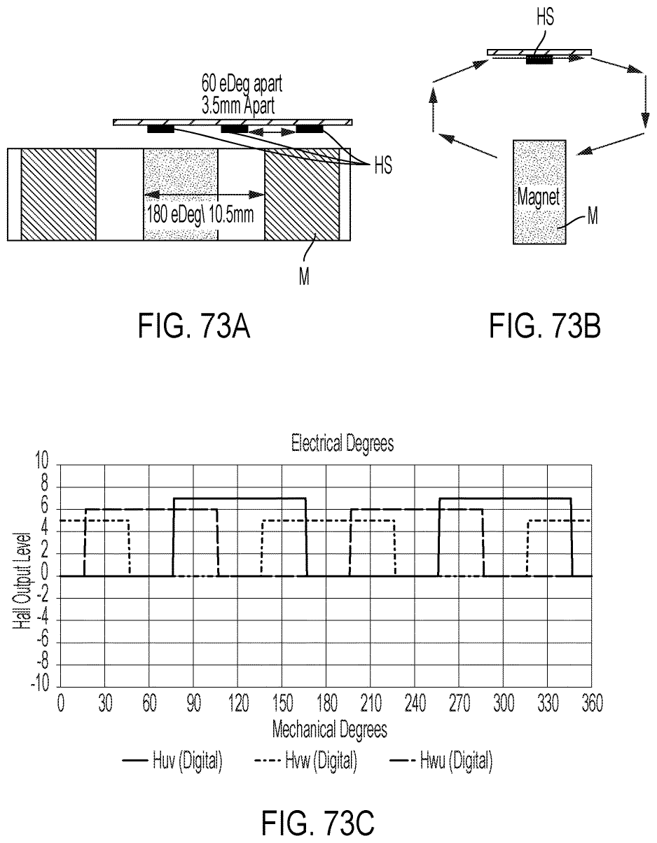

FIGS. 53-59 above show and describe the details about the Hall board HB with the Hall sensor and how the Hall board HB is mounted to the frame 44 of the linear motor 14. FIG. 73A-73B shows Hall sensing drive scheme in which three discrete sensors that are 60 electrical degrees apart may be used to detect the position of the plunger 22 with respect to the stator 18, 20. The sensors may be configured to detect stray fields from the magnets M of the plunger 22. The sensors may be on/off bipolar latching sensors. FIG. 73A shows three discrete Hall sensors HS that are disposed 60 electrical degrees apart and are configured to detect stray fields from the magnets M (e.g., electrical degree between two magnets having opposite polarity is shown as 180 eDeg) of the plunger 22. FIG. 73B also shows how stray fields from one of the magnets M of the plunger 22 may be detected by one of the three Hall sensors HS. The position of the magnets M of the plunger 22 within the 60 eDeg may be determined using levels of all three hall sensors HS. A sensing module/controller (with one or more processors) may be configured to receive and use the sensor signals from the three sensors to determine currents needed in the motor 14 for its operation.

FIG. 73C also shows a graphical representation of the hall sensing drive scheme in which hall output levels (measured in voltage on the graph, which is meant to represent state of magnetic field (positive or negative)) are shown on Y-axis, and mechanical angle (measured in degrees) and electrical angle (measured in eDeg or edegrees) are shown on X-axis. For example, assuming a motor phasing sequence in the clockwise (CW) direction looking into the torque/mounting end bell for phases U, V and W, the Halls then identified as Hu, Hv and Hw could further be described with motor phases as Hu (Huv), Hv (Hvw) and Hw (Hwu). The underlined letter is the identified motor phase reference when checked with an oscilloscope. In this case, Hall (Hu) identified as Huv could be verbally expressed as Hu is positive and in phase with the Bemf of motor phase U, and with respect to phase V as the plunger is rotated CW (where phase U leads phase V by 120 degrees). As noted above, the position of the magnets of the plunger within the 60 eDeg may be determined using these levels of all three hall sensors HS.

The spacing of the Hall sensor HS may be defined by magnet to magnet spacing, much like timing of commutations is linked to the magnet to magnet spacing. For example, for a magnet to magnet spacing of approximately 10.5 mm, the electrical degrees is 180 eDeg. The spacing of the Hall sensor HS is 60 electrical degrees, so the spacing of the Hall sensor HS may be calculated as follows: 10.5 mm*(60 eDeg/180 eDeg)=3.5 mm. That is, the spacing of the Hall sensor HS of approximately 3.5 mm, the spacing of the Hall sensor HS in electrical degrees is 60 eDeg.

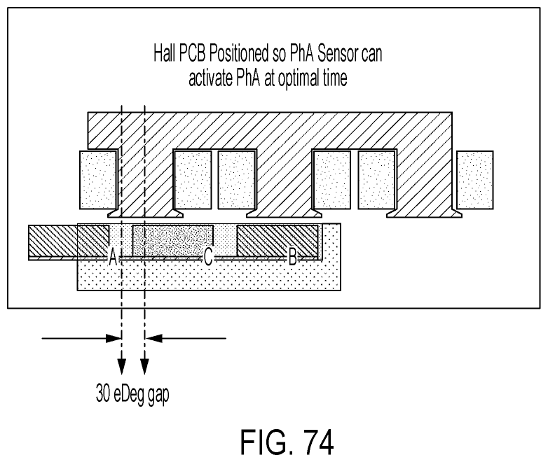

Referring to FIG. 74, the Hall board HB (e.g., printed circuit board (PCB)) and the Hall sensors HS may be fixed relative to the position of the stator coils & the stator teeth. For example, for 0 degrees of advance angle in trapezoidal voltage drive, the Hall sensors HS may be placed so the PhA Hall sensor may be positioned 30 eDeg earlier in the plunger travel from a center of the PhA coil. The Hall PCB may be positioned so that the PhA Hall sensor can activate the PhA coil at an optimal time. In another embodiment, as shown in FIGS. 53-59, the Hall board HB and the Hall sensors HS may be fixed relative to the frame 44 of the linear motor 14. The Hall sensors may not be directly tied to a specific phase. The Hall sensor may be used for timing of the phases.

Trapezoidal commutation (described in detail below) may be configured to direct current through three phases of the motor, based on the Hall sensor feedback, which senses the position of the plunger 22 relative to the stator 18, 20. All 3 phases of the motor may be active. The position of the plunger 22 may be determined by three Hall-effect sensors HS that are mounted on the stator 18, 20 or the frame 44 of the motor assembly 14. When the plunger 22 passes over or along the Hall sensors HS, the Hall sensors HS may be configured to produce either a high or a low signal to indicate which plunger pole (i.e., either N or S) is passing over. The change from high to low (or low to high) of the three Hall sensors HS provided the position information of the plunger 22 with respect to or relative to the stator 18, 20. The correct commutation sequence is determined from the combination of the signals from the Hall sensors HS. In one embodiment, nine Hall Sensors may be used.

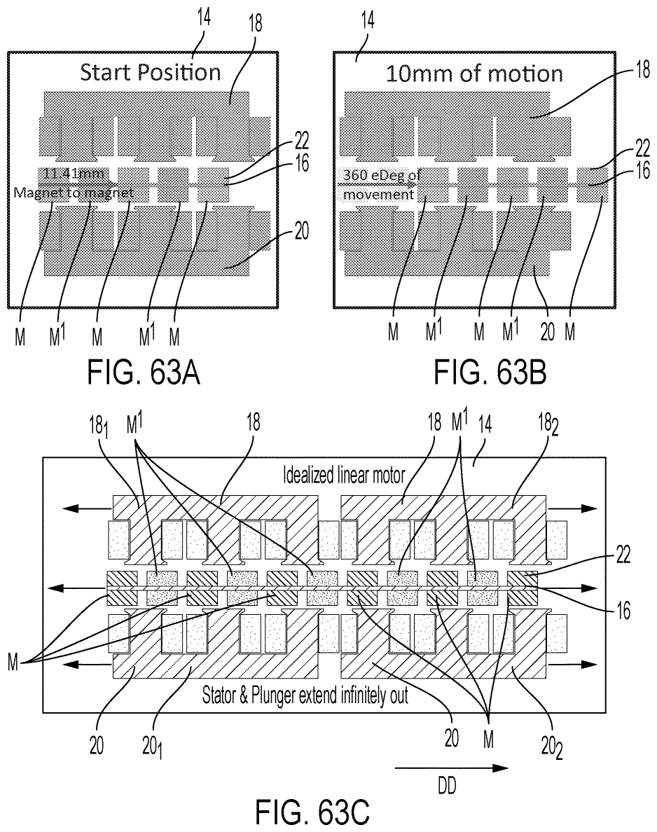

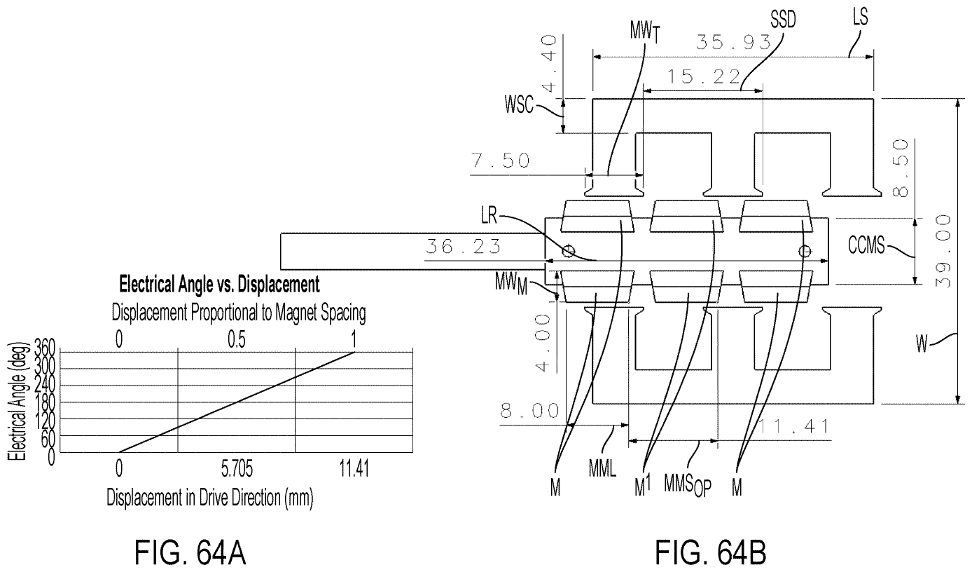

FIGS. 63A-64B show information about the geometry of the motor, relationship between electrical angle (used in motor drive calculations) and axial displacement, etc. FIG. 63C shows two stators side by side for driving the same plunger.

Referring to FIGS. 63A-63C, all inverter/commutation schemes of the linear motor 14 may use an electrical angle. The electrical degree may be the angle through which magnetic field has rotated/moved, i.e., 360 electrical degree equals transition from “North” to “South” to “North”. 360 electrical degrees (measured in, and referred to as eDeg) may equate to the spacing between magnets of like polarity. 180 eDeg may equate to the spacing between magnets of opposite polarity. For some given fixed current values at Phase A, Phase B, and Phase C coils/windings and in an ideal linear motor (i.e., a linear motor in which the stator and the plunger extend infinitely out as shown in FIG. 63C), the drive force produced at 0 eDeg may be the same as the drive force produced at 360 eDeg, and the drive force produced at 0 eDeg may be opposite to the drive force produced at 180 eDeg. 0 eDeg always may refer to position at which phase A Back EMF crosses zero on a falling edge, i.e., when north magnet is directly aligned with phase A coil. FIG. 63A shows a start position of the plunger 22 (and the driver 16 coupled to it) in the linear motor 14. The magnet M/M′ to magnet M/M′ spacing (i.e., spacing between magnets of like polarity (e.g., between M and M or between M′ and M′) is 11.41 millimeters (mm). All the magnets M in FIGS. 63A-63C have same polarities and all the magnets M′ in FIGS. 63A-63C have same polarities, and the magnets M and magnets M′ in FIGS. 63A-63C have opposite pluralities. Also, as shown in FIG. 63B, the 360 eDeg may equate to approximately 10 mm of travel of the plunger 22/driver 16 in the drive direction DD. The displacement/travel may refer to the displacement or travel of the driver 16 in the drive direction DD, measured in millimeters.

The linear motor 14 of the present disclosure may be used in an exemplary carpet stapler device. FIG. 64A also shows a graphical representation of the electrical angle vs displacement values for the exemplary carpet stapler using the linear motor 14. The electrical angle (in eDeg) is shown on the Y-axis and the displacement in drive direction (in mm) is shown in the X-axis in FIG. 64A. The displacement or travel of the driver 16 in the drive direction DD is proportional to the spacing between the magnets. For example, the magnet-magnet spacing may determine the relationship between driver displacement and change in electrical angle, so if the magnet to magnet spacing (between like polarities) is 1 unit of distance, the driver travels 360 eDeg for every 1 unit of travel. The spacing between opposite polarities is 11.41 mm, spacing between like polarities is 22.82 mm. For a spacing of approximately 11.41 mm between magnets (e.g., between M and M′) of opposite polarity, (a) the 180 eDeg electrical degrees of motion may equate to approximately 11.41 mm of displacement/travel; and (b) the 360 eDeg electrical degrees of motion may equate to approximately 22.82 mm of displacement/travel. FIG. 64B describes “11.41 mm=360 eDeg” as true relationship is eDeg to displacement as a proportion of magnet spacing. The values described here are exemplary.

FIG. 64B shows various dimensions of the linear motor 14 that is used in the exemplary carpet stapler. For example, the slot-to-slot distance SSD between an end of a stator teeth and the same end of an adjacent stator teeth is 15.22 mm. The maximum width MW_{T} of the stator teeth is 7.5 mm. The length LS of the stator 18, 20 is 35.93 mm. The magnet-to-magnet spacing MMS_{OP} between an end of a magnet M of the plunger 22 and the same end of the adjacent magnet M′ (having opposite polarity) of the plunger 22 is 11.41 mm. A width W of the envelope (i.e., the height by the width by the length) of the linear motor 14 is approximately 39 mm. The width MW_{M} of each magnet is 4 mm. The minimum length MML of each magnet is 8 mm. The center-to-center spacing CCMS between two magnets in the same plunger stack 22 is 8.50 mm. The width WSC of the stator core is 4.4 mm. The length LR of the plunger 22 is 36.23 mm. Dividing the slot-to-slot distance SSD between an end of a stator teeth and the same end of an adjacent stator teeth by magnet to magnet spacing MMS_{OP} between an end of a magnet M of the plunger 22 and the same end of the adjacent magnet M′ (having opposite polarity) of the plunger 22 (i.e., 15.22 mm/11.41 mm) equates to ¾ SPR. The values described here are exemplary.

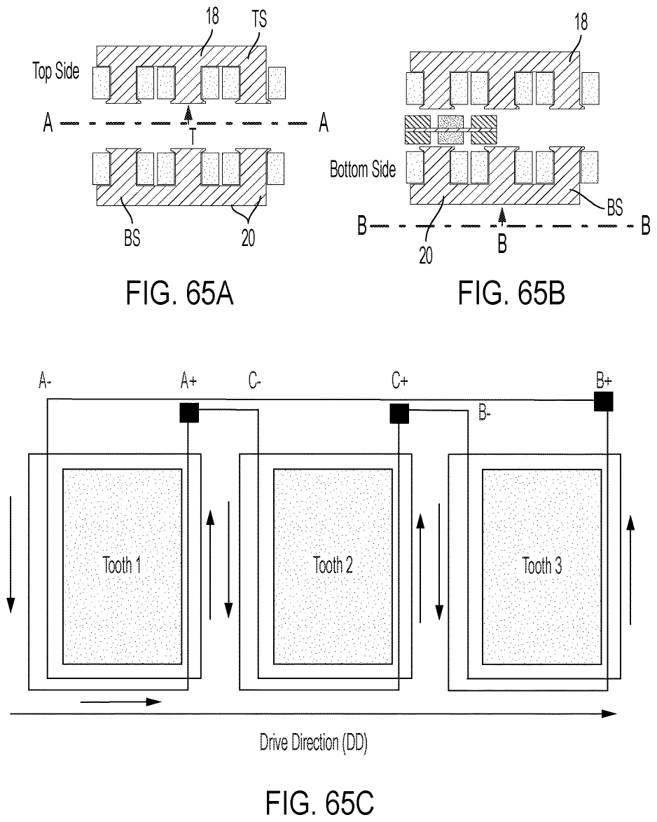

FIG. 65C shows a ¾ SPR winding for a single motor. The direction of wind direction in each of three stator tooth 1, 2 and 3 and the drive direction DD are shown in FIG. 65C. For example, FIG. 65C shows the direction of current in each of three stator tooth 1, 2 and 3 for the top stator TS/18 as seen from the arrow T on the cross-sectional line A-A as shown in FIG. 65A. FIG. 65C also shows the direction of current in each of three stator tooth 1, 2 and 3 for the bottom stator BS as seen from the arrow B on the cross-sectional line B-B as shown in FIG. 65B.

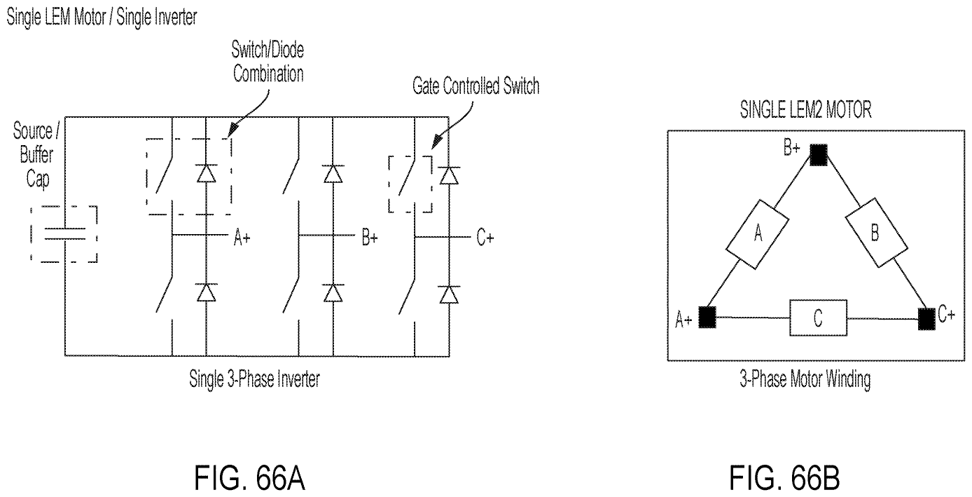

FIGS. 66A-66B show a single three phase inventor and a single linear electromagnetic motor. FIG. 66A shows the single three-phase inverter that connects to the single linear electromagnetic motor shown in FIG. 66B. The single three-phase inverter may include a source/buffer cap, a switch/diode combination, and a gate-controlled switch as shown in FIG. 66A. The timing of the inverter (i.e., when the inverter is on and when the inverter is off) may be controlled by an electrical angle of the plunger with respect to the stator. The single linear electromagnetic motor may include three-phase motor winding. In one embodiment, individual transistor (FET or other elements/components) may be used for each drive coil.

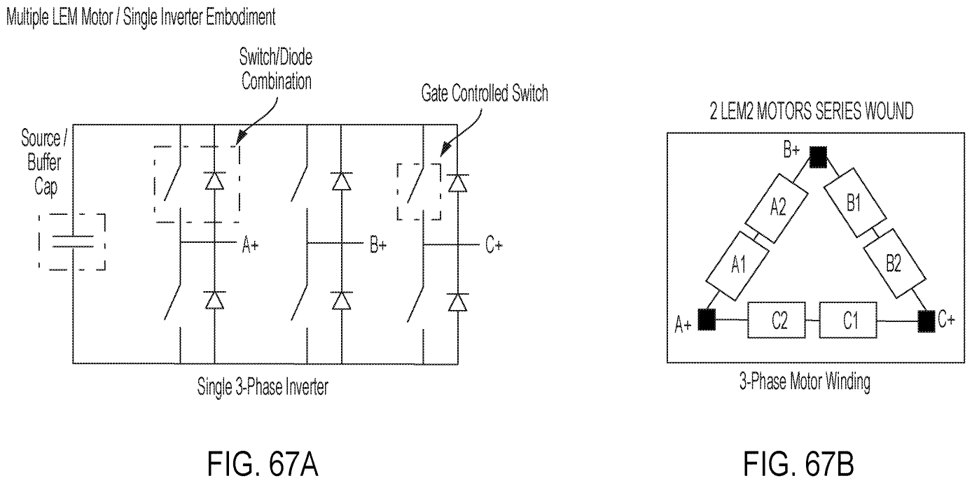

FIGS. 67A-69 show a drive system for driving the two stators. Some higher power applications may require two or more stators arranged in this manner.

FIGS. 67A and 67B show a single three phase inverter utilized for driving the two stators 18 and 20 described above, where the stator windings of stator 18 are coupled in series to corresponding stator windings of stator 20. FIG. 67A shows a single three-phase inverter that connects to the stators 18 and 20 shown in FIG. 67B. The single three-phase inverter may include a plurality of high-side and low-side gate-controlled switches interconnected as a multi-phase inverter circuit as shown in FIG. 67A. The stators in this embodiment include three-phase motor windings and are connected in series via a series of wires or connectors (not shown) that extend from one stator to the other alongside the frame. The inverter circuit may be controlled by a controller, which receive the Hall sensor data indicative of the linear position of the plunger along the drive axis, and controls commutation of the stators 18 and 20 by applying a gate drive control signal to the high-side and low-side power switches.

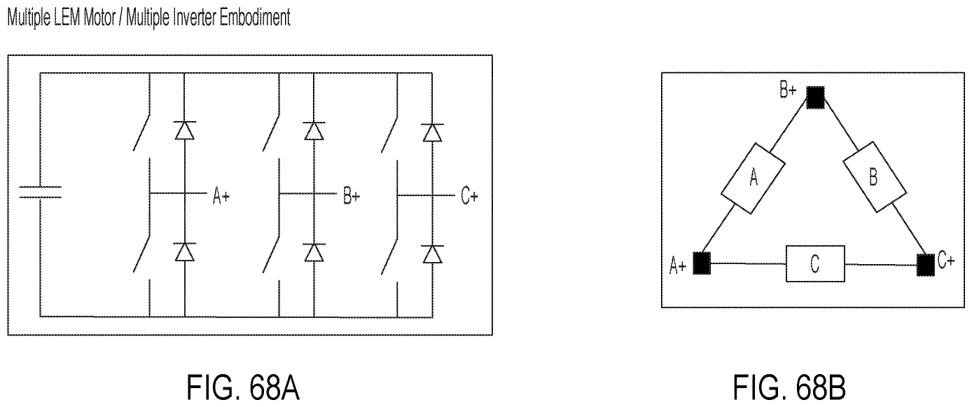

FIGS. 68A and 68B depicts an alternative embodiment, where the stator windings of the two stators 18 and 20 are not directly connected together (e.g., via wires or connectors extending along the frame). Rather, in this embodiment, the two stators 18 and 20 are individually and independently driven via separate inverter circuits. Each inverter circuit in this embodiment includes a plurality of high-side and low-side power switches configured as a multi-phase inverter circuit. In an embodiment, the inventors are controlled via a single controller or two different controllers. In an embodiment, the inverters may be controlled to drive the stator windings of the two stators fully synchronously, e.g., by applying the same set of drive signals to both inverters. Alternatively, the two inverters may be controlled to drive the stator windings of the two stators asynchronously. This may be the case, for example, where the magnets of the plunger facing stator 18 have different or out-of-synch polarities from the magnets facing stator 20, or where the two stators are axially offset with respect to the drive axis.

In an embodiment, the linearly aligned first stators 18₁ and 18₂ and the linearly aligned second stators 20₁ and 20₂ (FIGS. 33-52) may similarly be driven via a signal inverter, as shown in FIGS. 67A and 67B, or via two individual inverters, as shown in FIGS. 68A and 68B. Specifically, stator windings of first stators 18₁ and 18₂ may be connected in series and driven commonly via a single inverter, as shown in FIGS. 67A and 67B. Stator windings of second stators 20₁ and 20₂ may be similarly connected in series and driven commonly via a single inverter, as shown in FIGS. 67A and 67B. Alternatively, stator windings of first stators 18₁ and 18₂ may be respectively driven via two individual inverters, as shown in FIGS. 68A and 68B. Stator windings of second stators 20₁ and 20₂ may be similarly individually driven by two inverters.

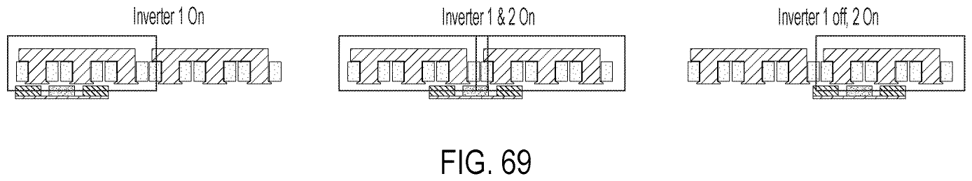

FIG. 69 shows timings (i.e., when the two inverters are on and when the two inverters are off) for a dual inverter configuration for driving two linearly aligned first stators 18₁ and 18₂ or two linearly aligned second stators 20₁ and 20₂. The timing of the individual inverter may be controlled by a controller (not shown) based on an electrical angle of the plunger (i.e., axial position of the plunger) with respect to the stator, as is the case with a single inverter configuration described above. For example, the first inverter of the dual inverter configuration may be activated as long as the plunger can efficiently be driven along of the first stator (until all magnets of the plunger have moved beyond the first stator). The second inverter of the dual inverter configuration may be activated when the plunger reaches a first predetermined axial position, e.g., when a first magnet of the plunger crosses by the first tooth of the second stator. The two inverters may cooperatively drive the plunger until the plunger reaches a second predetermined axial position, e.g., when the last magnet of the plunger crosses the first tooth of the second stator. At this point, the first inverter becomes deactivated. The second inverter may complete rest of the stroke when the first inverter/motor is deactivated. Although not shown in the figures, the inverter timings (i.e., when the inverter are on and when the inverter are off) for 3 or more inverters may follow the same sequence as the dual inverter timings.

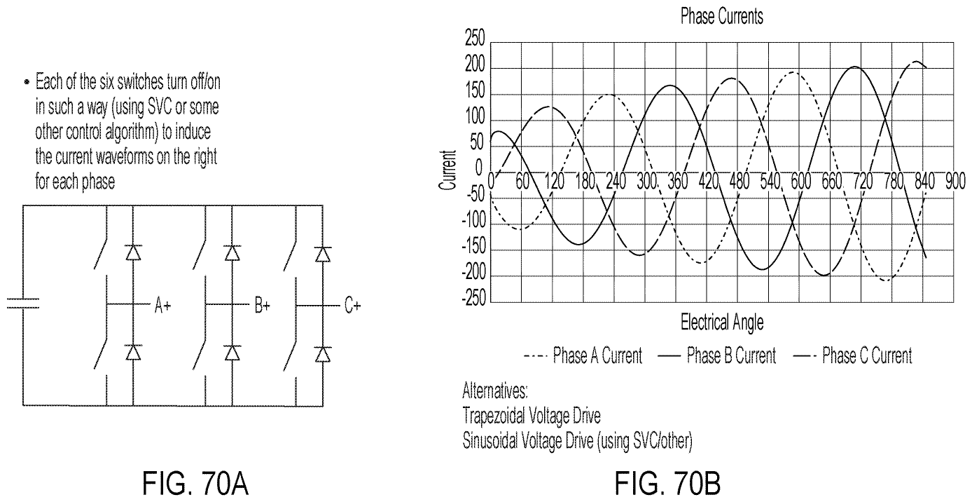

The motor assembly 14 may generally use either a sensored drive scheme (i.e., using induction sensors/sensing elements/features or the Hall board HB) or a sensorless drive scheme (i.e., trapezoidal or field-oriented control FOC). Some of these drive schemes for rotary brushless motors are shown and explained in detail in in U.S. Pat. Nos. 10,523,081; 11,171,586; and 11,469,697, which are commonly assigned to the same entity as the present disclosure and are herein incorporated by reference in their entirety. FIGS. 70A-74 disclose these drive schemes in relation to the linear motor of the present disclosure. FIGS. 53-59 show and describe the details about the sensor board/Hall board HB and how the sensor board is mounted to the frame 44 of the linear motor 14.

Commutation is used to direct current through the windings of a three-phase motor. Referring to FIG. 70A, each of the six switches are turned off/on in such a way, for example, using Space Vector Modulation (SVM) or some other control algorithm to induce the current waveforms for each phase currents (e.g., Phase A current, Phase B current, and Phase C current). For example, FIG. 70B shows a graphical representation of stator current vs electrical angle for different phase currents. The stator current (e.g., measured in amperes) is shown on Y-axis. The electrical angle (e.g., measured in eDegs) is shown on X-axis.

Vector control or FOC voltage drive is a variable-frequency drive (VFD) control method in which the stator currents of a three-phase AC or brushless DC electric motor are identified as two orthogonal components that can be visualized with a vector. One component of the vector may define the magnetic flux of the motor, the other component of the vector may define the torque or linear force. The control system of the drive may calculate the corresponding current component references from the magnetic flux and torque/linear force references given by the drive's speed control. Proportional-integral (PI) controllers may be generally used to keep the measured current components at their reference values. The pulse-width modulation of the variable-frequency drive may define the transistor switching according to the stator voltage references that are the output of the PI current controllers. This is a method in which the current vector (magnitude and direction) is determined relative to the plunger, rather than on the basis of sine waves, as is done in sinusoidal commutation.

The two other forms of commutation are Trapezoidal voltage drive and Sinusoidal voltage drive (using SVC/other). Trapezoidal (six-step or six-state) commutation is common in high-speed applications or when higher starting torque is required. Trapezoidal commutation may be configured to direct current through two phases of the motor, based on the Hall sensor feedback, which senses the position of the plunger relative to the stator. FIGS. 53-59 show and describe the details about the Hall board HB with the Hall sensor and how the Hall board HB is mounted to the frame 44 of the linear motor 14.

Trapezoidal commutation may also be performed based on the motor's back EMF, which allows the elimination of the Hall sensors HS. In a typical three-phase motor with trapezoidal current, one winding is positive, one winding is negative, and one is open. The open winding can be used to detect the zero-crossing point of the back EMF, which corresponds to what would be a signal change in a Hall sensor. However, the back EMF is proportional to motor speed. This means that at very slow speeds (and especially at startup), the back EMF will be very low, so the motor must be started in open-loop mode until sufficient speed and back EMF are generated. At that point, the controller may be switched to back EMF sensing for commutation.

The motor phases of the trapezoidal commutation include (1) Phase A is off, Phase B is positive, and Phase C is negative; (2) Phase A is negative, Phase B is positive, and Phase C is off; (3) Phase A is negative, Phase B is off, and Phase C is positive; (4) Phase A is off, Phase B is negative, and Phase C is positive; (5) Phase A is positive, Phase B is negative, and Phase C is off; and (6) Phase A is positive, Phase B is off, and Phase C is negative. There are more valid states, such as when conduction band is modified between 120 deg and 180 deg (see CBAA related information). State of phase dependent on inverter setting & phase winding configuration (Delta or wye).

Sinusoidal Voltage Drive (using SVM/other) or sinusoidal commutation directs voltage in the form of a sinewave through all three phases of the motor, which is sinusoidally synchronized by the drive. Each sinewave must be 120 electrical degrees from each other. Sinusoidal commutation may be achieved by utilizing an encoder feedback loop (algorithm) to maintain a 90-degree torque angle curve. Trapezoidal commutation with the hall sensors HS may be used at motor startup, and then may be switched to sinusoidal commutation, using the encoder after the first Hall state change. This process/procedure may avoid errors or inaccuracies from the drive's commutation algorithm and may take advantage of sinusoidal commutation from the encoder(s) once in motion.

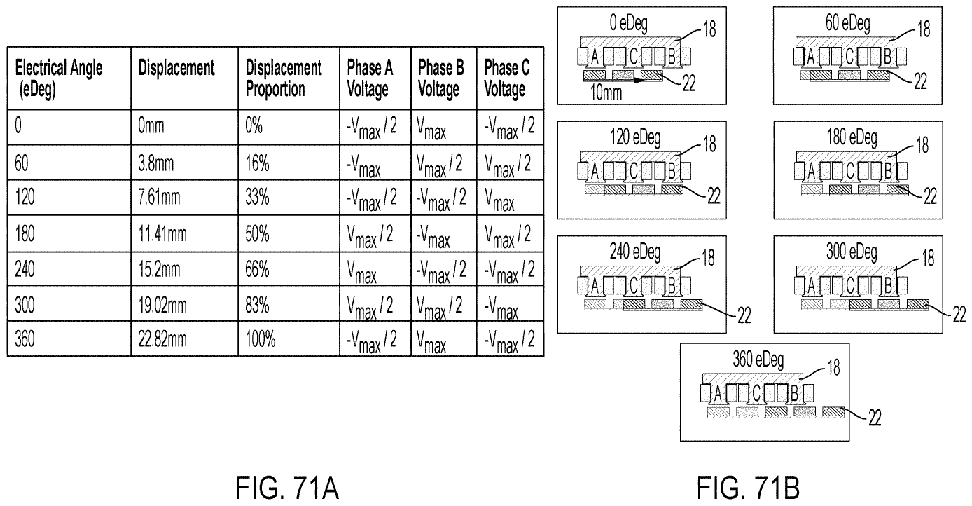

FIG. 71B shows the stator 18, 20 having three teeth and their corresponding windings A, C and B (in that order) and the plunger 22 (with a magnet to magnet spacing between like polarity magnets of approximately 10 mm). FIG. 71B also show the progression/displacement of the plunger 22 (and the driver 16 coupled to the plunger 22) through the stator 18, 20 and through the various electrical angles (i.e., 0 eDeg, 60 eDeg, 120 eDeg, 180 eDeg, 240 eDeg, and 360 eDeg).

The phase voltages at each of the three teeth and their corresponding windings of the stator at each electrical angle, the displacement/travel of the plunger at each electrical angle, and the displacement proportion at each electrical angle are shown in the table in FIG. 71A. As can be seen in the table in FIG. 71A, (1) when the electrical angle is approximately 0 eDeg and the displacement/travel of the plunger 22 is approximately 0 mm, both phase A voltage and phase C voltage are at-Vmax/2 and phase B voltage is at Vₘₐₓ; (2) when the electrical angle is approximately 60 eDeg and the displacement/travel of the plunger 22 is approximately 3.8 mm, both phase B voltage and phase C voltage are at Vₘₐₓ/2 and phase A voltage is at −Vₘₐₓ; (3) when the electrical angle is approximately 120 eDeg and the displacement/travel of the plunger 22 is approximately 7.61 mm, both phase A voltage and phase B voltage are at −Vₘₐₓ/2 and phase C voltage is at Vₘₐₓ; (4) when the electrical angle is approximately 180 eDeg and the displacement/travel of the plunger 22 is approximately 11.41 mm, both phase A voltage and phase C voltage are at Vₘₐₓ/2 and phase A voltage is at −Vₘₐₓ; (5) when the electrical angle is approximately 240 eDeg and the displacement/travel of the plunger 22 is approximately 15.2 mm, both phase B voltage and phase C voltage are at −Vₘₐₓ/2 and phase A voltage is at Vₘₐₓ; (6) when the electrical angle is approximately 300 eDeg and the displacement/travel of the plunger 22 is approximately 19.02 mm, both phase A voltage and phase B voltage are at Vₘₐₓ/2 and phase C voltage is at −Vₘₐₓ; and (7) when the electrical angle is approximately 360 eDeg and the displacement/travel of the plunger 22 is approximately 22.82 mm, both phase A voltage and phase C voltage are at −Vₘₐₓ/2 and phase B voltage is at Vₘₐₓ.

Also, the displacement proportion is 0% when the displacement is at approximately 0 mm and when the electrical angle is 0 eDeg and the displacement proportion is 100% when the displacement is approximately 11.41 mm and when the electrical angle is 180 eDeg. The values noted here are exemplary. The rest of the displacement proportions at various electrical angles and at various corresponding displacement are also shown in the table in FIG. 71A.

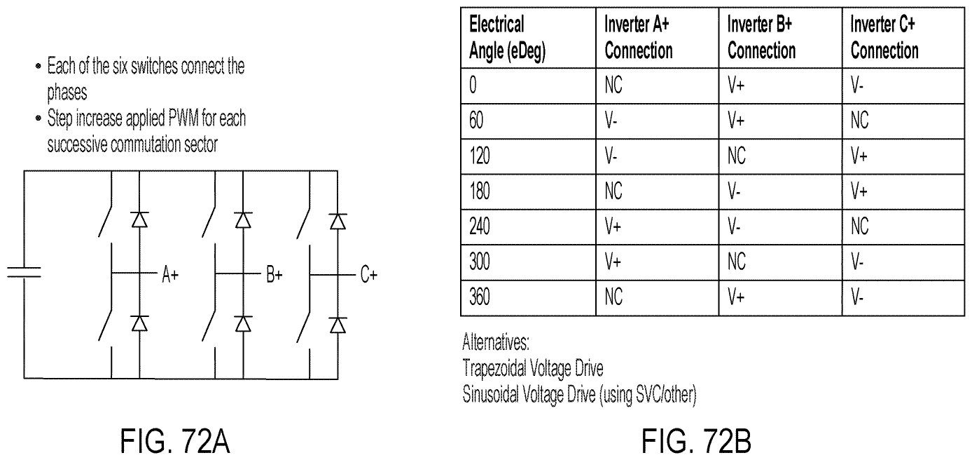

FIG. 72A shows a single three-phase inverter and FIG. 72B shows a table showing voltages at the inverter connections A+, B+ and C+ of the inverter at various electrical angles. Each of the six switches of the inverter connect the phases and step increase is applied pulse width modulation (PWM) for each successive commutation sector. As can be seen in the table in FIG. 72B, (1) when the electrical angle is approximately 0 eDeg, the inverter connection A+ is not connected, the inverter connection B+ is at +V, and the inverter connection C+ is at −V; (2) when the electrical angle is approximately 60 eDeg, the inverter connection A+ is −V, the inverter connection B+ is at +V, and the inverter connection C+ is at not connected; (3) when the electrical angle is approximately 120 eDeg, the inverter connection A+ is −V, the inverter connection B+ is not connected, and the inverter connection C+ is at +V; (4) when the electrical angle is approximately 180 eDeg, the inverter connection A+ is not connected, the inverter connection B+ is at −V, and the inverter connection C+ is at +V; (5) when the electrical angle is approximately 240 eDeg, the inverter connection A+ is +V, the inverter connection B+ is at −V, and the inverter connection C+ is not connected; (6) when the electrical angle is approximately 300 eDeg, the inverter connection A+ is +V, the inverter connection B+ is not connected, and the inverter connection C+ is at −V; and (7) when the electrical angle is approximately 360 eDeg, the inverter connection A+ is not connected, the inverter connection B+ is at +V, and the inverter connection C+ is at −V.

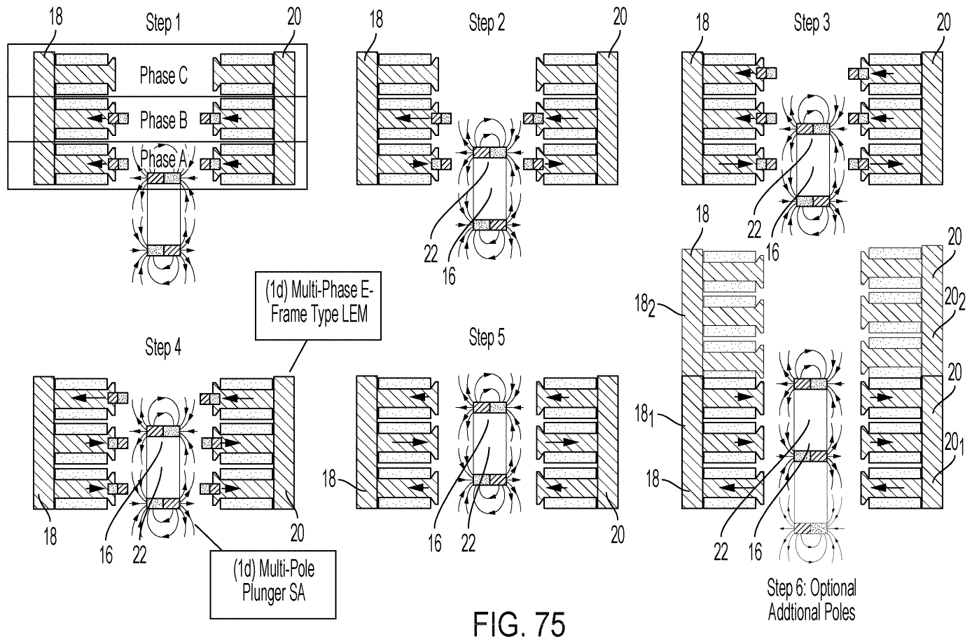

FIG. 75 show various steps in a trapezoidal voltage drive. The steps in FIG. 75 may interchangeably be referred to as procedures. Six steps are shown in FIG. 75 and step 6 is an optional step with additional poles. In FIG. 75, the stator 18, 20 is a multi-phase E-frame type linear electromagnetic motor and the plunger 22 and the driver 16 is a multi-pole plunger SA.

Arrows are shown in each step to present the value and the direction of current at each of the phase A, the phase B, and the phase C. When the values of the current at one or more of the phase A, the phase B, and the phase C are the same, the sizes of the arrows for those one or more of the phase A, the phase B, and the phase C are maintained the same. For example, see phases A and B in step 1, phases B and C in step 3, phases A and B in step 4, phases A and C in step 5, and phases B and C in step 6. When the values of the current at one or more of the phase A, the phase B, and the phase C are different, the sizes of the arrows for those one or more of the phase A, the phase B, and the phase C are changed. For example, see phases A and B in step 2, phase A compared to phases B and C in step 3, phase C compared to phases A and B in step 4, phase B compared to phases A and C in step 5, and phase A compared to phases B and C in step 6.

Similarly, when the directions of the current at one or more of the phase A, the phase B, and the phase C are the same, the directions of the arrows for those one or more of the phase A, the phase B, and the phase C are maintained the same. For example, see phases A and B in step 1, phases B and C in step 3, phases A and B in step 4, phases A and C in step 5, and phases B and C in step 6. When the directions of the current at one or more of the phase A, the phase B, and the phase C are different, the directions of the arrows for those one or more of the phase A, the phase B, and the phase C are changed. For example, see phases A and B in step 2, phase A compared to phases B and C in step 3, phase C compared to phases A and B in step 4, phase B compared to phases A and C in step 5, and phase A compared to phases B and C in step 6.

As shown in FIG. 75, there are no arrows shown at one of the phase A, the phase B, and the phase C, which means that one of the phase A, the phase B, and the phase C is not energized or activated. For example, see phase C in steps 1 and 2.

At the step 1, the direction and the magnitude of the current at phase A and the phase B are equal so as to attract a first pole of the plunger 22/driver 16. The current at phase A and the phase B also has smaller current values. The phase C is not energized/activated.

At the step 2, the current at phase A is reversed in polarity to repel the first pole of the driver 16/plunger 22, and the current at phase B is increased (compared to that in step 1 but with the same polarity as step 1) to maximally attract the first pole of the plunger 22/driver 16.

At the step 3, the current at phase A is increased (compared to that in step 2 but with the same polarity as step 2) to maximally repel first pole and to attract second pole of the plunger 22/driver 16, the current at phase B is decreased (compared to that in step 2 but with the same polarity as step 2) to prepare to switch polarity, and the current at the phase C begins to attract first pole of driver.

At the step 4, the current at phase A is decreased (compared to that in step 3 but with the same polarity as step 3) to prepare to switch polarity, the current at phase B switches polarity to repel first pole and to attract second pole of the plunger 22/driver 16, the current at phase C is increased (compared to that in step 3 but with the same polarity as step 3) to maximally attract first pole of the plunger 22/driver 16.

The step 5 is same as the step 3, but advanced by one phase. That is, whatever happened to the phase A, the phase B, and the phase C in step 3 now happens to the phase B, the phase C, the phase A, respectively, in step 5.

The step 6 is same as the step 4 but advanced by one phase. Model can be extended to ‘m’ number of phase groups and ‘n’ number of pole pairs. FIG. 75 demonstrates an exemplary commutation scheme but, in other embodiment, the commutation scheme may deviate from this exemplary commutation scheme. That is, the direction & magnitude of the currents may be close to but different from this exemplary commutation scheme.

Thus, the plunger 22/driver 16 returns to the retracted condition of the driver 16.

Although not shown in FIG. 75, additional steps 7-12 may repeat the steps 1-6, but with currents in the opposite direction, to move the plunger 22/driver 16 from the retracted condition to the extended condition. Although not shown in FIG. 75, provisions for using less energy/currents on the return steps (than on the drive stroke) may be included. The lower return energy can be achieved by either shortening how long the currents are applied to the phases, or by lowering the currents in the phases by lowering the voltage duty cycle, or by some other control scheme.

If lower drive energy is required/requested from the user feedback, the amount of current in the stator may be reduced. The velocity of the driver may be sensed by the sense system. This allows to detect whether the plunger need to be accelerated/add higher currents to complete the application or if the current can hold off for a lower-energy application, where the plunger would decelerate less once the plunger contacted the workpiece. Detection of energy of application can be interpreted using the position feedback from the sense system (i.e., the amount of deceleration when staple/nail hits the workpiece) and/or using the controller relationship between duty cycle & phase currents.

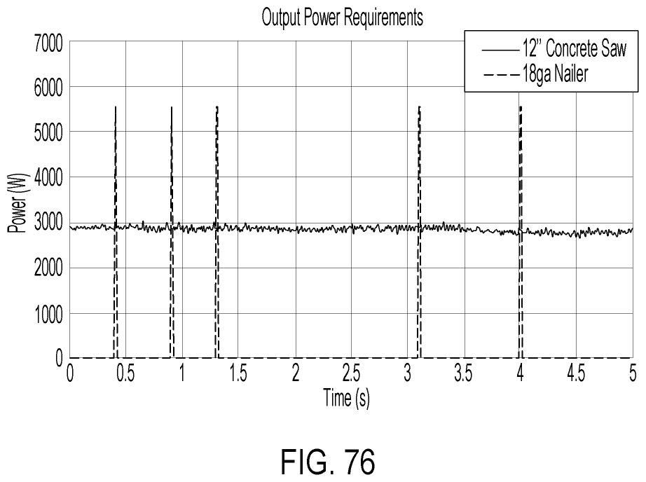

FIGS. 76 and 77 describe and show some electro-mechanical features of the linear electromagnetic motor (LEM) 14 for use in fastening tools such as nailers, staple guns, etc.

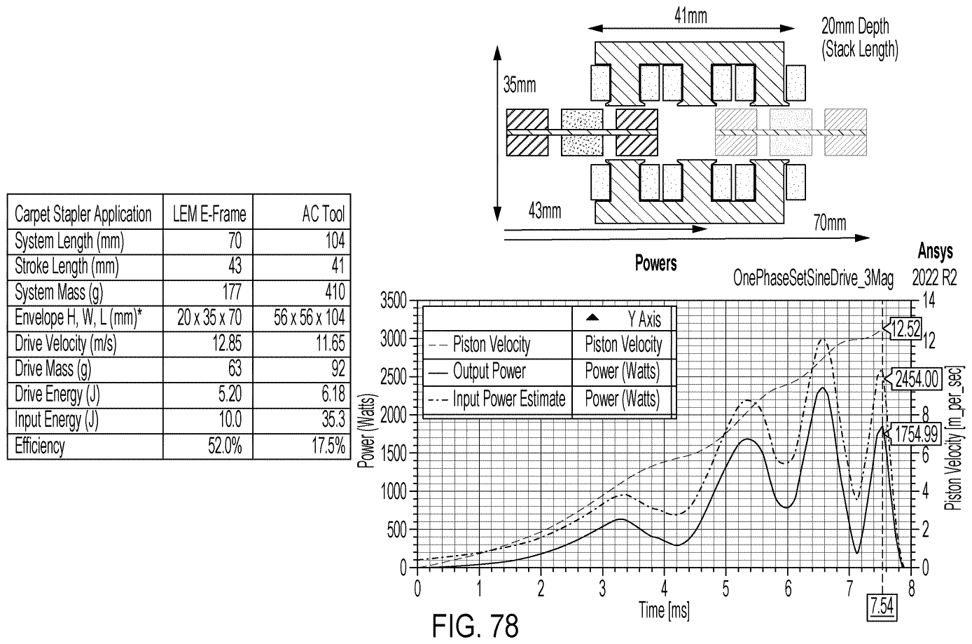

A carpet stapler tool/device may include the linear electromagnetic motor 14 described in the present disclosure. Referring to FIG. 78, in this exemplary embodiment, the length of the linear electromagnetic motor system in the carpet stapler device may be approximately 70 mm, the stroke length of the linear electromagnetic motor system may be approximately 43 mm, the mass of the linear electromagnetic motor system may be approximately 177 gms, and the envelope of the linear electromagnetic motor system (i.e., the height by the width by the length) is approximately 20 mm×approximately 35 mm×approximately 70 mm. The envelope does not include the driver guide. The height of the envelope may interchangeably be referred to as stator stack depth. The length of one stator stack (e.g., measured along the length of the envelope) may be approximately 41 mm. Higher efficiencies may be attained with increased stack length. The drive velocity may be approximately 12.85 meters/second (m/s). The driver mass may be approximately 63 gms. The driver energy is approximately 5.2 Joules (J). The input energy is approximately 10 J. The efficiency is approximately 52%. FIG. 78 shows a table with a side-by-side comparison of various parameters (discussed in detail above) of the linear electromagnetic E-frame system of the present disclosure and various parameters of a one stage AC solenoid. The values described here are exemplary.

The fastener device 10 may include the magazine assembly 15, which may be coupled to the housing 12. The magazine assembly 15 may be interchangeably referred to as magazine. The magazine assembly 15 may be coupled to the nose assembly 19 and disposed within the housing 12. The magazine assembly 15 is configured to carry a supply of fasteners through a feed channel along a feed channel direction toward the nose assembly 19. The feeder is configured to feed the fastener through the magazine assembly 15 and into the drive channel of the nose assembly 19 prior to driving the fastener into the workpiece.

The magazine assembly 15 is an elongated receptacle that extends away from the nose assembly 19, towards a back end of the handle 17. In one embodiment, the magazine assembly 15 may be provided such that it extends between the nosepiece 19 and a base portion of the fastener device 10 (e.g., near a battery receptacle 13 as shown in FIG. 1). In one embodiment, the magazine assembly 15 may be positioned an acute angle relative to the handle 17 and extending between the nose assembly 19 and a bottom portion of the handle 17, such that a bottom portion of the magazine assembly 15 may be positioned at an acute angle relative to a workpiece when the nose assembly 19 is positioned and is configured for applying the fastener thereto.

The magazine assembly 15 is configured to hold a plurality of fasteners or nails and sequentially feed the fasteners into the nosepiece 19. These fasteners or nails are then configured to be dispensed from the fastener device 10 with sufficient energy to penetrate a workpiece. The magazine assembly 15 may be configured to hold collated nails. The magazine assembly 15 may include a canister that is configured to hold coiled, collated nails/fasteners. The canister arrangement is shown and described in detail in U.S. Ser. No. 18/465,295, which is commonly assigned to the same entity as the present disclosure and is incorporated herein by reference in their entirety. The magazine assembly 15 (via its parts therein) is generally configured to sequentially feed/present a lead fastener of the plurality of fasteners into a drive channel of the fastener device 10. The magazine assembly 15 may include the feeder or feed mechanism, which will be described in detail below. The magazine assembly 15 may be opened to load collated fasteners into the magazine assembly 15 as described in detail in the incorporated '521 Patent. The further details of the magazine assembly 15 are provided in the incorporated '521 Patent and the incorporated '323 Patent.

The feeder, feed mechanism or feed assembly may include a feed pawl assembly (not shown) and a follower pawl assembly (not shown). The feed assembly is associated with the magazine assembly 15 and is configured to advance the fasteners contained therein in a feed direction (i.e., towards the drive channel, the nose assembly 19 and the driver 16) to present a lead fastener into the nose assembly 19. The feed assembly may include a feed actuator that is configured to move the lead fastener into the nose assembly 19. A coil or a set of the collated fasteners may be inserted into the canister and an end of the collated fasteners with a lead fastener may be strung towards the drive channel such that one of the collated fasteners is positioned in the feed assembly for feeding (e.g., using teeth and/or a pawl assembly, and the feed actuator).

In one embodiment, the feed assembly may include a biasing spring and a feed rod configured to move the lead fastener (from the set of collated fasteners contained in the canister) into the nosepiece assembly 19. The biasing spring may bias the feed rod into a first position, and the feed actuator may be configured to move (i.e., reciprocate) the feed rod to a second position, against a biasing force of the biasing spring, for moving the lead fastener into the nose assembly 19. In one embodiment, features of the feed assembly may include those of the incorporated '521 Patent. The feed actuator may be an electro-mechanical actuator such as a linear actuator. The feed actuator may be an electrical actuator. The feed actuator may be in the form of a solenoid, in accordance with an embodiment. The features of the feed actuator and the feeder/feed assembly may include those of the incorporated '323 Patent or the incorporated '521 Patent. For example, the feed assembly and feed actuator may be an automatic coil feeder assembly.

In one embodiment, the feeder may include a solenoid/feed actuator. The controller C activates the solenoid. The actual motion of feeding the nails/fastener may be caused by a spring. The spring moves forward and advances the nails/fasteners (e.g., after the solenoid is deenergized). That is, the controller C activates/energizes the solenoid, the spring is then pulled down and then the solenoid is deenergized. This pushes the nail/fastener forward. So, it is the combination of the spring and the solenoid that advance the nails/fasteners. When the solenoid is deenergized, the movement (e.g., forward and advancement) of the nails/fasteners start. The time at which the solenoid is energized may be referred to as the feed cycle start time (i.e., for both sequential and bump activation modes). While the exemplary illustrated embodiments are described as using solenoids (for the feed actuator) as the electro-mechanical actuators, other forms of actuators may be used, for example, an electric motor, a single dual-action solenoid, a multi-stage solenoid, a solenoid, a linear motor of the present disclosure in conjunction with a mechanical biasing element, such as a spring, a linear motion machine, or any combination thereof.

The trigger 191 may be adjacent to or on the handle 17 and may be connected to a controller C (also interchangeably referred to as a control unit or a power control module). The trigger 191 may be provided in the form of a button for manual operation such that when an operator/a user grips the handle 17, the trigger 191 may be engaged by a forefinger of the operator/user. The trigger 191 is mechanically coupled to the handle 17 and is electrically coupled to at least the motor assembly 14 and the controller C such that electric power may be selectively provided thereto. The trigger 191 may be a push button that moves back and forth, or a button that may be pivotally mounted to the housing 12 by way of a pivot, such that application of force via the operator's forefinger moves the trigger 191 relative to the handle 17. The trigger 191 may be associated with a trigger switch/sensor. The trigger 191 may also be associated with the controller C.

The contact trip assembly may include a contact trip (or contact trip member) actuatable to initiate the drive stroke. The contact trip may be positioned in front of the driver 16 in the housing 12 of the fastener device 10. The contact trip is configured for movement relative to the housing 12 parallel to the movement of the driver 16. Also, provided are a contact trip spring and a contact trip switch. The contact trip switch is configured such that the contact trip switch may be tripped or actuated (e.g., closed) to allow use of the fastener device 10 (when all conditions are met for driving or firing), and may also be electrically coupled to the controller C. The contact trip switch may be provided in a normally open position and closed when the contact trip spring is compressed by force upon the contact trip itself, for example. In one embodiment, as an operator applies force or bias on the fastener device 10, i.e., towards a workpiece, a contact surface of the contact trip assembly engages the workpiece and then actuates movement of the body of the contact trip relative to the drive channel, thereby closing the contact trip switch and spring-loading or compressing the contact trip spring that normally biases the contact trip assembly relatively forward such that the fastener device 10 is disabled from firing.

When the trigger 191 is actuated by the operator's forefinger (e.g., the trigger switch is closed) and all other conditions for firing are met, the drive system and thus the motor assembly 14 may be initiated i.e., activated or energized, to fire a fastener. Such features are known in the art and thus not further described here. That is, the trigger switch is configured to generate a trigger signal that may be employed in whole or in part to initiate the cycling of the fastener device 10 to install a fastener to a workpiece.

The contact trip assembly is configured to slide rearwardly in response to contact with a workpiece and may interact with either the trigger 191 or a contact trip sensor/switch. When the contact trip assembly interacts with the trigger 191, the contact trip assembly cooperates with the trigger 191 to permit the trigger 191 to actuate the trigger switch to generate the trigger signal. More specifically, the trigger 191 may include a primary trigger, which is actuated by a finger of the user, and a secondary trigger, which is actuated by sufficient rearward movement of the contact trip assembly. Actuation of either one of the primary and secondary triggers will not, in and of itself, cause the trigger switch 19 to generate the trigger signal. Rather, both the primary and the secondary trigger must be placed in an actuated condition to cause the trigger 191 to generate the trigger signal. When the contact trip assembly interacts with the contact trip sensor/switch, rearward movement of the contact trip assembly by a sufficient amount causes the contact trip sensor/switch to generate a contact trip signal, which may be employed in conjunction with the trigger signal to initiate the cycling of the fastener device 10 to install a fastener to a workpiece.

The controller C and circuitry may be provided in the housing 12. The controller C may include one or more processors P. The controller C may be provided in the form of a microprocessor and one or more circuit boards, for example, including relay module and one or more MOSFETs. The controller C may be configured to receive input from the trigger 191, which affects movement of the driver 16 and feed rod to load fasteners in the nose assembly 19 of the fastener device 10. The controller or control circuit C may include a microcontroller that is electrically connected to receive input signals from a plurality of switches/sensors, including the trigger switch, a contact trip switch, a mode selector switch and/or a fastener size selector switch. The trigger switch may be an ON/OFF switch that controls the application of power from the battery pack to the controller C, which in turn controls the application of power to the motor assembly 14. The controller C may also be configured to communicate with the motor assembly 14. The controller C may be programmed to provide power and/or control signals (e.g., electric pulses) over control lines to the motor assembly 14 and the feed actuator. The controller C may be configured to operate both the driver and feeder, to control the start timing of the driver and feeder, etc. Upon receiving a signal from the trigger switch and an operation restricting mechanism (e.g., contact trip assembly) and its switch, the controller C may be connected to the battery to receive power therefrom and the motor assembly 14 may be activated. The controller C may signal the motor assembly 14 to energize or activate for a predetermined amount of time (e.g., by applying voltage to the motor assembly 14) before activating the stators. As is understood by a person of ordinary skill in the art, the controller C is configured for outputting a driving control signal to the drive system and for outputting a motor signal to control an operation of the motor assembly 14 via selectively energizing coils (of the stator) of a plurality of phases of the motor assembly 14. In one embodiment, the controller C may include the control unit and/or features of the unit as disclosed in U.S. Pat. No. 10,693,344, which is commonly assigned to the same entity as the present disclosure and is incorporated herein by reference in its entirety. The controller using sensors, current, other data to adjust speed, force, etc. may be common of the brushless tools as described in detail in commonly owned U.S. Pat. No. 11,418,089, which is commonly assigned to the same entity as the present disclosure and is hereby incorporated in its entirety.

The fastener device 10 may have multiple modes of operation. For example, one mode of operation of the fastener device 10 may be a sequential fire mode (or sequential operational mode) in which the contact trip assembly is first be abutted against a workpiece (so that the contact trip sensor/switch generates the contact trip sensor signal and thereafter the trigger switch is actuated to generate the trigger signal). Another mode of operation of the fastener device 10 may be a mandatory bump feed mode (or bump operational mode) in which the trigger switch is first actuated to generate the trigger signal and thereafter the contact trip assembly is abutted against a workpiece so that the contact trip sensor/switch generates the contact trip sensor signal. Yet another mode of operation may be a combination mode that permits either sequential fire or bump feed wherein no particular sequence is required (i.e., the trigger sensor signal and the contact trip sensor signal may be made in either order or simultaneously).

The fastener device 10 may also include a mode selector switch. The mode selector switch may be a switch that produces a mode selector switch signal that is indicative of a desired mode of operation of the fastener device 10. The signals generated by the contact trip sensor/switch, the mode selector switch, and the trigger switch are received and processed by the controller C. As is generally known, one or more, or all, of the switches mentioned herein may be microswitches. The controller C may be configured such that the fastener device 10 will be operated in a given mode, such as the bump feed mode, only in response to the receipt of a specific signal from the mode selector switch. For example, the placement of the mode selector switch in a first position causes a signal of a predetermined first voltage to be applied to the controller C, while the placement of the mode selector switch in a second position causes a signal of a predetermined second voltage to be applied to the controller C. Limits may be placed on the voltage of one or both of the first and second voltages, such as ± a value or a percentage of voltage, so that if the voltage of one or both of the signals is outside the limits the controller C may default to a given feed mode (e.g., to the sequential feed mode) or operational condition (e.g., inoperative).

Other features may be provided on the fastener device 10. For example, a stall release lever may be provided on an outside of the housing 12 to address a stall condition or problem with regards to firing the fastener device 10, e.g., a jam. The stall release lever includes a lever arm, a spool, and a flange. The spool and the flange rotate with the lever arm. The stall release lever may be activated by a user/operator in an instance when a drive cycle is not completed. For example, when attempting to drive a nail into a hard material and insufficient power is available to fully sink the nail, the fastener device 10 may stall or jam. Other cases for an incomplete drive cycle may include operational anomalies such as improper nail loading, non-conforming nails being used, or worn or broken components in the tool. In operation, when a stall or jam occurs, the operator may rotate the lever arm in a counterclockwise direction to release the load on the activation system, thereby moving the roller assembly (as described in detail in the incorporated '323 Patent) away from the driver 16. Thus, the components in the fastener device 10 are able to return to their respective home positions.

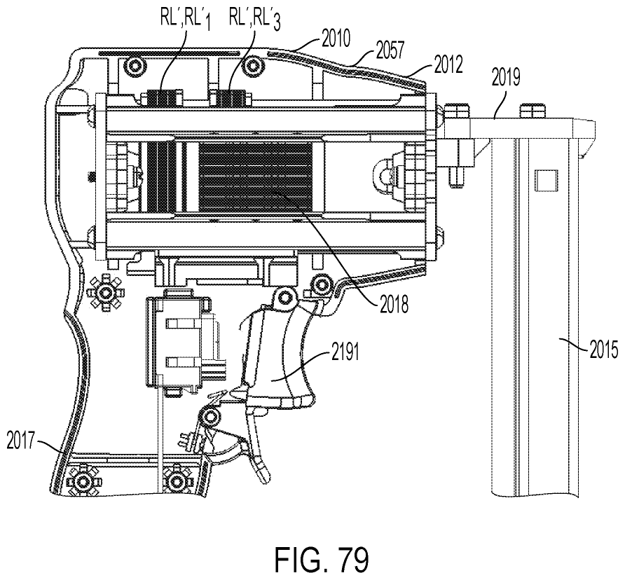

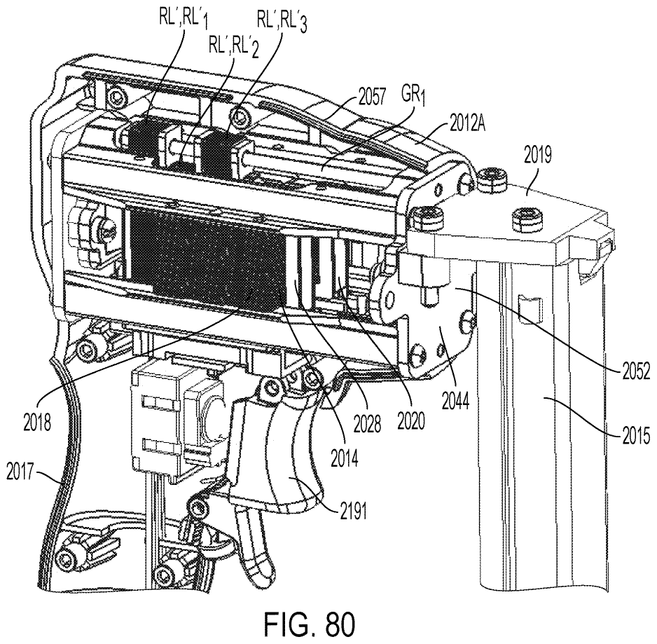

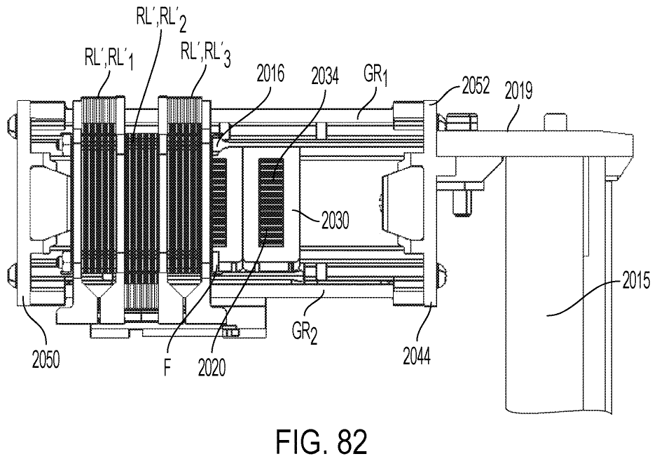

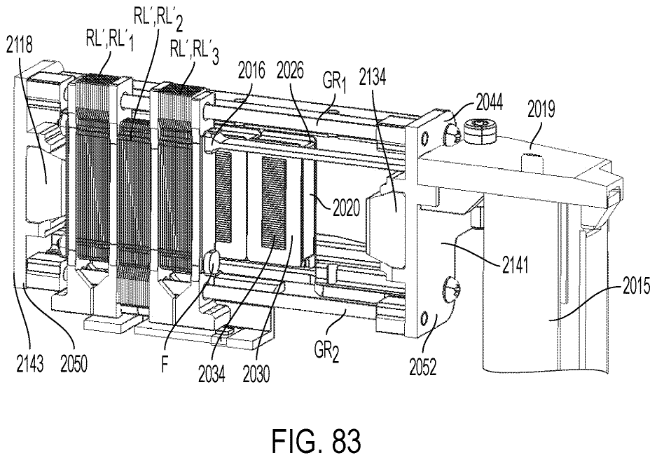

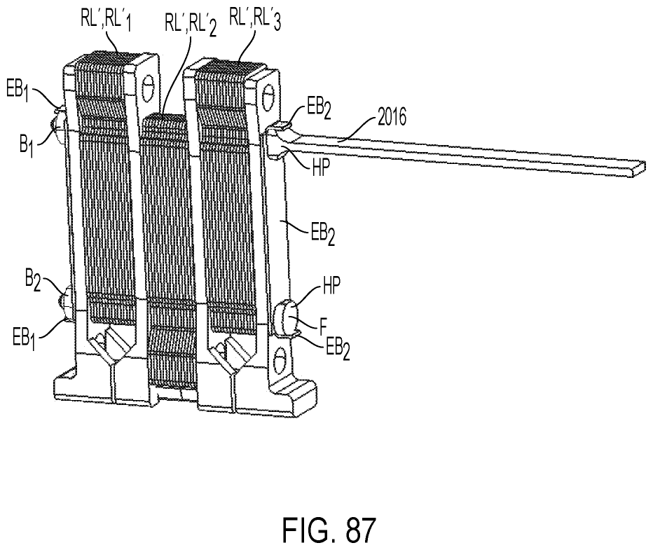

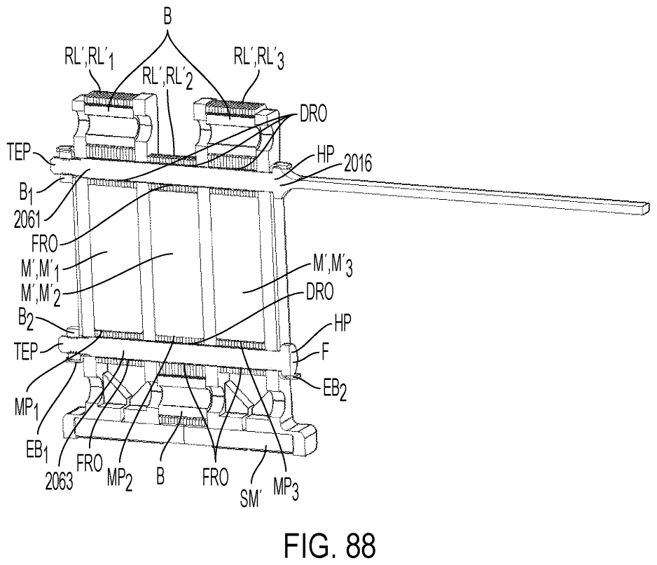

The present disclosure provides an embodiment of the linear motor assembly in which a plunger includes an offset driver. That is, the driver may be positioned/disposed in an offset configuration with respect to the plunger as shown in and will be described below in detail with respect to FIGS. 79-90.

Referring to FIGS. 79-90, a fastener device 2010 that drives one or more fasteners into a workpiece is provided. The fastener device 2010 comprises a tool housing 2012, a motor assembly 2014 within the tool housing 2012, and a driver 2016 within the tool housing 2012.

The components (e.g., the housing/tool housing 2012, trigger 2191, handle 2017, magazine 2015, first side part (not shown in FIGS. 79-90) and second side part 2012B of the housing 2012, nose assembly 2019, battery receptacle (not shown in FIGS. 79-90)) of the fastener device 2010 have the same operation and configuration as those described in the previous embodiments of the present disclosure and, therefore, these components will not be described in detail again here.

The motor assembly 2014 comprises a stator 2018, 2020 supporting a plurality of stator windings 2028, 2030, and a plunger 2022 including at least one permanent magnet M′, M′₁-M′₃ that magnetically interact with the plurality of stator windings 2028, 2030 to cause linear movement of the plunger 2022 along a center longitudinal axis CLA-CLA.

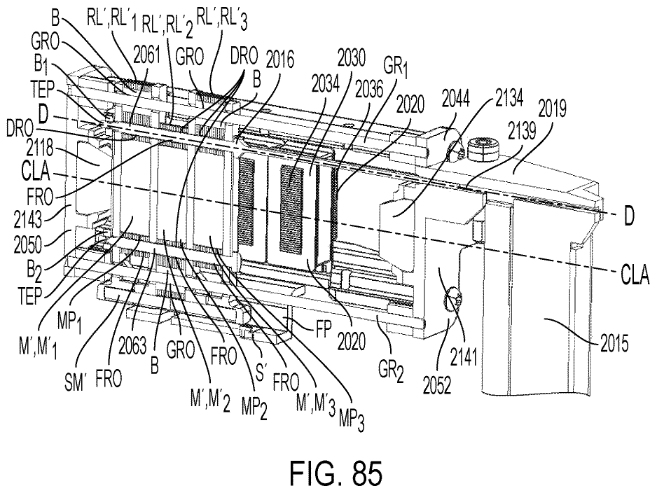

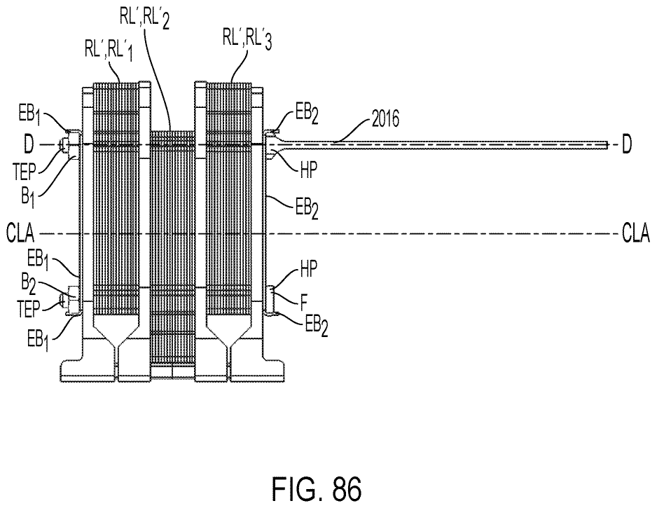

The plunger 2022 includes at least one plunger core RL′ comprising a magnet pocket MP through which the center longitudinal axis CLA-CLA passes and the at least one permanent magnet M′, M′₁-M′₃ is securely housed within the at least one plunger core RL′, and a driver receiving opening DRO through which the driver 2016 is securely received so that the linear movement of the plunger 2022 along the center longitudinal axis CLA-CLA drives the driver 2016 along a drive axis D′-D′ that is offset from but parallel to the center longitudinal axis CLA-CLA. The center longitudinal axis CLA-CLA of the plunger 2022 and the drive axis D′-D′ of the driver 2016 are shown in FIGS. 85-86. The driver 2016 may be disposed offset from a center point of the at least one plunger core RL′. The at least one plunger core RL′ of the plunger 2022 may be securely mounted on the driver 2016. The stator 2018, 2020 may be configured to drive the plunger along the drive axis D′-D′.

In the illustrated embodiment, the at least one plunger core RL′ may include three plunger cores RL′₁, RL′₂, and RL′₃. The number of plunger cores RL′ may vary. The plunger cores RL′₁, RL′₂, and RL′₃ may include magnet pockets MP₁, MP₂, and MP₃, respectively.

The at least one permanent magnet M′ may include three permanent magnets M′₁, M′₂, and M′₃. The magnet pockets MP₁, MP₂, and MP₃ may be configured to receive the permanent magnets M′₁, M′₂, and M′₃, respectively. That is, each of the magnet pockets may be configured to receive one of the permanent magnets.

The fastener device 2010 may comprise an offset plunger core RL′₂ that is disposed adjacent the at least one plunger core RL′₁, RL′₃. The offset plunger core RL′₂ may include the magnet pocket MP₂ that is substantially aligned with the magnet pockets MP₁, MP₃ of the at least one plunger core RL′₁, RL′₃. The driver 2016 may pass outside a body of the offset plunger core RL′₂.

Even though the plunger 2022 has an offset plunger core configuration, as the magnet pocket MP₂ (and the permanent magnet M′₂ disposed therein) of the offset plunger core RL′₂ is substantially aligned with the magnet pockets MP₁, MP₃ (and their respective permanent magnets M′₁, M′₃ disposed therein) of the at least one plunger core RL′₁, RL′₃, the stator 2018, 2020 may still be disposed at the same height/location/position with respect to the plunger 2022.

Although three plunger cores RL′₁, RL′₂, and RL′₃ are shown in the illustrated embodiment, in another embodiment, the at least one plunger core RL′ may include two plunger cores (e.g., one of which may be offset plunger core) or four plunger cores (e.g., two of which may be offset plunger cores). Although in the above discussion the plunger core RL′₂ may be referred to as the offset plunger core that is offset with respect to adjacent plunger cores RL′₁, RL′₃, a person of ordinary skill in the art may consider the plunger cores RL′₁, RL′₃ as the offset plunger cores that are offset with respect to the plunger core RL′₂.

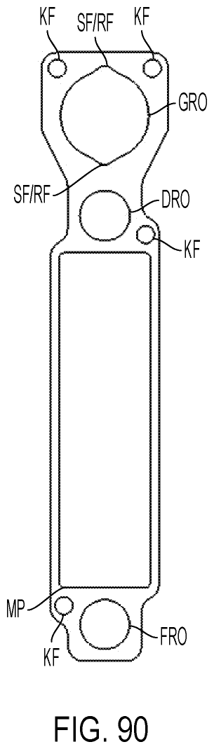

The offset plunger core configuration in which adjacently disposed plunger cores are offset with respect to each other enables the use of the same plunger lamination (as shown in FIG. 90) for all the plunger cores. As shown in FIG. 90, the plunger lamination includes a single guide rod receiving opening. When this plunger lamination is used for the at least one plunger core RL′₁, RL′₃, the guide rod receiving openings are used to receive the top bushings and the top guide rod. When the same plunger lamination is used for the offset plunger core RL′₂, this plunger lamination is flipped/rotated by 180 degrees (e.g., compared to the plunger lamination configurations of the at least one plunger core RL′₁, RL′₃) and is used to receive the bottom bushing and the bottom guide rod.

This offset plunger core configuration, thus, provides material and cost savings of the plunger laminations and the plunger cores as this plunger lamination has a single guide rod receiving opening, making the overall length of this plunger lamination shorter (compared to a plunger lamination having two guide rod receiving openings-one at the top for the top guide rod and one at the bottom for the bottom guide rod).

Although in the illustrated embodiment, the fastener device 2010 includes the offset plunger core RL′₂ that is disposed adjacent the at least one plunger core RL′₁, RL′₃. In another embodiment, each of the plunger laminations RL′₁, RL′₂, and RL′₃ may be designed so they can extend the same length (rather than being offset with respect to each other). In such an embodiment, each plunger core lamination may include two guide rod receiving openings (instead of the single guide rod receiving opening) along with the driver receiving opening and the fastener receiving opening.

The tool housing 2012 may include a top end portion 2057. The driver 2016 may be disposed closer to the top end portion 2057 of the tool housing 2012.

The at least one plunger core RL′ of the plunger 2022 may include a fastener receiving opening FRO that is configured to securely receive a fastener F, and a guide rod receiving opening GRO that is configured to receive a guide rod GR therethrough to enable the plunger 2022 to slide along a length of the guide rod GR so as to maintain an air gap between the plunger 2022 and the stator 2018, 2020.

The fastener F may be a shoulder screw. The driver 2016 may also be configured to act as a second fastener/shoulder screw. Unlike the previous embodiments where only the driver is used to assemble the plunger cores together to form the plunger, in this embodiment, both the fastener F and the driver 2016 may be used to assemble the plunger cores together to form the plunger 2022. The fastener F and the driver 2016 may be parallel to each other and (vertically) offset from each other. This two-fastener configuration allows for better distribution of (assembly) forces through the plunger 2022. This two-fastener configuration also provides a sturdy construction as the plunger 2022 is less likely going to come apart as the plunger 2022 is assembled using both fastener F and the driver 2016 (instead of using the single fastener/driver to assemble the plunger in other embodiments).

The guide rod receiving opening GRO may include some strain relief features SF/RF. The plunger lamination (as shown in FIG. 90) may have other features KF that may be used as keying/interlocking features.

The guide rod receiving opening GRO of the at least one plunger core RL′ of the plunger 2022 may be configured to receive either the guide rod GR₁ or the guide rod GR₂ therethrough. For example, the guide rod receiving openings GRO of the at least one plunger core RL′₁, RL′₃ may be configured to receive the guide rod GR₁ therethrough, while the guide rod receiving opening GRO of the offset plunger core RL′₂ may be configured to receive the guide rod GR₂ therethrough. As shown, the guide rod GR₁ may be disposed in the upper/top portion of the linear motor assembly, while the guide rod GR₂ may be disposed in the lower/bottom portion of the linear motor assembly. Central longitudinal axes of the guide rod GR₁ and the guide rod GR₂ are parallel to each other and (vertically) separated from each other. The guide rod GR₁ and the guide rod GR₂ are disposed on opposite sides (top/bottom or upper/lower) of the permanent magnets M′, M′₁-M′₃. The guide rod GR₁ and the guide rod GR₂ are disposed on opposite sides (top/bottom or upper/lower) of the driver 2016. In one embodiment, moving from the top of the tool and the linear motor assembly to the bottom of the linear motor assembly, the guide rod GR₁, the driver 2016, the permanent magnets M′, M′₁-M′₃, the fastener F, and the guide rod GR₂ are disposed in that order/sequence.

The at least one plunger core RL′ of the plunger 2022 may include the first plunger core RL′₁, RL′₃ and the second plunger core RL′₂. The first plunger core RL′₁, RL′₃ and the second plunger core RL′₂ may be adjacent to each other. The fastener F may be configured to connect the first plunger core RL′₁, RL′₃ and the second plunger core RL′₂ to each other. The driver 2016 may also be configured to connect the first plunger core RL′₁, RL′₃ and the second plunger core RL′₂ to each other. The driver receiving opening DRO and the fastener receiving opening FRO may be configured to be interchangeably used such that the one of the driver receiving opening DRO and the fastener receiving opening FRO is configured to securely receive the driver 2016 and the other of the driver receiving opening DRO and the fastener receiving opening FRO is configured to securely receive the fastener F.

As shown in FIG. 90, the size, the shape and/or the configuration of the driver receiving opening DRO and the fastener receiving opening FRO may be the same. In other embodiments, the size, the shape and/or the configuration of the driver receiving opening DRO and the fastener receiving opening FRO may be different.

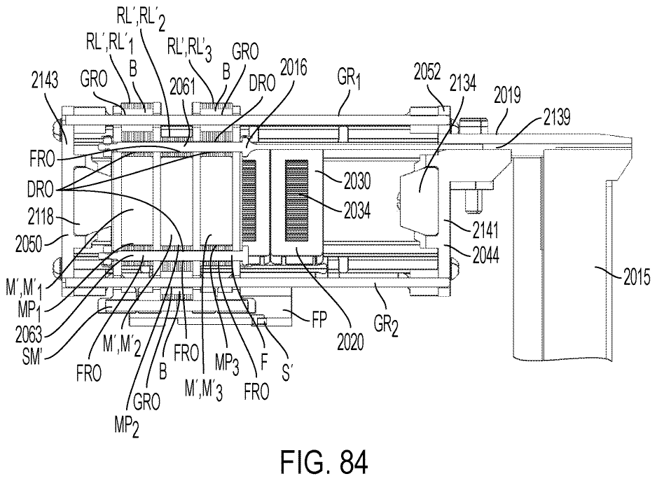

Referring to FIGS. 84 and 85, the driver receiving opening DRO and the fastener receiving opening FRO formed on the first plunger core RL′₁, RL′₃ may be configured to securely receive the driver 2016 and the fastener F, respectively. The driver receiving opening DRO and the fastener receiving opening FRO formed on the second plunger core RL′₂ may be configured to securely receive the fastener F and the driver 2016, respectively. That is, the driver receiving opening DRO formed on the second plunger core RL′₂ may be used as the fastener receiving opening FRO so as to securely receive the fastener F, while the fastener receiving opening FRO formed on the second plunger core RL′₂ may be used as the driver receiving opening DRO so as to securely receive the driver 2016. As discussed above, the second plunger core RL′₂ and the first plunger core RL′₁, RL′₃ may have the same size, shape and configuration but the second plunger core RL′₂ is flipped/rotated by 180 degrees (e.g., compared to the first plunger core RL′₁, RL′₃) before the second plunger core RL′₂ is being connected to the first plunger core RL′₁, RL′₃.

The driver receiving opening DRO formed on the first plunger core RL′₁, RL′₃ may be configured to align with the fastener receiving opening FRO formed on the second plunger core RL′₂ so as to securely receive the driver 2016 therein. The fastener receiving opening FRO formed on the first plunger core RL′₁, RL′₃ may be configured to align with the driver receiving opening DRO formed on the second plunger core RL′₂ so as to securely receive the fastener F therein.

A portion 2061 of the driver 2016 that is received in the driver receiving opening DRO formed on the first plunger core RL′₁, RL′₃ and the fastener receiving opening FRO formed on the second plunger core RL′₂ may include the same shape, size and configuration as a portion 2063 of the fastener F that is received in the fastener receiving opening FRO formed on the first plunger core RL′₁, RL′₃ and the driver receiving opening DRO formed on the second plunger core RL′₂.

The guide rod receiving opening GRO may be formed on the first plunger core RL′₁, RL′₃ and may be disposed on one (e.g., top/upper) side of the driver 2016. The guide rod receiving opening GRO may be formed on the second plunger core RL′₂ and may be disposed on the other side (e.g., bottom/lower) of the driver 2016. The guide rod receiving opening GRO formed on the first plunger core RL′₁, RL′₃ may be disposed above the driver 2016 and the guide rod receiving opening GRO formed on the second plunger core RL′₂ may be disposed below the driver 2016.

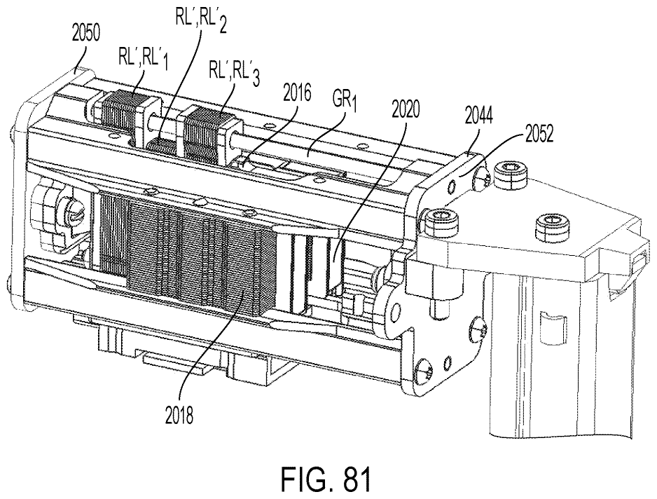

As shown in FIGS. 81-85, the motor assembly 2014 may include a frame 2044. The frame 2044 may include the first guide rod GR₁ and the second guide rod GR₂. The frame 2044 may include two end portions 2050 and 2052 that are configured to receive and support portions of the first guide rod GR₁ and the second guide rod GR₂. The first guide rod GR₁ and the second guide rod GR₂ may extend substantially parallel to the drive axis D-D. The first guide rod GR₁ and the second guide rod GR₂ may extend substantially parallel to the center longitudinal axis CLA-CLA.

The guide rod receiving opening GRO formed on the first plunger core RL′₁, RL′₃ may be configured to receive the first guide rod GR₁ therethrough to enable the plunger 2022 to slide along the length of the first guide rod GR₁ so as to maintain the air gap between the plunger 2022 and the stator 2018, 2022. The guide rod receiving opening GRO formed on the second plunger core RL′₂ may be configured to receive the second guide rod GR₂ therethrough to enable the plunger 2022 to slide along the length of the second guide rod GR₂ so as to maintain the air gap between the plunger 2022 and the stator 2018, 2020. The first guide rod GR₁ may be disposed on one side of the driver 2016 and the second guide rod GR₂ may be disposed on the other side of the driver 2016. The first guide rod GR₁ may be disposed above the driver 2016 and the second guide rod GR₂ may be disposed below the driver 2016.

As shown in FIGS. 84-85, the magnet pocket MP, MP₁-MP₃ may be disposed between the driver receiving opening DRO and the fastener receiving opening FRO and the magnet pocket MP, MP₁-MP₃ may be disposed below the driver 2016. The magnet pocket MP, MP₁-MP₃ may be disposed between the first guide rod GR₁ and the second guide rod GR₂ and the magnet pocket MP, MP₁-MP₃ may be disposed below the driver 2016. The magnet pockets MP₁-MP₃ may all be aligned with each other. The first guide rod GR₁ may be disposed above the driver 2016 and may be disposed above the magnet pocket MP, MP₁-MP₃ with the magnet M′, M′₁-M′₃ therein. The second guide rod GR₂ may be disposed below the driver 2016 and may be disposed below the magnet pocket MP, MP₁-MP₃ with the permanent magnet M′, M′₁-M′₃ therein.

Referring to FIGS. 84-85 and 88-89, the fastener device 2010 may further comprise a sense magnet (or sensor magnet) SM′ secured to the at least one plunger core RL′ and position sensor S′ (e.g., Hall sensor) fixedly secured to the frame 2044 or the stator 2018, 2022. The sense magnet SM′ includes one or more magnets moveably located along a longitudinal axis that is in close proximity with the position sensor S′ so the magnetic flux of the sense magnet SM′ can be sensed effectively by the position sensor. The sense magnet SM′ may be configured to extend along an axis parallel to the drive axis D-D (and to the center longitudinal axis CLA-CLA) and may be disposed below the driver 2016, the first guide rod GR₁, and the second guide rod GR₂. The position sensor S′ may include a magnetic sensing chip including multiple Hall sensors integrated into a single chip package that output a high resolution and accurate position signal based on the axial position of the sense magnet SM′ indicative of the axial position of the plunger. Alternatively, the position sensor may include a series of Hall sensors discretely secured to the frame along the axis. As shown in FIGS. 84-85, the fastener device 2010 may further comprise a frame or frame portion FP (or a bracket) extending from the stator 2018, 2020 configured to support the sensor S′ to sense a magnetic flux of the sense magnet SM′ as the plunger 2022 travels along the center longitudinal axis CLA-CLA (or along the drive axis D-D).

The plunger 2022 may include the plurality of plunger cores RL′, RL′₁, RL′₂, RL′₃ and a plurality of plunger spacers RS′, RS′₁, RS′₂, RS′₃, RS′₄. The at least one plunger core may be one of the plurality of plunger cores. Each RS′₂, RS′₃ of the plurality of plunger spacers may be configured to separate adjacent plunger cores RL′₁, RL′₂, RL′₃ of the plurality of plunger cores. The plunger spacers RS′₁, RS′₄ may form and be referred to as the end portions/spacers of the plunger 2022.

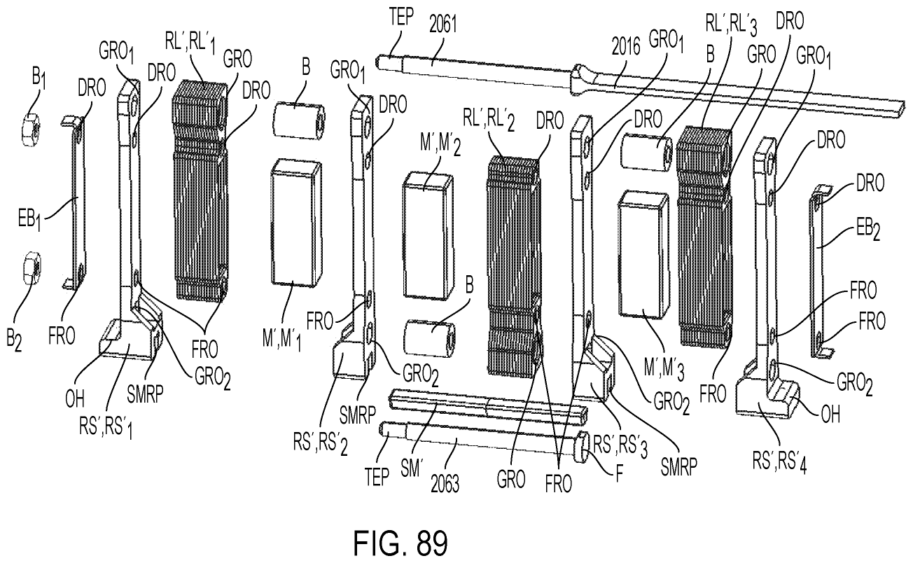

Referring to FIG. 89, each of the plurality of plunger spacers RS′, RS′₁, RS′₂, RS′₃, RS′₄ may include a driver receiving opening DRO that is configured to securely receive the driver 2016, a fastener receiving opening FRO that is configured to securely receive the fastener F, and a first guide rod receiving opening GRO₁ and a second guide rod receiving opening GRO₂ that are configured to receive the first guide rod GR₁ and the second guide rod GR₂, respectively therethrough to enable the plunger 2022 to slide along lengths of the first and the second guide rod GR₁, GR₂ so as to maintain an air gap between the plunger 2022 and the stator 2018, 2020.

Referring to FIGS. 86-89, the plunger 2022 may also include two end brackets EB₁, EB₂ that are disposed adjacent to the corresponding the end portions/spacers RS′₁, RS′₄ of the plunger 2022. The end brackets may be referred to as retaining plates or bent brackets. Each end bracket EB₁, EB₂ includes may include a driver receiving opening DRO that is configured to securely receive the driver 2016 therethrough and a fastener receiving opening FRO that is configured to securely receive the fastener F therethrough. The plunger 2022 may also include two fasteners or bolts B₁, B₂ that are configured to engage with tail end portions TEP of the driver 2016 and the fastener F to secure the driver 2016 and the fastener F in place (when assembling the plunger). The head portions HP of the driver 2016 and the fastener F may be configured to engage with (outer) surfaces of the end bracket EB₂ when the driver 2016 and the fastener F are secured in place (when assembling the plunger).

The end brackets EB₁, EB₂, the driver 2016, the fastener F, the bolts B₁, B₂ and the end portions/spacers RS′₁, RS′₄ form an assembly members/system that is configured to assemble/hold/secure the plunger cores to form the plunger 2022.

The end plunger spacers RS′₁, RS′₄ may also include overhang portions OH that retain the axial ends of the sense magnet SM′, according to an embodiment. The plunger spacers RS′₁, RS′₂, RS′₃, RS′₄ may include optional gussets/slanted portions for structural integrity.

Referring to FIGS. 84-85 and 88-89, the plunger 2022 may also include linear bearings or bushings B that are received in the guide rod receiving openings GRO. The bushings B may be configured to be press fit and may interface with the guide rod GR₁ and GR₂. The bushing B may be made of Polytetrafluoroethylene (PTFE) or Bronze material, preferably a powdered metal Iron Bronze or Iron Copper blend with embedded lubricant. In the illustrated embodiment, there are two bushings B at the top and one bushing B at the bottom of the plunger. The two top bushings B that are close to the driver 2016 may be referred to as and become the control bushings and the single bottom bushing B may be designed to be a little freer.

Each of the plurality of plunger spacers RS′, RS′₁, RS′₂, RS′₃, RS′₄ may include a sensor magnet receiving portion SMRP that is configured to receive and support the sense magnet SM′ therein.

As described in other embodiments, the driver 2016 may be configured to travel along the drive axis D-D between a retracted position and an extended position to drive a fastener of the one or more fasteners into the workpiece during a drive stroke. The fastener device 2010 may further comprise the magazine 2015 that holds the one or more fasteners; and a fastener feed mechanism that arranges the fastener from the magazine 2015 along the drive axis D-D for engagement with the driver 2016. The center longitudinal axis CLA-CLA may be configured to intersect the magazine 2015. The tool housing 2012 may include the handle portion 2017 that supports the trigger switch 2191 below the motor assembly 2014, and a front wall 2141 that supports a bumper 2134 along the center longitudinal axis CLA-CLA that limits the movement of the plunger 2022 along the center longitudinal axis CLA-CLA. The tool housing 2012 may include a rear wall 2143 that supports a bumper 2118 along the center longitudinal axis CLA-CLA that limits the movement of the plunger 2022 along the center longitudinal axis CLA-CLA. The driver 2016 may traverse through an opening 2139 (as shown in FIGS. 84-85) of the front wall 2141 at a location above the bumper 2134. The front wall 2141 of the tool housing 2012 may be interchangeably used as the end portion 2052 of the frame 2044 and the front wall 2143 of the tool housing 2012 may be interchangeably used as the end portion 2050 of the frame 2044.

The stator 2018, 2020 may be in magnetic interface with the plunger 2022. The stator (including the first stator, the second stator, the stages of the stator, the stator core, the stator teeth, the stator windings, etc.) is similar in configuration and operation to those disclosed in the previous embodiments and, therefore, the stator will not be described in detail here again except for the differences noted below.

The stator 2018, 2020 may comprise a stator core 2024, 2026, a plurality of stator teeth 2032, 2034 extending from the stator core 2024, 2026 towards the plunger 2022, and the plurality of stator windings 2028, 2030 wound around the plurality of stator teeth 2032, 2034. The at least one plunger core RL′, RL′₁, RL′₂, RL′₃ of the plunger 2022 may be configured to support one of the plurality of permanent magnets M′, M′₁-M′₃ in magnetic interaction with the plurality of stator windings 2028, 2030. The configuration of stator, the stator core, the stator teeth, and the stator windings are described in detail in the previous embodiments.

The at least one permanent magnet M′, M′₁-M′₃ may have a pole facing the plurality of stator windings 2028, 2030. The stator 2018, 2020 may include the first stator 2018 and the second stator 2020 that are spaced apart circumferentially around the plunger 2022 and the plunger 2022 may be disposed between the first stator 2018 and the second stator 2020 to magnetically interact with each of the first and second stator 2018, 2020.

The first stator 2018 may include the first stator core 2024 oriented along a first plane that is substantially perpendicular to the drive axis D-D, the plurality of first teeth 2032 extending inwardly from the first stator core 2024 in a direction substantially perpendicularly to the first plane and perpendicular to the drive axis D-D, and the plurality of first windings 2028 wound around the first stator teeth 2032. The second stator 2020 may include the second stator core 2024 oriented along a second plane that is substantially perpendicular to the drive axis D-D, the plurality of second teeth 2032 extending inwardly from the second stator core 2024 in a direction substantially perpendicular to the second plane and perpendicular to the drive axis D-D, and the plurality of second windings 2030 wound around the second stator teeth 2034.

The stator 2018, 2020 may comprise a plurality of stator core segments 2024, 2026 provided along a first plane extending parallel to a second plane formed by the drive axis D-D and the center longitudinal axis CLA-CLA, and a plurality of stator teeth 2032, 2034 extending perpendicularly from the plurality of stator core segments 2024, 2026 in the direction of the second plane. The plurality of stator windings 2028, 2030 may be wound around the plurality of stator teeth 2032, 2034.

The at least one permanent magnet M′, M′₁-M′₃ may traverse proximate inner tips of the plurality of stator teeth 2032, 2034 in magnetic interaction with the plurality of stator windings 2028, 2030. The driver 2016 may traverse proximate a top portion of the plurality of stator teeth 2028, 2030.

Unlike in the previous embodiments where the stators 18, 20 are disposed on the top and bottom (longitudinally extending) sides of the plunger 22, in this embodiment, the stators 2018, 2020 are disposed on the sides (e.g., left and right sides or longitudinally extending sides) of the plunger 22. This configuration of the stators 2018, 2020 will enable the driver 2016 to be disposed closer to the top (e.g., top rail or top guide rod) of the tool. The top and bottom sides and the left and right sides are relative to the orientation of the tool as a whole. Also, this configuration of the stators 2018, 2020 allows the guide rails to be moved to the top and bottom longitudinal sides (instead of the guide rails on the left and right longitudinal sides of the previous embodiments). This in turn also allows the driver 2016 to be moved closer to and aligned with the (very) top of the tool.

One of the benefits of the offset driver configuration is that this configuration enables the driver to be positioned closer to the top of the tool. This configuration, thus, provides better access for most of the nailing and stapling applications. That is, by having the driver and nose close to the top of the tool, the tool may be configured to provide better access, for example, in corners or up against edges.

Another benefit of the offset driver configuration is that it allows the use of one permanent magnet per section/plunger core. As discussed in detail above with respect to FIGS. 79-90, there is only permanent magnet per section/plunger core. This allows one/single plunger core/lamination for the whole construction unlike some of the previous embodiments. The single magnet in each plunger core may have a north pole facing the left side stator and may have a south pole facing the right side stator. The single magnet in each plunger core may alternate in polarity with respect to their adjacent single magnets (in their respective adjacent plunger cores) as discussed in the previous embodiments.

Also, in the previous embodiments with two magnets in each plunger core, the two magnets are separated from each other with some metal webbing/some plunger core lamination material. In the single magnet per plunger core configuration, there is no need for the metal webbing/plunger core lamination material (between the magnets that is used to separate the magnets). This provides some material and weight savings to the single magnet per plunger core configuration.

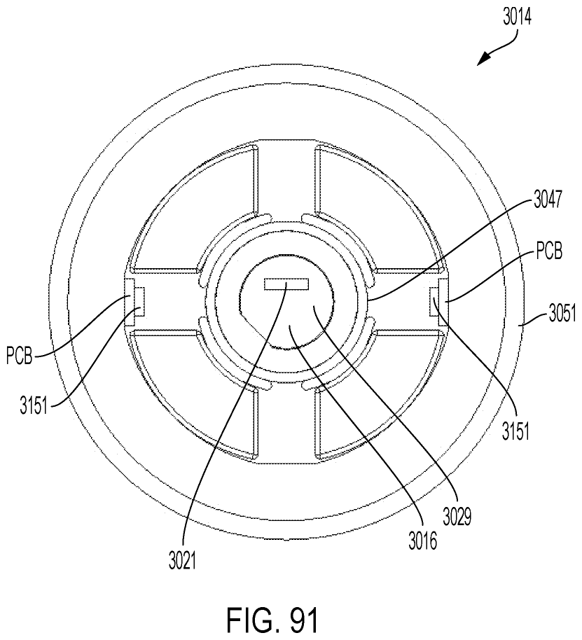

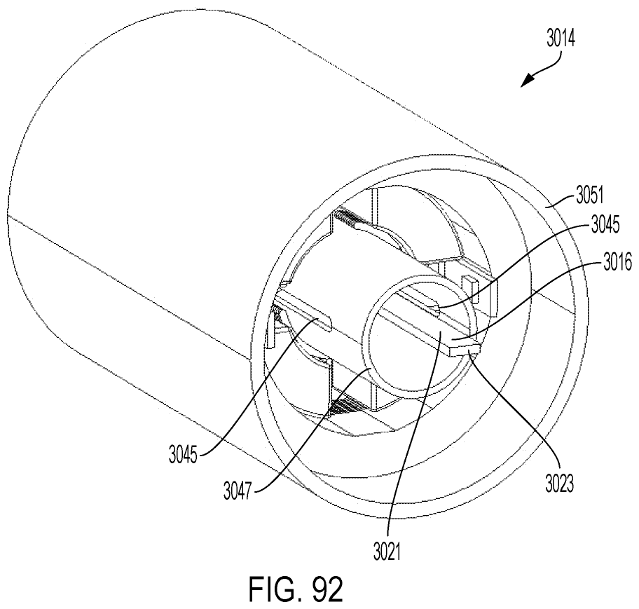

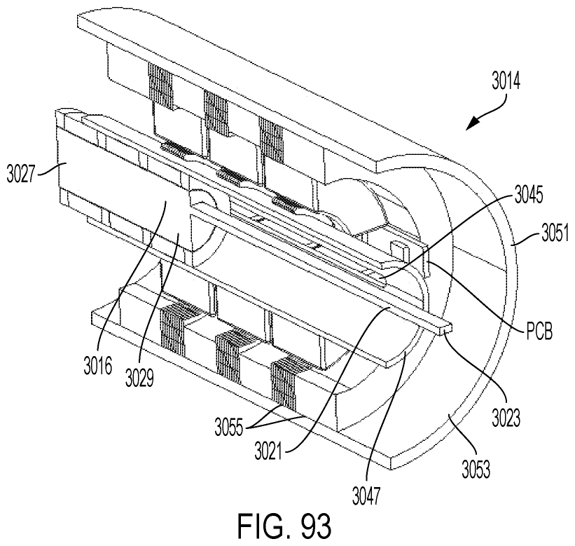

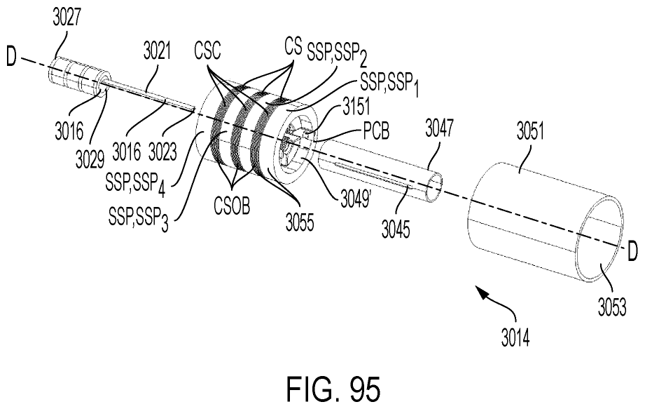

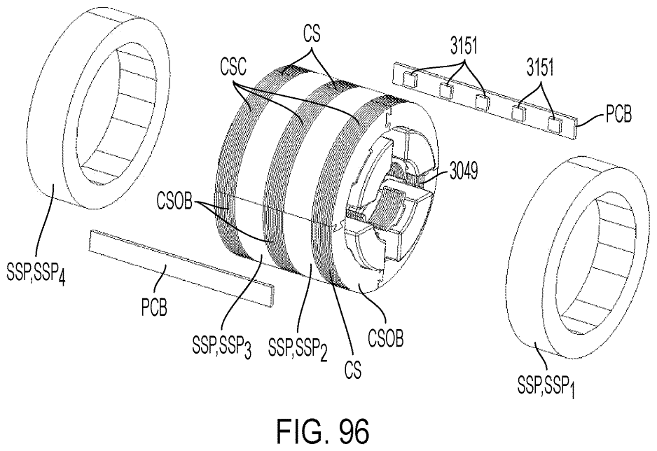

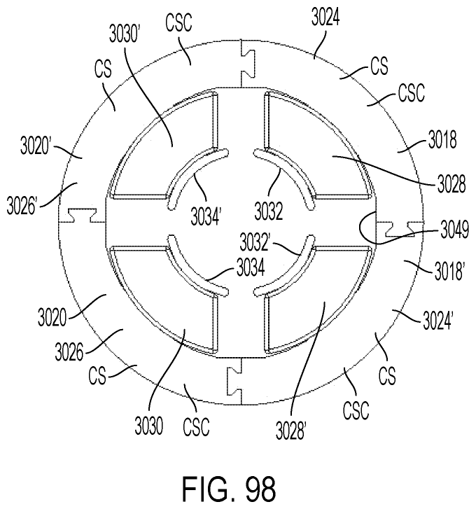

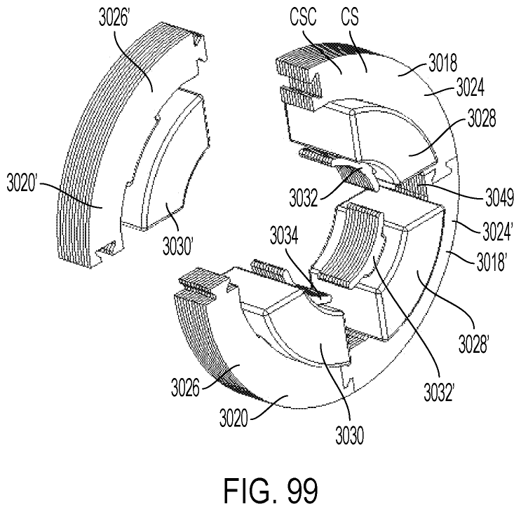

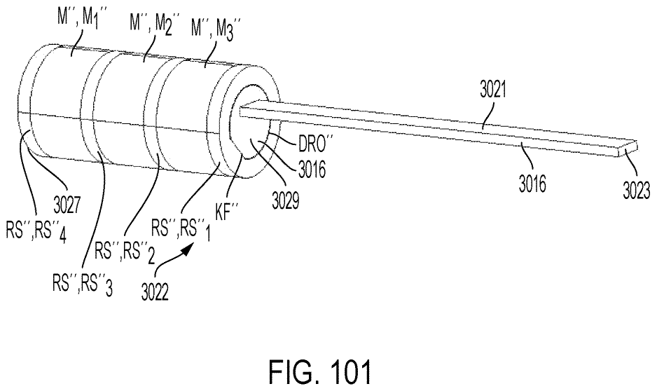

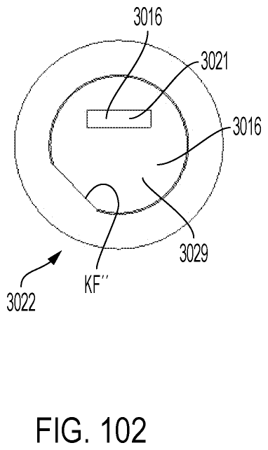

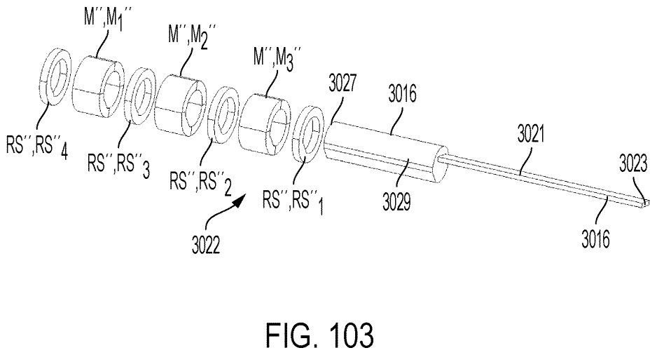

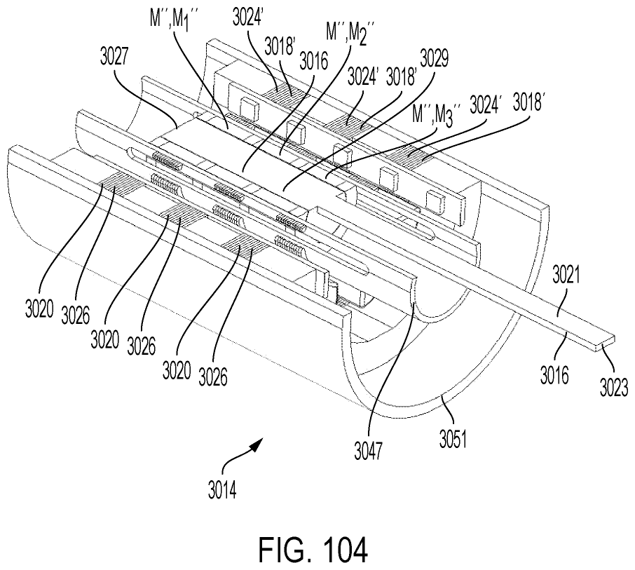

As shown in FIGS. 91-104, the present disclosure provides another embodiment of a motor assembly 3014. The motor assembly 3014 may be used in a fastener device that drives one or more fasteners into a workpiece. The fastener device may include a tool housing. The fastener device, the tool housing and other components of the fastener device are not shown in FIGS. 91-104 but they may have the same construction and the same operation as described in detail in other embodiments of the present disclosure. The fastener device may include the motor assembly 3014 within the tool housing.

The motor assembly 3014 is shown in FIGS. 91-104. The motor assembly 3014 may include a plunger 3022 including a plurality of permanent magnets M″, M″₁-M″₃ moveable along the drive axis D-D, and a cylindrical stator CS (e.g., including 3018, 3018', 3020 and 3020'). The cylindrical stator CS (e.g., including 3018, 3018', 3020 and 3020') may include a stator core CSC (e.g., 3024, 3024′, 3026 and 3026′) having a substantially cylindrical outer body CSOB and a plurality of teeth 3032, 3032′, 3034 and 3034′ that extend radially inwardly from the substantially cylindrical outer body CSOB, and a plurality of stator windings 3028, 3028′, 3030 and 3030′, respectively wound around the plurality of stator teeth 3032, 3032′, 3034 and 3034′. The plurality of stator windings 3028, 3028′, 3030 and 3030′ may be located peripherally around the plunger 3022 along a radial plane that is substantially perpendicular to the drive axis D-D to magnetically interact with the permanent magnets M″, M″₁-M″₃ of the plunger 3022.

In one embodiment, the cylindrical stator may be a stator that is extending peripherally around the plunger. The stator includes a stator core having an outer body and a plurality of teeth that extend inwardly from the outer body in the direction of the plunger.

The fastener device may further comprise a driver 3016 within the tool housing and configured to be drivable via the plunger 3022. The driver 3016 may include a first end 3023 and a second opposing end 3027. The driver 3016 may include a driver blade 3021 and a driver body 3029 having a central longitudinal axis. The central longitudinal axis being parallel to the drive axis D-D. The driver body 3029 may include a cylindrical shaped configuration.

The driver blade 3021 and the driver body 3029 of the driver 3016 may be integrally formed with each other. In another embodiment, the driver blade 3021 and the driver body 3029 of the driver 3016 may be connected to each other. The driver blade 3021 may extend between the driver body 3029 and the end 3023 of the driver 3016. The driver blade 3021 is oriented along a plane that is substantially parallel to the drive axis D-D and the central longitudinal axis of the driver body 3029 and that is offset from the central longitudinal axis of the drive body 3029. The driver blade 3021 may have a thinner, smaller or flatter (e.g., rectangular or square cross-sectional) configuration. The driver blade 3021 may have a rectangular or a square cross-sectional configuration. At the end 3023 of the driver 3016, the driver blade 3021 may be configured to engage with and drive a lead fastener (of the one or more fasteners) in the drive channel of the nose assembly of the fastener into a workpiece. In the illustrated embodiment, the driver blade 3021 is disposed/positioned offset with respect to the center longitudinal axis of the driver 3016. In another embodiment, the driver blade 3021 may not be offset with respect to the driver body 3029. That is, the driver blade 3021 may be disposed/positioned to align with respect to the center longitudinal axis of the driver 3016.

The plunger 3022 may be configured to travel along the drive axis D-D between a retracted condition and an extended condition to drive a fastener of the one or more fasteners into the workpiece during a drive stroke.

The stator core CSC may include a plurality of arcuate stator segments 3024, 3024′, 3026 and 3026′ that interlock with each other to form the substantially cylindrical outer body CSOB. The plurality of arcuate stator segments includes four arcuate stator segments 3024, 3024′, 3026 and 3026′. The number of arcuate stator segments may vary. The plurality of arcuate stator segments includes three arcuate stator segments or two arcuate stator segments.

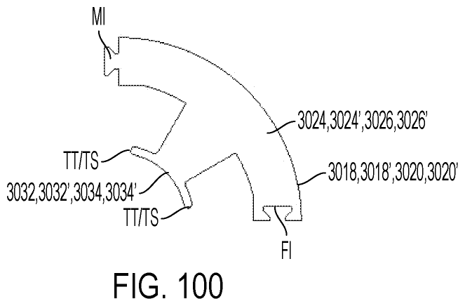

For example, as shown in FIG. 100, each arcuate stator segment 3024, 3024′, 3026 and 3026′ may include a male interlock MI at one end thereof and a female interlock FI at the other (opposing end) thereof. The male interlock MI of one of the arcuate stator segments 3024, 3024′, 3026 and 3026′ may be configured to interengage and interlock with the female interlock FI of the adjacent arcuate stator segment 3024, 3024′, 3026 and 3026′. Similarly, the female interlock FI of one of the arcuate stator segments 3024, 3024′, 3026 and 3026′ may be configured to interengage and interlock with the male interlock MI of the adjacent arcuate stator segment 3024, 3024′, 3026 and 3026′. The interengagement and interlock connections between the male interlock MI and the female interlock FI of the adjacent arcuate stator segment 3024, 3024′, 3026 and 3026′ enable the connection between the adjacent arcuate stator segment 3024, 3024′, 3026 and 3026′ (the connection of the adjacent arcuate stator segment 3024, 3024′, 3026 and 3026′ with each other) to form the substantially cylindrical outer body CSOB. The shape and configuration of the male and the female interlocks MI, FI shown in FIG. 100 are exemplary and should not be considering limiting. In other embodiments, the male and the female interlocks MI, FI may be referred to as first and second interlocks, respectively and the male and the female interlocks MI, FI may have other shapes/configurations as would be appreciated by a person of ordinary skill in the art.

Each arcuate stator segment 3024, 3024′, 3026 and 3026′ may be formed from a plurality of steel laminations. As shown in FIG. 100, each steel lamination including an arcuate portion extending at an angular distance that is approximately equivalent to 360/n degrees, where n is the number of the plurality of arcuate stator segments, a corresponding tooth portion 3032, 3032′, 3034, 3034′ extending radially inwardly from the arcuate portion/stator segment 3024, 3024′, 3026 and 3026′, and a tooth shoe TT/TS (referred to as “teeth tips”) extending laterally from an inner end of the tooth portion 3032, 3032′, 3034, 3034′. The details about the teeth, tooth shoes, laminations, cores, and stator bodies are described in detail in other embodiments of the present disclosure are equally applicable here except that the teeth, tooth shoes, laminations, cores, and stator bodies, in this embodiment, are shaped arcuately. Although the arcuate portion of the steel lamination extends at an angular distance of at least approximately 90 degrees in FIG. 100, in other embodiments, the arcuate portion of the steel lamination may extend at an angular distance of at least approximately 180 degrees or 120 degrees.

It is noted that while the stators CS of this embodiment are described as cylindrical, each stator may be of any cross-sectional shape, including, but not limited to, square, square with curved corners, non-concentric annular, etc., so long as the stator extends circumferentially around all or a substantial portion of the plunger 3022. For example, a square stator may include four stator segments having substantially planar core portions. Further, while the illustrated stators each include four stator segments, the number of stator segments may be smaller than 4. For example, the stator may include 2 stator segments (e.g., similar to the embodiment of FIGS. 1-24 but with circumferentially arched stator cores) or 3 stator segments (e.g., forming a triangular or Reuleaux triangular cross-section). Similarly, the number of stator segments may be greater than 4, forming, e.g., a pentagonal, hexagonal, etc. cross-section.

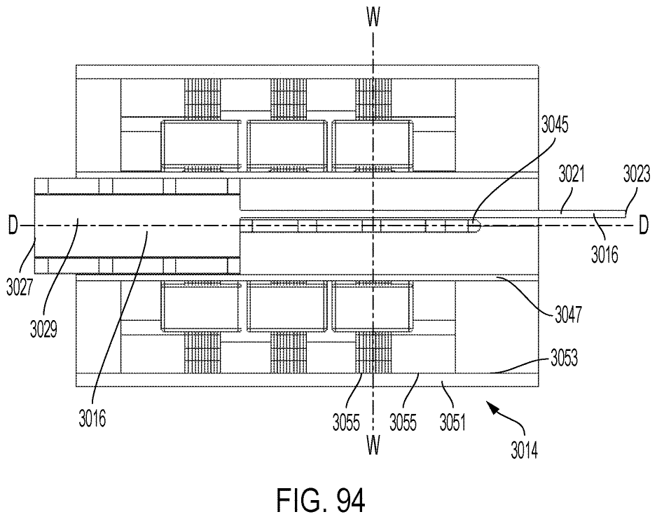

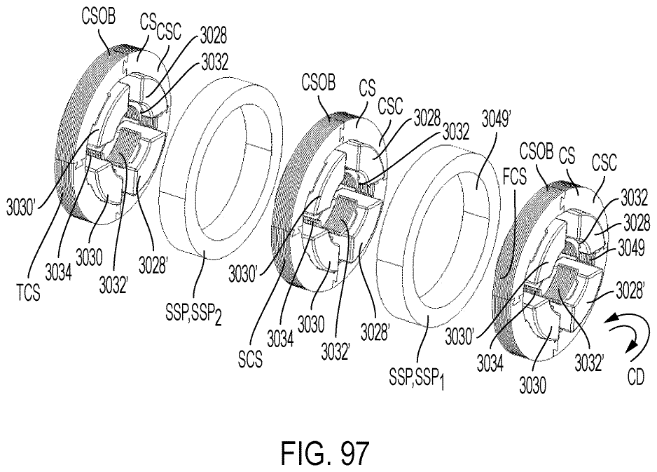

Each of the plurality of stator windings 3028, 3028′, 3030 and 3030′ may be wound along a winding axis W-W (as shown in FIG. 94) that is substantially perpendicular to the drive axis D-D. The plurality of stator windings 3028, 3028′, 3030 and 3030′ may be spaced apart along a circumferential direction CD (as shown in FIG. 97). The circumferential direction CD may be either clockwise or counterclockwise direction.

As shown in FIG. 97, the motor assembly 3014 may include a plurality of cylindrical stators CS including at least a first cylindrical stator FCS and a second cylindrical stator SCS. The plurality of cylindrical stators CS may include a first cylindrical stator FCS and at least a second cylindrical stator SCS. The first cylindrical stator may be referred to the stator. The cylindrical stator is the first cylindrical stator. The second cylindrical stator SCS may be oriented along a second radial plane substantially parallel to the radial plane of the first cylindrical stator FCS. As shown in FIG. 97, the motor assembly 3014 may also include a third cylindrical stator TCS. The third cylindrical stator may be oriented along a third radial plane substantially parallel to the radial planes of the first cylindrical stator FCS and the second cylindrical stator SCS.

The plurality of stator windings 3028, 3028′, 3030 and 3030′ of the first cylindrical stator FCS may be energized in a first energization pattern, and the plurality of stator windings 3028, 3028′, 3030 and 3030′ of the second cylindrical stator SCS may be energized in a second energization pattern.

At a first predetermined position of the plunger 3022, the plurality of stator windings 3028, 3028′, 3030 and 3030′ of the first cylindrical stator FCS and the plurality of stator windings 3028, 3028′, 3030 and 3030′ of the second cylindrical stator SCS may be both energized at the first energization pattern. Also, the values of the current at the plurality of stator windings 3028, 3028′, 3030 and 3030′ of the first cylindrical stator FCS and at the plurality of stator windings 3028, 3028′, 3030 and 3030′ of the second cylindrical stator SCS are the same at the first predetermined position of the plunger 3022. At the first predetermined position of the plunger 3022, the plurality of stator windings 3028, 3028′, 3030 and 3030′ of the third cylindrical stator TCS is not energized.

At a second predetermined position of the plunger 3022, the plurality of stator windings 3028, 3028′, 3030 and 3030′ of the first cylindrical stator FCS may be energized at a second energization pattern that is different from the first energization pattern and the plurality of stator windings 3028, 3028′, 3030 and 3030′ of the second cylindrical stator SCS is energized at the first energization pattern. Also, the values of the current at the plurality of stator windings 3028, 3028′, 3030 and 3030′ of the first cylindrical stator FCS and at the plurality of stator windings 3028, 3028′, 3030 and 3030′ of the second cylindrical stator SCS are different at the second predetermined position of the plunger 3022. That is, the values of the current at the plurality of stator windings 3028, 3028′, 3030 and 3030′ of the second cylindrical stator SCS is greater than the values of the current at the plurality of stator windings 3028, 3028′, 3030 and 3030′ of the first cylindrical stator FCS. At the second predetermined position of the plunger 3022, the plurality of stator windings 3028, 3028′, 3030 and 3030′ of the third cylindrical stator TCS is not energized.

At a third predetermined position of the plunger 3022, the plurality of stator windings 3028, 3028′, 3030 and 3030′ of the second cylindrical stator SCS may be energized at the first energization pattern and the plurality of stator windings 3028, 3028′, 3030 and 3030′ of the third cylindrical stator TCS is energized at the first energization pattern. Also, the values of the current at the plurality of stator windings 3028, 3028′, 3030 and 3030′ of the second cylindrical stator SCS and at the plurality of stator windings 3028, 3028′, 3030 and 3030′ of the third cylindrical stator TCS are the same at the third predetermined position of the plunger 3022. At the third predetermined position of the plunger 3022, the plurality of stator windings 3028, 3028′, 3030 and 3030′ of the first cylindrical stator FCS may be energized at the second energization pattern. The values of the current at the plurality of stator windings 3028, 3028′, 3030 and 3030′ of the first cylindrical stator FCS is different from the values of the current at the plurality of stator windings 3028, 3028′, 3030 and 3030′ of the second cylindrical stator SCS and the values of the current at the plurality of stator windings 3028, 3028′, 3030 and 3030′ of the third cylindrical stator TCS at the third predetermined position of the plunger 3022.

At a fourth predetermined position of the plunger 3022, the plurality of stator windings 3028, 3028′, 3030 and 3030′ of the first cylindrical stator FCS and the plurality of stator windings 3028, 3028′, 3030 and 3030′ of the second cylindrical stator SCS may be energized at the second energization pattern, and the plurality of stator windings 3028, 3028′, 3030 and 3030′ of the third cylindrical stator TCS is energized at the first energization pattern. The values of the current at the plurality of stator windings 3028, 3028′, 3030 and 3030′ of the first cylindrical stator FCS is the same as the values of the current at the plurality of stator windings 3028, 3028′, 3030 and 3030′ of the second cylindrical stator SCS at the fourth predetermined position of the plunger 3022. Also, at the fourth predetermined position of the plunger 3022, the values of the current at the plurality of stator windings 3028, 3028′, 3030 and 3030′ of the third cylindrical stator TCS are different from the values of the current at the plurality of stator windings 3028, 3028′, 3030 and 3030′ of the second cylindrical stator SCS and the values of the current at the plurality of stator windings 3028, 3028′, 3030 and 3030′ of the first cylindrical stator FCS.

At a fifth predetermined position of the plunger 3022, the plurality of stator windings 3028, 3028′, 3030 and 3030′ of the first cylindrical stator FCS and the plurality of stator windings 3028, 3028′, 3030 and 3030′ of the third cylindrical stator TCS may be energized at the first energization pattern, and the plurality of stator windings 3028, 3028′, 3030 and 3030′ of the second cylindrical stator SCS is energized at the second energization pattern. The values of the current at the plurality of stator windings 3028, 3028′, 3030 and 3030′ of the first cylindrical stator FCS is the same as the values of the current at the plurality of stator windings 3028, 3028′, 3030 and 3030′ of the third cylindrical stator TCS at the fifth predetermined position of the plunger 3022. Also, at the fifth predetermined position of the plunger 3022, the values of the current at the plurality of stator windings 3028, 3028′, 3030 and 3030′ of the second cylindrical stator SCS are different from the values of the current at the plurality of stator windings 3028, 3028′, 3030 and 3030′ of the third cylindrical stator TCS and the values of the current at the plurality of stator windings 3028, 3028′, 3030 and 3030′ of the first cylindrical stator FCS.

In the described embodiment, the stator assembly includes a plurality of stators CS that are successively oriented along the movement axis of the plunger 3022, where each peripherally surround substantially all or at least a portion of the plunger 3022, and where each stator CS corresponds to an energization stage of the stator assembly. The stator windings 3028, 3028′, 3030 and 3030′ of each stator CS are energized synchronously based on a linear position of the plunger 3022. Thus, the stator windings of the first cylindrical stator FCS are synchronously driven and define a first stage of the stator assembly, the stator windings of the second cylindrical stator FCS are synchronously driven and define a second stage and the stator assembly, and the stator windings of the third cylindrical stator FCS are synchronously driven and define a third stage and the stator assembly.

It is noted, however, that this embodiment may be described in an alternative fashion, where the stator assembly includes a plurality of stators (e.g. four stators in this example) that extend linearly along the movement axis of the plunger 3022, where the stators cooperate and interlock one another to peripherally surround substantially all or at least a portion of the plunger 3022. Here, each stator is similar in structure and function to stators 18 and 20 of the first embodiment, except each stator includes a non-linear (e.g., arcuate) stator core structure. Specifically, each stator includes a plurality of stator windings located side-by-side along the movement axis of the plunger 3022, where the stator windings are sequentially and/or successively energized in an energization pattern based on the linear location of the plunger 3022. Thus, in the illustrated example, stator windings 3028 are considered as part of a first stator, stator windings 3028′ are considered as a part of a second stator, stator windings 3030 are considered as a part of a third stator, and stator windings 3030′ are considered as a part of a fourth stator. Provision of four stators, each extending an angular distance of approximately 90 degrees around the plunger, allows the stator assembly to peripherally surround the plunger 3022. Each stator includes a multi-phase construction, where the phases of the motor are controlled and selectively energized as needed to apply a repelling or attracting force to the plunger at any given time. In an embodiment, opposing stator windings 3028 and 3030 are energized using the same energization sequence, as they interact with the same magnetic polarity of the plunger. Similarly, stator windings 3028′ and 3030′ are energized using the same energization sequence.

In one embodiment, the stator assembly may include a plurality of (e.g., three) stators CS that are successively oriented along the movement axis of the plunger 3022 and parallel to the drive axis. In one embodiment, each of the stators CS may include a plurality of (e.g., four) non-linear (e.g., arcuate) stator core sections/structures. Each of the non-linear (e.g., arcuate) stator core sections/structures may cooperate and interlock with one another to peripherally surround substantially all or at least a portion of the plunger 3022. In one embodiment, the stator spacers may be disposed between each of the plurality of stators CS.

Each of the plurality of permanent magnets M″, M″₁-M″₃ may include a magnet ring including magnet segments having alternating polarities (e.g., N-S-N-S in this example) slid around the driver body 3029, or a plurality of discrete magnets having alternating polarities (e.g., N-S-N-S in this example) mounted on the driver body 3029. The permanent magnets M″, M″₁-M″₃ are arranged to magnetically interface with the plurality of stator windings 3028, 3028′, 3030 and 3030′ as the plunger linearly moved relative to the stator assembly. In the first energization pattern, the plurality of stator windings 3028, 3028′, 3030 and 3030′ of the first cylindrical stator FCS may be energized in alternating polarities corresponds to the polarities of the permanent magnets.

The stator may include a single-pole construction. The plurality of stator windings 3028, 3028′, 3030 and 3030′ of the first cylindrical stator FCS may be wound from a single magnet wire and in the same winding direction.

Each of the plurality of permanent magnets M″, M″₁-M″₃ may include at least a N-S magnetic polarity. The stator may include a multi-pole construction. The plurality of stator windings 3028, 3028′, 3030 and 3030′ of the first cylindrical stator FCS may be wound in at least two opposite winding directions.

An axial distance between the plurality of permanent magnets M″, M″₁-M″₃ may be smaller than an axial distance between the plurality of cylindrical stators FCS, SCS, TCS, and in an embodiment, approximately equal to ¾ of the axial distance between the plurality of cylindrical stators.

Each of the plurality of cylindrical stators FCS, SCS, TCS may be configured to be separated from adjacent cylindrical stators of the plurality of cylindrical stators FCS, SCS, TCS along the drive axis D-D. The motor assembly 3014 may further include a plurality of stator spacers SSP, SSP₁, SSP₂, SSP₃, SSP₄. Each of the plurality of stator spacers SSP, SSP₂, SSP₃ may be configured to separate adjacent cylindrical stators of the plurality of cylindrical stators FCS, SCS, TCS. Each of the plurality of stator spacers SSP, SSP₁, SSP₂, SSP₃, SSP₄ may comprises at least one of magnetic material, insulating material or non-magnetic material. Each of the plurality of stator spacers SSP, SSP₁, SSP₂, SSP₃, SSP₄ may be molded around at least one lead wire that supplies electric power to the plurality of stator windings 3028, 3028′, 3030 and 3030′ of at least one of the plurality of the cylindrical stators FCS, SCS, TCS. The stator spacers SSP, SSP₁, SSP₄ may be referred to the end members/spacers.

The motor assembly 3014 may further include a cylindrical outer housing 3051 that is configured to receive and fixedly support the plurality of stator spacers SSP, SSP₁, SSP₂, SSP₃, SSP₄ and the plurality of cylindrical stators FCS, SCS, TCS. An inner circumferential surface 3053 of the cylindrical outer housing 3051 may be configured to engage with outer circumferential surfaces 3055 of the plurality of stator spacers SSP, SSP₁, SSP₂, SSP₃, SSP₄ and the plurality of cylindrical stators FCS, SCS, TCS.

The motor assembly 3014 may further include a plurality of linearly oriented sensors 3151 that is configured to sense a linear position of the plunger 3022 as the plunger 3022 travels along the drive axis D-D. The plurality of linearly oriented sensors 3151 may be disposed on a circuit board PCB supported by inner circumferential surfaces 3049 of the stator cores of the plurality of cylindrical stators FCS, SCS, TCS (and inner circumferential surfaces 3049′ of the stator spacers SSP, SSP₁, SSP₂, SSP₃, SSP₄).

In an embodiment, the sensors 3151 may be optical sensors, including a set of optical transmitters arranged on a first PCB on one side of the plunger 3022, and a set of optical receivers arranged on a second PCB on an opposite side of the plunger 3022. As the plunger 3022 travels along the drive axis to a location where it is situated between an optical transmitter and its corresponding receiver, it disrupts the transmission of an optical beam between the transmitter and the receiver. Similarly, as the plunger 3022 moves past the optical transmitter and its corresponding receiver, transmission of the optical beam between the two is restored. Thus, the controller can determine an axial position of the plunger 3022 based on which of the optical receivers receive optical beams.

Alternatively, the sensors 3151 may include one or more Hall sensors arranged to detect a magnetic flux associated with the plunger 3022. The Hall sensors may magnetically interact directly with the permanent magnets M″, M″₁-M″₃, or with a sense magnet secured to the plunger 3022 or the driver 3016.

The fastener device may further include at least one controller C configured to control a commutation of the plurality of cylindrical stators FCS, SCS, TCS such that, during at least a position of the plunger 3022 relative to the plurality of cylindrical stators FCS, SCS, TCS, the plurality of stator windings 3028, 3028′, 3030 and 3030′ of the first cylindrical stator FCS applies a repelling force to the plunger 3022 while the plurality of stator windings 3028, 3028′, 3030 and 3030′ of the second cylindrical stator SCS applies an attracting force to the plunger 3022.

The plunger 3022 may be configured to be securely mounted on the driver 3016. The plunger 3022 may include a plurality of plunger spacers RS″, RS″₁, RS″₂, RS″₃, RS″₄. The plunger spacers RS″, RS″₁, RS″₂, RS″₃, RS″₄ may be made of non-magnetic material. The plunger spacers RS″, RS″₁, RS″₂, RS″₃, RS″₄ may include keying features KF″. The plunger spacers RS″, RS″₁, RS″₄ may be referred to the end members/spacers. Each of the plurality of plunger spacers RS″, RS″₂, RS″₃ may be configured to be disposed between the plurality of permanent magnets M″, M″₁-M″₃ and to separate adjacent of the plurality of permanent magnets M″, M″₁-M″₃.

Each of the plurality of plunger spacers RS″, RS″₁, RS″₂, RS″₃, RS″₄ and each of the plurality of permanent magnets M″, M″₁-M″₃ may include a ring-shaped configuration and may include a driver receiving opening DRO″ configured to securely receive the driver 3016 therein. As previously discussed, each of the plurality of permanent magnets M″, M″₁-M″₃ may discretely or integrally include a magnet ring including a plurality of magnetic poles or a plurality of arcuate magnet portions that cooperate with each other to form the permanent magnet M″, M″₁-M″₃. The permanent magnets M″, M″₁-M″₃ may have a surface mounted configuration in which magnets M″, M″₁-M″₃ may be mounted on a surface of a supporting frame member (e.g., lamination). The permanent magnets M″, M″₁-M″₃ may have an embedded mounted configuration in which the magnets M″, M″₁-M″₃ may be mounted in a magnet pocket formed in the supporting frame member. The plurality of arcuate magnet portions may include alternating polarities in sequence along the circumference of the permanent magnet M″, M″₁-M″₃.

The motor assembly 3014 may further include a cylindrical inner housing 3047 that is disposed radially between the plunger 3022 and the plurality of cylindrical stators FCS, SCS, TCS. The cylindrical inner housing 3047 may interchangeably referred to as a sleeve. The sleeve 3047 may be configured to replace the air gap between the plunger 3022 and the stator FCS, SCS, TCS in other embodiments. The inner housing 3047 may include non-magnetic, low friction material. The inner housing 3047 may be securely positioned relative to inner ends of the plurality of stator teeth 3032, 3032′, 3034, 3034′. The inner housing 3047 may be configured to receive and support the plurality of plunger spacers RS″, RS″₁, RS″₂, RS″₃, RS″₄ and the plurality of permanent magnets M″, M″₁-M″₃ therein.

The plurality of plunger spacers RS″ may include four plunger spacers RS″₁, RS″₂, RS″₃, RS″₄. The plurality of permanent magnets M″ may include three magnets M″₁-M″₃. The number of the plunger spacers RS″ and the permanent magnets M″ may vary. An inner circumferential surface of the inner housing 3047 may be configured to support outer circumferential surfaces of the plurality of permanent magnets M″, M″₁-M″₃ as the plurality of permanent magnets M″, M″₁-M″₃ travel along the drive axis D-D.

The inner housing 3047 may include longitudinal extending openings 3045 (one on each side) that are configured to enable passage of optical beams between optical sensor receiver and transmitter sets as the plunger 3022 travels along the drive axis D-D.

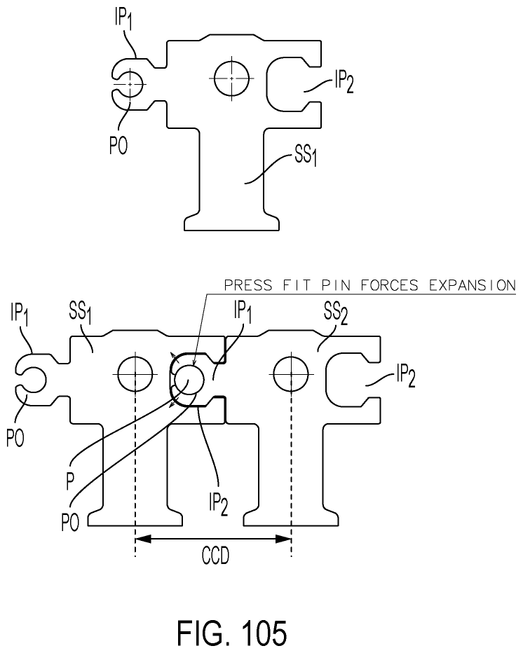

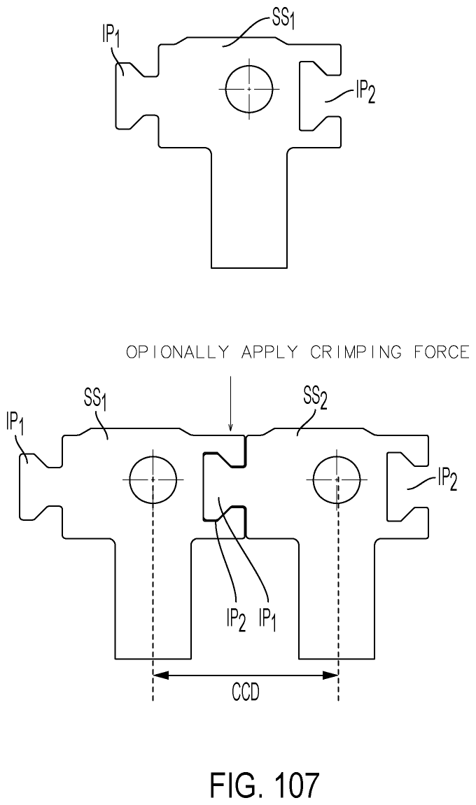

FIGS. 105-107 show different stator constructions. For example, a press fit stator construction is shown in FIG. 105. The stator segments SS1 and SS2 may be pressed (as shown in FIG. 105) or crimped (as shown in FIG. 107) together to form a part of the E-frame stator construction. As shown in various embodiments of the present disclosure, the E-frame stators 18, 20, 2018, 2020 may include three stator segments. The E-frame of the stator may include an E-shaped frame of the stator. Although only two stator segments are shown to be joined/connected to each other in FIGS. 105-107, the number of stator segments in each stator frame may vary. Instead of having a single lamination (with three integrally formed stator segments) stator design, a segmented stator design may be used as shown in FIGS. 105-107. The segmented design as shown in FIGS. 105-107 provides more flexibility for platforming. The winding process for each of these stator segments may also be easier. A single stator segment may be placed into the winder. The winder may wind the stator windings (to the desired width or desired slot fill) on to each of these stator segments.

Referring to FIG. 105, interengaging portion IP₁ of the stator segment SS₂ is first received in/interengaged with interengaging portion IP₂ of the stator segment SS₁. A pin P is then inserted/press fit through an opening PO of the interengaging portion IP₁ of the stator segment SS₂. The press fit pin P forces the expansion of the interengaging portion IP₁ in the interengaging portion IP₂. This causes interengagement and interlocking of the stator segments SS₁ and SS₂ to form a part of the stator construction.

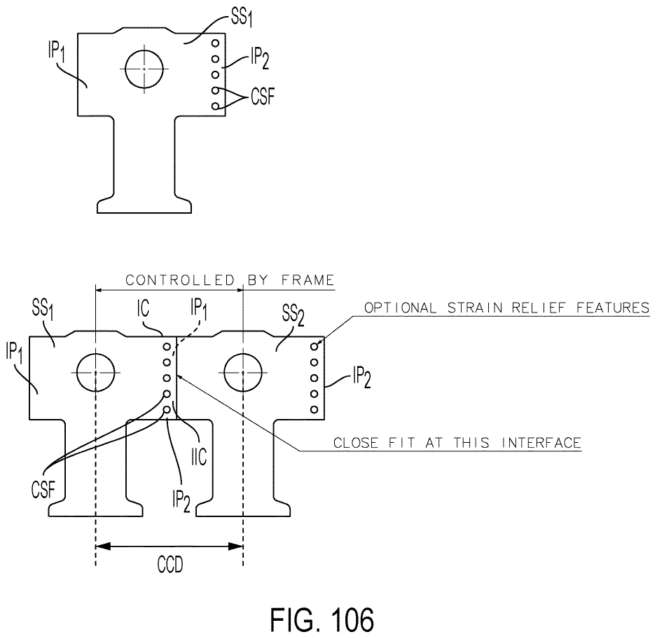

In FIG. 106, the stator segments SS₁ and SS₂ may be connected to each other to form the stator frame using crush or strain features CSF. Referring to FIG. 106, interengaging portion IP₁ of the stator segment SS₂ is first received in interengaging portion IP₂ of the stator segment SS₁. The diameter of the interengaging portion IP₂ may be greater than diameter of the interengaging portion IP₁. The interengaging portion IP₂ of the stator segment SS₁ may be configured to receive the interengaging portion IP₁ of the stator segment SS₂ therein. The crush or strain features CSF on the stator segment SS₁ at the interengaging connection IC between the stator segments SS₁ and SS₂ may then be used to form interengagement and interlocking connection IIC between the stator segments SS₁ and SS₂. This causes interengagement and interlocking of the stator segments SS₁ and SS₂ to form a part of the stator construction.

As shown in FIG. 107, when the stator segments SS₁ and SS₂ are crimped, the stator segments cannot include the tooth shoe feature. In such an embodiment, a bobbin would have to be used for holding the stator coils/windings.

The center-to-center distance between the stator segments SS₁ and SS₂ is shown in FIGS. 105-107 as CCD.

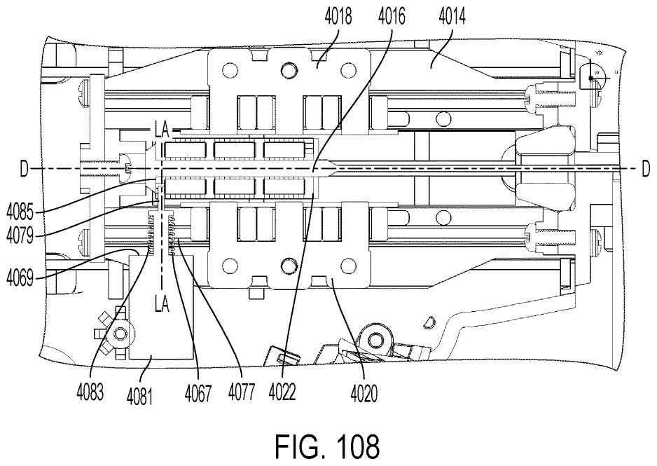

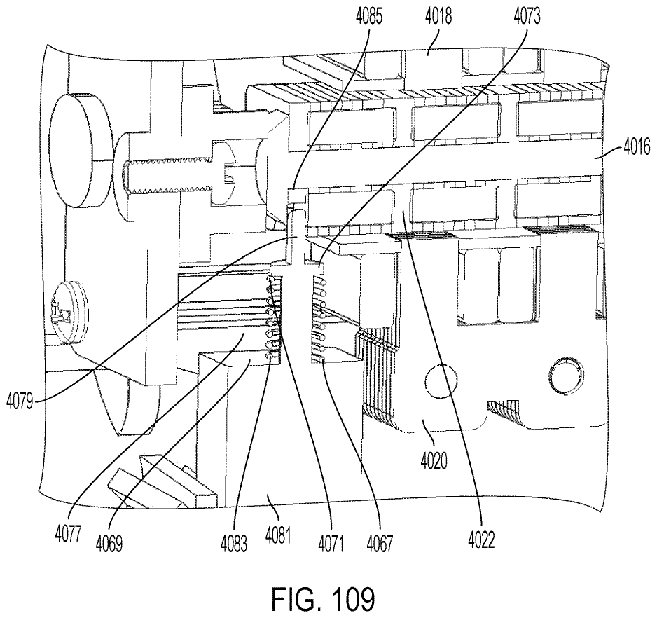

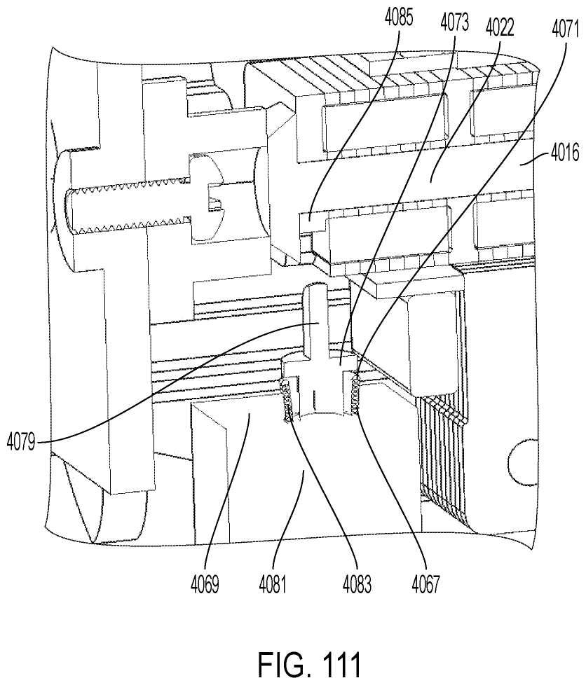

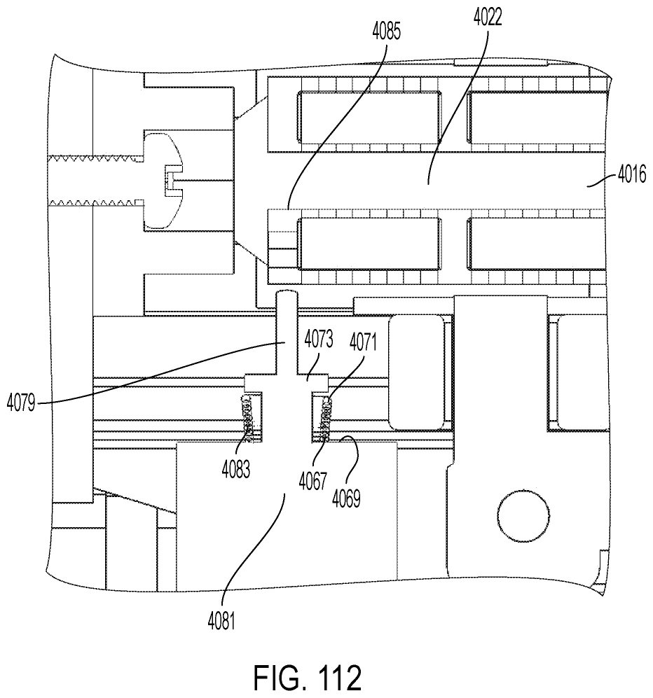

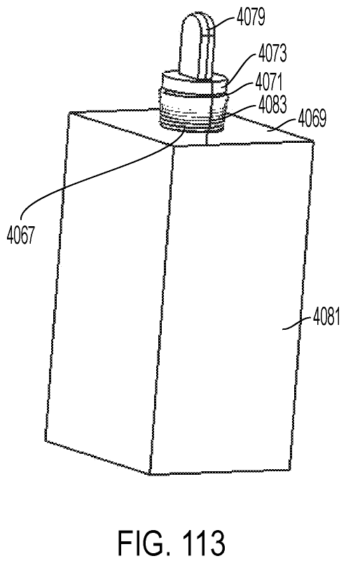

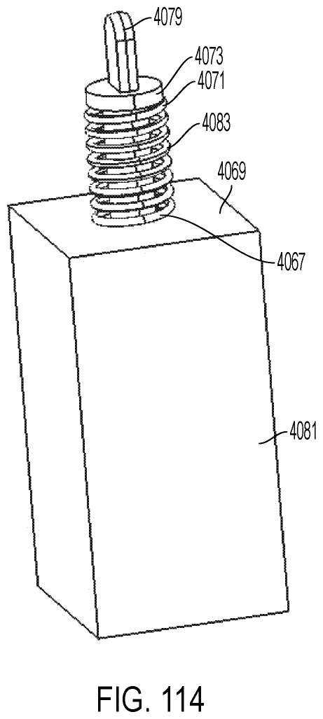

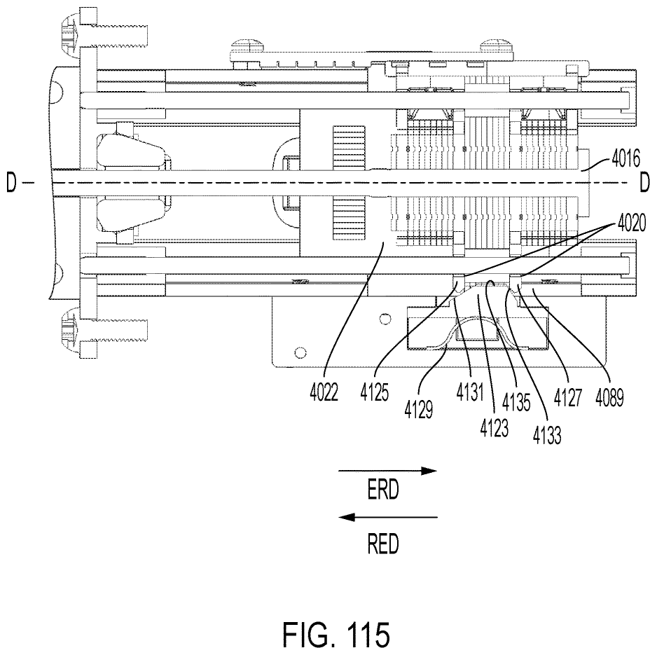

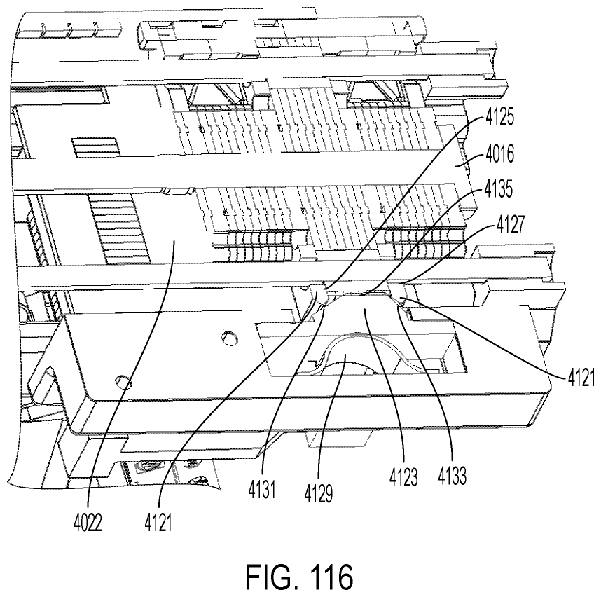

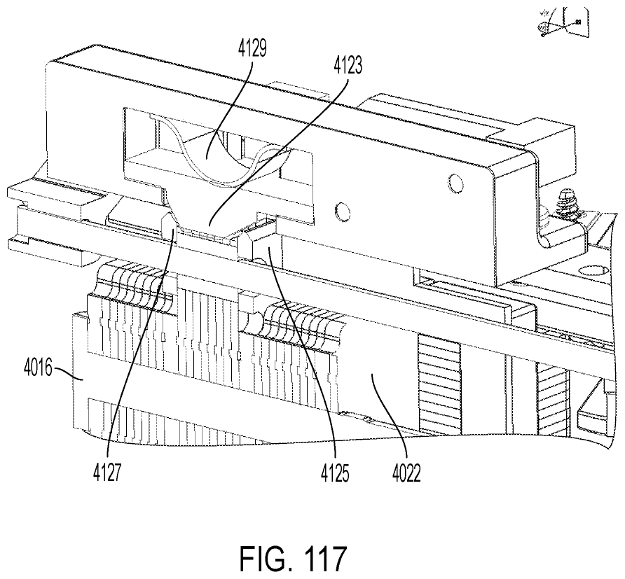

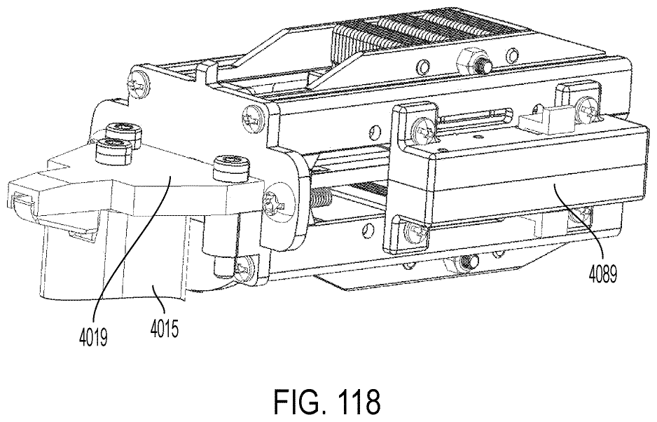

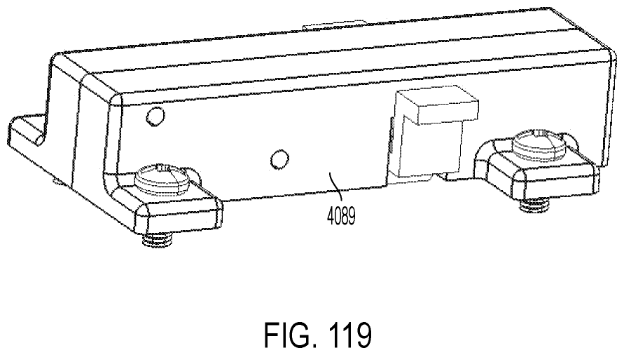

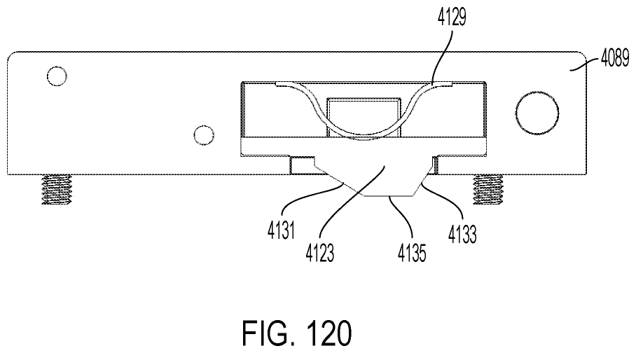

In one embodiment, as shown in FIGS. 108-120, the fastener device that drives one or more fasteners into a workpiece is provided. The fastener device comprises a tool housing, a motor assembly 4014 within the tool housing, a driver 4016 within the tool housing, and a lock 4077 (as shown in and described with respect to FIGS. 108-114) or lock 4089 (as shown in and described with respect to FIGS. 115-120). The motor assembly 4014 comprises a plunger 4022 and a stator 4018, 4020. The driver 4016 is configured to be drivable via the plunger 4022. The plunger 4022 is configured to travel along the drive axis D-D between a retracted position and an extended position to drive a fastener of the one or more fasteners into the workpiece during a drive stroke. The lock 4077 or the lock 4089 may be configured to releasably lock the plunger 4022 when the plunger 4022 is in the retracted position.

The plunger 4022 is shown in its retracted position in FIGS. 108-110. The plunger 4022 is configured to travel along the drive axis D-D and in one or more intermediate positions that are disposed between the retracted position and the extended position. The plunger 4022 may have a fully retracted position and a fully extended position in addition to the retracted position and the extended position. In one embodiment, the retracted position may be a fully retracted position and the extended position may be a fully extended position.

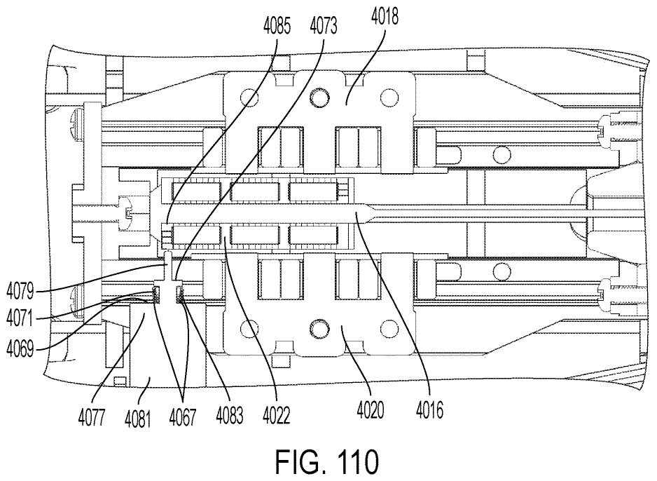

The lock 4077 comprises an electronically activated lock. The lock 4077 includes a lock position and an unlock/a release position. The lock 4077 is shown in its lock position in FIGS. 108-109 and 114, while the lock 4077 is shown in its unlocked position in FIGS. 110-113.

The fastener device further may comprise the controller C that is configured to cause the electronically activated lock 4077 to release the plunger 4022 from the retracted position approximately at or within a predetermined time period before or after the stator 4018, 4020 being energized to drive the plunger 4022.

The electronically activated lock 4077 may comprise a spring biased and solenoid actuated lock member 4079. The lock member 4079 may be moveable along an axis LA-LA that is substantially perpendicular to the drive axis D-D to engage with or disengage from the plunger 4022.

The fastener device may further include a solenoid 4081 that drives the lock member 4079 The fastener device may further comprise a biasing member 4083 that biases the lock member 4079 to hold the plunger 4022 in the retracted position. The lock member 4079 is biased by the biasing member 4083 to engage with the recess 4085 when the plunger 4022 is in its retracted position. When the solenoid 4081 is activated, as shown in FIGS. 110-113, the lock member 4079 is retracted against the bias of the biasing member 4083 so as to release the lock member 4079 from the recess 4085. As shown in FIGS. 110-113, the biasing member 4083 is in its compressed state/configuration. As shown in 108-109 and 114, the biasing member 4083 is in its expanded state/configuration. The biasing member 4083 may be a spring. A first end 4071 of the biasing member 4083 may be configured to be in engagement with a flange portion 4073 of the lock portion 4079. An opposing, second end 4067 of the biasing member 4083 may be configured to be in engagement with portions 4069 of the solenoid housing.

The plunger 4022 may be disengaged from the retracted position when an electromagnetic force applied by the stator 4018, 4020 to the plunger 4022 exceeds a threshold at a biasing force of the biasing member 4083 applied to the lock member 4079 is overcome.

The retracted position of the plunger 4022 may be a home position of the plunger 4022. The lock 4079 may include a first lock portion and a second lock portion that are configured to engage with each other to releasably lock the plunger 4022 when the plunger 4022 is in its retracted position. The first lock portion may include the lock member 4079. The second lock portion may include the recess 4085 formed in the driver 4016/plunger 4022. The recess 4085 may be configured to receive the lock member 4079 when the plunger 4022 is in the retracted position.

The driver 4016 may include a forward driver end that is configured to engage with the fastener of one or more fasteners so as to drive the fastener into the workpiece during the drive stroke and a rearward driver end. The rearward driver end of the driver 4016 may form the second lock portion (or the recess 4085 that is configured to receive the lock member 4079 when the plunger 4022 is in the retracted position).

In another embodiment, the solenoid may be optional. In such an embodiment, the second lock portion may include a chamfered portion that is configured to enable the plunger 4022 to slide past the lock member 4079, as the plunger 4022 is being moved to its retracted position, so that the lock member 4079 is received in the recess 4085 when the plunger 4022 is in its retracted position. That is, in this embodiment, a passive engagement between the lock member 4079 and the recess 4085 is provided (e.g., no power to the solenoid).

In one embodiment, the solenoid may include a solenoid pin. The lock member 4079 may formed as an extension of the solenoid pin. The solenoid may drive the solenoid pin and the lock member may in turn be driven by the solenoid.

Referring to FIGS. 115-120, the lock 4089 may be configured to releasably lock the plunger 4022 when the plunger 4022 is in the retracted position. The retraction position of the plunger 4022 may be a home position of the plunger 4022. The lock 4089 includes a first lock portion 4121 and a second lock portion 4123 that are configured to engage with each other to releasably lock the plunger 4022 when the plunger 4022 is in its retracted position. The first lock portion 4121 includes two protruding members 4125, 4127 that are disposed on the plunger 4022 and that extend towards the second lock portion 4123.

The second lock portion 4123 includes a biasing member 4129 that is configured to bias the second lock portion 4123 towards the first lock portion 4121. The second lock portion 4123 also includes a first angled surface portion 4131, a second angled surface portion 4133, and a flat surface portion 4135 between the first and second angled surface portions 4131, 4133. The flat surface portion 4135 extends in a plane parallel the drive axis D-D. The first and second angled surface portions 4131, 4133 are configured to be angled with respect to the drive axis D-D.

A first 4125 of the two protruding members 4125, 4127 of the plunger 4022 is configured to engage with the first angled surface portion 4131 and a second 4127 of the two protruding members 4125, 4127 of the plunger 4022 is configured to engage with the second angled surface portion 4133 to releasably lock the plunger 4022 when the plunger 4022 is in its retracted position.

An angle of the first angled surface portion 4131 may be different from an angle of the second angled surface portion 4133. The angle of the second angled surface portion 4133 may be greater than the angle of the first angle surface portion 4131. The second angled surface portion 4133 may include a steeper slope than the first angle surface portion 4131.

As the plunger 4022 is being moved from its extended position to its retracted position (e.g., in the direction ERD as shown in FIG. 115), the second 4127 of the two protruding members 4125, 4127 is first configured to engage with the first angled surface portion 4131 and a first force is applied to the plunger 4022 to move the second 4127 of the two protruding members 4125, 4127 past the first angled surface portion 4131. As the plunger 4022 is being moved from its retracted position to its extended position (e.g., in the direction RED as shown in FIG. 115), a second force is applied to the plunger 4022 to move the second 4127 of the two protruding members 4125, 4127 past the second angled surface portion 4133. The second force may be greater than or equal to the first force. The second force is greater than a spring biasing force that biases the second lock portion 4123 towards the first lock portion 4121.

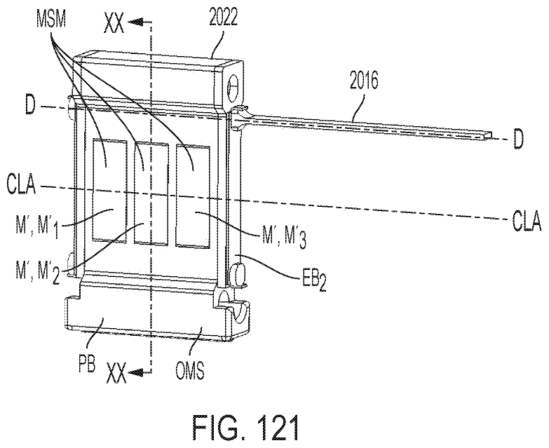

In one embodiment, referring to FIGS. 79-90, 121-124 and 125-128, a fastener device 2010 that drives one or more fasteners into a workpiece is provided. The fastener device 2010 comprises a housing 2012 and a motor assembly 2014 within the housing 2012. The motor assembly 2014 comprises a stator 2018, 2020 supporting a plurality of stator windings 2028, 2030, and a plunger 2022 including one or more permanent magnets M′, M′₁, M′₂, M′₃ that magnetically interact with the plurality of stator windings 2028, 2030 to cause linear movement of the plunger 2022 along a longitudinal axis CLA-CLA. The embodiments described in FIGS. 121-124 and 125-128 are similar to the embodiment described in FIGS. 79-90 except for the differences discussed in detail below.

Referring to FIGS. 121-124 and 125-128, the plunger 2022 comprises an overmold structure OMS that is configured to hold/secure the one or more permanent magnets M′, M′₁, M′₂, M′₃ in place during the linear movement of the plunger 2022 along the longitudinal axis CLA-CLA.

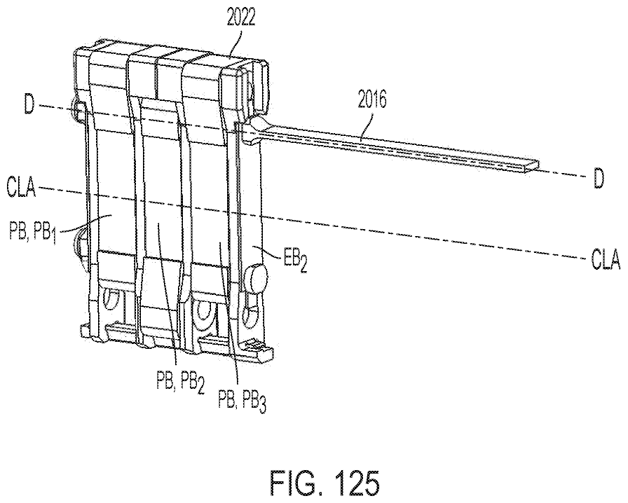

Referring to FIGS. 121-124 and 125-128, the linear motor may have same bearing(s), same driver, and same magnet parts/components as the offset laminated plunger shown in FIGS. 79-90 but the plunger shown in FIGS. 121-124 and 125-128 includes an insert molded construction. The permanent magnets of the plunger may be sandwiched by steel sheets (referred to as magnet support members MSM in the discussions below). The steel sheets with the permanent magnets of the plunger sandwiched therebetween are then insert molded into a plastic plunger body. The bearings may also be insert molded into the plunger body. In another embodiment, the bearings may not be insert molded into the plunger body but the bearings may be inserted into the plunger body later. This design could provide significant weight savings that could have also performance benefits. FIGS. 125-128 show similar concept as the insert molded construction of FIGS. 121-124. In FIGS. 125-128, the magnets are molded into (e.g., three) separate plunger cores/bodies instead of a single plunger body of FIGS. 121-124. Parts/components are assembled in the same way as the laminated offset plunger design as shown in and described with respect to FIGS. 79-90. This design in FIGS. 125-128 has less weight than the laminated design of FIGS. 79-90 and may have manufacturing advantages over the full plunger insert molded design of FIGS. 121-124.

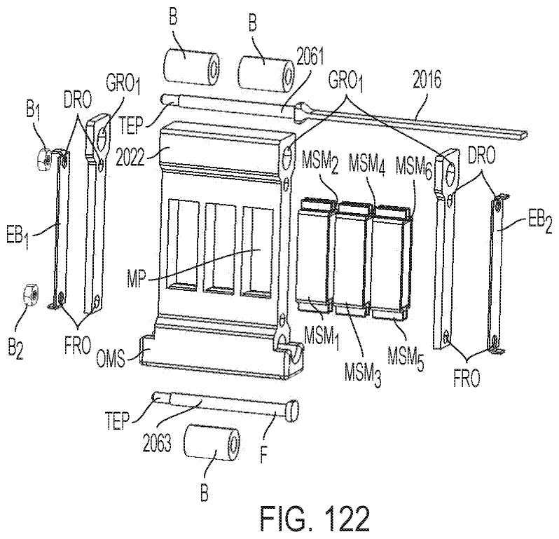

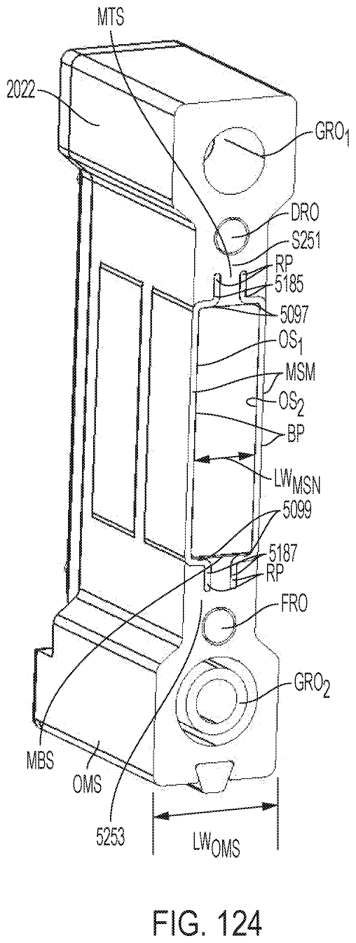

The overmold structure OMS may comprise at least a plunger body PB. As shown in FIGS. 122 and 124, the fastener device 2010 may further comprise at least two magnet support members MSM, MSM₁₋₆ provided in engagement with opposite surfaces OS₁, OS₂ of the one or more permanent magnets M′, M′₁, M′₂, M′₃. For example, as shown in FIG. 122, the two magnet support members MSM₁, MSM₂ are provided in engagement with opposite surfaces OS₁, OS₂ of the permanent magnets M′, M′₁; the two magnet support members MSM₃, MSM₄ are provided in engagement with opposite surfaces OS₁, OS₂ of the permanent magnets M′, M′₂; and the two magnet support members MSM₅, MSM₆ are provided in engagement with opposite surfaces OS₁, OS₂ of the permanent magnets M′, M′₃. The magnet support members may interchangeably referred to as metal clips, magnet retainers, magnet supports, or magnet retainer members.

Each magnet support member MSM may include a body portion BP in contact with the one or more permanent magnets M′, M′₁, M′₂, M′₃ and a retaining portion RP that is captured by the overmold structure OMS to secure the one or more permanent magnets M′, M′₁, M′₂, M′₃ relative to the overmold structure OMS. The retaining portion RP may interchangeably referred to as connector portion/retention features.

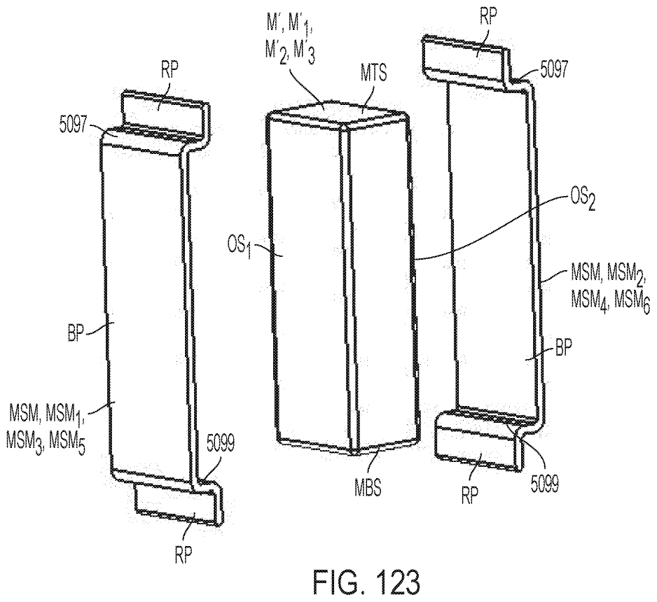

As shown in FIGS. 123 and 124, the at least two magnet support members MSM may be disposed on opposing sides of one of the one or more permanent magnets M′, M′₁, M′₂, M′₃ such that the body portion BP of each magnet support member MSM engages with the outer side surfaces OS₁, OS₂ of one of the one or more permanent magnets M′, M′₁, M′₂, M′₃ and the retaining portion RP of each magnet support member MSM engages with the at least portions of the top surface MTS and the bottom surface MBS of the one or more permanent magnets M′, M′₁, M′₂, M′₃. For example, portions 5097, 5099 of the retaining portion RP of each magnet support member MSM engages with the at least portions of the top surface MTS and the bottom surface MBS of the one or more permanent magnets M′, M′₁, M′₂, M′₃.

As shown in FIGS. 123 and 124, the retaining portion RP of each magnet support member MSM may include two angular lip portions 5185, 5187 projecting from ends of the body portion BP. For example, the angular lip portions 5185, 5187 may include L-shaped configuration. The angular lip portion 5185 may extend from a top end of the body portion BP of each magnet support member MSM and the angular lip portion 5187 may extend from a bottom end of the body portion BP of each magnet support member MSM.

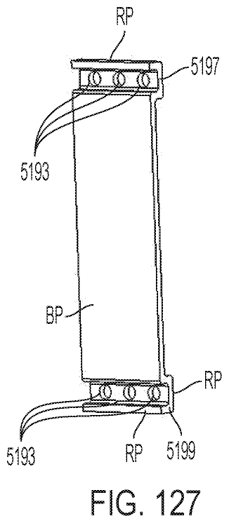

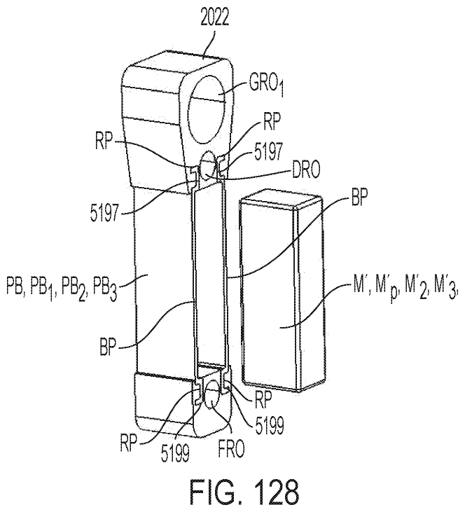

As shown in FIGS. 127 and 128, the retaining portion RP of each magnet support member MSM may include two substantially U-shaped members 5197, 5199 that project over at least portions of the top surface MTS and the bottom surface MBS of the one or more permanent magnets M′, M′₁, M′₂, M′₃. As shown in FIG. 127, the bight portions of the U-shaped members 5197, 5199 may include openings 5193 that are configured to allow the overmold material to pass therethrough to facilitate the retaining portion RP to be captured by the overmold structure OMS.

The substantially U-shaped members 5197 may project over at least portions of the top surface MTS of the one or more permanent magnets M′, M′₁, M′₂, M′₃ and the substantially U-shaped members 5199 may project over at least portions of the bottom surface MBS of the one or more permanent magnets M′, M′₁, M′₂, M′₃.

In an aspect, one of the one or more permanent magnets M′, M′₁, M′₂, M′₃ and the at least two magnet support members MSM surrounding/sandwiching portions of one of the one or more permanent magnets M′, M′₁, M′₂, M′₃ may be configured to be insert molded into the plunger body PB so as to form the overmold structure. In one embodiment, the body portions BP connect to the magnet M′, M′₁, M′₂, M′₃, the connector portion/retention features RP engage into the overmold structure.

The plunger body PB may be made of a plastic material and each magnet support member MSM may be made of a metal material.

Each magnet support member MSM may be exposed and substantially uncovered by the overmold structure OSM alongside the one or more permanent magnets M′, M′₁, M′₂, M′₃ facing the stator 2018, 2020 (as shown in FIGS. 79-90).

The body portions BP of the magnet support members MSM may be disposed in planes that are parallel to each other and are parallel to a plane formed by the plurality of stator windings 2028, 2030 (as shown in FIGS. 79-90).

As shown in FIG. 124, a lateral width LW_{OMS} of the overmold structure OMS may be greater than a lateral width LM_{MSM} defined between outer surfaces of the two magnet support members MSM.

As shown in FIG. 124, the overmold structure OSM may comprise two discrete portions 5251, 5253 each engaging one end of the magnet support members MSM.

The fastener device 2010 may further comprise the driver 2016 within the housing 2012. The driver 2016 may be configured to be drivable axially/longitudinally via the plunger 2022. The housing 2012 may include the top end portion 2057. The driver 2016 may be disposed closer to the top end portion 2057 of the housing 2012.

The linear movement of the plunger 2022 along the longitudinal axis CLA-CLA may drive the driver 2016 along the drive axis D-D that is offset from but parallel to the longitudinal axis CLA-CLA.

The at least a plunger body PB may include the fastener receiving opening FRO that is configured to securely receive the fastener F, and at least one guide rod receiving opening GRO₁, GRO₂ that is configured to receive a guide rod GR therethrough to enable the plunger 2022 to slide along a length of the guide rod GR so as to maintain an air gap between the plunger 2022 and the stator 2018, 2022.

The at least one guide rod receiving opening GRO₁, GRO₂ may include two guide rod receiving openings GRO₁, GRO₂. One of the two guide rod receiving openings GRO₁, GRO₂ may be configured to disposed on a top end portion of the housing 2012 and the other of the two guide rod receiving openings GRO₁, GRO₂ may be configured to disposed on a bottom end portion of the housing 2012.

The plunger body PB may include a guide rod receiving member B that is configured to be received in the at least one guide rod receiving opening GRO₁, GRO₂. The guide rod receiving member GRO₁, GRO₂ may also be configured to receive the guide rod GR therethrough. The guide rod receiving member B may be a linear bearing or bushing B. The guide rod receiving member B may be configured to be insert molded into the at least one guide rod receiving opening GRO₁, GRO₂ of the plunger body PB.

The longitudinal axis CLA-CLA may be a center longitudinal axis CLA-CLA. The plunger body PB may comprise a magnet pocket MP through which the center longitudinal axis CLA-CLA passes and in which the at least two magnet support members MSM along with one of the one or more permanent magnets M′, M′₁, M′₂, M′₃ therebetween are insert molded, and a driver receiving opening DRO through which the driver 2016 is securely received so that the linear movement of the plunger 2022 along the center longitudinal axis CLA-CLA drives the driver 2016 along the drive axis D-D that is offset from but parallel to the center longitudinal axis CLA-CLA.

Referring to FIGS. 125, 126, and 128, the overmold structure OMS may comprise two or more plunger bodies PB₁, PB₂, PB₃.

The two or more plunger bodies may include a first plunger body and a second plunger body. The first plunger body and the second plunger body (e.g., PB₁ and PB₂ or PB₂ and PB₃) may be adjacent to each other. A magnet pocket MP of the first plunger body PB₁ may be substantially aligned with a magnet pocket MP of the second plunger body PB₂. A magnet pocket MP of the first plunger body PB₂ may be substantially aligned with a magnet pocket MP of the second plunger body PB₃. The fastener may be configured to connect the first plunger body and the second plunger body to each other. The driver may also be configured to connect the first plunger body and the second plunger body to each other. The driver receiving opening DRO and the fastener receiving opening FRO may be configured to be interchangeably used such that the one of the driver receiving opening DRO and the fastener receiving opening FRO is configured to securely receive the driver 2016 and the other of the driver receiving opening DRO and the fastener receiving opening FRO is configured to securely receive the fastener F. Some of these features are discussed in detail in the embodiment as shown in FIGS. 79-90.

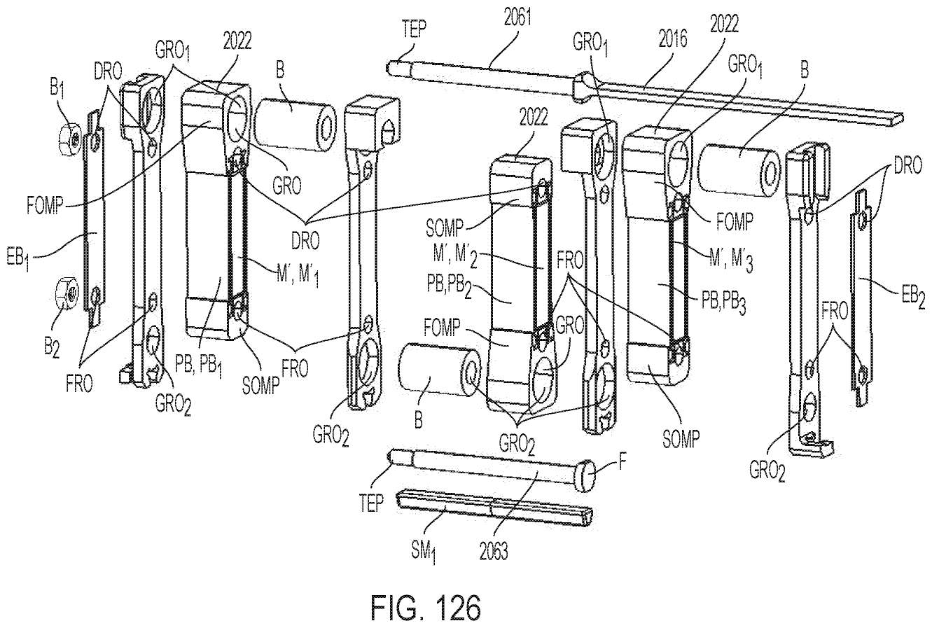

As shown in FIG. 126, the overmold structure OMS may comprise two or more plunger bodies PB₁, PB₂, PB₃ each associated with a corresponding permanent magnet M′₁, M′₂, M′₃ of the one or more permanent magnets. Each plunger body PB₁, PB₂, PB₃ may include a first overmold portion FOMP securing a first end of the corresponding permanent magnet M′₁, M′₂, M′₃ and a second overmold portion SOMP securing a second end of the corresponding permanent magnet M′₁, M′₂, M′₃. The first overmold portion FOMP may include a guide rod receiving opening GRO and the second overmold portion SOMP is smaller than the first overmold portion FOMP and does not include a guide rod receiving opening GRO. The one or more permanent magnets may be substantially aligned with one another, but the first overmold portion FOMP of a first PB₁ of the plunger bodies is not aligned with the first overmold portion FOMP of a second PB₂ of the plunger bodies. Similarly, the first overmold portion FOMP of a first PB₂ of the plunger bodies is not aligned with the first overmold portion FOMP of a second PB₃ of the plunger bodies.

Referring to FIGS. 125-128, in yet another embodiment, a linear motor is provided. The linear motor comprises a plunger 2022 and a stator 2018, 2022 in magnetic interface with the plunger 2022. The stator 2018, 2022 supports a plurality of stator windings 2028, 2030. The plunger 2022 comprises at least one permanent magnet M′, M′₁, M′₂, M′₃ that magnetically interacts with the plurality of stator windings 2028, 2030 to cause linear movement of the plunger 2022 along a longitudinal axis CLA-CLA. The plunger 2022 comprises an overmold structure OMS that is configured to hold the at least one permanent magnet M′, M′₁, M′₂, M′₃ in place during the linear movement of the plunger 2022 along the longitudinal axis CLA-CLA.

In yet another embodiment, a linear motor 6014 is provided. The linear motor 6014 comprises a frame 6044, a plunger 6022 including one or more permanent magnets M configured to travel along a drive axis D-D, and at least one stator 6018, 6020 disposed on one side of the plunger 6022 and in magnetic interface with the plunger 6022. The at least one stator 6018, 6020 includes a plurality of stator segments 6024, 6024′, 6026 and a spacer 6167, 6169 disposed between the plurality of stator segments 6024, 6024′, 6026. Each of the spacer 6167, 6169 and the stator segment 6024, 6024′, 6026 includes one or more first engagement portions 6171. The frame 6044 comprises one or more second engagement portions 6173 that correspond to the one or more first engagement portions 6171 of the at least one stator 6018, 6020. The one or more second engagement portions 6173 of the frame 6044 are configured to engage with the one or more first engagements portions 6171 of the at least one stator 6018, 6020 to support the at least one stator 6018, 6020 on the frame 6044.

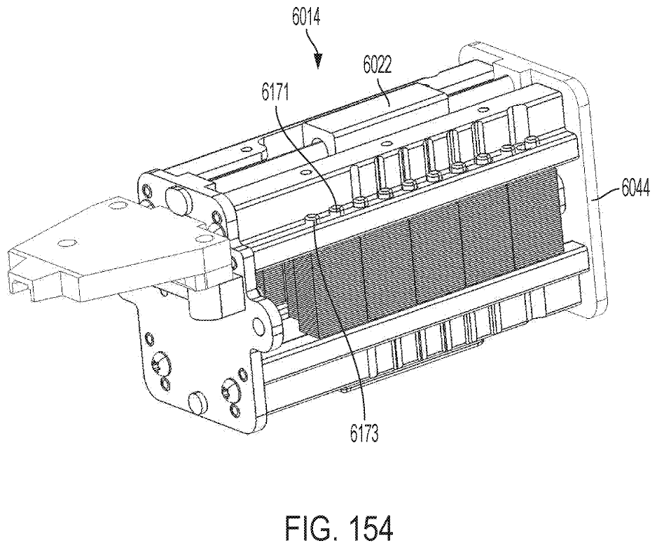

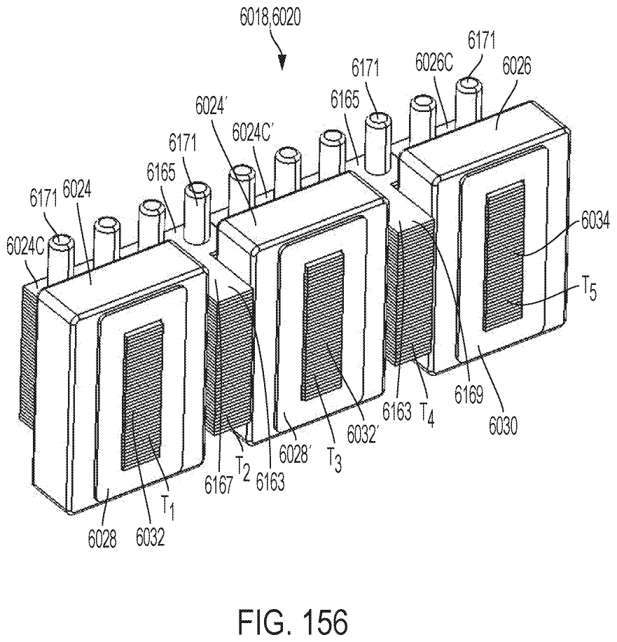

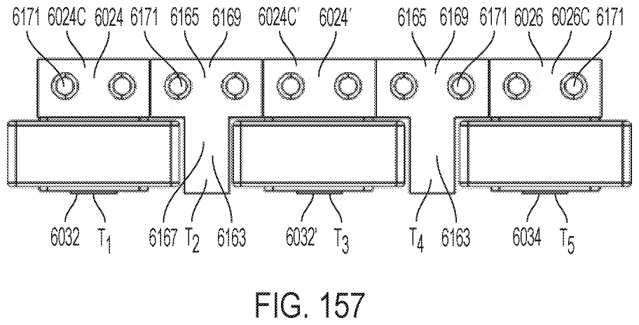

The design in FIGS. 154-157 shows a five tooth (e.g., T₁-T₅) segmented stator with three wound coils (e.g., T₁, T₃, and T₅) and two unwound teeth. This takes advantage of the extra steel while maintaining the three wound coils layout. This design could also be done with a seven tooth segmented stator with three wound coils and four unwound teeth. For example, seven teeth segmented stator configuration with three wound coils and four unwound teeth may have 0101010 (where 1 is a wound tooth, 0 is an unwound spacer tooth).

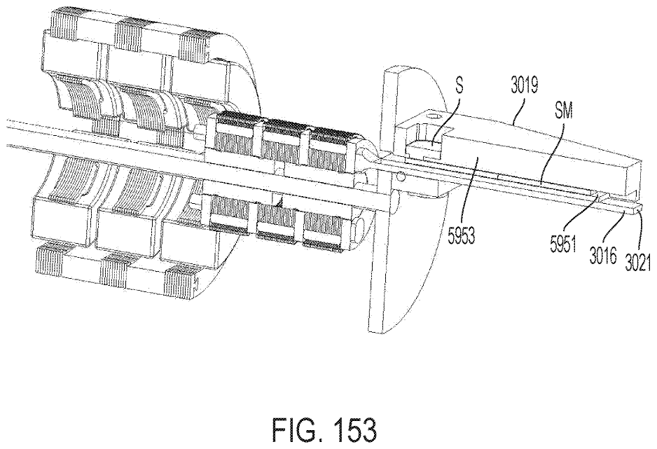

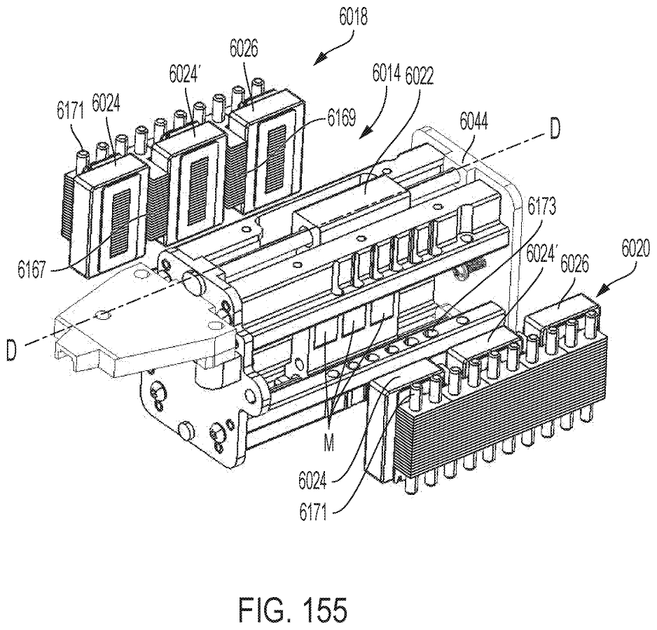

As shown in FIGS. 153-157, the one or more first engagement portions 6171 of the at least one stator 6018, 6020 may be spaced apart and equidistant from each other. As shown in FIGS. 154-155, the one or more second engagement portions 6173 of the frame 6044 may be spaced apart and equidistant from each other.

As shown in FIGS. 153-157, the one or more first engagement portions 6171 of the at least one stator 6018, 6020 may include pin members 6171. As shown in FIGS. 154-155, the one or more second engagement portions 6173 of the frame 6044 may include openings 6173 that are configured to receive the pin members 6171.

In another embodiment, the one or more first engagement portions 6171 of the at least one stator 6018, 6020 may include openings that are configured to receive pin members on the frame 6044.

Each of the spacers 6167, 6169 may include a spacer core 6165 and a spacer tooth 6163 extending from the spacer core 6165 towards the plunger 6022. Each of the plurality of stator segments 6024, 6024′, 6026 may include a stator core 6024C, 6024C′, 6026C, a stator tooth 6032, 6032′, 6034 extending from the stator core 6024C, 6024C′, 6026C towards the plunger 6022, and a stator winding 6028, 6028′, 6030 wound around the stator segment tooth 6032, 6032′, 6034.

The size and shape of the spacer core 6165 may be the same as the size and shape of the stator core 6024C, 6024C′, 6026C.

The stator windings 6028, 6028′, 6030 of adjacent stator segments 6024, 6024′, 6026 are separated from each other by the spacer tooth 6163.

The plurality of stator segments 6024, 6024′, 6026 may include three stator segments 6024, 6024′, 6026 and the spacer may include one of two spacers 6167, 6169.

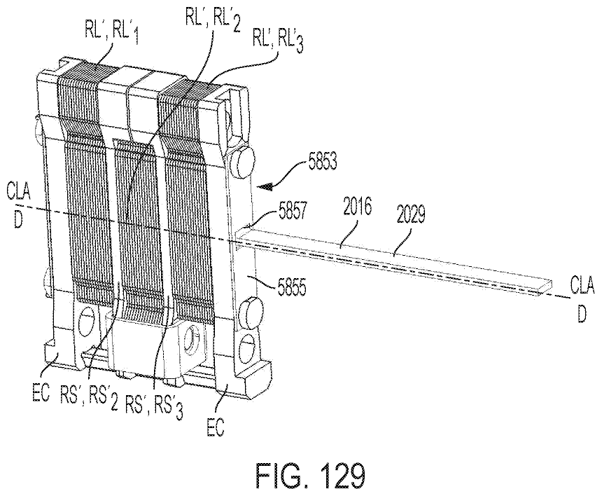

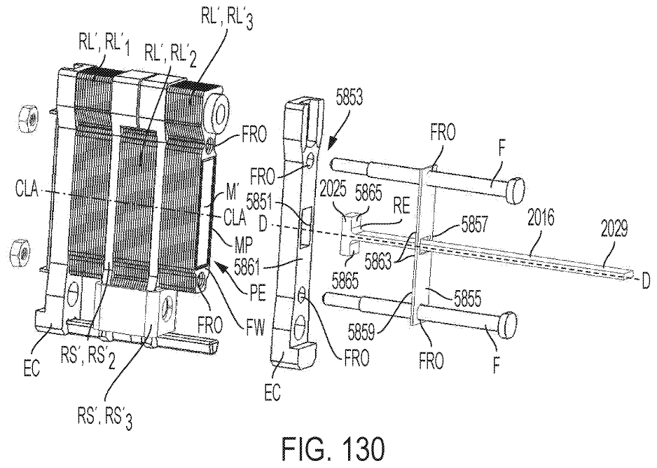

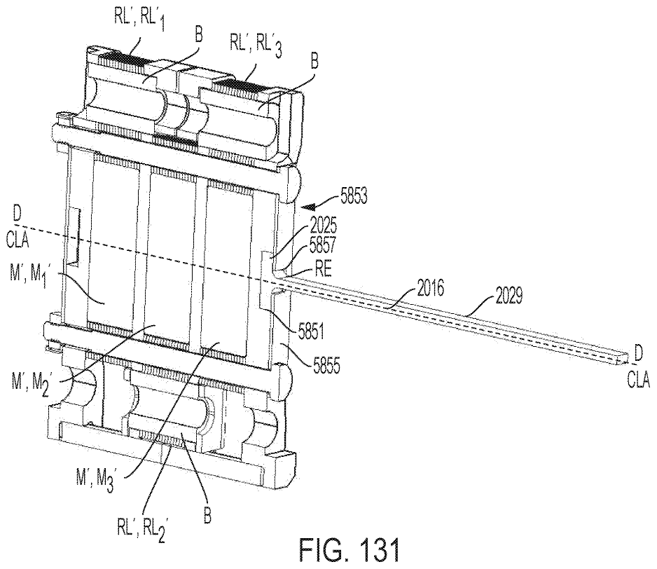

FIGS. 129-131 show an alternate driver blade arrangement design for the plunger. Instead of the driver being integrated into the shoulder screws, the driver may be captured within a pocket of the front spacer by the front steel sheet. That is, the head (e.g., T-head) of the driver may be captured in an end cap. In another embodiment, the head of the driver may be captured in a pocket that is disposed in one of the plurality of overmolded plunger bodies or in a single overmolded plunger body. In such an embodiment, the driver received in the pocket may be retained by the front steel sheet.

The driver may have an offset configuration with respect to the plunger or the driver may be centered with respect the plunger. Everything in the plunger may be fastened together by the shoulder screws. The driver blade may be positioned directly in line with the center of gravity that would lessen the eccentric loading of the linear bearings during a drive event.

In one embodiment, as shown FIGS. 79-90 and 129-131 a fastener device 2010 that drives one or more fasteners into a workpiece is provided. The fastener device 2010 comprises a housing 2012, a motor assembly 2014 within the housing 2012, and a driver 2016 within the housing 2012. The motor assembly 2014 comprises a stator 2018, 2020 supporting a plurality of stator windings 2028, 2030, and a plunger 2022 comprising at least a plunger core RL′, RL′₁, RL′₂, and RL′₃ comprising a magnet pocket MP through which a longitudinal axis CLA—CLA passes and within which at least one permanent magnet M′, M′₁, M′₂, M′₃ is securely housed. The at least one permanent magnet M′, M′₁, M′₂, M′₃ magnetically interacts with the plurality of stator windings 2028, 2030 to cause linear movement of the plunger 2022 along the longitudinal axis CLA—CLA. The driver 2016 is driveably coupled to the plunger 2022 and is configured to drive the one or more fasteners into the workpiece with movement by the driver 2016 along a drive axis D-D. The embodiment described in FIGS. 129-131 is similar to the embodiment described in FIGS. 79-90 except for the differences discussed in detail below.

The drive axis D-D is the same as the longitudinal axis CLA-CLA as shown in FIGS. 129-131. In another embodiment, the drive axis D-D may be parallel to the longitudinal axis CLA-CLA (e.g., as shown in FIGS. 79-90). The driver 2016 is securely coupled to an end PE of the plunger 2022 and the driver 2016 is configured not to longitudinally extend through the at least the plunger core RL′, RL′₁, RL′₂, and RL′₃.

The plunger 2022 may include an end cap EC mounted to the end PE thereof adjacent a longitudinal end of the at least one plunger core RL′, RL′₃. The driver 2016 may include a head 2025 extending perpendicularly from a rear end RE thereof. The end-cap EC may include a driver head opening 5851 that is configured to securely receive the head 2025 therein. The driver head opening 5851 of the end-cap EC may be configured to receive at least a portion of the head 2025 of the driver 2016 therein. The end-cap EC may be interchangeably referred to as a front end-cap. In one embodiment, the driver head opening 5851 may be disposed in an offset configuration (with respect to the central longitudinal axis CLA-CLA of the plunger 2022) on the front end-cap EC. In another embodiment, the driver head opening 5851 may be disposed centrally (at a central location/position) on the front end-cap EC.

The at least a plunger core RL′, RL′₁, RL′₂, and RL′₃ may include a plurality of plunger cores RL′, RL′₁, RL′₂, and RL′₃ including a front plunger core RL′, RL′₃, a rear plunger core RL′, RL′₁ and one or more plunger cores RL′, RL′₂ therebetween. The plurality of plunger cores RL′, RL′₁, RL′₂, and RL′₃ may be separated from each other by a plunger spacer RS′, RS′₂, RS′₃. The end cap EC of the plunger 2022 may be configured to be attached to a front wall FW of the front plunger core RL′, RL′₃. The end-cap EC may be oriented substantially along a plane that is perpendicular to the longitudinal axis CLA-CLA.

The plunger 2022 may include a driver support assembly 5853 that is configured to support the driver 2016. The driver support assembly 5853 may include the front end-cap EC.

The driver support assembly 5853 may also include a driver retention member 5855. The driver retention member 5855 may be made of steel material and may include sheet steel member/plate 5855. The driver retention member 5855 may include a driver body opening 5857 that is configured to receive and allow a body 2029 of the driver 2016 to pass therethrough. A rear wall 5859 of the driver retention member 5855 may be configured to engage with a front wall 5861 of the front end cap EC when the driver retention member 5855 is connected to the front end cap EC. Portions 5863 of the rear wall 5859 of the driver retention member 5855 that surround the driver body opening 5857 are configured to engage with portions 5865 of the head 2025 of the driver 2016 received in the driver head opening 5851 when the driver retention member 5855 is connected to the front end-cap EC. The driver retention member 5855 may also include two fastener receiving openings FRO that are configured to securely receive fasteners F therein. Each fastener F may be configured extend axially/longitudinally through the plunger cores RL′, RL′₁, RL′₂, and RL′₃ to connect the plunger cores RL′, RL′₁, RL′₂, and RL′₃ to each other. One of the two fastener receiving openings FRO of the driver retention member 5855 may be disposed on one side of the driver 2016 and the other of the two fastener receiving openings FRO of the driver retention member 2855 is disposed on the other side of the driver 2016. The end cap EC may also include two fastener receiving openings FRO and each of the plunger cores RL′, RL′₁, RL′₂, and RL′₃ may also include two fastener receiving openings FRO. The fastener receiving openings FRO of the end cap EC and the fastener receiving openings FRO of each of the plunger cores RL′, RL′₁, RL′₂, and RL′₃ align with fastener receiving openings FRO of the driver retention member 5855 so as to receive the fasteners F therethrough.

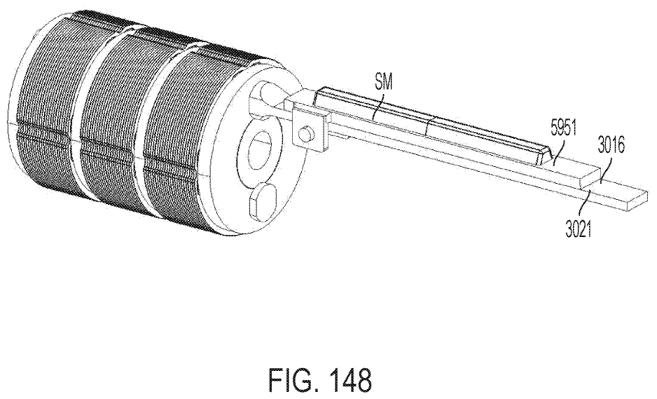

Referring to FIGS. 148-153, this disclosure provides an alternate sensing design for a cylindrical plunger (e.g., as shown in FIGS. 91-104). This sensing design uses the same sense magnet as the rectangular plunger concept except that the magnet is mounted on a bracket (referred to as support member 5951 in the discussions below) that is affixed/attached to the blade of the driver. A (e.g., position) sensor uses the sense magnet to determine the position of the plunger during operation of the tool/fastener device.

Referring to FIGS. 91-104 and 148-153, a fastener device is provided. The fastener device comprises a housing and the motor assembly 3014 within the housing. The motor assembly 3014 comprises the plunger 3022. The plunger 3022 is configured to travel along a longitudinal axis and comprises at least one permanent magnet M″, M″₁-M″₃. The motor assembly 3014 also comprises the stator CS (e.g., including 3018, 3018′, 3020 and 3020′) that is in magnetic interface with the plunger 3022. The fastener device comprises the driver 3016 within the housing and that is coupled to the plunger 3022. The driver 3016 is drivable along the drive axis D-D via the plunger 3022. The fastener device comprises a sense magnet SM that is secured to the driver 3016 and a frame 5953 that is configured to support a sensor S to sense a magnetic flux of the sense magnet SM as the plunger 3022 travels along the longitudinal axis so as to detect an axial position of the plunger 3022.

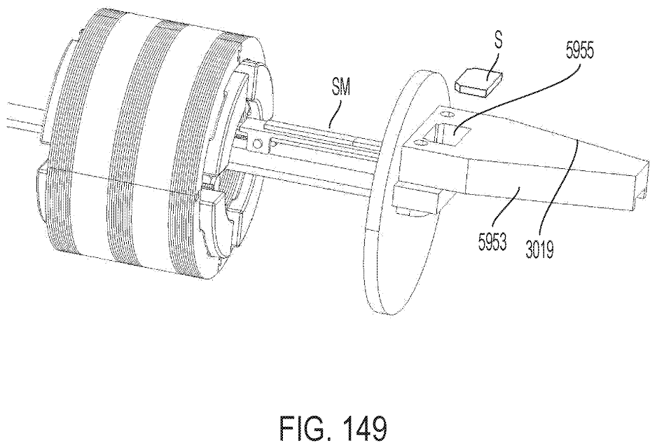

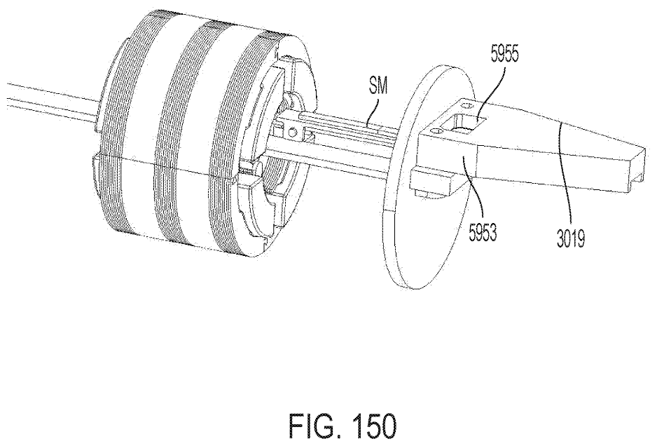

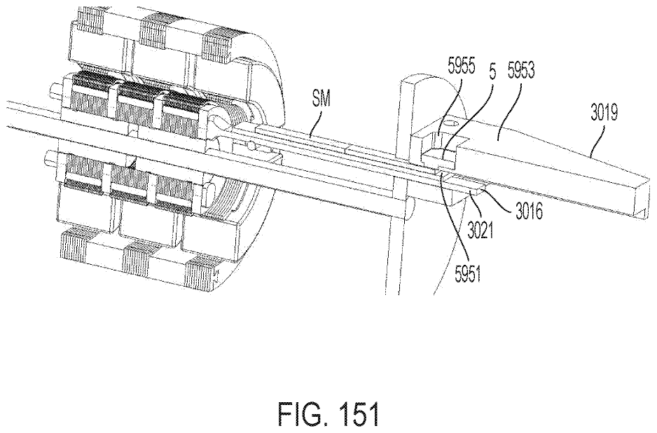

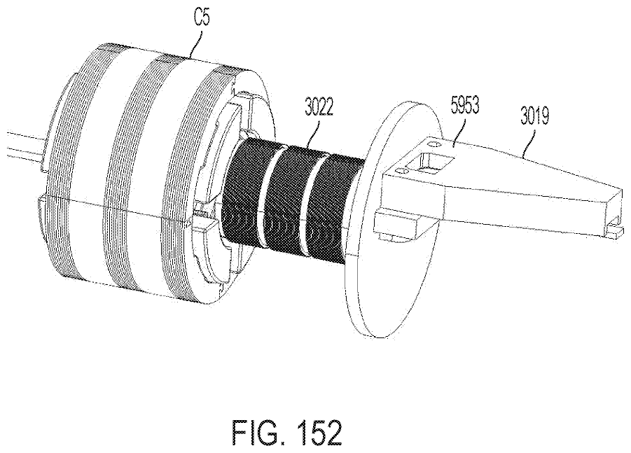

FIGS. 149 and 150 show perspective views of the linear motor (with the cylindrical stator CS) of FIG. 148 when the plunger (and the driver) is in its retracted position. FIG. 149 shows before the sensor S (configured to sense a magnetic flux of the sense magnet SM as the plunger 3022 travels along the longitudinal axis so as to detect an axial position of the plunger 3022) is supported by the frame 5953 and FIG. 150 shows after the sensor S is supported by the frame 5953. FIGS. 150 and 151 show a perspective view and a cross-sectional view, respectively of the linear motor of FIG. 148 when the plunger (and the driver) is in its retracted position. FIGS. 152 and 153 show a perspective view and a cross-sectional view, respectively of the linear motor of FIG. 148 when the plunger (and the driver) is in its extended position.

The sense magnet SM may be separate from the at least one permanent magnet M″, M″₁-M″₃ of the plunger 3022.

The fastener device may further comprise a support member 5951 that is configured to be coupled to a blade 3021 of the driver 3016. The sense magnet SM may be supported by and mounted on the support member 5951.

The sensor S may be a magnetic sensor including one or more Hall sensors that are configured to output a signal corresponding to a position of the plunger 3022 based on a magnetic flux of the sense magnet SM relative to the magnetic sensor.

The fastener device may further include a nose assembly 3019. The nose assembly 3019 may include the frame 5953. The sensor may be configured to be supported by and received in a portion 5955 of the frame 5953.

The frame 5953 may be configured to extend from the stator CS and the frame 5953 may be configured to support the sensor S.

The sense magnet SM may be configured to extend axially/longitudinally along an axis parallel to the drive axis D-D of the driver and the longitudinal axis of the plunger. The sense magnet may be disposed above the driver.

The stator CS may be configured to extend peripherally around the plunger 3022. The stator CS (e.g., including 3018, 3018′, 3020 and 3020′) may comprise a stator core CSC (e.g., 3024, 3024′, 3026 and 3026′) including a plurality of stator teeth 3032, 3032′, 3034 and 3034′ that extend inwardly from the stator core CSC (e.g., 3024, 3024′, 3026 and 3026′) in the direction of the plunger 3022, and a plurality of stator windings 3028, 3028′, 3030 and 3030′ respectively wound around the plurality of stator teeth 3032, 3032′, 3034 and 3034′. The plurality of stator windings 3028, 3028′, 3030 and 3030′ may be located peripherally around the plunger 3022 along a radial plane that is substantially perpendicular to the drive axis D-D to magnetically interact with the at least one permanent magnet M″, M″₁-M″₃ of the plunger 3022.

The plunger 3022 may be configured to interact with the plurality of stator windings 3028, 3028′, 3030 and 3030′ to cause linear movement of the plunger 3022 along the longitudinal axis. The linear movement of the plunger 3022 along the longitudinal axis may drive the driver 3016 along the drive axis D-D that is offset from but parallel to the longitudinal axis.

The sense magnet SM may comprise a plurality of sense magnets having opposing polarities mounted along the drive axis D-D.

The plunger 3022 may be moveable along the drive axis D-D between a retracted position and an extended position, to drive a fastener into a workpiece during a drive stroke in a direction of the extended position and return to the retracted position during a return stroke. The plurality of sense magnets may be positioned relative to a front face of the plunger 3022 such that, in the extended position, none of the plurality of sense magnets may be located within a body of the stator CS, and in the retracted position, at least one of the plurality of sense magnets may be located within the body of the stator CS.

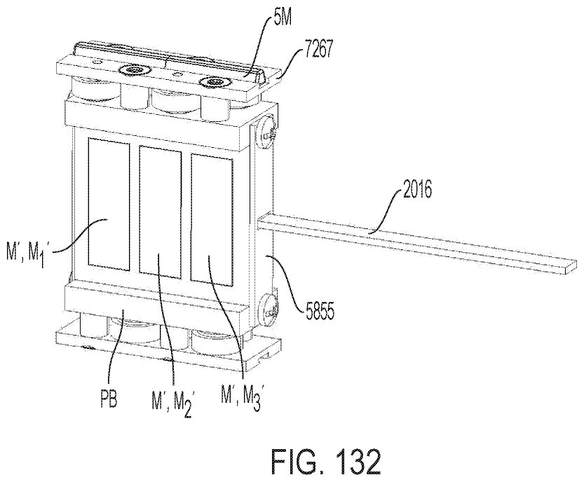

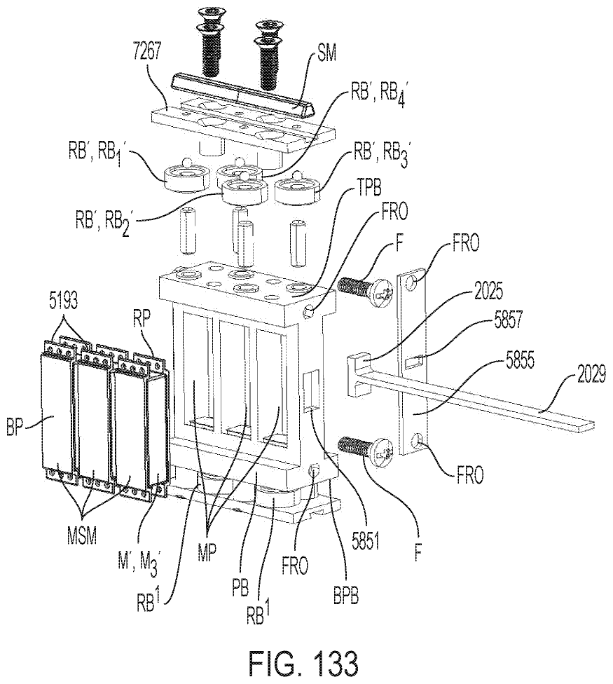

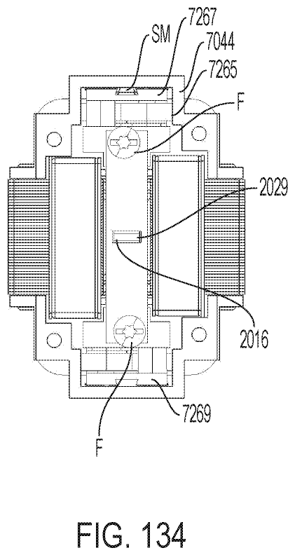

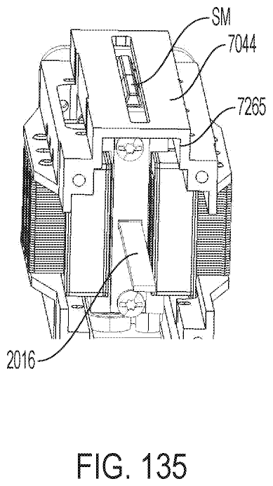

FIGS. 132-135 show a design of a linear motor having linear retention and guide system. Instead of using linear bearings mounted on (e.g., longitudinally/horizontally extending) rails or guide rods GR (e.g., as shown in FIGS. 79-90, 121-128, 129-131, and 154-155), this design uses multiple roller bearings RB′, RB′₁, RB′₂, RB′₃, RB′₄ mounted on the top TPB of the plunger PB and the bottom BPB of the plunger PB. For example, there may four roller bearings on the top TPB of the plunger PB and there may four roller bearings on the bottom BPB of the plunger PB. The number of roller bearings on the top and the bottom of the plunger may vary. The multiple roller bearings mounted on the plunger ride along a track 7265 made by the frame 7044.

These roller bearings may be offset so that one set on both the top of the plunger and the bottom of the plunger are configured to contact the left side of the frame or the right side of the frame groove upon which the plunger rides. Bracket 7267 may be mounted on top of the top roller bearings to capture balls that interact with the frame 7044 to provide vertical positioning. Bracket 7269 may also be mounted on bottom of the bottom roller bearings to capture balls that interact with the frame 7044 to provide vertical positioning. The bracket 7267 (or bracket 7269) also may be the mounting point of the sense magnet SM that is used to sense the position of the plunger during drive. The roller bearings may have higher speed and lower friction specifications than linear bearings (e.g., as shown in FIGS. 79-90, 121-128, 129-131, and 154-155) that could increase drive efficiency.

In FIGS. 132-135, the plunger is shown to have a single insert molded plunger body construction. The plunger, in other embodiments, may include a plurality of insert molded plunger bodies or may include laminated plunger construction. The driver 2016 is shown to have centered configuration with respect to the plunger. The driver, in other embodiments, may have an offset configuration with respect to the plunger. The plunger, the driver, the stator may have any other type of constructions as discussed in other embodiments of this disclosure or may have other types of constructions as would be appreciated by a person of ordinary skill in the art.

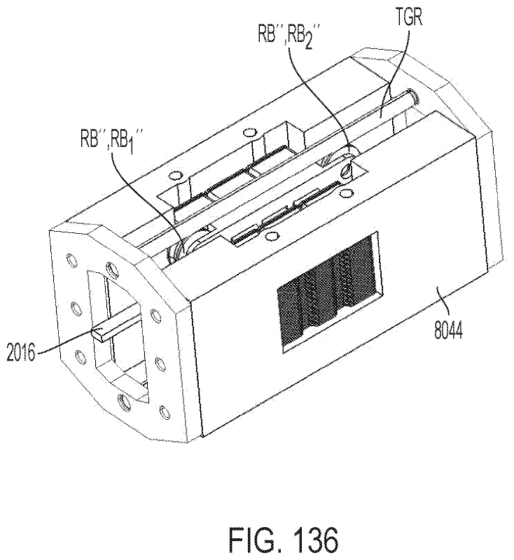

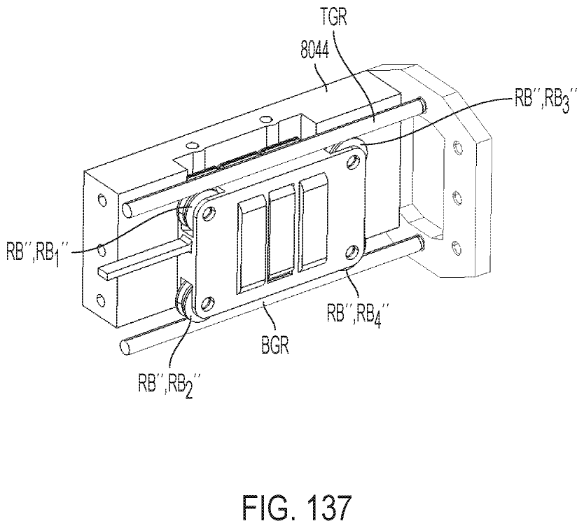

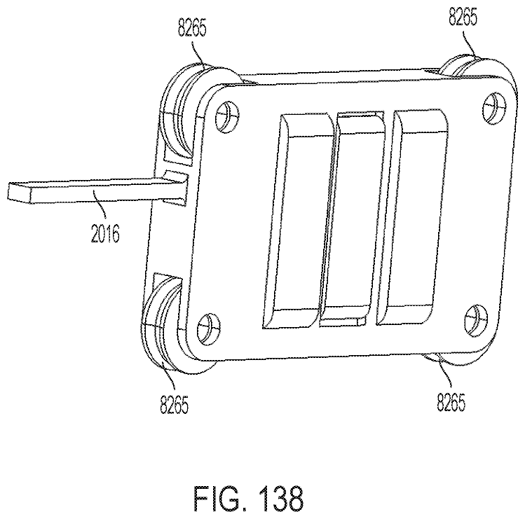

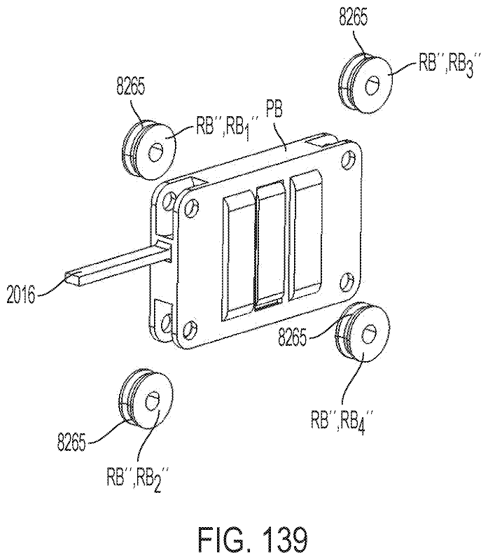

Like FIGS. 132-135, FIGS. 136-139 show another design of the linear motor in which roller bearings RB″, RB″₁, RB″₂, RB″₃, RB″₄ are used as the linear retention mechanism. Instead of rolling on the sides of the frame as shown in FIGS. 132-134, the roller bearings in FIGS. 136-139 have U grooved outer surfaces 8265 that interface with the top and bottom rails TGR, BGR on the frame 8044. This design in FIGS. 136-139 requires fewer roller bearings than the design in FIGS. 132-135.

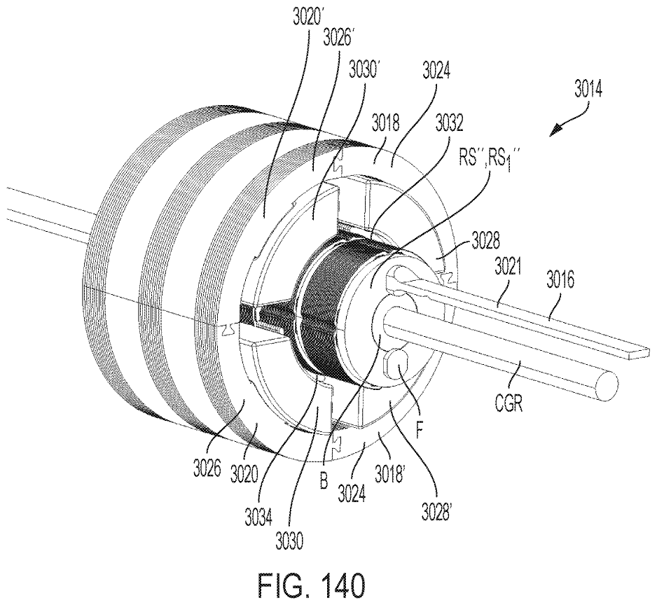

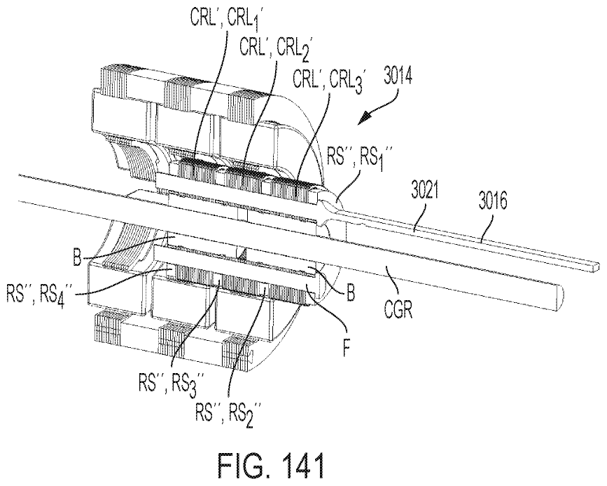

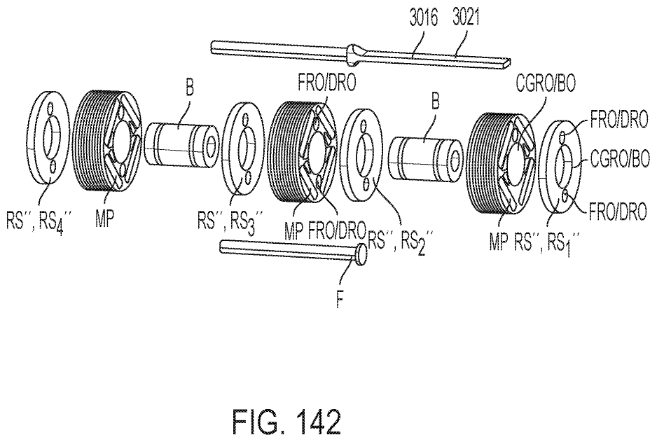

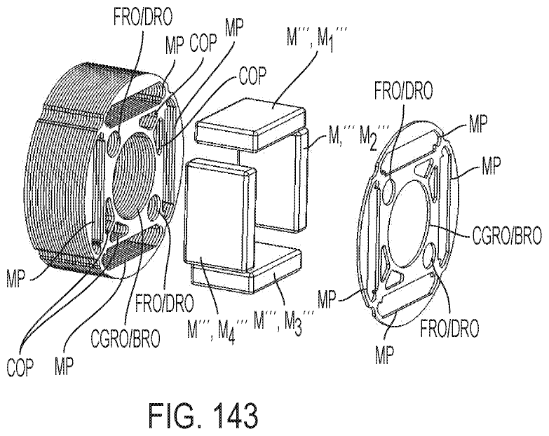

FIGS. 140-141 show an assembled view and a cross-sectional view, respectively of a cylindrical linear motor with cylindrical stator and cylindrical plunger in accordance with another embodiment of this disclosure. FIG. 142 shows an exploded view of the cylindrical plunger of the linear motor. FIG. 143 shows a partially exploded view of the cylindrical plunger core and one or more permanent magnets received therein. The cylindrical linear motor in FIGS. 140-143 and FIGS. 144-147 is similar in configuration and operation to those disclosed in the other embodiments (e.g., FIGS. 90-104 and FIGS. 148-153) of this application and, therefore, the cylindrical linear motor will not be described in detail here again except for the differences noted below.

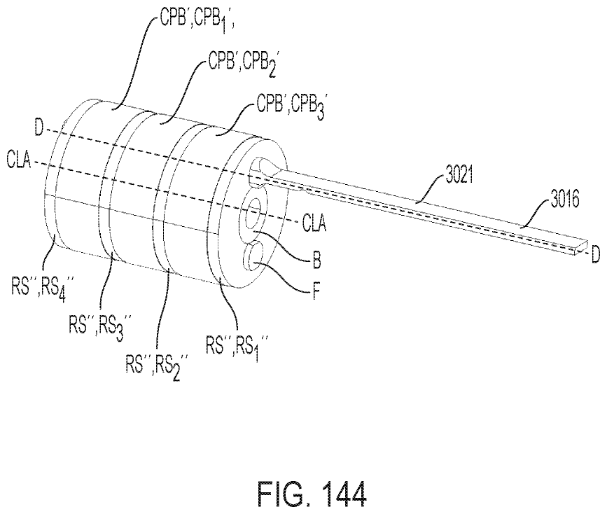

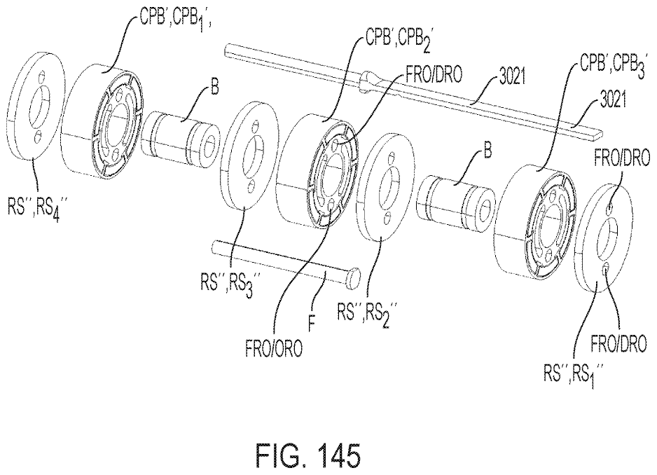

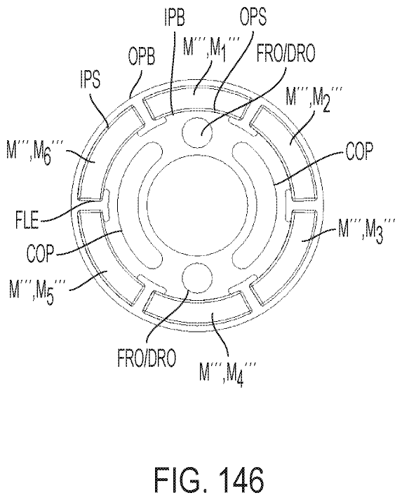

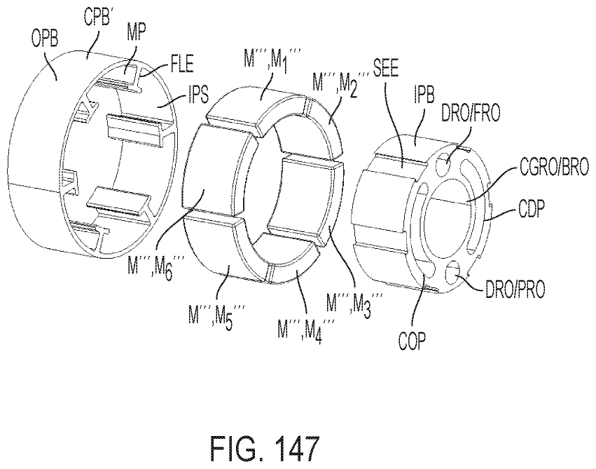

FIGS. 144-145 show a perspective view and an exploded view, respectively of a cylindrical plunger in accordance with another embodiment of this disclosure. FIGS. 146-147 show a cross-sectional view and an exploded view, respectively of a plunger core (of the cylindrical plunger of FIGS. 144-145) and the magnets disposed therein.

Referring to FIGS. 140-143 and 144-147, the plunger 3022 may comprise a central longitudinal axis CLA-CLA that is parallel to and spaced apart from the drive axis D-D. Referring to FIGS. 140-143, the plunger 3022 may comprise a plurality of (laminated) plunger cores CRL′, CRL′₁, CRL′₂, CRL′₃. Referring to FIGS. 144-147, the plunger 3022 may comprise a plurality of plunger cores/bodies CPB′, CPB′₁, CPB′₂, CPB′₃. The plurality of plunger cores may include a first plunger core and a second plunger core. The first plunger core and the second plunger core are adjacent to each other. The second plunger core is oriented along a second radial plane substantially parallel to a first radial plane of the first plunger core. Each of the plurality of plunger cores may be configured to receive one or more of the plurality of permanent magnets M′″, M″_{′1-6} therein. Each of the plurality of plunger cores may comprise one or more magnet pockets MP. Each magnet pocket MP may be configured to receive one of the one or more permanent magnets M′″, M″_{′1-6} therein. As shown in FIGS. 140-143, each magnet pocket MP may be configured to fully enclose one of the one or more permanent magnets M′″, M″_{′1-6} therein. As shown in FIGS. 144-147, each magnet pocket is configured to partially enclose one of the one or more permanent magnets M′″, M″_{′1-6} therein. The motor assembly 3014 may further include a plurality of plunger spacers RS″, RS″₁, RS″₂, RS″₃, RS″₄. Each of the plurality of plunger spacers RS″, RS″₁, RS″₂, RS″₃, RS″₄ may be configured to separate, along the drive axis D-D and/or along the central longitudinal axis CLA-CLA, adjacent plunger cores of the plurality of plunger cores. The cylindrical plunger cores/bodies may be separated by the cylindrical plunger spacers RS″, RS″₁, RS″₂, RS″₃, RS″₄.

The motor assembly 3014 may further include a central guide rod CGR that extends substantially parallel to the drive axis D-D. The plunger 3022 may be configured to be securely mounted on the central guide rod CGR. Each of the plurality of plunger spacers RS″, RS″₁, RS″₂, RS″₃, RS″₄ and each of the plurality of plunger cores may include a ring-shaped configuration.

Each of the plurality of plunger spacers RS″, RS″₁, RS″₂, RS″₃, RS″₄ and each of the plurality of plunger cores comprise a driver receiving opening DRO configured to securely receive the driver 3016 therein, a fastener receiving opening FRO configured to securely receive a fastener F therein, and a guide rod receiving opening CGRO/BRO configured to receive the central guide rod (and the associated bearing) therethrough to enable the plunger 3022 to slide along a length of the central guide rod CGR so as to maintain an air gap between the plunger 3022 and the stator 3018, 3018′, 3020, and 3020′. The fastener F may be configured to connect the plurality of plunger cores to each other. The driver 3016 may also be configured to connect the plurality of plunger cores to each other. The driver receiving opening DRO and the fastener receiving opening FRO may be configured to be interchangeably used such that the one of the driver receiving opening DRO and the fastener receiving opening FRO is configured to securely receive the driver 3016 and the other of the driver receiving opening DRO and the fastener receiving opening FRO is configured to securely receive the fastener F. The size, the shape and/or the configuration of the driver receiving opening DRO and the fastener receiving opening FRO may be the same. The guide rod receiving opening CGRO/BRO is disposed between the driver receiving opening DRO and the fastener receiving opening FRO. The one or more magnet pockets MP are disposed on peripheral portions of each plunger core. The guide rod receiving opening CGRO/BRO, the driver receiving opening DRO and the fastener receiving opening FRO may be disposed in central portions of each plunger core.

For each plunger core, the one or more magnet pockets MP are disposed to surround the guide rod receiving opening CGRO/BRO, the driver receiving opening DRO and the fastener receiving opening FRO. For each plunger core, the guide rod receiving opening CGRO/BRO, the driver receiving opening DRO and the fastener receiving opening FRO are disposed within the one or more magnet pockets MP. The fastener device may further comprise a guide rod receiving member B that is configured to be received in the guide rod receiving openings CGRO of the plunger spacers and the plunger cores. The guide rod receiving member B may also be configured to receive the guide rod CGR therethrough. The guide rod receiving member B is a linear bearing.

Referring to FIGS. 140-143 and 144-147, the cylindrical linear motor 3014 construction may use the central guide rail CGR with two linear bearings B mounted in the center of the plunger 3022. The plunger 3022 may be held together in the same manner as the rectangular offset laminated construction (e.g., FIGS. 79-90) with two shoulder screws F. One of the shoulder screws F may be configured to function as the driver blade 3021.

Each cylindrical plunger core may include optional cut out portions COP so as to reduce the weight of the cylindrical plungers. The number of cylindrical plunger cores in the cylindrical linear motor may vary. In the illustrated embodiments of FIGS. 140-143 and 144-147, three cylindrical plunger cores/bodies are shown. The driver blade 3021 within the nose assembly may be configured to function as the clocking mechanism for the cylindrical linear motor given the singular central guide rail CGR.

Referring to FIGS. 140-143, permanent magnets M′″, M′″₁-M′″₄ may be mounted within magnet pockets MP of cylindrical laminated plunger cores CRL′, CRL′₁, CRL′₂, CRL′₃. Although four permanent magnets are shown, the number of permanent magnets in each laminated cylindrical plunger core may vary. In other embodiments, the cylindrical laminated plunger cores may have two or three permanent magnets. The permanent magnets in this embodiment may be shown to have rectangular, cube, or plate shaped configurations. The permanent magnets may have ring or curved shaped configurations in other embodiments.

Referring to FIGS. 144-147, the cylindrical plunger has very similar design as the previous embodiment of FIGS. 140-143 except the magnets are insert molded into plunger cores with a capturing metal ring to carry the flux instead of fully metal laminated plunger cores. This design would have significant weight advantages. Although three separate plunger cores are shown in FIGS. 144-147, in other embodiment, a single plunger body (e.g., FIGS. 121-124 vs FIGS. 125-128) may be used.

Referring to FIGS. 146-147, each cylindrical plunger body CPB′ may include an outer body OPB and inner body IPB. The outer body OPB may have first lock elements FLE protruding from an inner surface IPS thereof. The inner body IPB may have second lock elements SLE formed on the outer surface OPS of the inner body IPB. The first lock elements FLE of the outer body OPB are configured to engage with the second lock elements SLE of the inner body IPB so as to connect the outer body OPB and the inner body IPB to each other. The outer body OPB and the inner body IPB, when connected to each other, may form magnet pockets that receive magnets therein. The first lock elements FLE may have an inverted T-shaped configuration (with leg/body portion and head portion) and the second lock elements SLE may include notches/grooves that are configured to receive the head portions of the T-shaped lock elements. The magnets received in the magnet pockets are engaged with/supported on (a) their upper surfaces by the inner surface IPS of the outer body OPB, (b) their side surfaces by the leg/body portions of the adjacent T-shaped lock elements FLE, and (c) their lower surfaces by the outer surface OPS of the inner body IPB. In the illustrated embodiment, there are six second lock elements, six first lock elements, and six magnets. The number of second lock elements, first lock elements, and magnets may vary in other embodiments.

As would be appreciated by a person of ordinary skill in the art, in other embodiments, the first lock elements FLE and the second lock elements SLE may have other shapes, sizes and/or configurations that facilitate the connection between the outer body OPB and the inner body IPB and enable the magnets to be received in the pockets formed between the outer body OPB and the inner body IPB.

In one embodiment, a low energy return concept for the fastener device is described. In an embodiment, the fastener device requires a significant amount of electrical energy to drive the motor during the drive stroke to effectively drive a fastener into a workpiece. In other words, the driving action of the fastener significantly absorbs the energy of the plunger during the drive stroke. During the return stroke, as the motor returns to its home position, there is no moving component that absorbs the energy of the plunger. Accordingly, in an embodiment, the motor energization may be controlled at a lower level of electrical energy to bring the plunger back to its home position smoothly and at a slower velocity. This control scheme, referred to herein as a low energy return control, the motor is driven with a lower level of electric power (e.g., by setting a lower PWM duty cycle, a lower cycle-by-cycle current limit, a lower advance angle, a lower conduction band, and/or a lower field-oriented control/current vector control) during the return stroke than the motor is driven during the drive stroke. The low energy return concept may be applied to any linear motor or a fastener device using such a linear motor, in which more power is input during the drive stroke and less power is input during the return stroke. For example, with more PWM duty cycle, more current is being input to the motor during the drive stroke, while during the return stroke, the PWM duty cycle of the inverter may be reduced so that less current is input to the motor. In one embodiment, a capacitor may be used to boost the voltage to the motor during the drive stroke. The voltage may be boosted from the 20V battery voltage to a higher level (e.g., 60V in some designs but over 120V in other designs). For example, both the battery and the capacitor may be relied on during the drive stroke to achieve high energy drive, but the battery alone is relied on during the return stroke to achieve low energy return. In other words, the capacitor may be configured to be discharged only during the drive stroke (and not during the return stroke).

In one embodiment, a fastener device comprises a housing, and a motor assembly within the housing. The motor assembly includes a stator including a plurality of coils and a plunger including at least one permanent magnet configured to magnetically interact with the plurality of coils of the stator to cause a linear movement of the plunger along a drive axis between a retracted position and an extended position, to drive a fastener into the workpiece during a drive stroke in a direction of the extended position and return to the retracted position during a return stroke. The fastener device also comprises a power source configured to provide electric power to the stator, and a controller disposed within the housing.

The controller may be configured switchably to control a supply of electric power from the power source to the stator to control the linear movement of the plunger during the drive stroke and the return stroke. The controller may be configured to control the electric power applied the stator at a lower level during the return stroke than during the drive stroke such that a velocity of the linear movement of the plunger is greater during the drive stroke within which the plunger drives the fastener into the workpiece than it is during the return stroke within which a subsequent fastener is positioned for engagement with the plunger.

The fastener device, the housing, the motor assembly, the stator, the plurality of coils, the plunger, the at least one permanent magnet, the drive axis, the drive stroke, the return stroke, the extended position, the retracted position, and the controller are all described in detail in other embodiments of this disclosure and, therefore, will not be described in detail here again.

The power source of the fastener device is also described in detail in other embodiments of this disclosure. For example, the power source may include a removeable battery pack and a capacitor. The capacitor may be mounted within the housing. The capacitor may have a nominal voltage of approximately 60V to 480V. The capacitor may be configured to store electric energy of greater than or equal to approximately 10 Joules.

The fastener device may include a battery receptacle that is configured to receive the battery pack. The battery pack is configured to apply a charge current to the capacitor. The battery pack may have a maximum voltage of less than approximately 20V. The battery pack may have a maximum voltage of approximately 12V. The battery pack may have a maximum voltage of approximately 20V.

In one embodiment, a discharge current from the capacitor may be configured to power the stator during the drive stroke and the return stroke.

In one embodiment, a discharge current from the capacitor may be configured to power the stator during the drive stroke and a discharge current from the battery pack powers the stator during the return stroke.

In one embodiment, a discharge current from the capacitor is boosted by a discharge current from the battery pack to power the stator during the drive stroke, but not during the return stroke.

The capacitor may be configured to be discharged only during the drive stroke.

In one embodiment, a nominal voltage of the electric energy applied to the stator is greater during the drive stroke than it is during the return stroke by a factor of approximately 3 to 4 times.

In one embodiment, the electric energy (e.g., controlled by the controller) applied to the stator is in a range of approximately 0.25 Joules to approximately 2 Joules, preferably approximately 0.5 Joules to 1.5 Joules, during the return stroke and in a range of approximately 4.5 Joules to approximately 9.5 Joules, preferably greater than or equal to 5.5 Joules, during the drive stroke. In one embodiment, these ranges may be specific for low-energy fastener devices (e.g., T50 staple gun, carpet fastener device, etc.).

The fastener device may further comprise a switch circuit located between the power source and the motor. The controller may be configured to apply drive signals to the switch circuit to control the commutation of the stator.

The switch circuit is described in detail in other embodiments of this disclosure and, therefore, will not be described in detail here again. The switch circuit may interchangeably referred to as the invertor circuit that comprises a plurality of power switches configured to drive the stator via a plurality of phase voltage input lines. The process of commutation is switching the current supplied to the stator when the plunger has reached the desired position as explained in other embodiments of this disclosure.

The controller may be configured to apply the drive signals to control an average current (or an average energy) of the electric power applied to the stator to be greater during the drive stroke than it is during the return stroke by a factor of approximately 7 times to approximately 12 times, preferably at least approximately 6 times, more preferably approximately 7 times.

The controller may be configured to set a pulse-width modulation (PWM) duty cycle of the drive signals to a first level during the drive stroke and to a second level that is smaller than the first level during the return stroke. In one embodiment, the PWM duty cycle is in a range of approximately 11% to approximately 100%, preferably at least approximately 20%, during the drive stroke and in a range of approximately 2% to approximately 10% during the return stroke.

The controller may be configured to control a pulse-width modulation (PWM) duty cycle of the drive signals to regulate the flow of electric power to the stator, and to apply a cycle-by-cycle current limit by interrupting the flow of electric power through the switch circuit for a remainder of each PWM cycle if a current level of the electric power exceeds a current threshold. For a detailed description of cycle-by-cycle current limit control in a power tool, reference is made to U.S. Pat. No. 10,411,558, which is incorporated herein by reference in its entirety. The cycle-by-cycle current limit is set to a first level during the drive stroke and to a second level that is smaller than the first level during the return stroke.

In one embodiment, a pulse-width modulation (PWM) with a variable duty may be used. For example, higher duty may effectively increase the source voltage for the drive stroke, and lower duty for lower voltages, currents and, therefore, forces for the return stroke. The drive stroke and the return stroke may interchangeably be referred to as drive sequence and return/homing/start sequence, respectively. In one embodiment, the return stroke may take significantly longer than the drive stroke due to lower velocity and/or lower applied forces.

In one embodiment, a variable voltage may be used. For example, a battery pack voltage of approximately 20V may be used for the return stroke and a capacitor voltage of approximately 60V may be used for the driver stroke.

The controller may be configured to control a conduction band corresponding to a bandwidth of the plurality of phases of the stator, and/or an advance angle corresponding to an angle by which a phase of the motor is advanced. For a description of advance angle and/or conduction band control of a brushless DC motor, reference is made to U.S. Pat. No. 11,794,327, which is incorporated herein by reference in its entirety. In an embodiment, the conduction band and/or the advance angle may be set to a first level during the drive stroke and to a second level that is smaller than the first level during the return stroke.

In another or further aspect, the controller may be configured to apply a current vector control, or a field-oriented control (FOC), so as to apply current at a first level during the drive stroke and at a second level that is smaller than the first level during the return stroke.

The controller may be configured to set a current vector control in field-oriented control of the motor to a first level during the drive stroke and to a second level that is smaller than the first level during the return stroke. For a detailed description of field-oriented control of a brushless DC motor, reference is made to U.S. Pat. No. 11,469,697, which is incorporated herein by reference in its entirety.

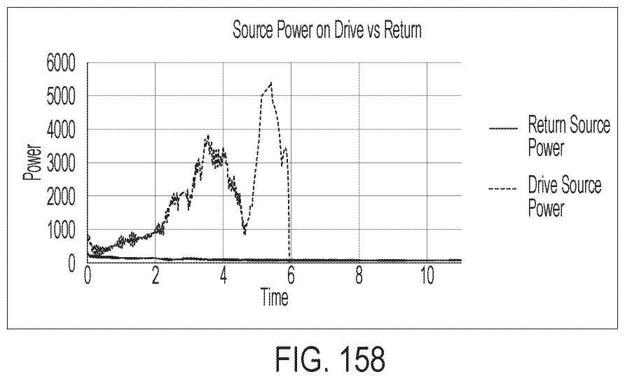

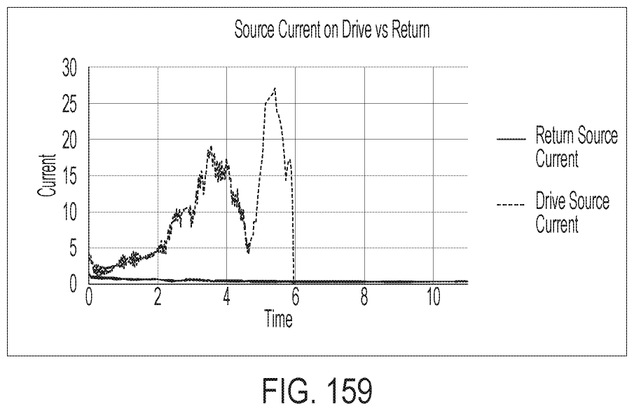

FIG. 158 shows a comparison of source power for the drive stroke and for the return stroke. The source power (in Watts) is shown on the Y-axis and the time (in seconds) is shown in the X-axis in FIG. 158. FIG. 159 shows a comparison of source current (i.e., current drawn from the power source) for the drive stroke and for the return stroke. The source current (in Amperes) is shown on the Y-axis and the time (in seconds) is shown in the X-axis in FIG. 159. FIGS. 158 and 159 show that less electric power, less current draw, less energy, and less charge are required to return the plunger to its start/retracted position during the return stroke (vs. the energy and the charge required to move the plunger during the drive stroke from its retracted position to its extended position). For example, the peak input power to the motor may be in the range of approximately 200 watts to over 3000 watts during the drive stroke, and exceeding approximately 4000 watts corresponding to impact with the fastener; while the power input to the motor may be less than approximately 200 watts during the return stroke. Similarly, the current draw from the power supply (e.g., the capacitor) may be in the range of approximately 3 amps to over 15 amps during the drive stroke, and exceeding approximately 20 amps corresponding to impact with the fastener; while the current draw may be less than approximately 2 amps during the return stroke. In an example, a charge of approximately 0.003 ampere-seconds may be used during the return stroke, while a charge of approximately 0.032 ampere-seconds may be used during the drive stroke. An energy of approximately 0.7 Joules may be used during the return stroke, while an energy of approximately 6.4 Joules may be used during the drive stroke.

As can be seen from FIG. 159, maximum source currents may be needed to push the plunger (and the driver) as fast as possible during the drive stroke, while just enough source current may be needed to push the plunger (and the driver) back (e.g., overcoming cogging force oscillations) to its home position during the return stroke.

Applicant of this disclosure has found that, even with the motor de-energized (e.g., there is no current in the stator), there may be significant force oscillations working on the plunger inside of the stator. The force oscillations may be due to forces between the magnets of the plunger and the (steel) stator. That is, the plunger may be sucked into the stator because of magnetic attraction between the magnets of the plunger and the steel stator. The amount of attraction may oscillate the plunger as it moves within the stator. Cogging force may include an amount of energy that is required to overcome the magnetic interaction between the stator and the magnets of the plunger. These force oscillations may need to be overcome to bring the plunger to its start position during the return stroke. The start position of the plunger may also be interchangeably referred to as the retracted position of the plunger. For example, the stator may need to be energized to apply over approximately 80 Newtons (N) of force on the plunger to return the plunger to its start position. The (return) energy required to overcome the energy of cogging during the return stroke, in this example, is equal to 0.56 Joules (i.e., 80 N force*10 mm stroke/sqrt(2)). In one embodiment, a 100 N of force may be applied in the return stroke for 10 mm stroke to get over a first cogging force hump (e.g., approximately 1 Joule). Thereafter, the momentum and the cogging force during the return stroke may be configured to carry the plunger all the way to its start position.

In one embodiment, the energy input required during the drive stroke may be approximately 5 Joules. For 40 mm stroke, approximately 125 Newtons (N) (i.e., 5 Joules/0.04) of force may be applied on the plunger on average during the drive stroke. For a 12 meters/second (m/s) velocity of the plunger and for 40 mm stroke, it may take approximately 8 milliseconds for the plunger to move from its retracted position to its extended position during the drive stroke. That is, approximately 600 Watts (i.e., 5 Joules/0.008 seconds) of drive power on average may be used during the drive stroke.

The motor currents required during the return stroke are less than the motors currents required during the drive stroke. The duty/voltage required from the source during the return stroke is less than duty/effective voltage to the motor during the drive stroke. In one embodiment, the charge/energy required from the source capacitor during the return stroke is less than the charge/energy required from the source capacitor during the drive stroke. The energy and the velocity required to return the plunger (and the driver) to its start position during the return stroke may be significantly less than the energy and the velocity required to drive nail during the drive stroke. The speed of the plunger (and the driver) during the return stroke may be significantly less than the speed of the plunger (and the driver) during the drive stroke.

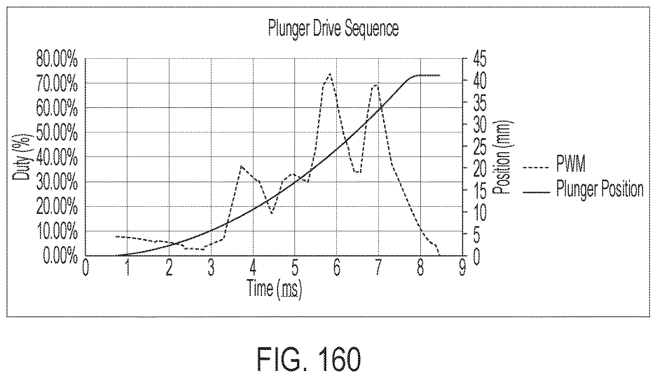

FIG. 160 shows an exemplary PWM duty cycle control sequence during the drive stroke of the plunger. The duty cycle (in percentage (%)) is shown on the left-hand side Y-axis, the position of the plunger (in millimeters (mm)) is shown in the right-hand side Y-axis, and the time (in milliseconds (ms)) is shown in the X-axis in FIG. 160. In an embodiment, during the drive stroke, the PWM duty cycle is controlled to increase gradually between approximately 5% to over 60% as the plunger is moved from the home position (i.e., 0 mm at 1 ms) towards the extended position (i.e., 41 mm at 7.7 ms). There are fluctuations in the PWM duty control along the way that correspond to back-Electromotive Force (EMF) of the motor. In this example, contact with the fastener takes place at approximately 25 mm of the travel distance of the plunger, and the plunger reaches its final extended position at approximately 41 mm of the travel distance. The PWM duty cycle begins to ramp down at some point during or after contact with the fastener

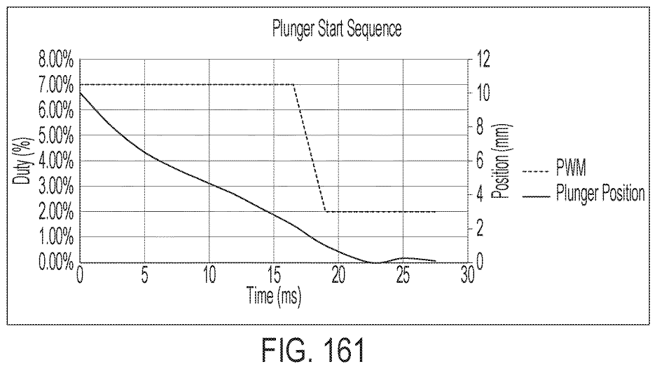

FIG. 161 shows an exemplary PWM duty cycle sequence during a start of the drive stroke of the plunger. The duty cycle (in percentage (%)) is shown on the left-hand side Y-axis, the position of the plunger (in millimeters (mm)) is shown in the right-hand side Y-axis, and the time (in milliseconds (ms)) is shown in the X-axis in FIG. 161. In an embodiment, the cogging force of the motor may move the plunger to a position that is offset relative to the fully retracted position. In this example, this offset position is approximately 10 mm from the retracted position. Accordingly, in an embodiment, prior to initiation of a drive stroke, the PWM duty cycle is applied to return the plunger to the retracted position. Specifically, in an embodiment, during this start sequence, a first PWM duty cycle (e.g., approximately 7%) is applied to the motor until the plunger is moved back within a preset distance (e.g., approximately 2 mm) of its fully retracted position, and the PWM duty cycle is ramped down to a second PWM duty cycle (e.g., approximately 2%) until the plunger reaches the fully retracted position. This allows the plunger to start at the fully retracted position during the subsequent drive sequence, which allows it to build more momentum during the drive sequence and apply a greater amount of force to the fastener.

Another aspect of the application is discussed herein.

As previously discussed, a capacitor may be utilized as a power source for driving the motor. Applicant of this disclosure has found that capacitors may have performance challenges at cold temperatures. For example, the resistance of the capacitor at 0 °C temperature may be approximately 3 times the resistance of the capacitor at 20 °C temperature (or at ambient temperature). Also, the resistance of the capacitor at −20 °C temperature may be approximately 6 times the resistance of the capacitor at 20 °C temperature (or at ambient temperature). Cold temperatures may cause the capacitor to charge slower and/or to discharge slower (compared to that at ambient temperature). Accordingly, an embodiment of this disclosure provides a cold temperature ready sequence or a warming sequence for a capacitor. The warming sequence may be used for any linear motor that includes a capacitor and that receives electric power from the capacitor. The warming sequence may be used for a fastener device having a capacitor and a linear motor that receives electric power from the capacitor.

In one embodiment, a fastener device comprises a housing, and a motor assembly within the housing. The motor assembly includes a stator including a plurality of coils and a plunger including at least one permanent magnet configured to magnetically interact with the plurality of coils of the stator to cause a linear movement of the plunger along a drive axis between a retracted position and an extended position, to drive a fastener into the workpiece during a drive stroke in a direction of the extended position and return to the retracted position during a return stroke.

The fastener device also comprises a capacitor that provides electric power to the stator. The fastener device further includes a controller disposed within the housing. The controller may be configured switchably to control a supply of electric power from the capacitor to the stator to control the linear movement of the plunger during the drive stroke and the return stroke. The controller may be configured to: obtain a voltage of the capacitor during at least one of a charge sequence or a discharge sequence of the capacitor, and measure a rate of change of the voltage of the capacitor during the at least one of the charge sequence or the discharge sequence. If the rate of change of the voltage of the capacitor is below a predetermined threshold: the controller may be configured to interrupt the at least one of the charge sequence and/or the discharge sequence, and to apply a warming sequence including a plurality of charge pulses and a plurality of discharge current pulses to the capacitor for a preset duration of time or until the rate of change of the voltage of the capacitor is greater than or equal to the predetermined threshold.

The fastener device, the housing, the motor assembly, the stator, the plurality of coils, the plunger, the at least one permanent magnet, the drive axis, the drive stroke, the return stroke, the extended position, the retracted position, and the controller are all described in detail in other embodiments of this disclosure and, therefore, will not be described in detail here again. The power source of the fastener device is also described in detail in other embodiments of this disclosure. For example, the power source may include a (removeable) battery pack and the capacitor. The power source may include the capacitor.

The fastener device may further include a voltage sensor coupled to the capacitor. The controller may be configured to obtain the voltage of the capacitor from the voltage sensor. The voltage sensor may be operatively connected to the controller so that the voltage of the capacitor from the voltage sensor may be transmitted (wired or wirelessly) to the controller.

The charge sequence or charging sequence of the capacitor may be a process/procedure during which the capacitor may be charged (e.g., by a battery pack of the fastener device). The discharge sequence or discharging sequence of the capacitor may be a process/procedure during which the capacitor may be discharged. During the discharge sequence of the capacitor, the capacitor may be configured to provide electric power to the stator including the plurality of coils. During the discharge sequence of the capacitor, the capacitor may provide discharge current that is configured to cause movement of the plunger away from the retracted position.

The controller may also be configured to control the plurality of discharge current pulses (e.g., during the warming sequence of the capacitor) such that the plurality of discharge current pulses does not cause a substantial movement of the plunger away from the retracted position. The controller may be configured to control the plurality of discharge current pulses (e.g., during the warming sequence of the capacitor) to have a smaller average current than the discharge sequence of the capacitor.

The controller may also be configured to set a pulse-width modulation (PWM) duty cycle for discharging the capacitor to a first level during the drive stroke and to a second level that is smaller than the first level during the warming sequence. The first level may be configured to cause movement of the plunger away from the retracted position. The second level may be configured to does not cause a substantial movement of the plunger away from the retracted position.

The fastener device may further comprise a switch circuit located between the capacitor and the motor assembly. The controller may be configured to apply drive signals to the switch circuit to control the commutation of the stator. The switch circuit is described in detail in other embodiments of this disclosure and, therefore, will not be described in detail here again. The switch circuit may interchangeably referred to as the invertor circuit that comprises a plurality of power switches configured to drive the stator via a plurality of phase voltage input lines. The process of commutation is switching the current supplied to the stator when the plunger has reached the desired position as explained in other embodiments of this disclosure.

The controller may also be configured to control the drive signals (applied to the switch circuit) in a sequence that substantially prevents the movement of the plunger away from the retracted position while applying the plurality of discharge current pulses to the capacitor.

The predetermined threshold corresponds to the rate of change of the voltage of the capacitor during the at least one of the charge sequence or the discharge sequence when a temperature of the capacitor is within an ambient temperature range. The predetermined threshold may correspond to the voltage of the capacitor during the at least one of the charge sequence or the discharge sequence when the temperature of the capacitor is within the ambient temperature range. The predetermined threshold may include a first threshold that corresponds to the charge sequence of the capacitor and a second threshold that corresponds to the discharge sequence of the capacitor. The predetermined threshold may include a predetermined voltage threshold.

The fastener device may further comprise a warming sequence illuminator mounted on the housing. The warming sequence illuminator may include an LED and may be operatively connected to the controller. The controller may be configured to illuminate the warming sequence illuminator during the warming sequence of the capacitor. The controller may be configured to turn off the warming sequence illuminator after the warming sequence of the capacitor is complete. The warming sequence illuminator may be configured to provide a visual indication of the warming sequence of the capacitor to a user. The warming sequence illuminator may be optional. In other embodiments, the warming sequence illuminator may be in the form of a warming sequence indicator that is configured to provide other types of indications (e.g., audio, haptic, etc.) of the warming sequence of the capacitor to a user.

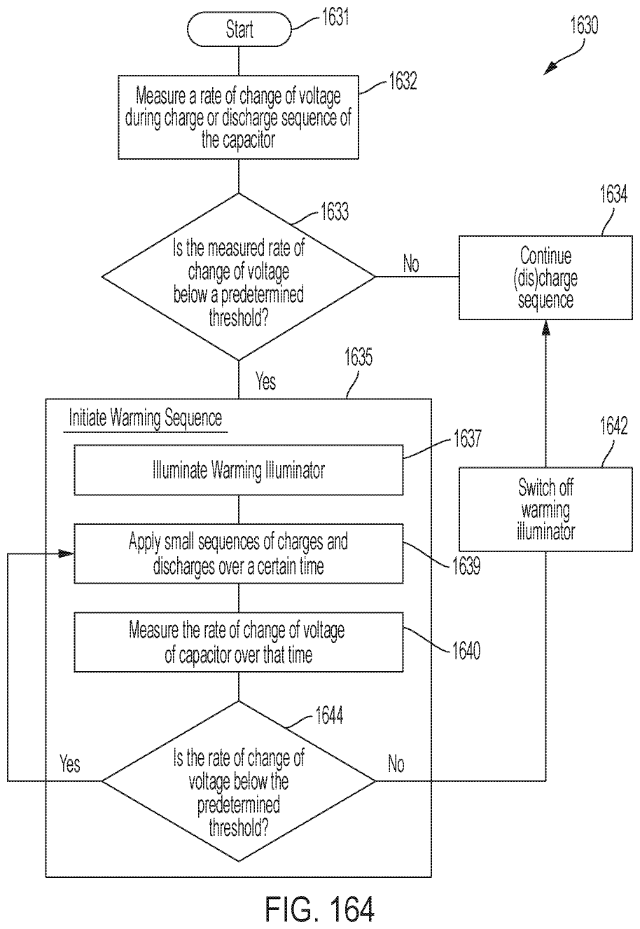

Referring to FIG. 164, a method 1630 for applying a warming sequence to a capacitor of a fastener device, during at least one of a charge sequence or a discharge sequence of the capacitor, is provided. The warming sequence may be applied if the rate of change of the voltage of the capacitor or the voltage of the capacitor is below the predetermined threshold. The method starts at procedure 1631.

At procedure 1632, the voltage of the capacitor may be measured or obtained. The voltage of the capacitor may be measured or obtained during a charge sequence of the capacitor and/or a discharge sequence of the capacitor. At procedure 1632, in one embodiment, the controller may be configured to obtain a voltage of the capacitor during at least one of a charge sequence or a discharge sequence of the capacitor, and to measure a rate of change of the voltage of the capacitor during the at least one of the charge sequence or the discharge sequence. The rate of change of the voltage of the capacitor may be measured as a function of the voltage of the capacitor over time.

At procedure 1633, the controller may be configured to determine if the (measured/obtained) voltage of the capacitor or the rate of change of the voltage of the capacitor is below the predetermined threshold.

At procedure 1633, if it is determined that the voltage of the capacitor or the rate of change of the voltage of the capacitor is above the predetermined threshold, the controller may be configured to continue with the at least one of the charge sequence or the discharge sequence at procedure 1634. That is, if it is determined that the voltage of the capacitor is above the predetermined threshold, the controller may be configured to continue with a normal operation of the motor and apply a charge current to the capacitor, or discharge the capacitor to power the motor, in a normal course of operation.

At procedure 1633, if it is determined that the rate of change of the voltage of the capacitor is below the predetermined threshold, the controller may be configured to interrupt the at least one of the charge sequence and/or the discharge sequence, and apply a warming sequence to raise the temperature of the capacitor to an acceptable operating level. In an embodiment, the warming sequence, which is applied at procedure 1635, may include applying a plurality of charge pulses and/or a plurality of discharge current pulses to the capacitor for a preset duration of time or until the voltage of the capacitor or the rate of change of the voltage of the capacitor is greater than or equal to the predetermined threshold.

The warming sequence may include procedure 1637 in which the controller may be configured to illuminate the warming sequence illuminator during the warming sequence of the capacity. The warming sequence illuminator may be, for example, an LED mounted on the housing of the fastening tool that is visible by the tool operator. In an example, a lighting pattern of the LED may be controlled in a unique pattern that is indicative of the execution of the warming sequence. In an embodiment, the warming sequence may further include procedure 1639 in which the controller may be configured to apply the plurality of charge pulses and/or the plurality of discharge current pulses to the capacitor for the preset duration of time. The charge and/or discharge pulses are controlled at sufficiently low current levels designed to circulate current through the capacitor without causing a noticeable energization force being applied to the motor. Ina n embodiment, the warming sequence may further include method 1640 in which the controller may be configured to obtain or measure the voltage of the capacitor or to obtain a voltage of the capacitor during at least one of a charge sequence or a discharge sequence of the capacitor, and to measure the rate of change of the voltage of the capacitor during the at least one of the charge sequence or the discharge sequence. The warming sequence may also include procedure 1641 in which the controller is configured to determine if the voltage of the capacitor or the rate of change of the voltage of the capacitor is below the predetermined threshold.

At procedure 1641, if it is determined that the voltage of the capacitor or the rate of change of the voltage of the capacitor is above the predetermined threshold, the controller may be configured to switch off the warming illuminator at procedure 1642 and to continue with the at least one of the charge sequence or the discharge sequence at procedure 1634.

At procedure 1641, if it is determined that the voltage of the capacitor or the rate of change of the voltage of the capacitor is below the predetermined threshold, the controller may be configured apply a warming sequence including a plurality of charge pulses and a plurality of discharge current pulses to the capacitor for a preset duration of time or until the voltage of the capacitor or the rate of change of the voltage of the capacitor is greater than or equal to the predetermined threshold at procedure 1639.

The procedures shown in the method 1630 are exemplary. Some of the procedures in the method 1630 may be combined with other procedures in the method 1630. Some of the procedures in the method 1630 may be optional. For example, the procedures of illuminating and switching off the warming sequence illuminator may be optional in some embodiments.

Another aspect of this disclosure is described herein. Specifically, in an embodiment, the plunger may exhibit a bounce back from the extended position at or after a completion of a driving sequence. If the driving force of the motor is not appropriately set, i.e., if the driving force of the motor is too high or too low for a given size of a fastener, the plunger may exhibit a bounce back from the extended position that is either too high or too low. Furthermore, a bounce-back velocity may be associated with drive energy relative to fastener drive requirements. In some examples, the driving force of the motor may be configured to enable the plunger to drive the longest possible fasteners that can be used with the fastening device, or to drive fasteners into the hardest workpiece material. However, when a fastening application involves use of shorter fasteners and/or driving fasteners into softer workpiece material, the driving force of the motor may be too high for that fastening application, which may cause excessive bounce back velocity Thus, according to this aspect of this disclosure, the controller may be configured to monitor the bounce back the plunger and adjust the motor drive accordingly.

In one embodiment, a fastener device comprises a housing and a motor assembly within the housing. The motor assembly comprises a stator including a plurality of coils and a plunger including at least one permanent magnet configured to magnetically interact with the plurality of coils of the stator to cause a linear movement of the plunger along a drive axis between a retracted position and an extended position, to drive a fastener into a workpiece during a drive stroke in a direction of the extended position and return to the retracted position during a return stroke. The fastener device also comprises a power source configured to provide electric power to the stator, and a controller disposed within the housing.

The fastener device, the housing, the motor assembly, the stator, the plurality of coils, the plunger, the at least one permanent magnet, the drive axis, the drive stroke, the return stroke, the extended position, the retracted position, and the controller are all described in detail in other embodiments of this disclosure and, therefore, will not be described in detail here again. The power source of the fastener device is also described in detail in other embodiments of this disclosure. For example, the power source may include a (removeable) battery pack. The power source may include the battery pack and a capacitor.

The controller may be configured switchably to control a supply of electric power from the power source to the stator to control the linear movement of the plunger during the drive stroke and the return stroke. The controller may also be configured to determine a bounce back velocity of the plunger relative to the extended position, and to change an energization value of the electric power supplied to the stator if the bounce back velocity of the plunger is outside a predetermined range relative to a bounce back velocity threshold.

The fastener device may further comprise a sensor configured to output a signal corresponding to a position of the plunger. The controller may be configured to determine bounce back velocity after the plunger reaches the extended position based on the signal from the sensor. The sensor may be interchangeably referred to as plunger position sensor. The sensor may be configured to output a signal corresponding to a position and/or velocity of the plunger. The sensor may be interchangeably referred to as plunger position and velocity sensor.

The controller may be configured to calculate the bounce back velocity during a preset amount of time or a preset amount of distance after the plunger begins to move towards the retracted position from the extended position. The controller may be configured to calculate the bounce back velocity during a preset amount of time or a preset amount of distance after the plunger starts the return stroke.

The fastener device further comprises a bumper that is engaged by the plunger or a driver coupled to the plunger when the driver/plunger reaches the extended position. The bumper may be made of resiliently deformable material that absorb the residue kinetic energy of the driver and/or the plunger when the extended position has been reached. The bounce back velocity may be associated with contact with the bumper. Specifically, the biasing force applied by the bumper to the plunger and/or driver may contribute to the bounce back velocity. The bumper is described in detail in other embodiments of this disclosure and, therefore, will not be described in detail here.

The fastener device may further comprise a switch circuit located between the power source and the motor assembly. The controller may be configured to apply drive signals to the switch circuit to control the commutation of the stator. The process of commutation is switching the current supplied to the stator when the plunger has reached the desired position.

The energization value of the electric power may be controlled by controlling the pulse-width modulation (PWM) duty cycle. The energization value of the electric power may alternatively and/or additionally be controlled by controlling the cycle-by-cycle current limit applied to the motor. The energization value of the electric power may include pulse-width modulation (PWM) duty cycle and cycle-by-cycle current limit. It should be understood that the energization value may be set and/or controlled according to any other power or current control technique previously described, including but not limited to, current vector control, conduction band control, etc.

The controller may be configured to control a pulse-width modulation (PWM) duty cycle of the drive signals at a first duty cycle during the drive stroke and at a second duty cycle during the return stroke. The controller may be configured to modify at least one of the second duty cycle during the return stroke or the first duty cycle during a subsequent drive stroke if the bounce back velocity of the plunger is outside the predetermined range relative to the bounce back velocity threshold.

The controller may be configured to control a pulse-width modulation (PWM) duty cycle of the drive signals to regulate the flow of electric power to the stator, and to apply a cycle-by-cycle current limit by interrupting the flow of electric power through the switch circuit for a remainder of each PWM cycle if a current level of the electric power exceeds a current threshold. The cycle-by-cycle current limit is set to a first level during the drive stroke and to a second level during the return stroke. The controller may be configured to modify at least one of the second duty cycle during the return stroke or the first duty cycle during a subsequent drive stroke if the bounce back velocity of the plunger is outside the predetermined range relative to the bounce back velocity threshold.

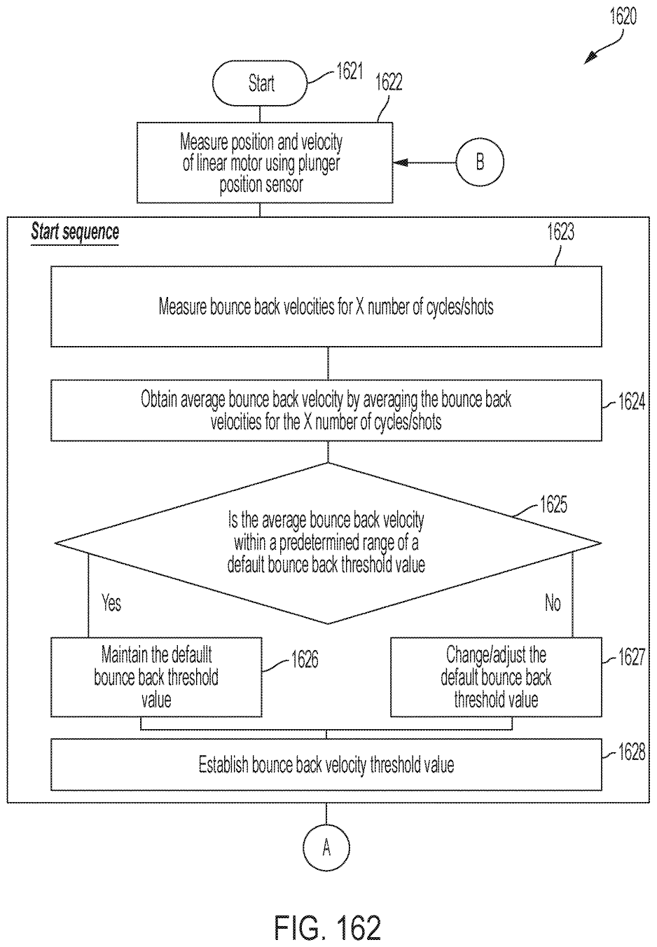

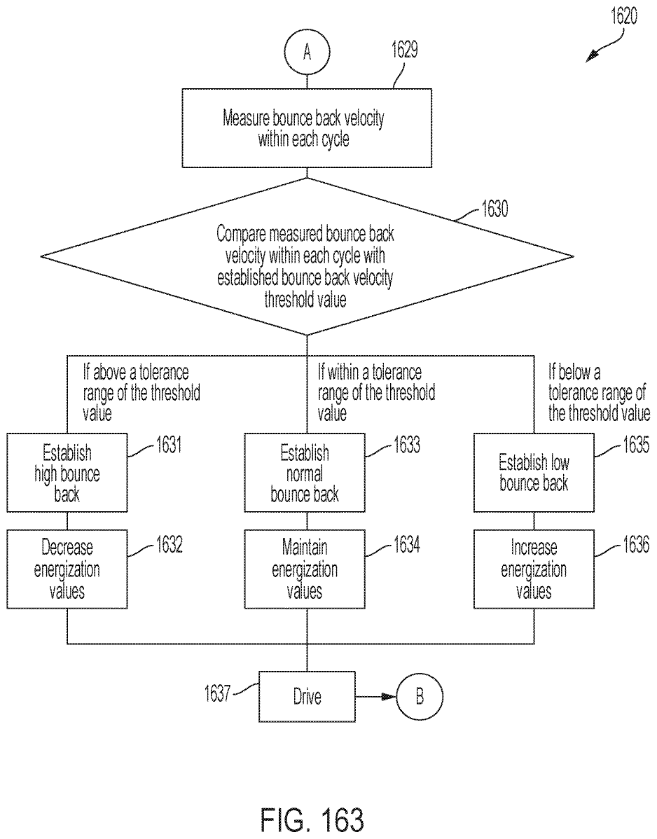

Referring to FIGS. 162 and 163, a method 1620 for determining/detecting bounce back and for adjusting/changing the energy based on the determination/detection of the bounce back is provided. That is, the method 1620 may be configured for changing an energization value of the electric power supplied to the stator if the bounce back velocity of the plunger is outside a predetermined range relative to the bounce back velocity threshold.

Referring to FIG. 162, the method 1620 begins at procedure 1621. At procedure 1622, the position and/or the velocity of the plunger may be measured using the plunger position sensor. Specifically, in an embodiment, the controller may receive a position signal indicative of the position of the plunger may from the plunger position sensor and may determine the velocity of the plunger (after the plunger reaches the extended position) based on the position signal.

In an embodiment, the controller may be configured to dynamically set the bounce back velocity threshold as a function of repeated operations of the fastener device. For example, the controller may be configured to determine a plurality of bounce back velocity values associated with a predetermined number of drive strokes, determine a target bounce back velocity of the plunger as a function of the plurality of bounce back velocity values, and change the bounce back velocity threshold according to the target bounce back velocity if the target bounce back velocity is outside the predetermined range relative to the bounce back velocity threshold. The controller may be configured to maintain the bounce back velocity threshold if the target bounce back velocity of the plunger is within the predetermined range. This concept is also explained below with respect to procedures 1623-1628 denoted as the “start sequence” in FIG. 162. It should be understood, however, that these procedures may be executed at any time during the fastening tool operation, and are not limited to a start-up operation of the fastening tool.

In the start sequence of the method 1620, the controller may monitor the bounce back over a number of drive sequences and dynamically set the bounce back velocity threshold accordingly. The start sequence of the method 1620 may include procedure 1623 in which the plurality of bounce back velocities are measured for the predetermined number of drive strokes (e.g., for X number of cycles/shots) and procedure 1624 in which the target bounce back velocity of the plunger may be determined as a function of the plurality of bounce back velocity values. For example, at procedure 1624, an average bounce back velocity may be obtained by averaging the measured plurality of bounce back velocities for the predetermined number of drive strokes. The target bounce back velocity of the plunger may include the average bounce back velocity.

The start sequence of the method 1620 also may include procedure 1625 in which the controller may be configured to determine whether the target (or average) bounce back velocity is within the predetermined range relative to the bounce back velocity threshold, procedure 1626 in which the controller may be configured to maintain the bounce back velocity threshold if the target (or average) bounce back velocity of the plunger is within the predetermined range relative to the bounce back velocity threshold, procedure 1627 in which the controller may be configured to change the bounce back velocity threshold if the target (or average) bounce back velocity of the plunger is outside the predetermined range relative to the bounce back velocity threshold, and procedure 1628 in which the controller may be configured to establish/set the bounce back velocity threshold (e.g., either maintained bounce back velocity threshold from the procedure 1626 or changed bounce back velocity threshold from the procedure 1627).

Referring to FIG. 163, after the bounce back velocity threshold is optionally set in the start sequence described above, the method 1620 may proceed to procedure 1629 in which the controller may be configured to measure the bounce back velocity of the plunger within each subsequent cycle or to determine the bounce back velocity of the plunger relative to the extended position.

The method 1620 may include procedure 1630 in which the controller may be configured to compare the bounce back velocity of the plunger with the (established/set) bounce back velocity threshold of procedure 1628 to determine if the bounce back velocity of the plunger is outside the predetermined range relative to the bounce back velocity threshold.

When the bounce back velocity of the plunger is above the bounce back velocity threshold (i.e., outside a predetermined range relative to the bounce back velocity threshold), at procedure 1631, the controller may be configured to establish that the bounce back of the plunger is high and, at procedure 1632, the controller may be configured to decrease the energization value of the electric power supplied to the stator. That is, the controller may be configured to determine that the plunger has a high bounce back velocity if the bounce back velocity of the plunger is greater than the predetermined range relative to the bounce back velocity threshold, and to decrease the energization value if the plunger has the high bounce back velocity.

When the bounce back velocity of the plunger is below the bounce back velocity threshold (i.e., outside a predetermined range relative to the bounce back velocity threshold), at procedure 1635, the controller may be configured to establish that the bounce back of the plunger is low and, at procedure 1636, the controller may be configured to increase the energization value of the electric power supplied to the stator. That is, the controller may be configured to determine that the plunger has a low bounce back velocity if the bounce back velocity of the plunger is smaller than the predetermined range relative to the bounce back velocity threshold, and to increase the energization value if the plunger has the low bounce back velocity.

When the bounce back velocity of the plunger is within the predetermined range relative to the bounce back velocity threshold), at procedure 1633, the controller may be configured to establish that the bounce back of the plunger is normal and, at procedure 1634, the controller may be configured to maintain the energization value of the electric power supplied to the stator. That is, the controller is configured to determine that the plunger has a normal bounce back velocity if the bounce back velocity of the plunger is within the predetermined range relative to the bounce back velocity threshold, and to maintain the energization value of the motor assembly if the plunger has the normal bounce back velocity.

After changing or maintaining the energization value of the motor assembly based on the bounce back velocity of the plunger (e.g., at procedures 1632, 1634, or 1636), the method 1620 continues with the return stroke and with the subsequent drive stroke using this energization value of the motor assembly at procedure 1637.

Another aspect of the disclosure is described herein. In an embodiment, in a normal firing operation of the fastener, the driver is expected to make contact with the fastener as the plunger is approaching its extended position. This contact causes a rapid deceleration of the plunger within a predetermined range of the extended position. If a fastener has not been fed (e.g., via a feeding mechanism from the magazine) for engagement with the driver (referred to herein as a “dry fire event”), the deceleration of the plunger occurs at approximately the extended position (i.e., upon reaching the bumper). Similarly, if a fastener is jammed along the drive path and cannot be driven by the driver into the workpiece (referred to herein as a “jam event”), the deceleration of the plunger occurs upon contact with the fastener. If the plunger itself becomes stalled along the travel path, it may exhibit a rapid deceleration at some point before contact with the fastener. In any of these events (cumulatively referred to as “abnormal drive events”), the deceleration of the plunger exhibits characteristics that are different from the rapid deceleration of the plunger associated with a normal firing operation of the fastener. In an embodiment, the controller may be configured to detect one or more of these conditions by monitoring the timing and/or location of a declaration of the plunger relative to the extended position, as discussed herein in detail.

In one embodiment, a fastener device comprises a housing and a motor assembly within the housing. The motor assembly comprises a stator including a plurality of coils and a plunger including at least one permanent magnet configured to magnetically interact with the plurality of coils of the stator to cause a linear movement of the plunger along a drive axis between a retracted position and an extended position, to drive a fastener into a workpiece during a drive stroke in a direction of the extended position and return to the retracted position during a return stroke. The fastener device may also include a power source configured to provide electric power to the stator, and a controller disposed within the housing. The controller may be configured switchably to control a supply of electric power from the power source to the stator to control the linear movement of the plunger during the drive stroke and the return stroke. The controller may be configured to detect a change in a velocity of the plunger during a drive stroke, and to detect an abnormal drive event indicative of the fastener not having been driven during the drive stroke as a function of an axial position of the plunger at the time of the detected change of the velocity of the plunger.

The fastener device, the housing, the motor assembly, the stator, the plurality of coils, the plunger, the at least one permanent magnet, the drive axis, the drive stroke, the return stroke, the extended position, the retracted position, and the controller are all described in detail in other embodiments of this disclosure and, therefore, will not be described in detail here again. The power source of the fastener device is also described in detail in other embodiments of this disclosure. For example, the power source may include a (removeable) battery pack. The power source may include the battery pack and a capacitor.

The fastener device may further include a sensor configured to output a signal corresponding to a position of the plunger. The sensor may be interchangeably referred to as plunger position sensor.

The fastener device may further include an abnormal drive error illuminator. The abnormal drive error illuminator may be, for example, an LED mounted on the housing of the fastening tool that is visible by the tool operator. The abnormal driver error illuminator may be the same as the warming sequence LED previously discussed. In an example, a lighting pattern of the LED may be controlled in a unique pattern associated with the abnormal driver error, i.e., a jam event, a stall event, or a dry fire event. The controller may be configured to illuminate the abnormal drive error illuminator when the abnormal drive event is detected. In an embodiment, the abnormal drive error illuminator may include a jam error illuminator that is configured to be illuminated when the jam event is detected, a dry-fire error illuminator that is configured to be illuminated when the dry-fire event is detected, and a stall illuminator that is configured to be illuminated when the stall event is detected.

The abnormal drive error illuminator (including the jam error illuminator, the stall illuminator, and/or the dry-fire error illuminator) may include LEDs and may be operatively connected to the controller. The controller may be configured to illuminate the jam error illuminator when the jam event is detected, to illuminate the stall illuminator when the stall event is detected and to illuminate the dry-fire error illuminator when the dry-fire event is detected. The controller may be configured to turn off the dry-fire error illuminator after the dry-fire event is resolved/addressed. The controller may be configured to turn off the jam error illuminator after the jam event is resolved/addressed. The controller may be configured to turn off the stall illuminator after the stall event is resolved/addressed. The abnormal drive error illuminator (including the jam error illuminator, the stall illuminator, and/or the dry-fire error illuminator) may be configured to provide a visual indication of the abnormal drive error to a user. The abnormal drive error illuminator may be optional. In other embodiments, the abnormal drive error illuminator may be in the form of an abnormal drive error indicator that is configured to provide other types of indications (e.g., audio, haptic, etc.) of the abnormal drive error to a user.

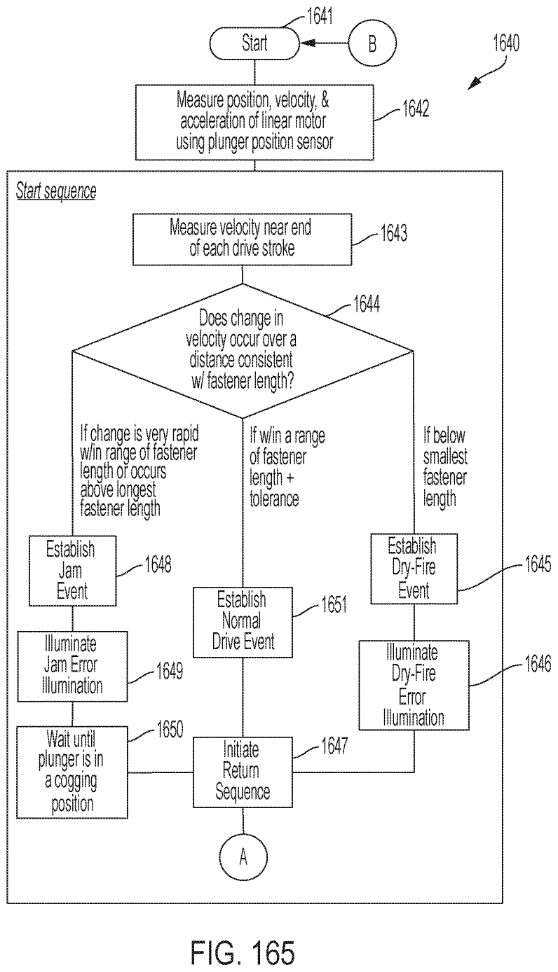

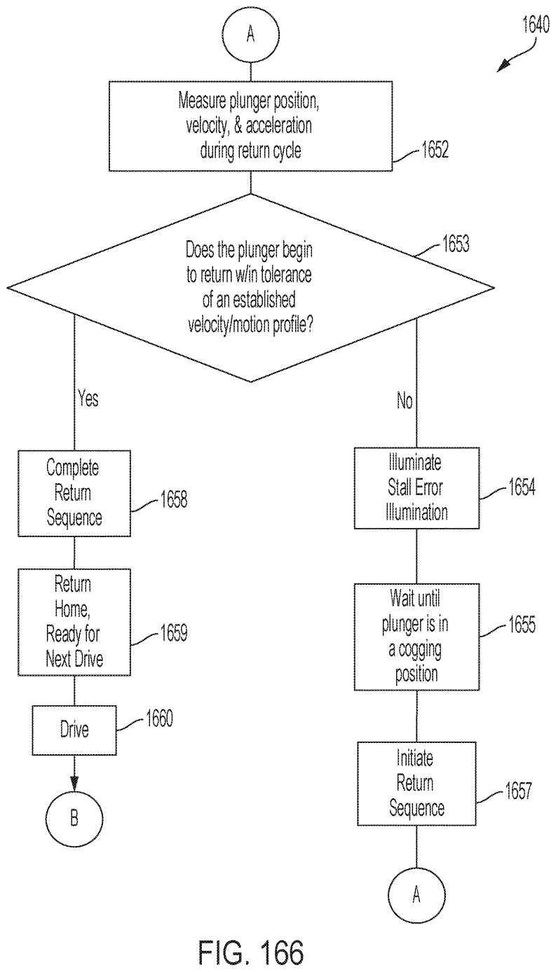

Referring to FIGS. 165 and 166, a method 1640 for determining/detecting dry fire/stall based on position and/or velocity profile of the plunger is provided.

Referring to FIG. 165, the method 1640 begins at procedure 1641. At procedure 1642, the position, velocity and/or acceleration of the plunger may be measured using the plunger position sensor. The position of the plunger may be measured using the plunger position sensor and the velocity and/or the acceleration of the plunger may be determined using the position of the plunger from the sensor.

In a start sequence of the method 1640, jam event, normal drive event, or dry fire event may be established. The start sequence of the method 1620 may include procedure 1643 in which the controller may be configured to measure velocity of the plunger (e.g., near end of each drive stroke), and procedure 1644 in which the controller may be configured to determine if change in velocity of the plunger occurs over a distance consistent with the length of the fastener.

At procedure 1645, a dry fire event is detected. The controller may be configured to calculate a rate of change in the velocity of the plunger within a predetermined travel range of the plunger relative to the extended position to detect the dry fire event. The predetermined travel range of the plunger may correspond to a length of the fastener relative to an end of each drive stroke. The abnormal drive event may be a dry fire event. At procedure 1646, the controller may be configured to illuminate the dry-fire error illuminator when the dry-fire event is detected (at procedure 1645). The method 1640 then returns to procedure 1647 in which the return stroke is initiated.

In an aspect, the predetermined travel range corresponds to the length of the fastener, and an absence of change in the velocity of the plunger until it has reached the extended position is indicative of the dry fire event.

At procedure 1648, a jam event is detected. The controller may be configured to detect the jam event if a magnitude of the detected rate of change of velocity exceeds a predetermined threshold and the detected change in the velocity of the plunger occurs at a distance from the extended position that is greater than a distance threshold. The distance threshold may correspond to a length of the fastener. The abnormal drive event may include a jam event related to the fastener. At procedure 1649, the controller may be configured to illuminate the jam error illuminator when the jam event is detected (at procedure 1648). At procedure 1650, the controller may be configured to wait until the plunger is in a cogging equilibrium before initiating the return stroke. The cogging equilibrium refers to one or more positions of the plunger relative to the stator in a deenergized state of the motor. Specifically, the cogging forces resulting from the magnetic interaction between the stator windings and the plunger magnets tend to cause the plunger to be held at one of a series of specific cogging locations along the drive axis. In an embodiment, the controller may be configured to wait for the plunger to be located at one of the cogging locations relative to the stator before it initiates the return stroke. In some instances, human intervention may be needed to release the jam before the return stroke can be initiated. The method 1640 then returns to the procedure 1647 in which the return stroke is initiated.

At procedure 1651, a normal drive event is detected. The controller may be configured to detect a normal drive stroke if the change in the velocity of the plunger occurs at a distance from the extended position that is within a distance threshold range. The distance threshold range may correspond to a range of possible lengths of the fastener. The controller may be configured to initiate the return stroke when the normal drive stroke is detected. The method 1640 then returns to the procedure 1647 in which the return stroke is initiated.

Referring to FIG. 166, at procedure 1652, the controller may be configured to obtain the velocity and the position of the plunger for each return stroke. In one embodiment, position, velocity, and/or acceleration of the plunger during the return stroke are measured. In one embodiment, the position of the plunger during the return stroke is measured, and the velocity, and/or acceleration of the plunger are measured using the position of the plunger.

At procedure 1653, the controller may be configured to determine if the velocity and/or the position of the plunger for each return stroke is within a predetermined return stroke threshold.

At procedure 1654, the controller may be configured to detect a stall event if the velocity and/or the position of the plunger for each return stroke is not within a predetermined return stroke threshold. The predetermined return stroke threshold may include a predetermined return stroke velocity threshold and/or a predetermined return stroke position threshold. The controller is configured to illuminate the stall error illuminator when the stall event is detected.

After detection of the stall event, at procedure 1655, the controller may be configured to wait until the plunger is in a cogging position relative to the stator before initiating a return sequence at procedure 1657.

If, at procedure 1653, it is determined that the velocity and/or the position of the plunger for each return stroke is within a predetermined return stroke threshold, the controller may be configured to complete the return stroke at procedure 1658, the controller may be configured to return the plunger to the retracted position so as to be ready for the next/subsequent drive cycle at 1659, and the controller may be configured to initiate the drive cycle at procedure 1660.

Applicant of this disclosure has recognized that air gap between the stator and the plunger is important so both the stator and the plunger must be retained in relation to each other. The plunger must be able to translate forward and backwards along the drive axis with minimal friction while maintaining an acceptable airgap with the stator. For drive efficiency, mass in the plunger should also be maintained low and the entire assembly should be manufacturable in an efficient manner. This disclosure provides many different constructions of the stator, the plunger, and related retention parts/components that are possible to achieve similar effects (drive efficiency, airgap between the plunger and the stator, etc.). Similar electromagnetic outcomes are also possible with different plunger and stator constructions that offer varied benefits. Some of these constructions are detailed in the discussions of this disclosure.

The present disclosure and its various embodiments as described above uniquely address the observed, noted and researched findings and improve on the prior and current state of the art systems. The listed products, features and embodiments as described in the present disclosure should not be considered as limiting in any way.

Although the present disclosure has been described in detail for the purpose of illustration, it is to be understood that such detail is solely for that purpose and that the present disclosure is not limited to the disclosed embodiments, but, on the contrary, is intended to cover modifications and equivalent arrangements that are within the spirit and scope of the appended claims. In addition, it is to be understood that the present disclosure contemplates that, to the extent possible, one or more features of any embodiment can be combined with one or more features of any other embodiment.

The illustration of the embodiments of the present disclosure should not be taken as restrictive in any way since a myriad of configurations and methods utilizing the present disclosure can be realized from what has been disclosed or revealed in the present disclosure. The systems, features and embodiments described in the present disclosure should not be considered as limiting in any way. The illustrations are representative of possible construction and mechanical embodiments and methods to obtain the desired features. The location and/or the form of any minor design detail or the material specified in the present disclosure can be changed and doing so will not be considered new material since the present disclosure covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by a person of ordinary skill in the art in the context of the various elements, components, regions, layers and/or sections being described.

The foregoing illustrated embodiments have been provided to illustrate the structural and functional principles of the present disclosure and are not intended to be limiting. To the contrary, the present disclosure is intended to encompass all modifications, alterations and substitutions within the spirit and scope of the appended claims.

What is claimed is:

1. A fastener device that drives one or more fasteners into a workpiece comprising:
a tool housing;
a motor assembly within the tool housing, the motor assembly comprising a stator set including a first stator, a second stator, and a plunger; and
a driver within the tool housing and drivable via the plunger, the plunger configured to travel along a drive axis between a retracted condition and an extended condition to drive a fastener of the one or more fasteners into the workpiece during a drive stroke,
wherein the first stator and the second stator are spaced apart circumferentially around the plunger and the plunger is disposed between the first stator and the second stator to magnetically interact with each of the first stator and the second stator.

2. The fastener device of claim 1, wherein the first stator includes a first stator core oriented along a first plane that is substantially parallel to the drive axis, a plurality of first teeth extending inwardly from the first stator core in a direction substantially perpendicularly to the first plane and perpendicular to the drive axis, and a plurality of first windings wound around the plurality of first teeth, and
wherein the second stator includes a second stator core oriented along a second plane that is substantially parallel to the drive axis, a plurality of second teeth extending inwardly from the second stator core in a direction substantially perpendicular to the second plane and perpendicular to the drive axis, and a plurality of second windings wound around the plurality of second teeth.

3. The fastener device of claim 1, wherein the first stator and the second stator are:
physically separate from each other, and
configured to be operated synchronously.

4. The fastener device of claim 1, wherein a plurality of phases of the first stator is respectively electrically coupled to a plurality of phases of the second stator,
further comprising an inverter circuit comprising a plurality of power switches configured to synchronously drive the first stator and the second stator via a common plurality of phase voltage input lines.

5. The fastener device of claim 4, wherein the motor assembly further comprises a frame,
wherein the first stator and the second stator are configured to be coupled to the frame, and
wherein the plurality of phases of the first stator is connected to the plurality of phases of the second stator via a plurality of connectors or wires disposed along the frame.

6. The fastener device of claim 1, further comprising a first inverter circuit comprising a plurality of first power switches configured to drive the first stator via a first plurality of phase voltage input lines, and a second inverter circuit comprising a plurality of second power switches configured to drive the second stator via a second plurality of phase voltage input lines.

7. The fastener device of claim 6, wherein the first inverter circuit and the second inverter circuit are synchronously controlled to cause synchronous drive of the first stator and the second stator.

8. The fastener device of claim 1, wherein the motor assembly includes a plurality of first stators and a plurality of second stators,
wherein the plurality of first stators extends along a single first axis substantially parallel to the drive axis and are disposed on one side of the driver,
wherein the plurality of second stators extends along a single second axis substantially parallel to the drive axis and are disposed on an opposing side of the driver,
wherein the first stator is one of the plurality of first stators and the second stator is one of the plurality of second stators,
wherein one of the plurality of first stators and one of the plurality of second stators is operated synchronously to drive the driver along the drive axis, and
wherein the plurality of first stators is configured to be sequentially energized to drive the driver along the drive axis, and the plurality of second stators are configured to be sequentially energized to drive the driver along the drive axis.

9. The fastener device of claim 8, wherein a commutation of a subsequent stator of the plurality of first stators begins when the plunger reaches a predetermined distance relative to the first stator.

10. The fastener device of claim 1, wherein the plunger includes a plurality of magnets with alternating polarities in sequence, and
wherein the plunger includes a plurality of plunger cores, each plunger core is configured to house at least one magnet of the plurality of magnets.

11. The fastener device of claim 10, wherein the at least one magnet includes a first magnet and a second magnet,
wherein each plunger core is configured to house the first magnet on a first side of that plunger core and the second magnet on a second side of that plunger core, the second side opposing the first side, and
wherein the driver is disposed between the first side and the second side of each plunger core and is disposed between the first magnet and the second magnet.

12. The fastener device of claim 2, wherein the motor assembly further comprises a frame, and
wherein the first stator and the second stator are configured to be coupled to the frame.

13. The fastener device of claim 12, wherein the frame comprises non-magnetic material.

14. The fastener device of claim 12, wherein the frame extends along a third plane substantially perpendicular to the first plane and the second plane between the first stator and the second stator.

15. A linear motor comprising:
a plunger including at least one permanent magnet configured to travel along a drive axis; and
a stator in magnetic interface with the plunger, the stator comprising: a stator core oriented along a plane that is substantially parallel to the drive axis, a plurality of stator teeth extending from the stator core towards the plunger in a direction substantially perpendicular to the plane, and a plurality of stator windings wound around the plurality of stator teeth such that a winding plane of the plurality of stator windings is substantially perpendicular to the drive axis.

16. The linear motor of claim 15, wherein the plunger includes a plunger core that supports the at least one permanent magnet in magnetic interaction with the plurality of stator windings.

17. The linear motor of claim 16, further comprising a sense magnet secured to a side of the plunger core not facing the stator, and a frame extending from the stator configured to support a Hall board having a plurality of Hall sensors linearly oriented to sense a magnetic flux of the sense magnet as the plunger travels along the drive axis.

18. A power tool comprising:
a linear motor including a plunger including at least one permanent magnet configured to travel along a drive axis; a first stator in magnetic interface with the plunger; and a second stator in magnetic interface with the plunger and disposed adjacent the first stator along the drive axis, wherein each of the first stator and the second stator includes: a stator core, a plurality of stator teeth extending from the stator core towards the plunger, and a plurality of stator windings wound around the plurality of stator teeth such that a winding plane of the plurality of stator windings is substantially tangential to the drive axis, the plurality of stator windings forming a plurality of phases for each of the first stator and the second stator; and
at least one controller configured to control a commutation of the first stator and the second stator such that, during at least a position of the plunger relative to the first stator and the second stator, at least one of the plurality of phases of the first stator applies a repelling force to the plunger while at least one of the plurality of phases of the second stator applies an attracting force to the plunger.
